(19) United States
(12) Patent Application Publication
(10) Pub. No.: US 2003/0233321 A1
(43) Pub. Date: Dec. 18, 2003

(54) Integrated invoice solution

(76) Inventors: Anthony J. Scolini, Danville, CA (US); John C. Gingrich, San Ramon, CA (US); Steven P. Tibbetts, Concord, CA (US); Robert T. Barber, Antioch, CA (US)

Correspondence Address: ACCENTURE C/O MORRISON & FOERSTER, 755 PAGE MILL ROAD, PALO ALTO, CA, 94304, US

(21) Appl. No.: 10/285,000

(22) Filed: Oct. 30, 2002

Related U.S. Application Data
(60) Provisional application No. 60/334,065, filed on Nov. 30, 2001.

(51) Int. Cl. G06F 17/60

(52) U.S. Cl. 705/40; 705/35

(57) ABSTRACT

A system and method for a web-based, convergent communications billing solution for large-scale customers/users is disclosed. The environment in which the present invention is used encompasses the general Internet environment, with connections to Banks and other similar payment mechanisms, connections to multiple carriers/users to obtain legacy files and to provide results and analysis capabilities to these same carriers/users, and encompasses modem computing and server technology to process the data, create the integrated bills, process payments and adjustments and provide the required reports to the customers and multiple carriers participating.

### RELATED APPLICATION

This application is based on Provisional Patent Application No. 60/334,065 filed on Nov. 30, 2001, the content of which is hereby incorporated by reference.

### TECHNICAL FIELD

This invention relates to the field of computer systems. More particularly, the present invention relates to a method and system for a web-based, convergent communications billing solution for large scale enterprises.

### BACKGROUND ART

It was reported in early 1999 by research & consulting company Killen & Associates, that companies that adopt electronic billing systems can expect to save up to $8 billion by 2001. The fastest movement towards electronic billing systems was reported in the utilities industries. This report was based on research done on billing practices at 50 major companies including American Express™, AT&T™ and BellSouth™.

At this time, systems for Online Billing exist in many forms. For example, Verizon™ touts Online Billing as an exciting new service for residential and small business local telephone service customers, wherein one can review a bill online, use interactive features to analyze calls, and schedule payments in advance. There also exists a number of online billing providers or online customer service providers (CSPs), wherein one can go to the CSP's website to receive, view, and pay Online bills. There appear to be at least four types of CSPs: Online bill providers, such as “CheckFree™”; Banks and Credit Unions, such as Bank One™, Chase Bank™, Hewlett-Packard Employees Credit Union™, etc.; Internet Portal sites such as “bills.com”™, Excite™, Yahoo™, etc.; and Financial Management Services, such as American Express™, Charles Schwab™, Quicken™, etc.

For example, a consumer oriented system is disclosed in U.S. Pat. No. 6,128,603 issued Oct. 3, 2000, titled “Consumer-Based System and Method for Managing and Paying Electronic Billing Statements.”

The above online billing services are focused on providing retail customers (consumers) an avenue to review and pay bills online wherein their suppliers of products and services are willing to produce the bills for their goods and services in electronic form, and are willing to participate in the various CSP arrangements. In addition however, some of these CSPs, such as Mellon Financial Corporation™, provide financial products and services to the corporate sector. Their electronic billing information system—“ebis”—offers capabilities of integrating third parties in billing and/or service functions, and gives customers and other designated users a self-service option via the Internet and a Voice Response Unit. Another example of such a system is disclosed in U.S. Pat. No. 6,078,907 issued Jun. 20, 2000 titled “Method and System for Electronically Presenting and Paying Bills.” Nevertheless, these systems are focused on smaller corporations looking to integrate straightforward billing packages with an online delivery function.

Individual companies, especially large companies in specific industries such as the communications industry or the airlines industry, wherein a single customer transaction (a long distance call for example) traverses multiple corporate entities, have special billing and accounting transaction problems which require special technical solutions. Moreover, these larger commercial entities are generally served by multiple suppliers that have legacy billing systems that are economically irreplaceable, and the integration of these legacy systems into efficient online consolidated billing and analysis functions remains a major technical and financial problem.

A technical problem presently exists in the attempt to aggregate multiple legacy billing files across carriers into a single data stream, for purposes of organizing all billing information into a customer defined and maintained web-based hierarchy. A technical solution is required for the communications industry to aggregate the data from these legacy systems into an efficient process which can produce web-based invoices and reports for fast analysis and processing; provide data drill down and data downloading for additional ad-hoc analysis; provide the ability to process adjustments and disputes and to accept a single customer payment for a consolidated invoice.

There is a need in the art for a system and method for an electronic billing system which is a web-based, convergent communications billing solution for large-scale customers.

### SUMMARY OF THE INVENTION

The present invention provides a solution to the needs described above through a system and method for:

accepting legacy billing files “as is” from multiple users/carriers/customers;

establishing and maintaining a user/customer defined hierarchy;

applying and tracking administrative fees;

calculating and applying light taxing for product set;

displaying integrated invoices and reports for analysis via the Web;

producing paper output and CD-ROM;

processing payments and adjustments made by a user/customer; and

presenting single amount to customer/user and managing the individual amounts that need to be remitted back to each user/carrier.

Still other embodiments of the present invention will become apparent to those skilled in the art from the following detailed description, wherein is shown and described only the embodiments of the invention by way of illustration of the best modes contemplated for carrying out the invention. As will be realized, the invention is capable of modification in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

The features and advantages of the system and method of the present invention will be apparent from the following description in which:

FIG. 1 illustrates an exemplary Internet distributed system configuration.

FIG. 2 illustrates a representative general purpose computer server configuration.

FIG. 3 illustrates a block diagram of the Functional Architecture of the present invention.

FIG. 4 illustrates a block diagram of a preferred embodiment depicting the Web Architecture.

FIG. 5 illustrates a block diagram of a preferred embodiment depicting the Batch Execution Environment.

FIG. 6 illustrates a block diagram of a preferred embodiment depicting the Production Hardware/Software Configuration.

FIG. 7 illustrates a block diagram of a preferred embodiment depicting the Site Map for the electronic billing solution (EBS).

FIG. 8 illustrates a block diagram of a preferred embodiment depicting the View/Pay bill section of the EBS Site Map.

FIG. 9 illustrates a block diagram of a preferred embodiment depicting the maintain hierarchy section of the EBS Site Map.

FIG. 10 illustrates a block diagram of a preferred embodiment depicting the support customer inquiries section of the EBS Site Map.

FIG. 11 illustrates a block diagram of a preferred embodiment depicting the order entry (OC3) section of the EBS Site Map.

FIG. 12 illustrates a block diagram of a preferred embodiment depicting the download reports section of the EBS Site Map.

FIG. 13 illustrates a block diagram of a preferred embodiment depicting the online reports section of the EBS Site Map.

FIG. 14 illustrates a block diagram of a preferred embodiment depicting the system administration section of the EBS Site Map.

FIG. 15 illustrates a block diagram of a preferred embodiment depicting the edit profile section of the EBS Site Map.

FIG. 16 illustrates a screen shot of a preferred embodiment depicting the invoice face page.

FIG. 17 illustrates a screen shot of a preferred embodiment depicting the summary bill face page.

FIG. 18 illustrates a screen shot of a preferred embodiment depicting the summary bill face page—private line circuit detail.

FIG. 19 illustrates a screen shot of a preferred embodiment depicting the line item adjustment.

FIG. 20 illustrates a screen shot of a preferred embodiment depicting a first user blank adjustment.

FIG. 21 illustrates a screen shot of a preferred embodiment depicting a second user blank adjustment.

FIG. 22 illustrates a block diagram of a preferred embodiment depicting the Cyclic Front End Daily File Process.

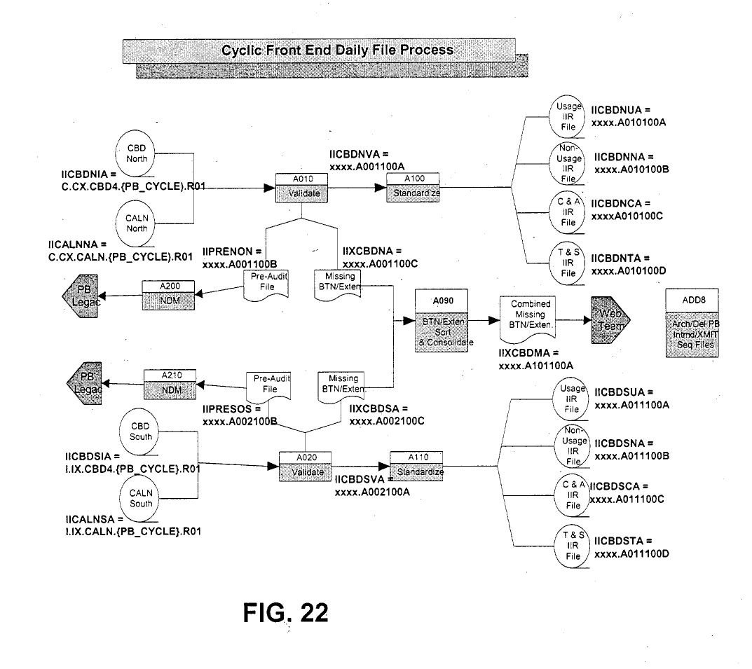

FIG. 23 illustrates a block diagram of a preferred embodiment depicting the Cyclic Front End Monthly File Process.

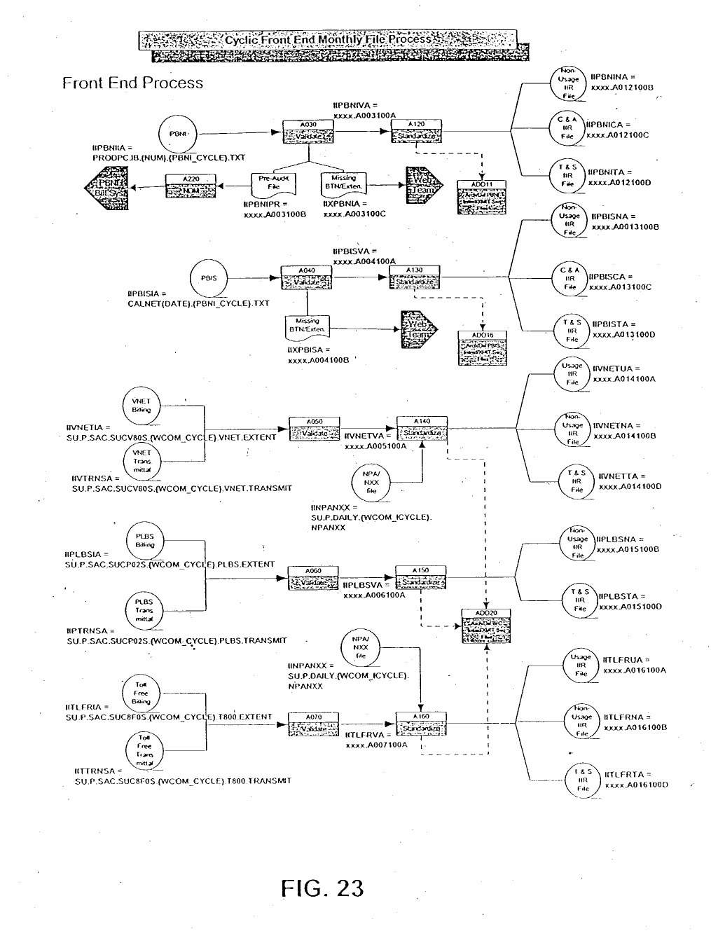

FIG. 24 illustrates block diagrams of a preferred embodiment depicting the Create Current Day File and Load ECDC.

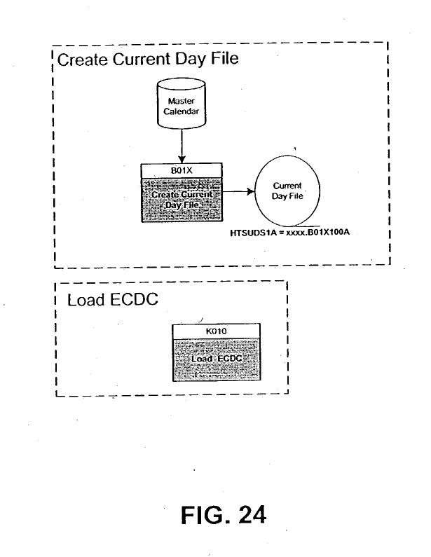

FIG. 25 illustrates a block diagram of a preferred embodiment depicting the Create Trigger Request.

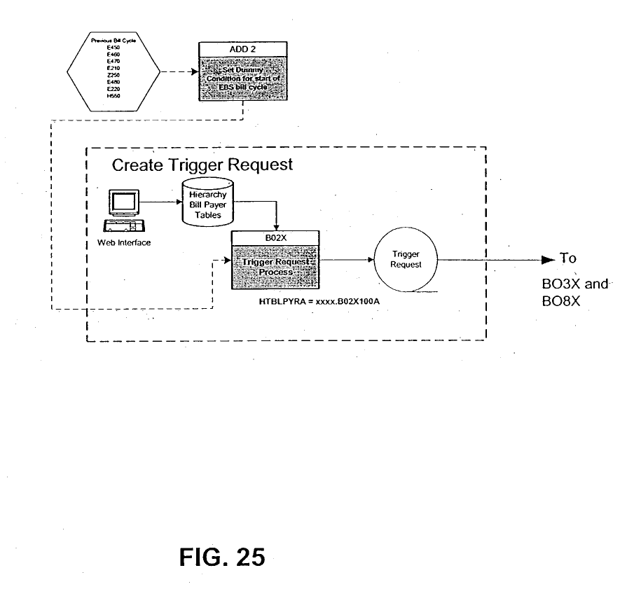

FIG. 26 illustrates a block diagram of a preferred embodiment depicting the NPA/NXX Extensions.

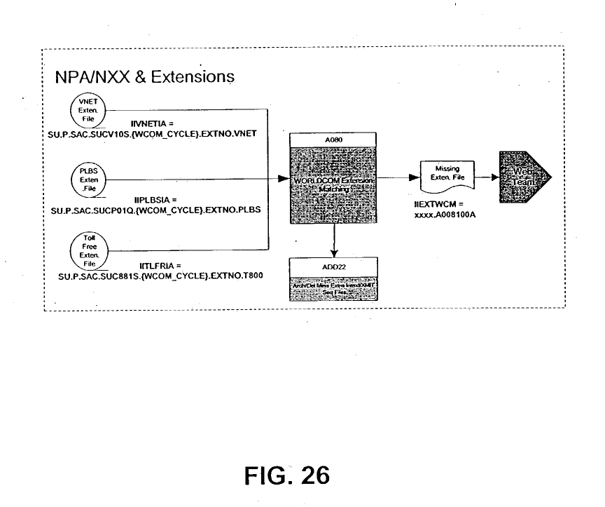

FIG. 27 illustrates a block diagram of a preferred embodiment depicting the Create Hierarchy Match File Process.

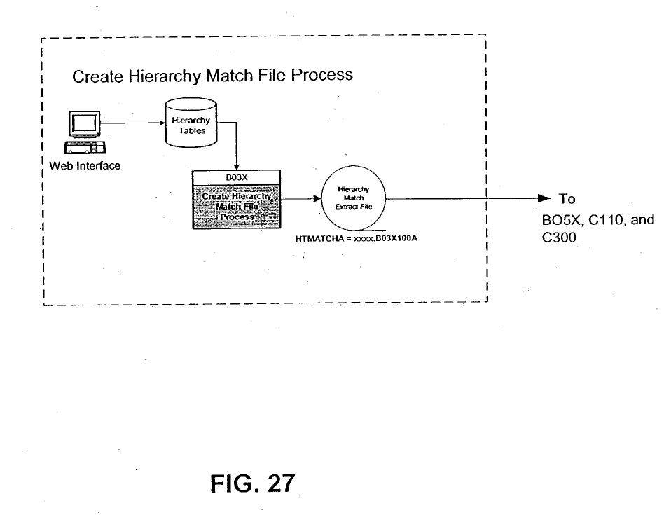

FIG. 28 illustrates a block diagram of a preferred embodiment depicting the Hierarchy Match Process.

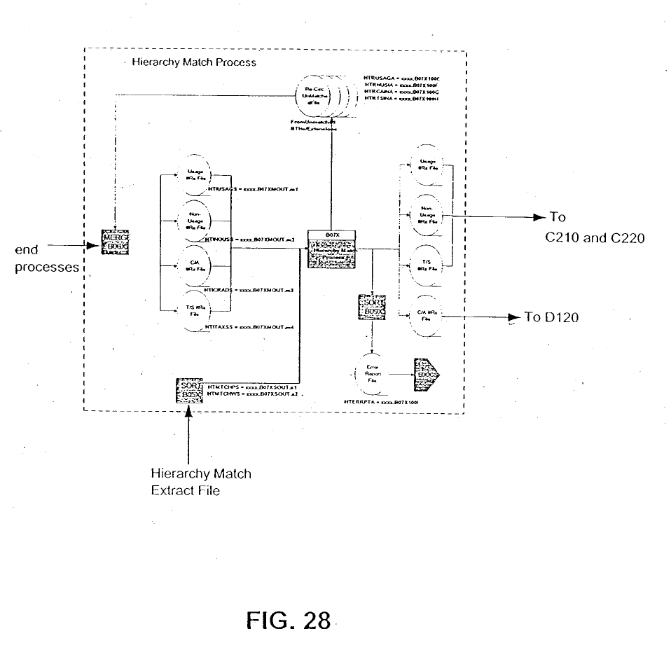

FIG. 29 illustrates a block diagram of a preferred embodiment depicting the Create OC3 Process.

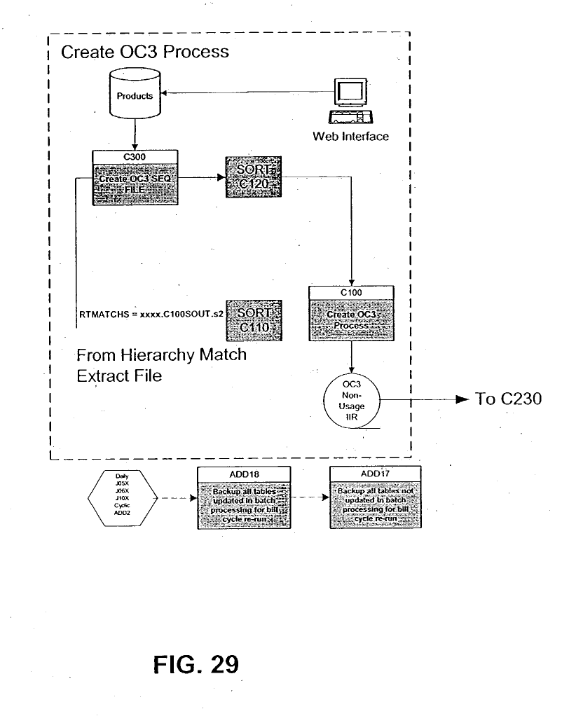

FIG. 30 illustrates a block diagram of a preferred embodiment depicting the Create Extract and Trigger File Process.

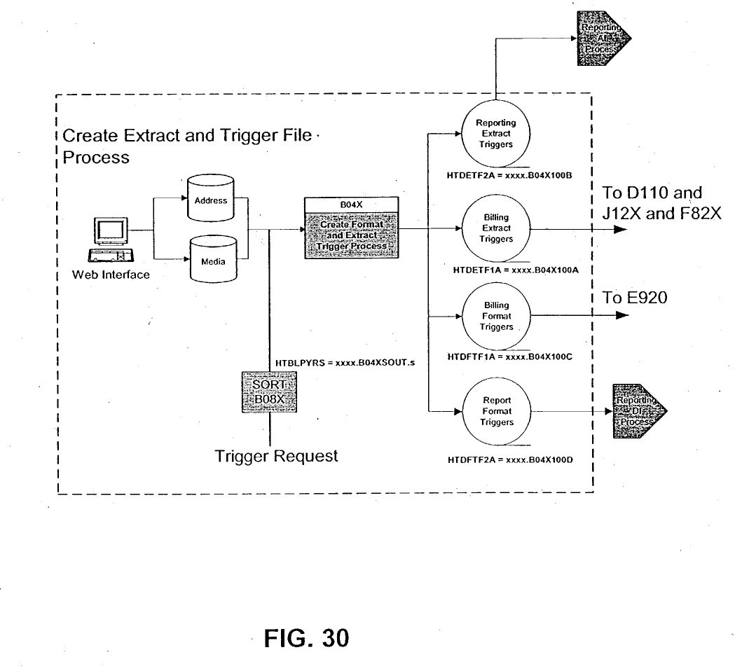

FIG. 31 illustrates a block diagram of a preferred embodiment depicting the Rating, Fees, and Taxes Process.

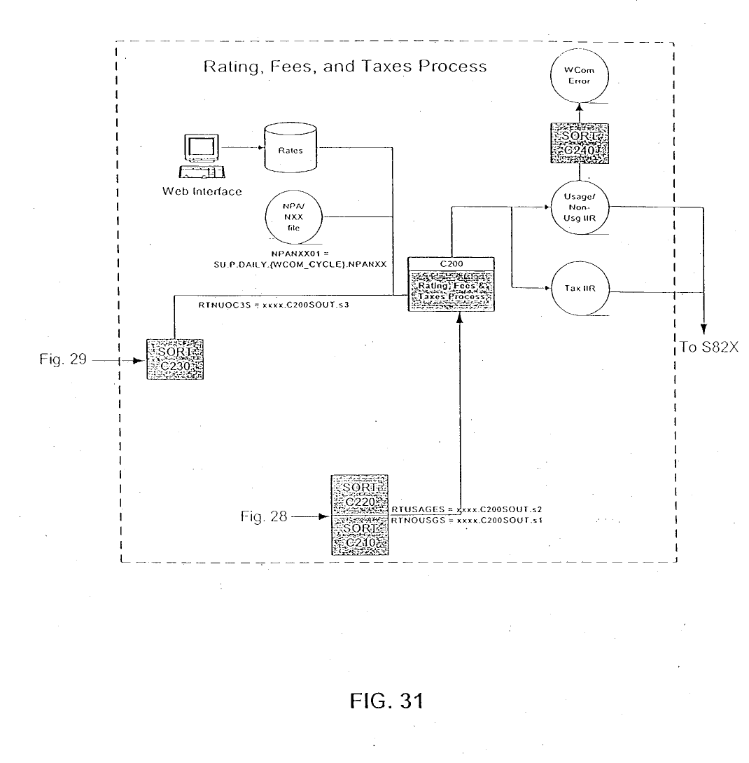

FIG. 32 illustrates a block diagram of a preferred embodiment depicting the Adjustments Process.

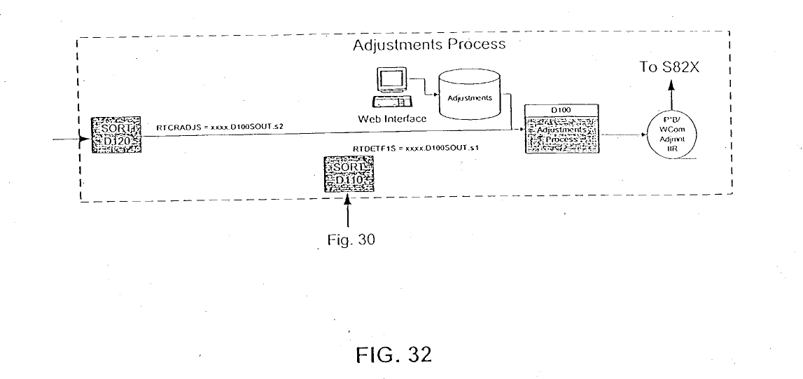

FIG. 33 illustrates a block diagram of a preferred embodiment depicting the Ar-Billing Extraction.

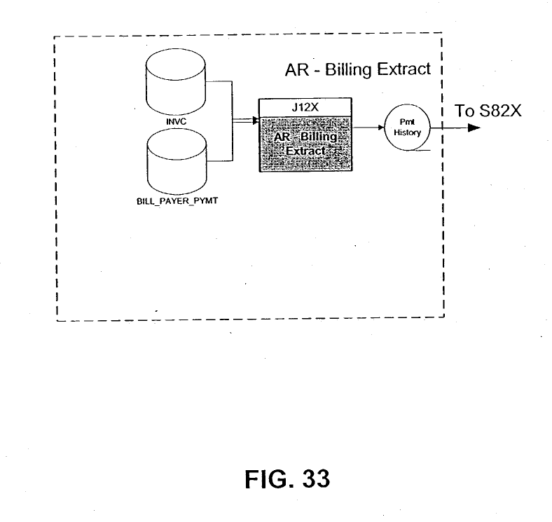

FIG. 34 illustrates a block diagram of a preferred embodiment depicting the BAI Processes.

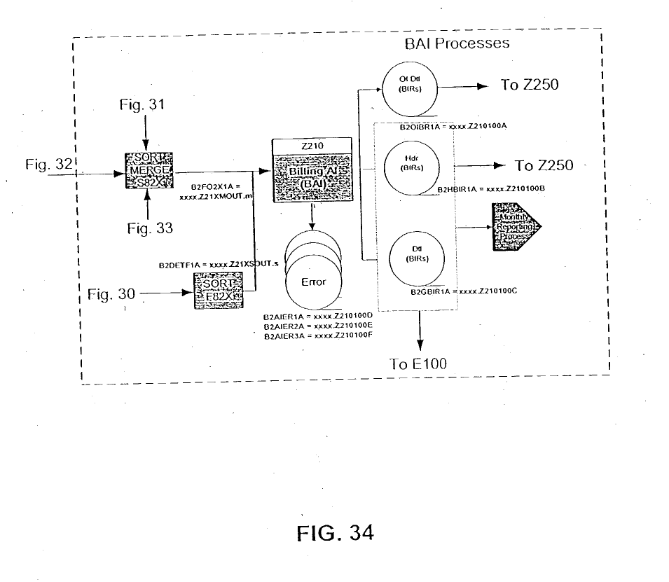

FIG. 35 illustrates a block diagram of a preferred embodiment depicting the Cyclic Tech Jobs.

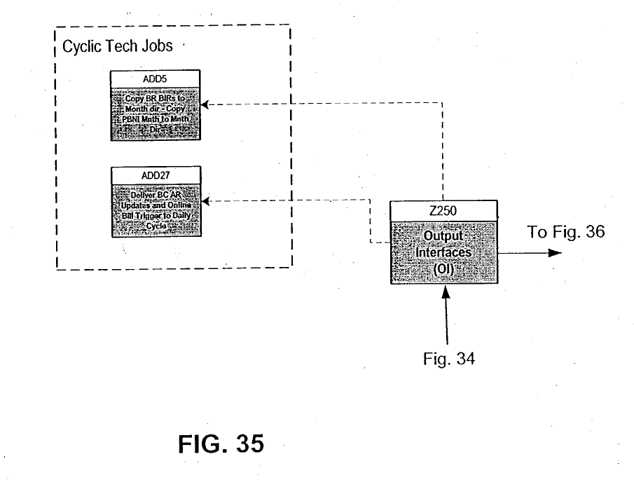

FIG. 36 illustrates a block diagram of a preferred embodiment depicting the Output Interfaces (OI) Process.

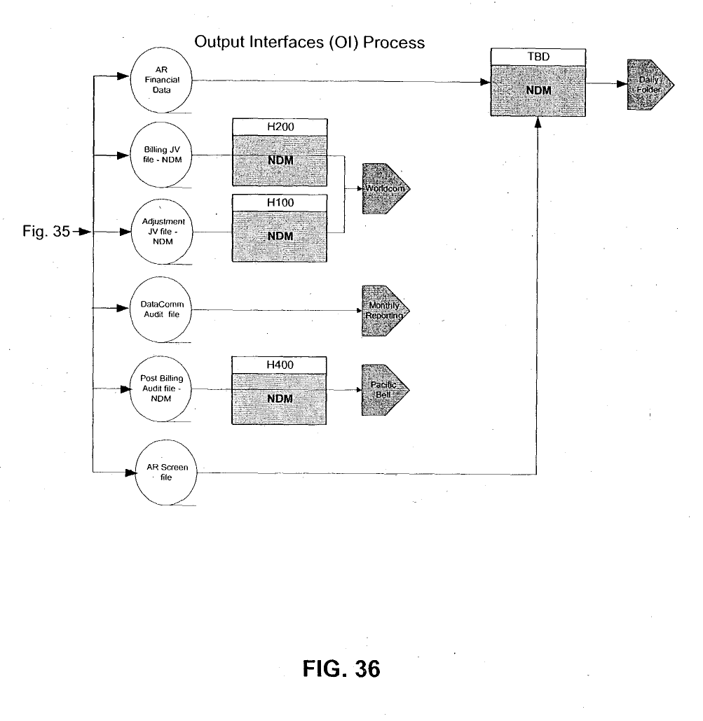

FIG. 37 illustrates a block diagram of a preferred embodiment depicting a part of the Create Billing Invoices Cyclic Processes.

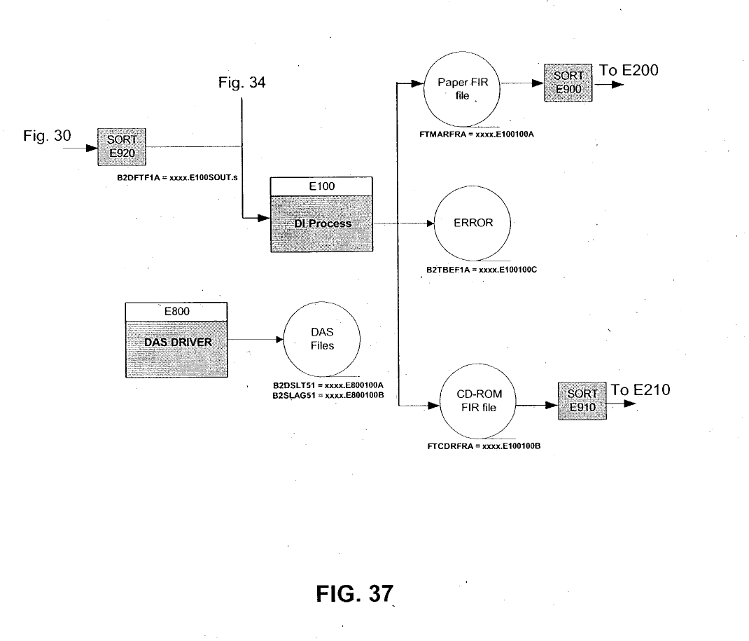

FIG. 38 illustrates a block diagram of a preferred embodiment depicting a part of the Create Billing Invoices Cyclic Processes.

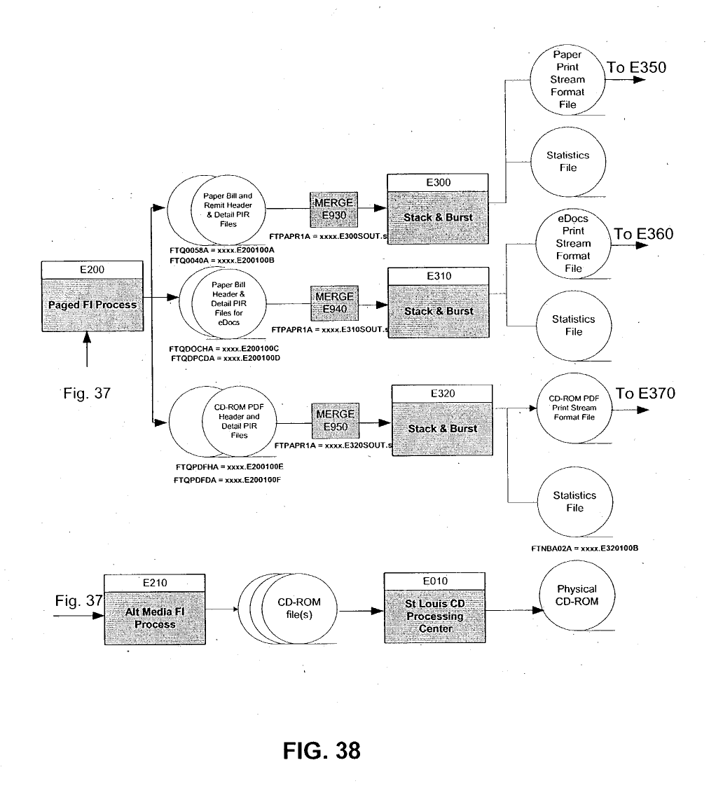

FIG. 39 illustrates a block diagram of a preferred embodiment depicting a part of the Create Billing Invoices Cyclic Processes.

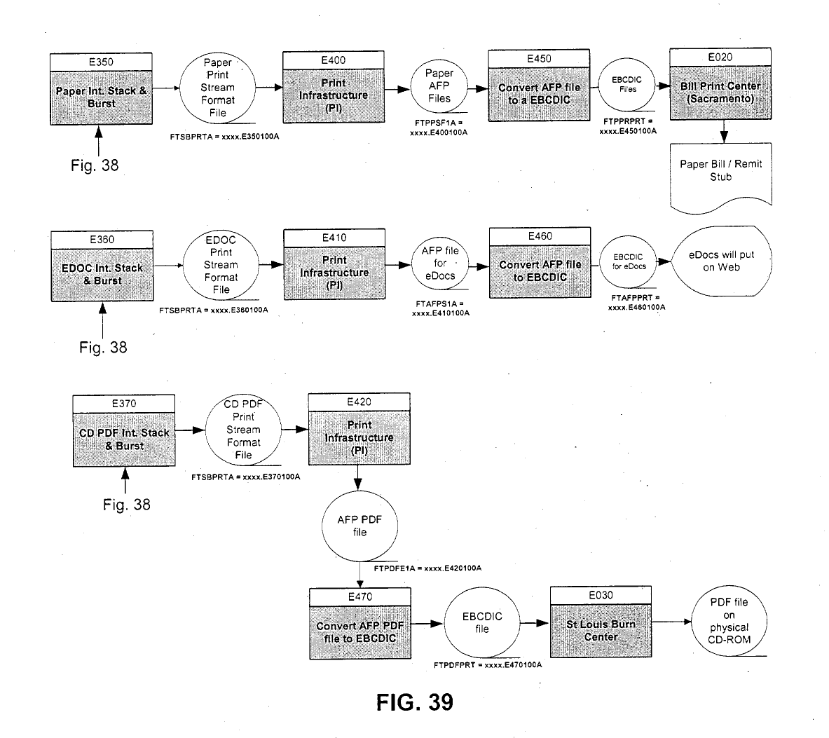

FIG. 40 illustrates a block diagram of a preferred embodiment depicting the Post Bill Cycle Process.

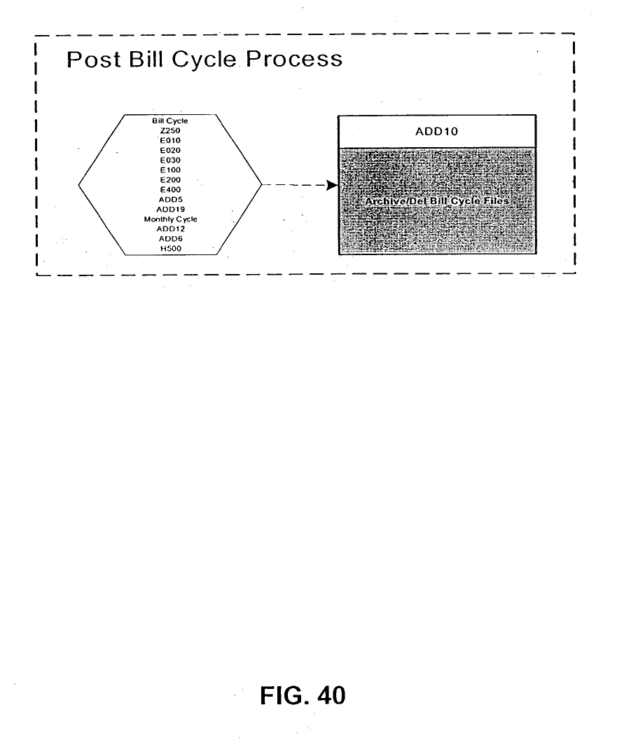

FIG. 41 illustrates a block diagram of a preferred embodiment depicting the Monthly Accounts Receivable Processes.

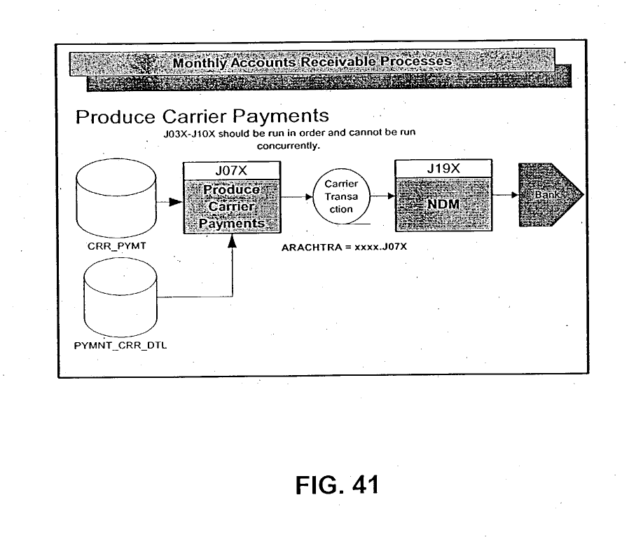

FIG. 42 illustrates a block diagram of a preferred embodiment depicting the End of Month Accounts Receivable Processes.

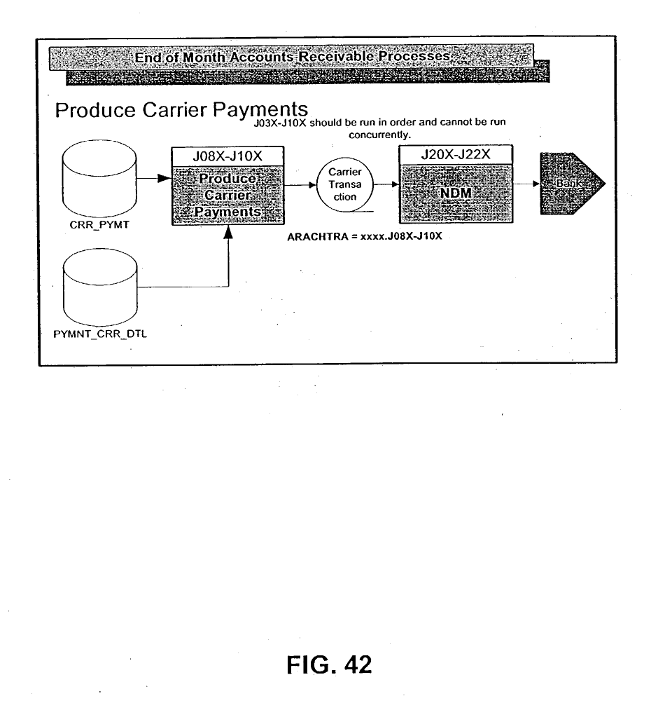

FIG. 43 illustrates a block diagram of a preferred embodiment depicting the Daily Table Reporting Processes.

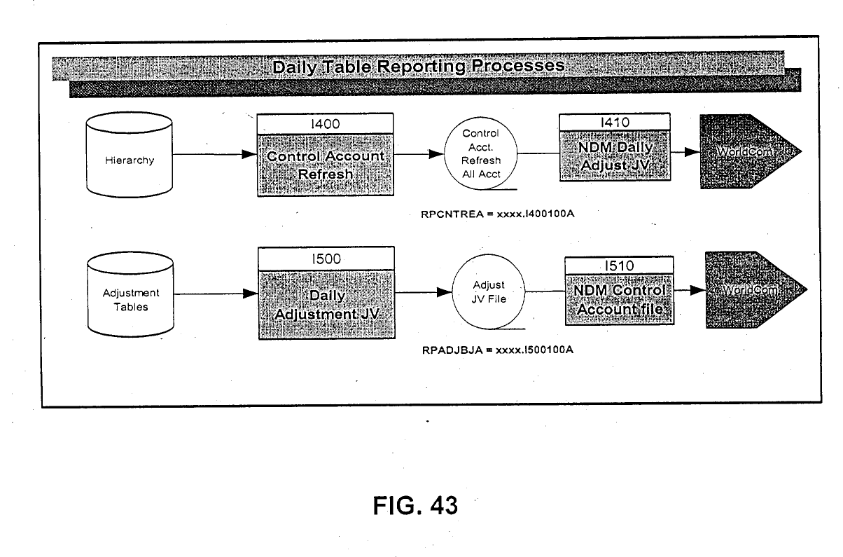

FIG. 44 illustrates a block diagram of a preferred embodiment depicting the Cyclic Accounts Receivable Process.

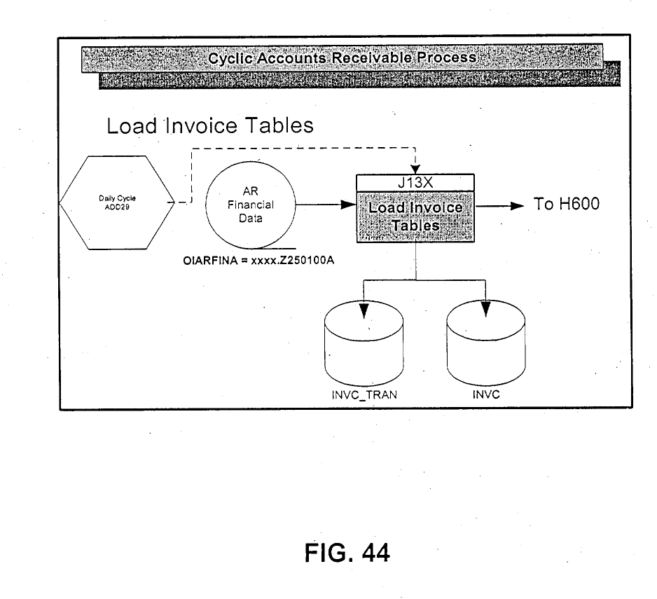

FIG. 45 illustrates a block diagram of a preferred embodiment depicting the Cyclic Reporting Process.

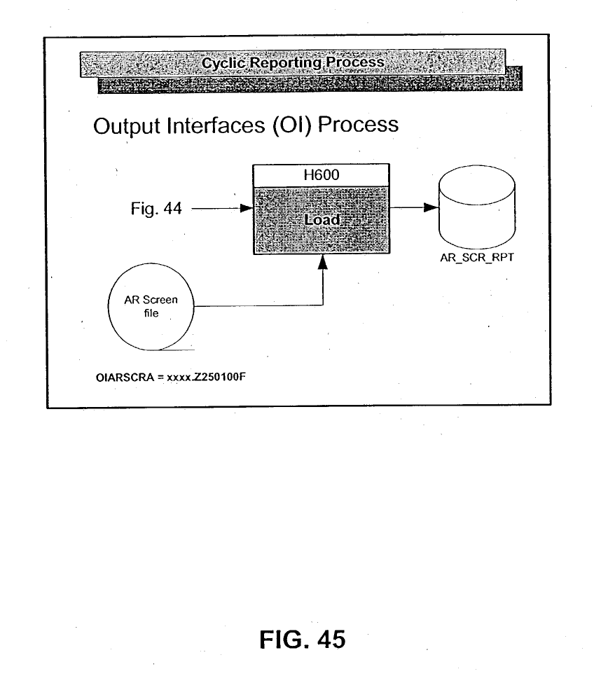

FIG. 46 illustrates a block diagram of a preferred embodiment depicting the Monthly Reporting Flows.

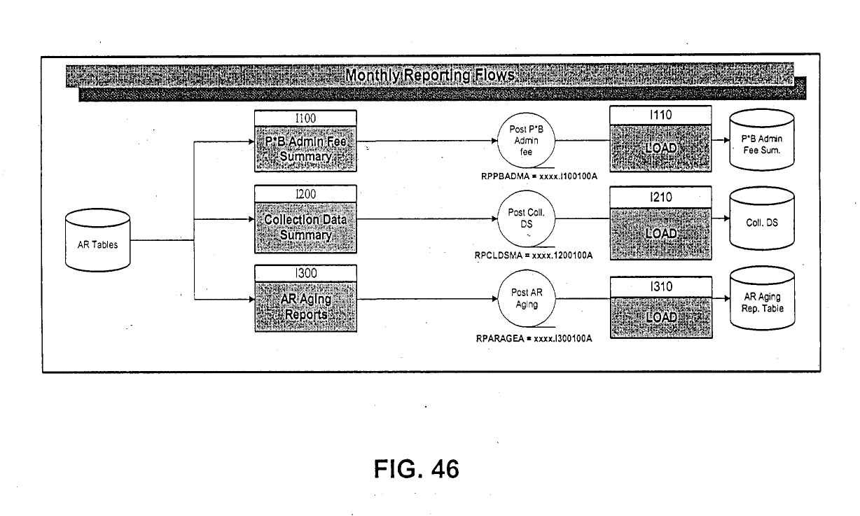

FIG. 47 illustrates a block diagram of a preferred embodiment depicting the Daily Accounts Receivable Processes.

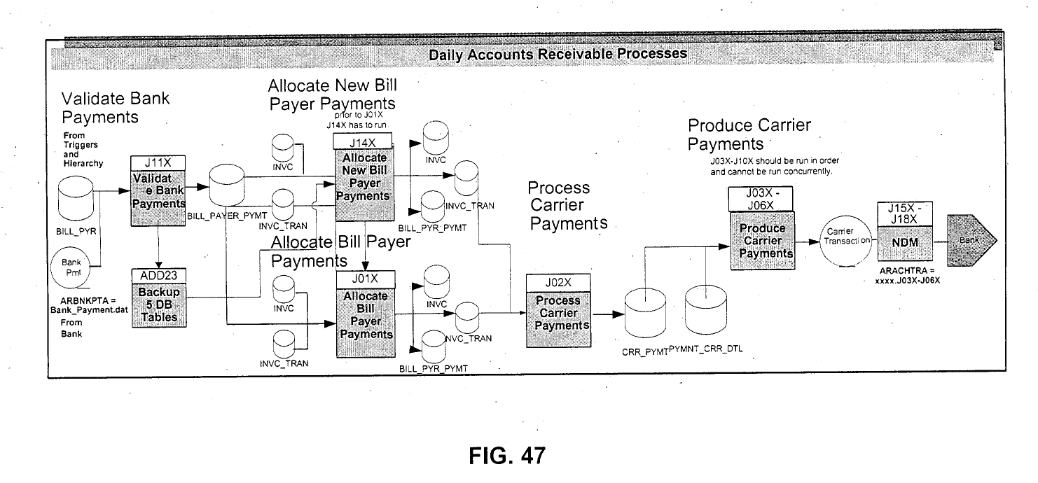

FIG. 48 illustrates a block diagram of a preferred embodiment depicting the Daily Tech Process.

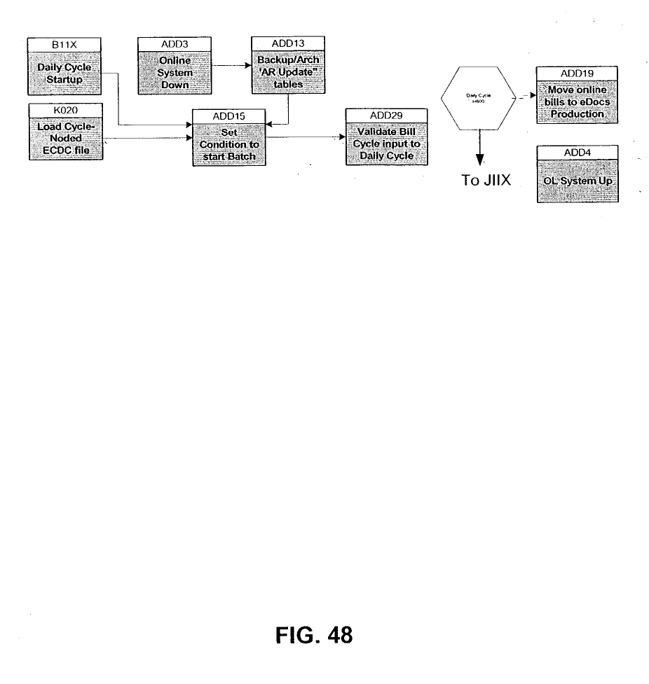

FIG. 49 illustrates a block diagram of a preferred embodiment depicting the Post Daily Process.

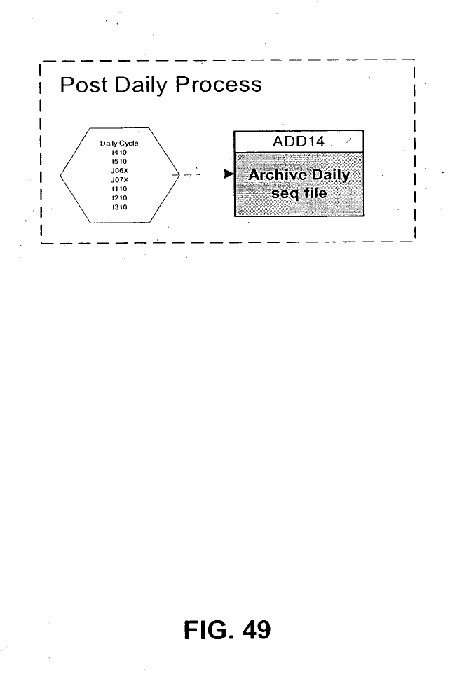

FIG. 50 illustrates a block diagram of a preferred embodiment depicting the Monthly Reporting Flows.

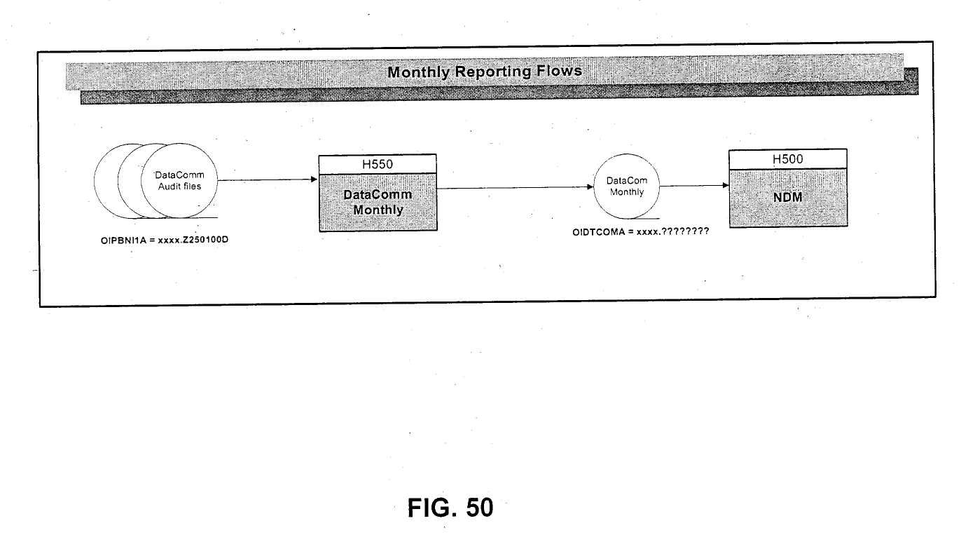

FIG. 51 illustrates a block diagram of a preferred embodiment depicting the Monthly CASS Reporting.

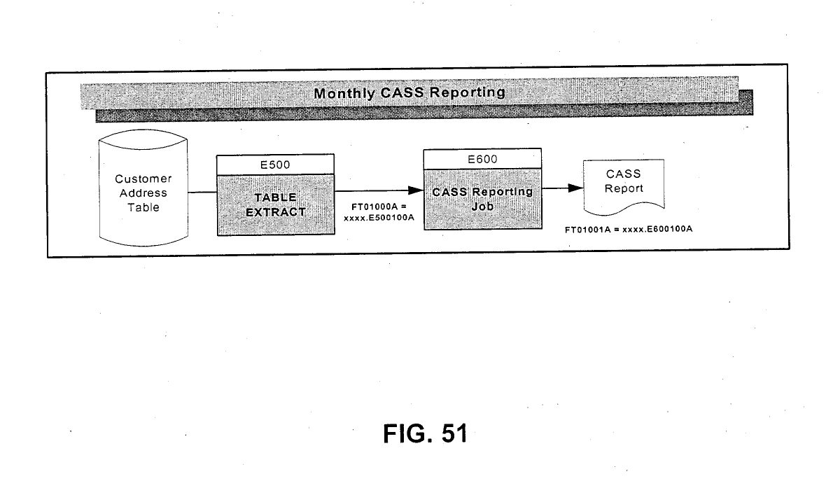

FIG. 52 illustrates a block diagram of a preferred embodiment depicting the Post Month End Process.

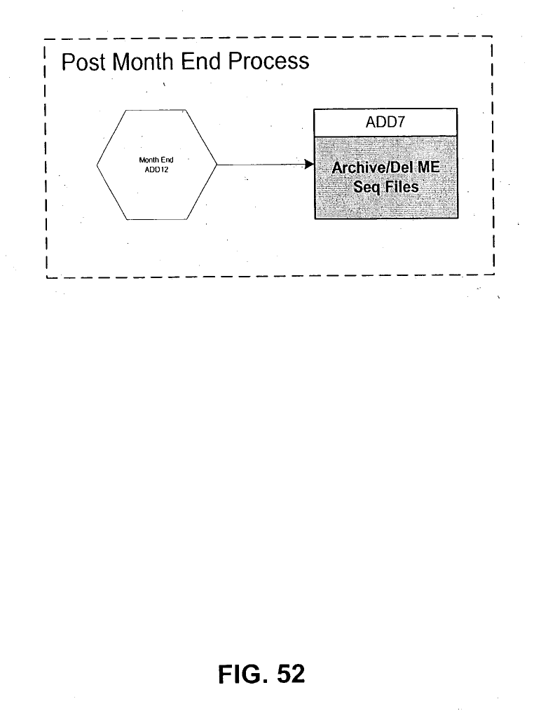

FIG. 53 illustrates a block diagram of a preferred embodiment depicting the Monthly Data Reporting and RAI Processes.

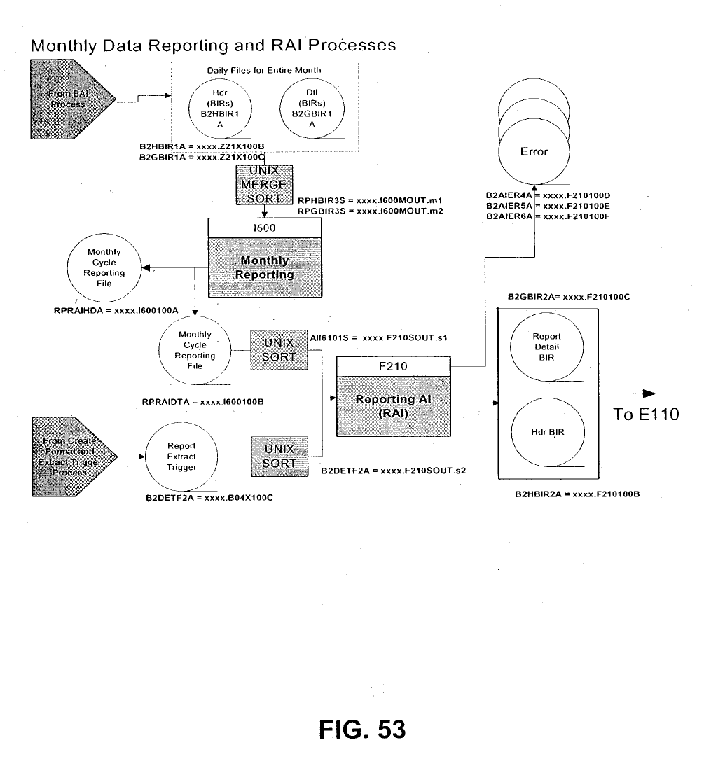

FIG. 54 illustrates a block diagram of a preferred embodiment depicting the Create eDocs Reporting Monthly Processes.

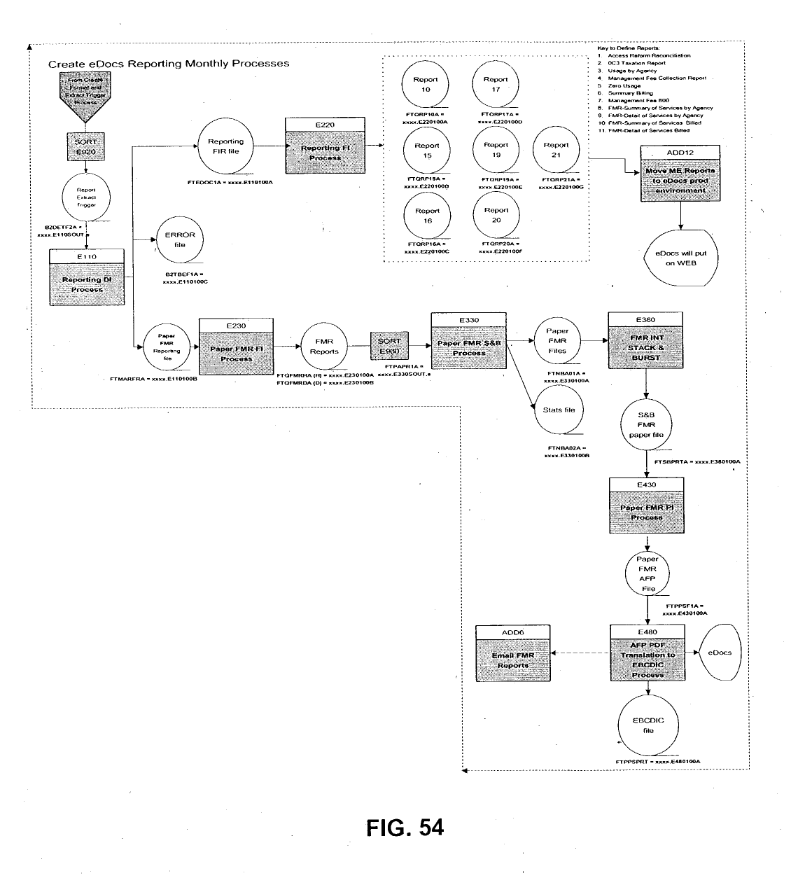

FIG. 55 illustrates a block diagram of a preferred embodiment depicting the Monthly CASS Reporting.

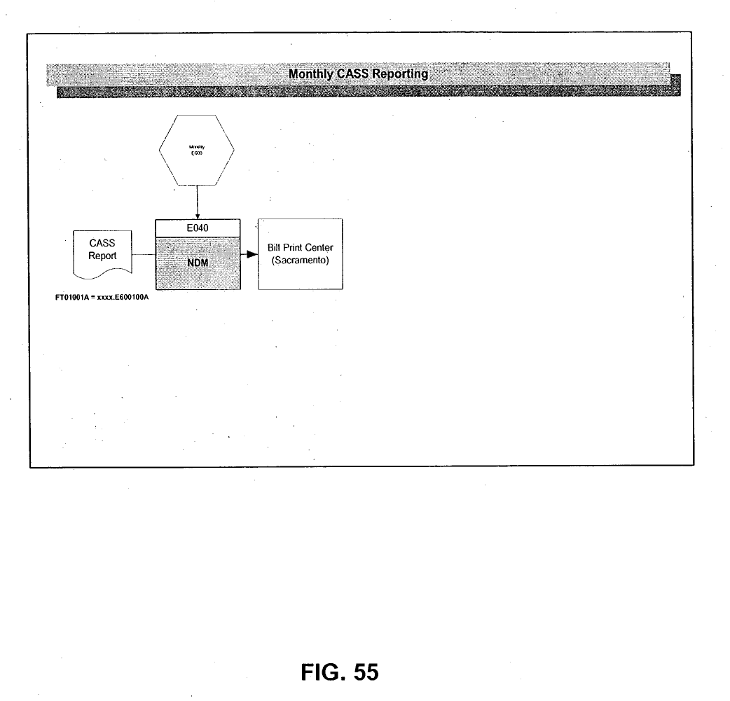

FIG. 56 illustrates a block diagram of a preferred embodiment depicting the Parser.

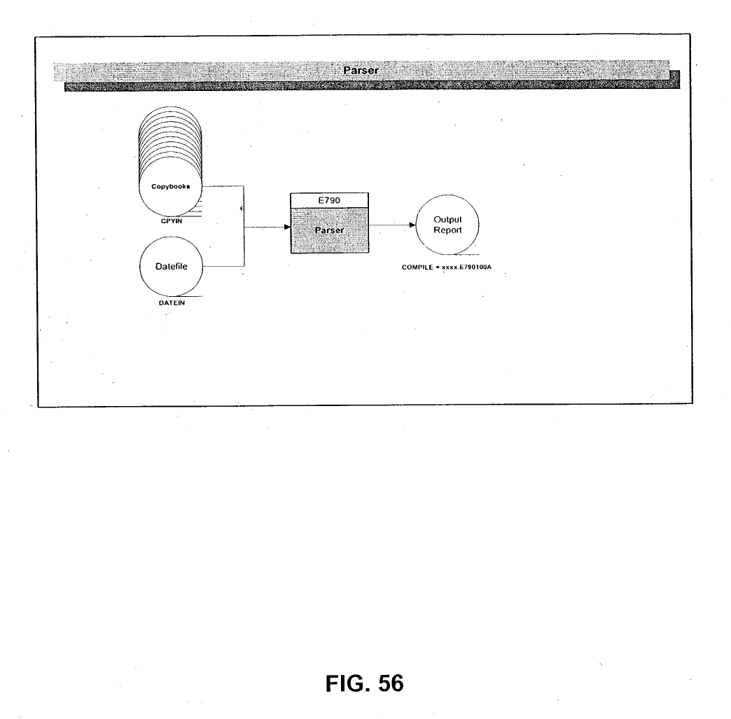

FIG. 57 illustrates a block diagram of a preferred embodiment depicting the Reformat Recirc Files.

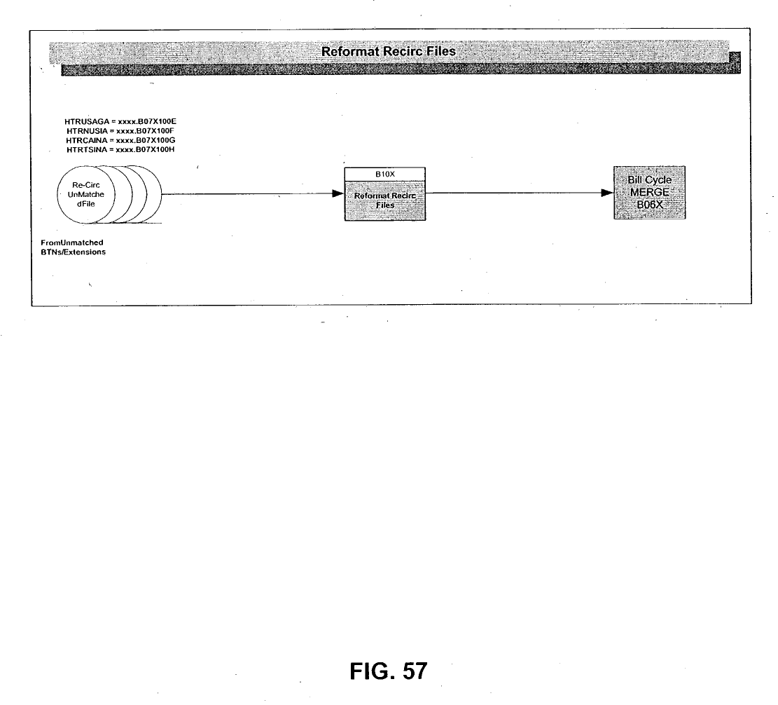

FIG. 58 illustrates a block diagram of a preferred embodiment depicting the Reformat Month End Files.

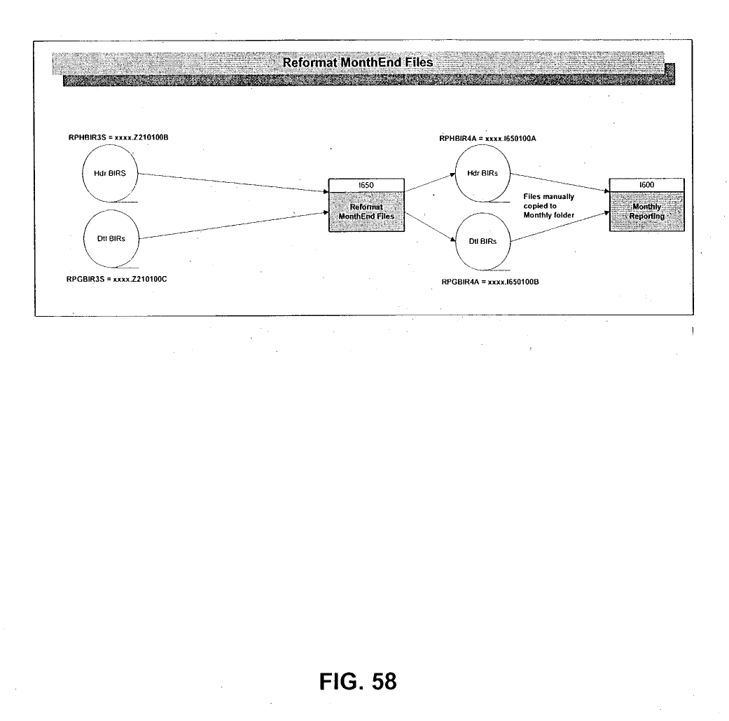

FIG. 59 illustrates a block diagram of a preferred embodiment depicting the Process Flow for FI.

FIG. 60 illustrates a block diagram of a preferred embodiment depicting the PI system flow.

FIG. 61 illustrates a block diagram of a preferred embodiment depicting the Stack & Burst Flow.

FIG. 62 illustrates a block diagram of a preferred embodiment depicting the Create Billing Invoices Cyclic Processes.

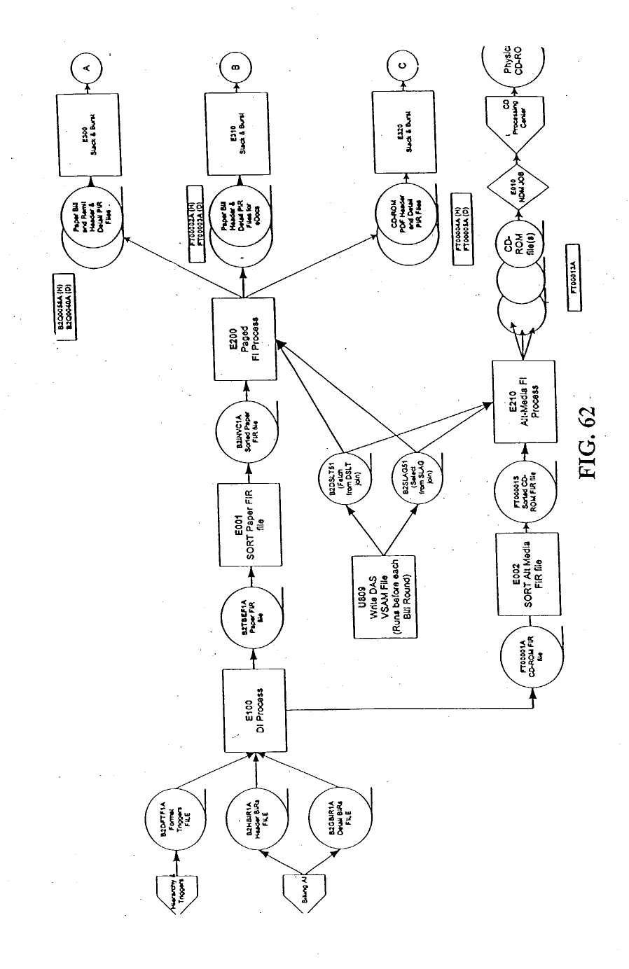

FIG. 63 illustrates a block diagram of a preferred embodiment depicting the Create Billing Invoices Cyclic Processes.

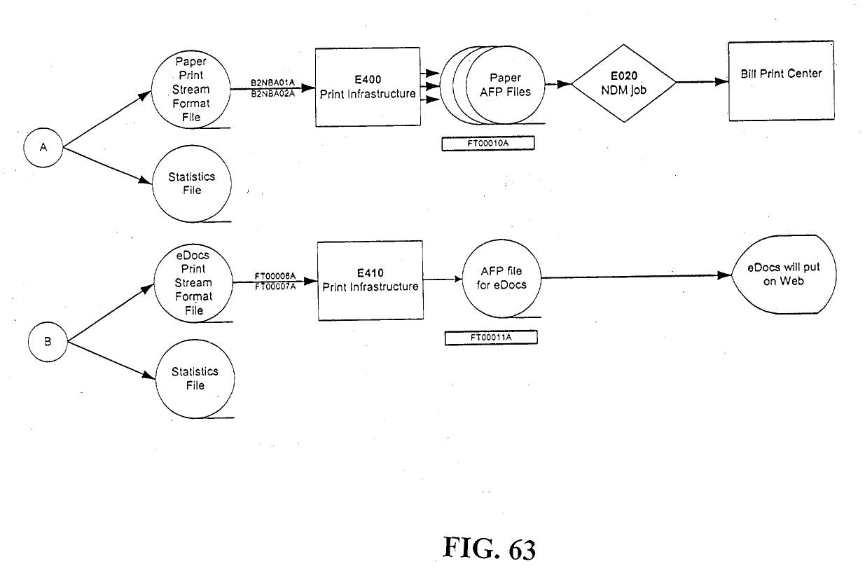

FIG. 64 illustrates a block diagram of a preferred embodiment depicting the Create Billing Invoices Cyclic Processes.

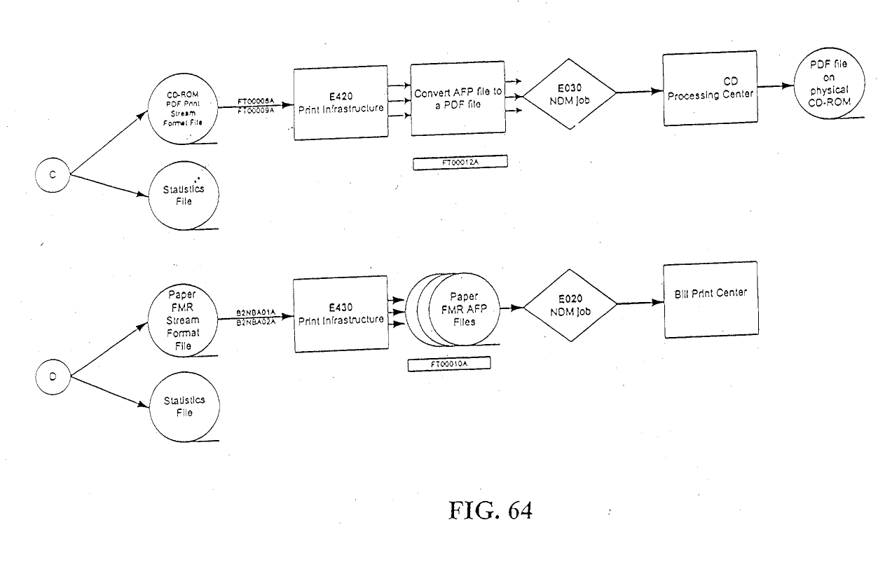

FIG. 65 illustrates a block diagram of a preferred embodiment depicting the Create eDocs Reporting Monthly Processes.

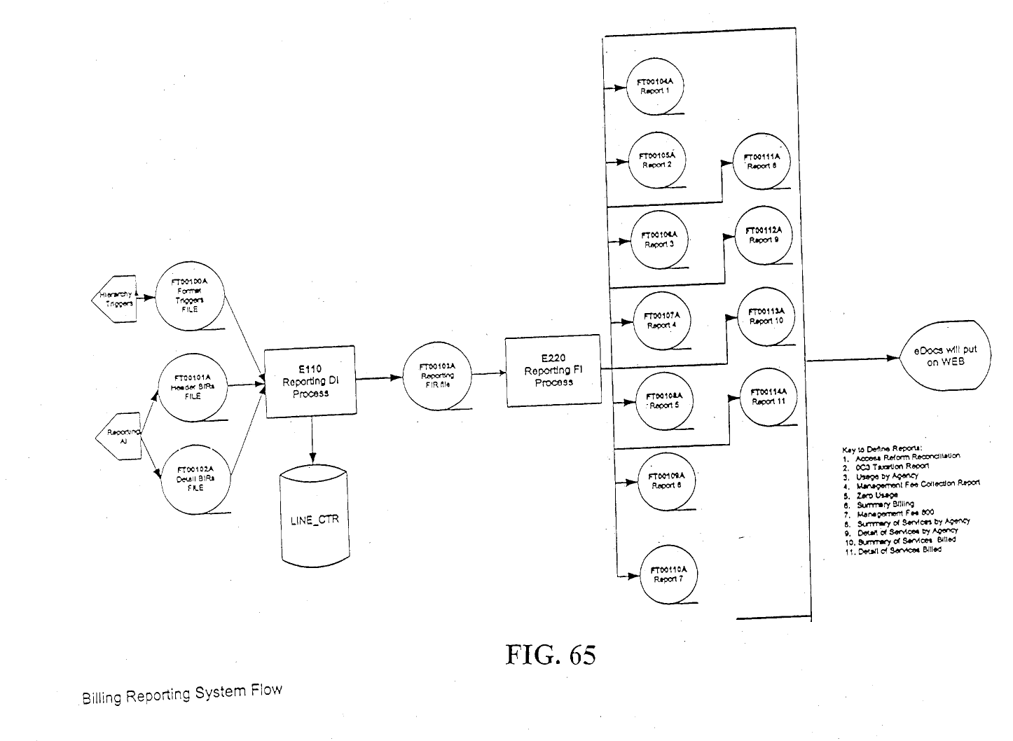

FIG. 66 illustrates a block diagram of a preferred embodiment depicting the Create CASS Report Monthly.

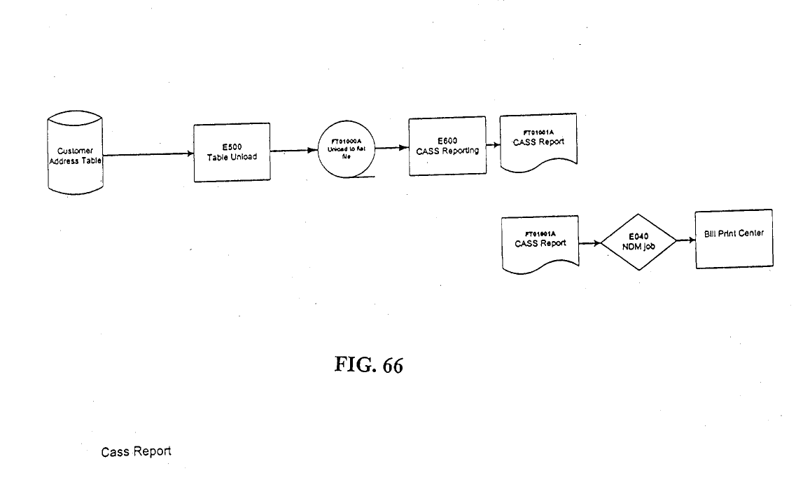

FIG. 67 illustrates a block diagram of a preferred embodiment depicting the eBill—DI Process.

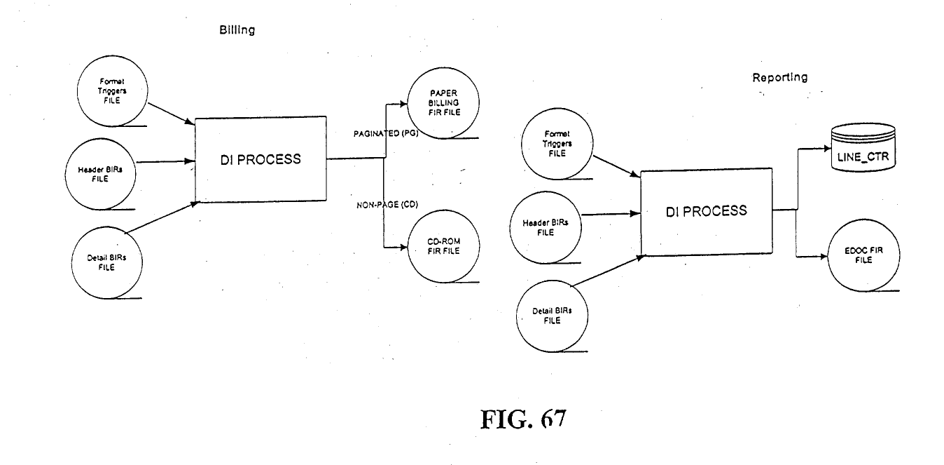

FIG. 68 illustrates a block diagram of a preferred embodiment depicting the Distribute: Module—Table Relationship.

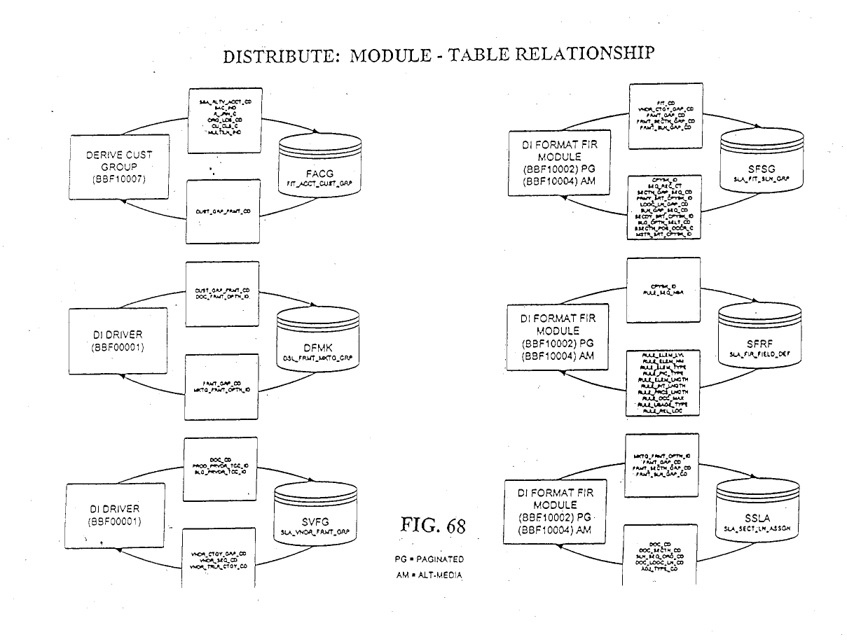

FIG. 69 illustrates a block diagram of a preferred embodiment depicting the Front End Process Files for various users.

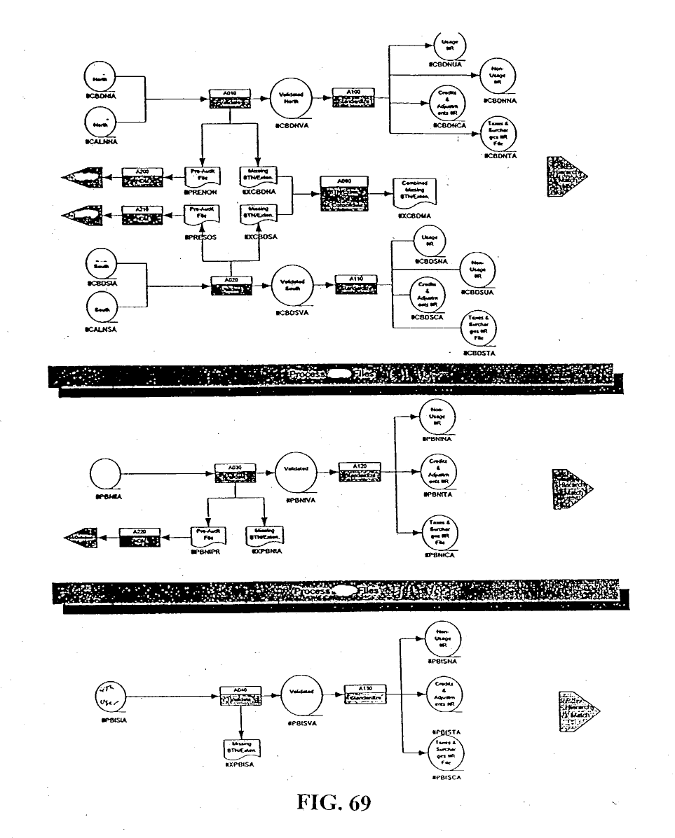

FIG. 70 illustrates a block diagram of a preferred embodiment depicting the Front End Process Files for various users.

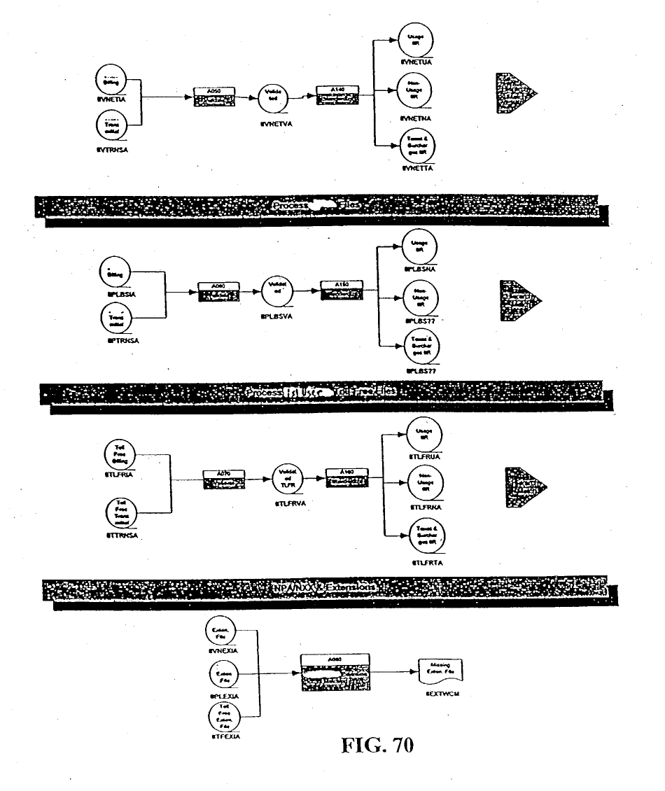

FIG. 71 illustrates a block diagram of a preferred embodiment depicting the Rating, Fee, Taxes and Adjustments.

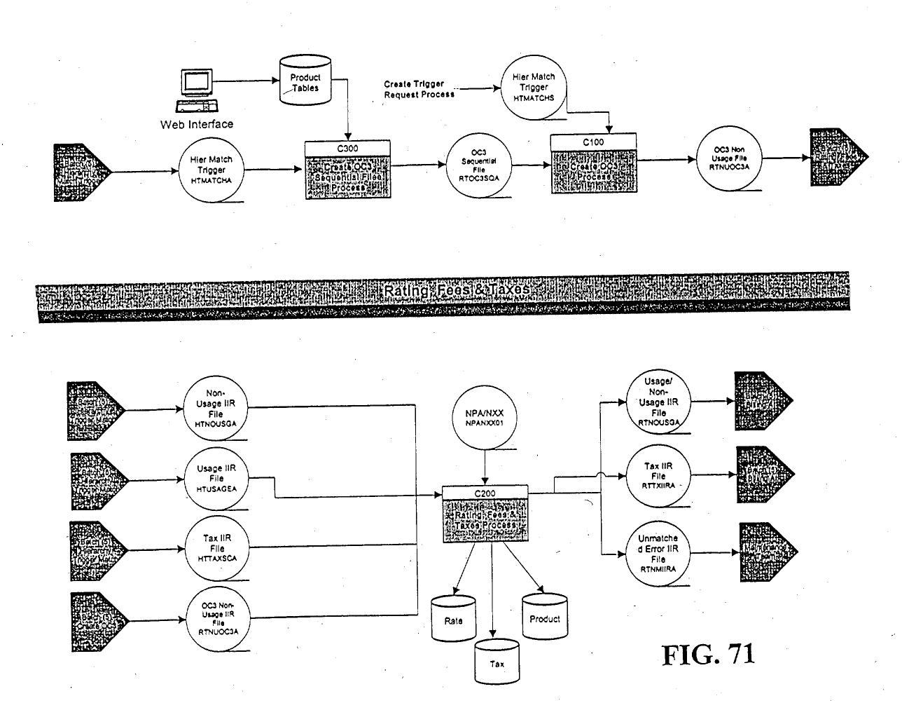

FIG. 72 illustrates a block diagram of a preferred embodiment depicting the Adjustments.

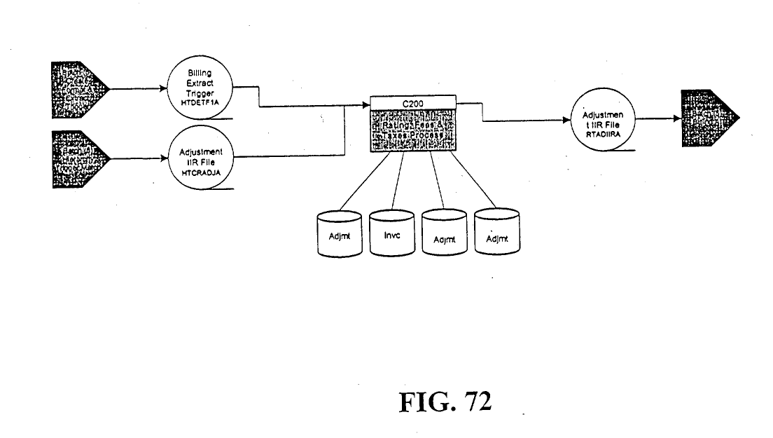

FIG. 73 illustrates a block diagram of a preferred embodiment depicting the Daily and Monthly Reports.

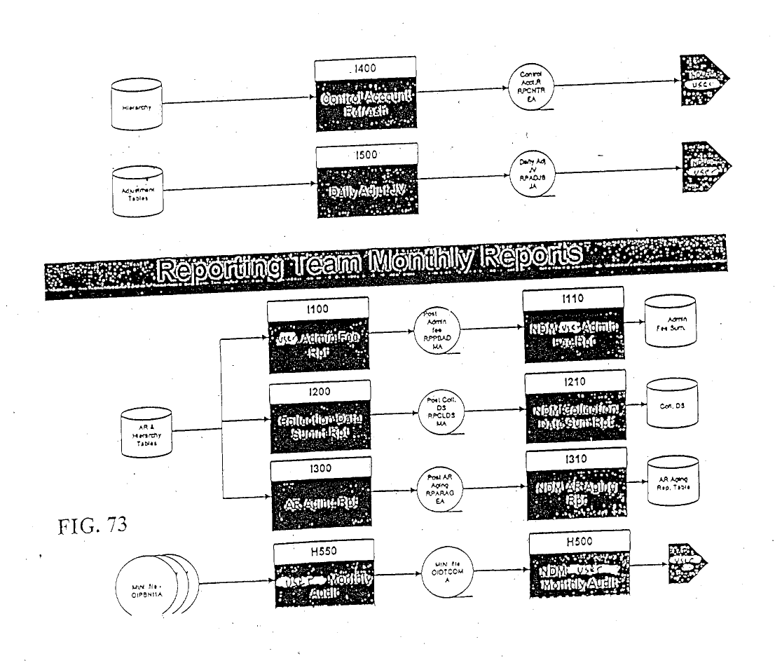

FIG. 74 illustrates a block diagram of a preferred embodiment depicting the Monthly Report Cycle.

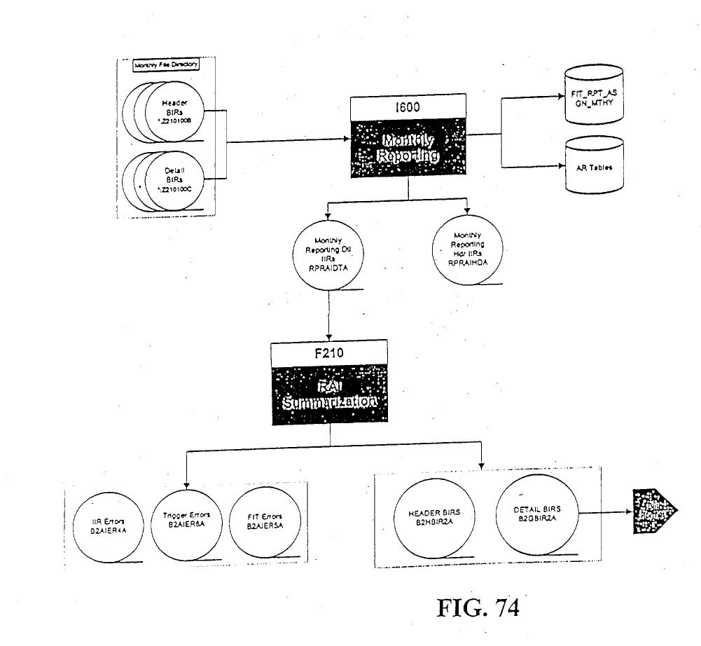

FIG. 75 illustrates a block diagram of a preferred embodiment depicting the Bill Cycle Reporting Team.

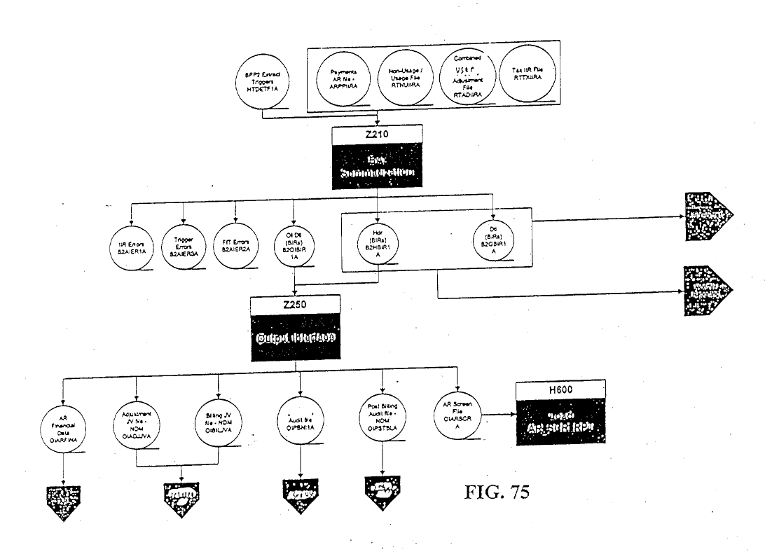

FIG. 76 illustrates a legend for the Process Architecture of the preferred embodiments described herein.

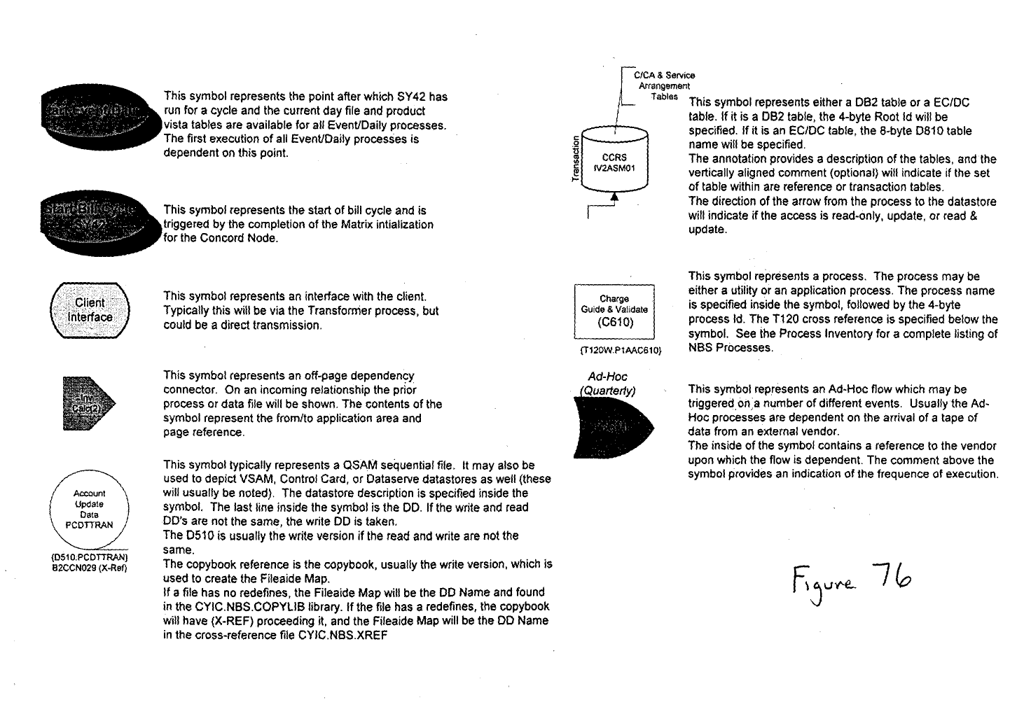

FIG. 77 illustrates a block diagram of a preferred embodiment depicting the Triggers & Hierarchy.

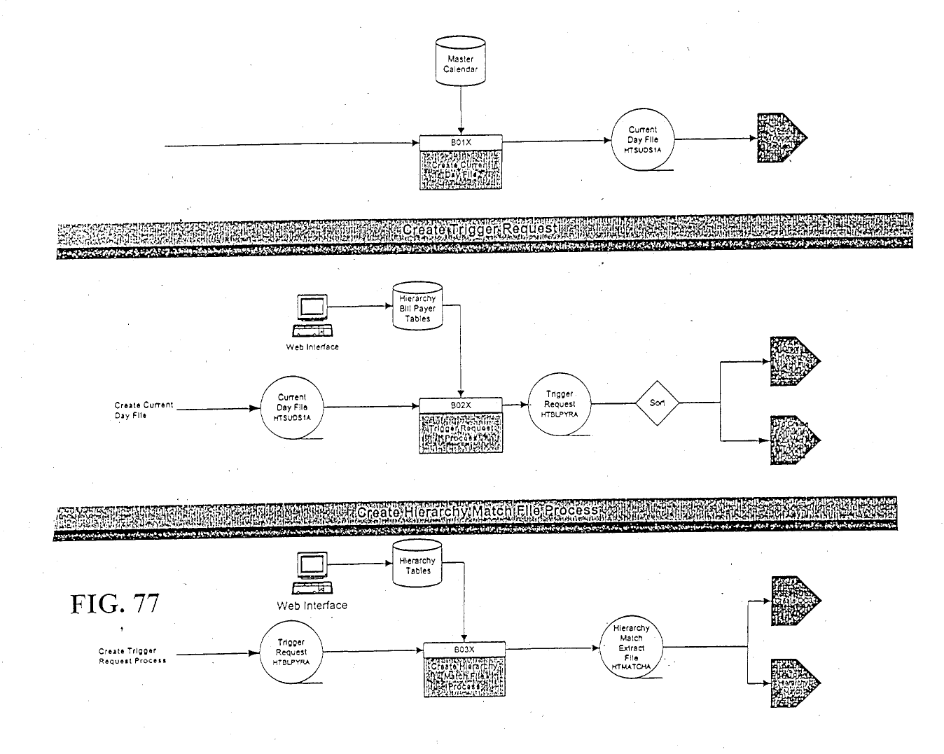

FIG. 78 illustrates a block diagram of a preferred embodiment depicting the Triggers & Hierarchy.

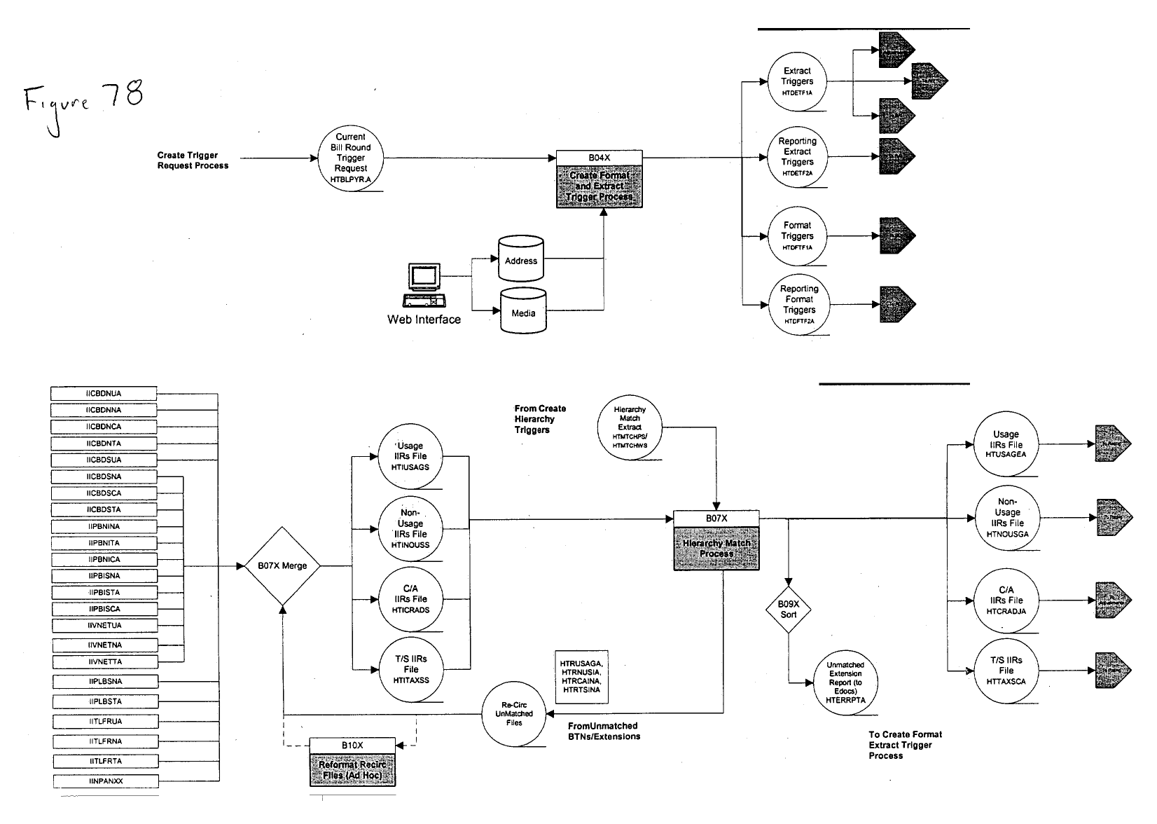

FIG. 79 illustrates a block diagram of a preferred embodiment depicting the eBill Cycle—Batch Load Invoice Tables.

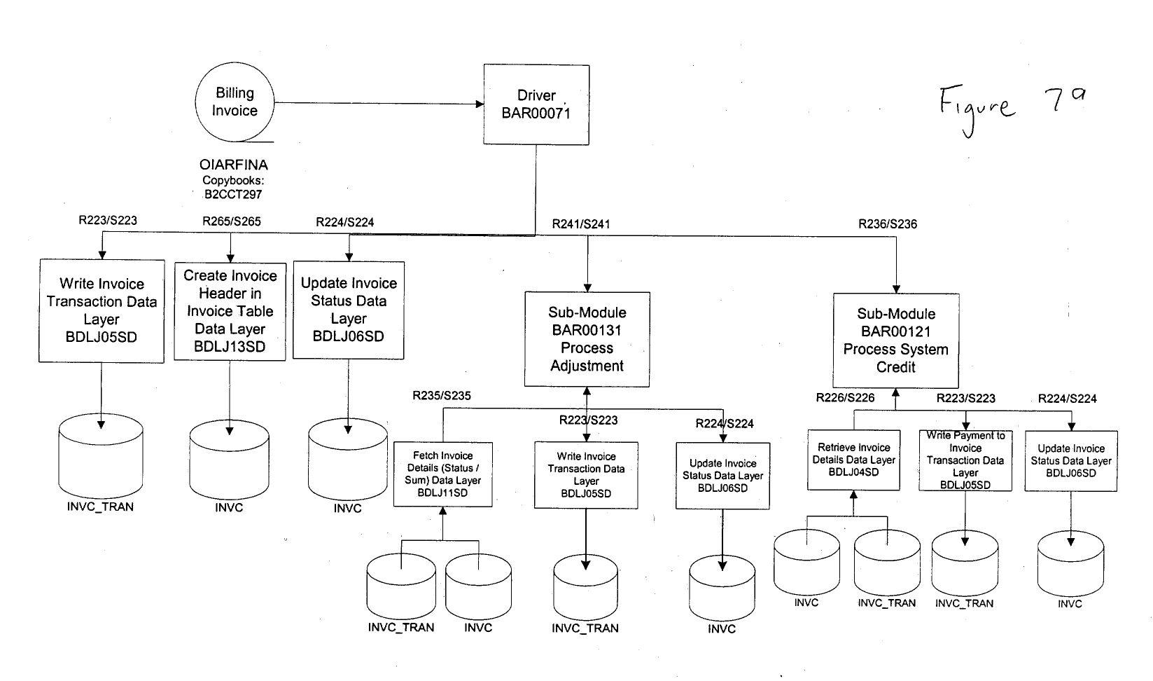

FIG. 80 illustrates a block diagram a preferred embodiment depicting the eBill Cycle—Batch Billing Extract.

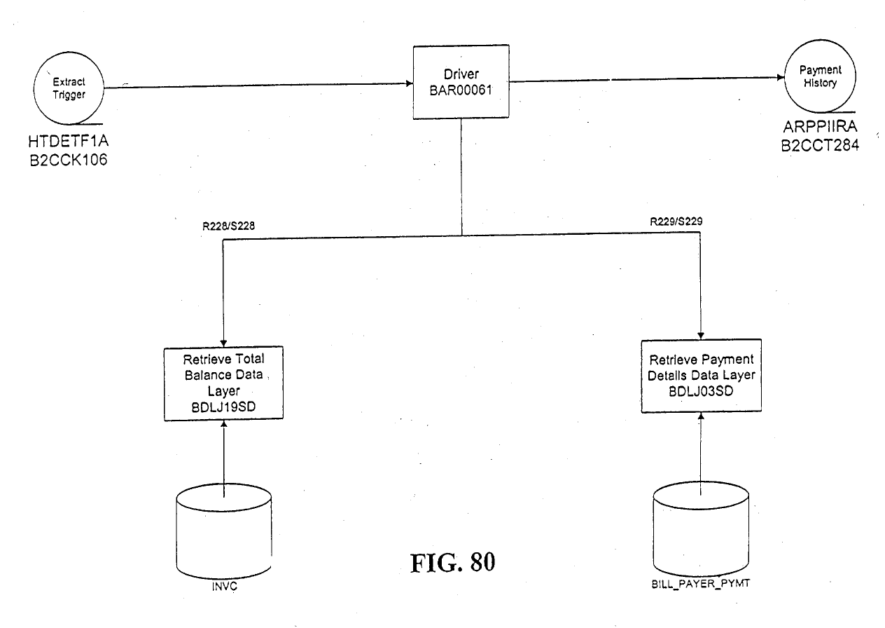

FIG. 81 illustrates a block diagram of a preferred embodiment depicting the eBill Cycle—Batch (6) Adjustments.

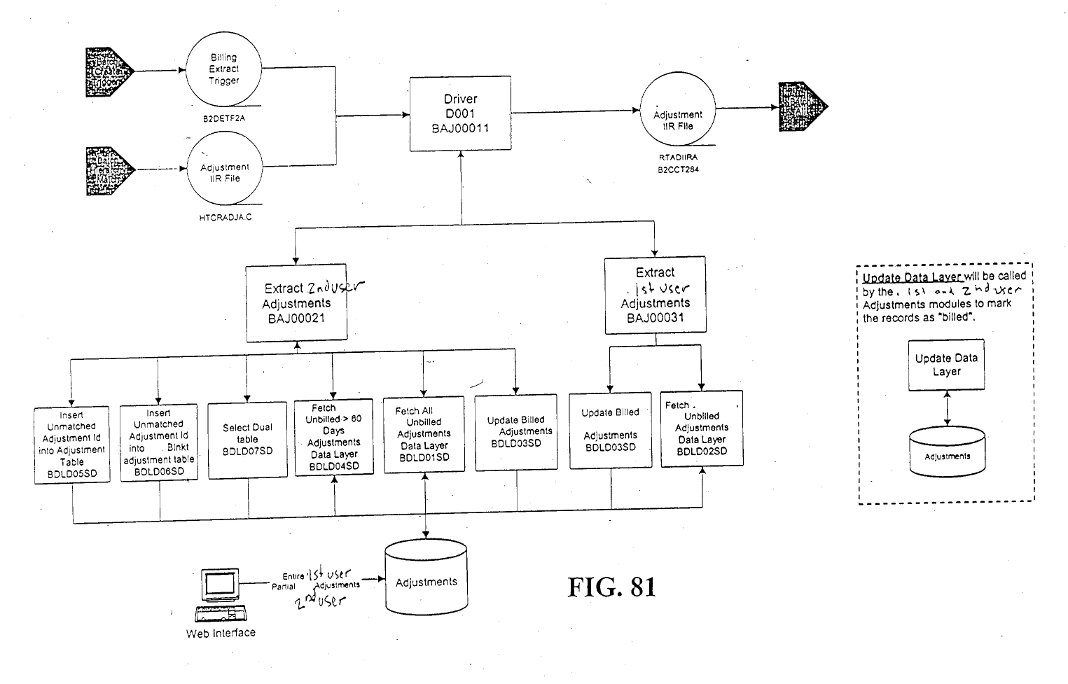

FIG. 82 illustrates a block diagram of a preferred embodiment depicting the eBill Cycle—Batch: Hierarchy Match Trigger.

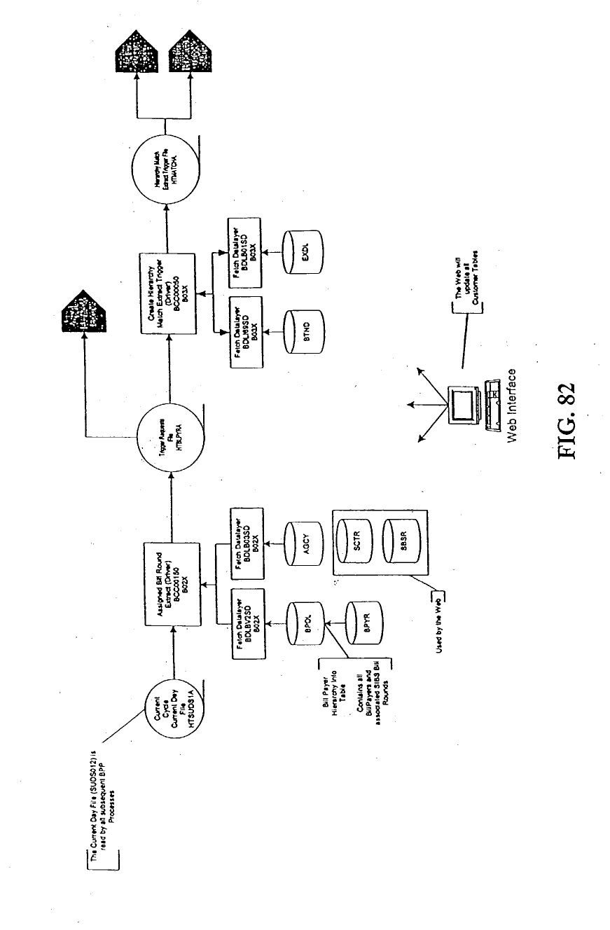

FIG. 83 illustrates a block diagram of a preferred embodiment depicting the eBill Cycle—Batch: Create Format & Extra Trigger.

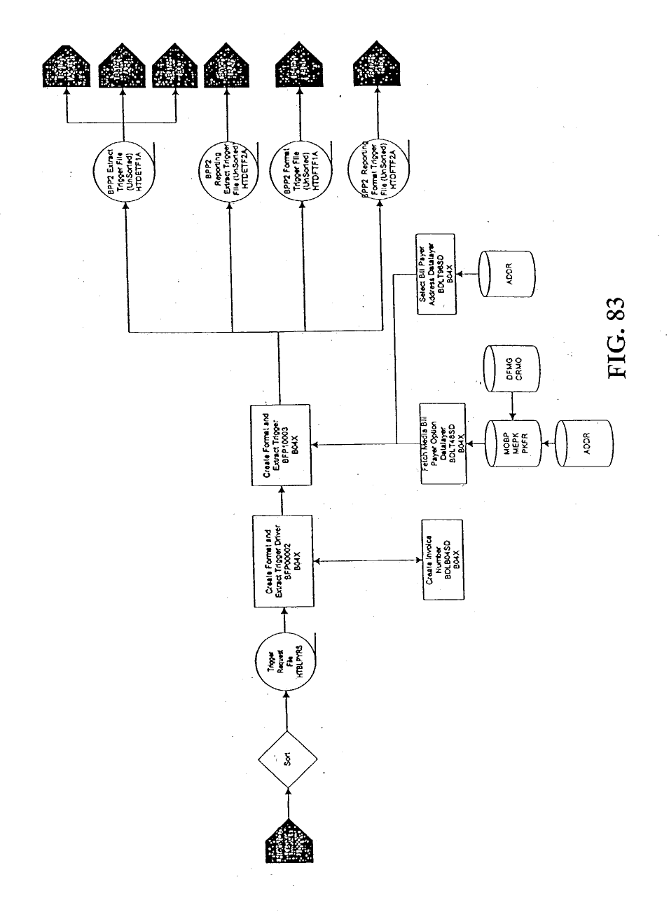

FIG. 84 illustrates a block diagram of a preferred embodiment depicting the eBill Cycle —Batch: Hierarchy Trigger Match.

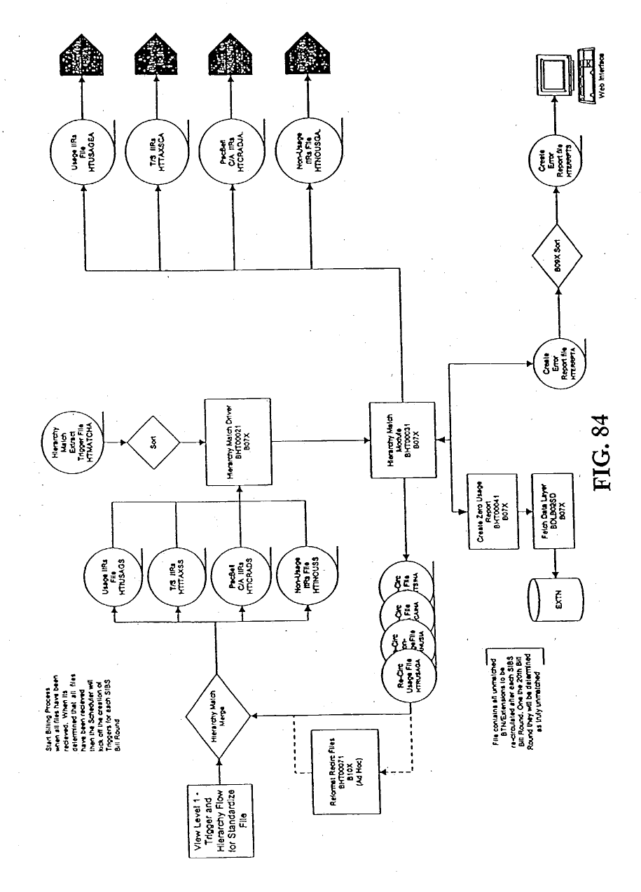

FIG. 85 illustrates a block diagram of a preferred embodiment depicting the eBill Cycle —Batch Allocate Bill Payer Payments.

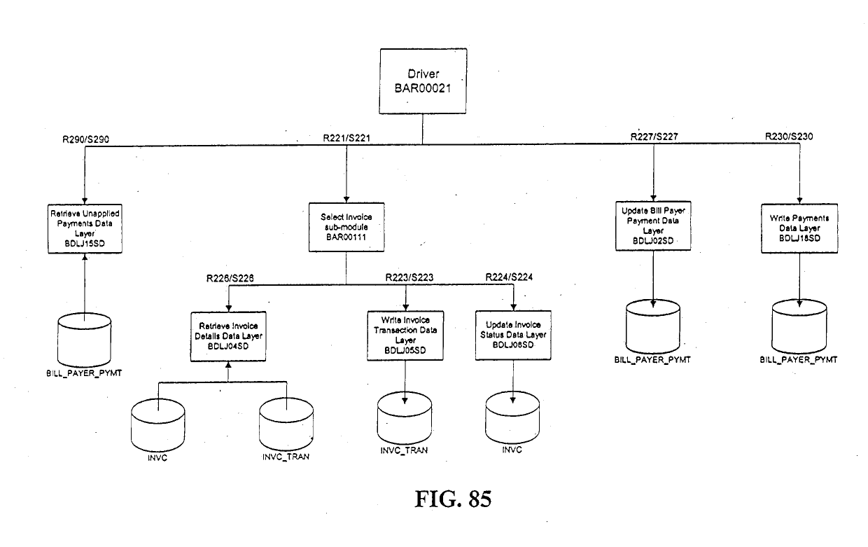

FIG. 86 illustrates a block diagram of a preferred embodiment depicting the eBill Cycle—Batch Process Carrier Payment.

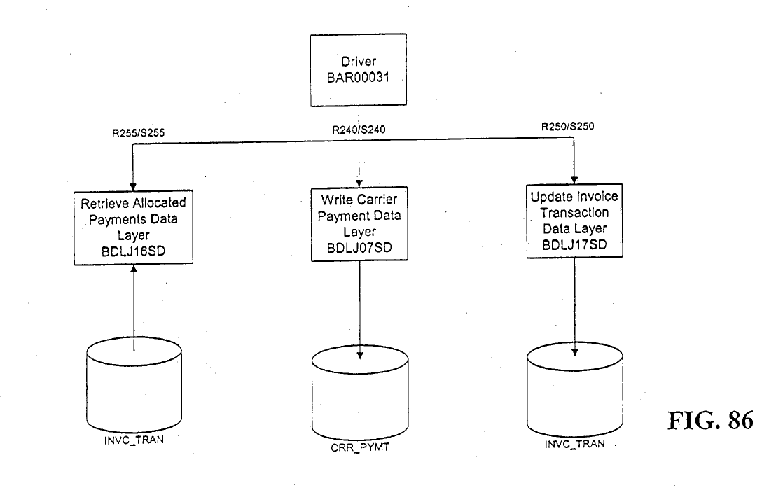

FIG. 87 illustrates a block diagram of a preferred embodiment depicting the eBill Cycle—Batch Produce Carrier Payment.

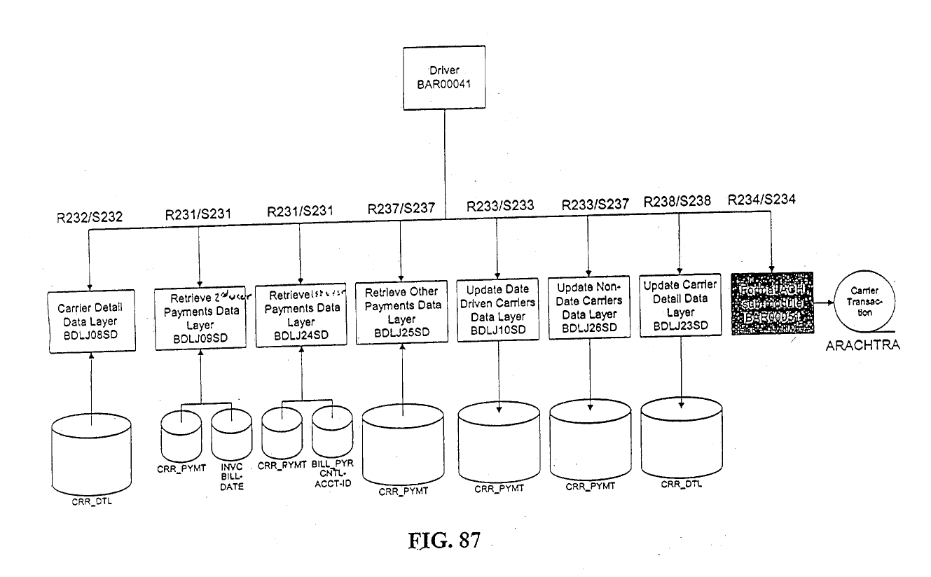

FIG. 88 illustrates a block diagram of a preferred embodiment depicting the eBill Cycle—Batch (5) Rating, Fees and Taxes.

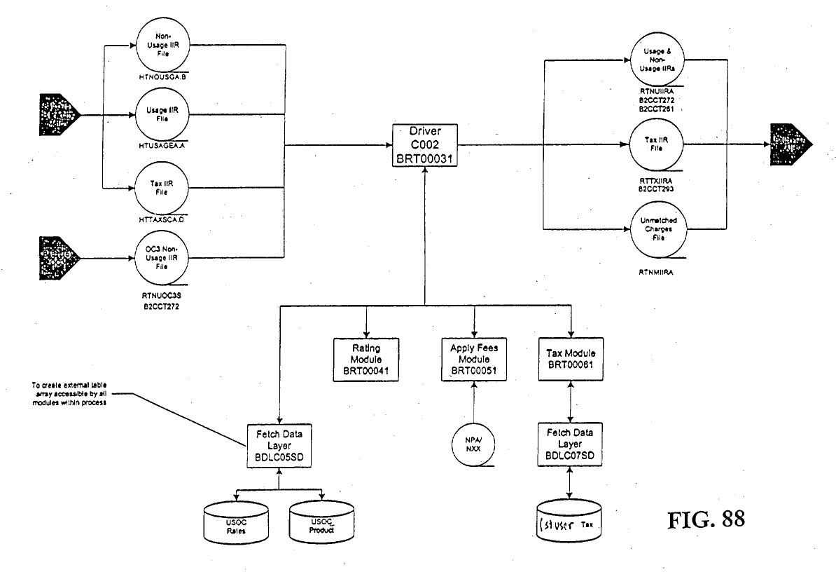

FIG. 89 illustrates a block diagram of a preferred embodiment depicting the eBill Cycle—Batch (3) Create OC3.

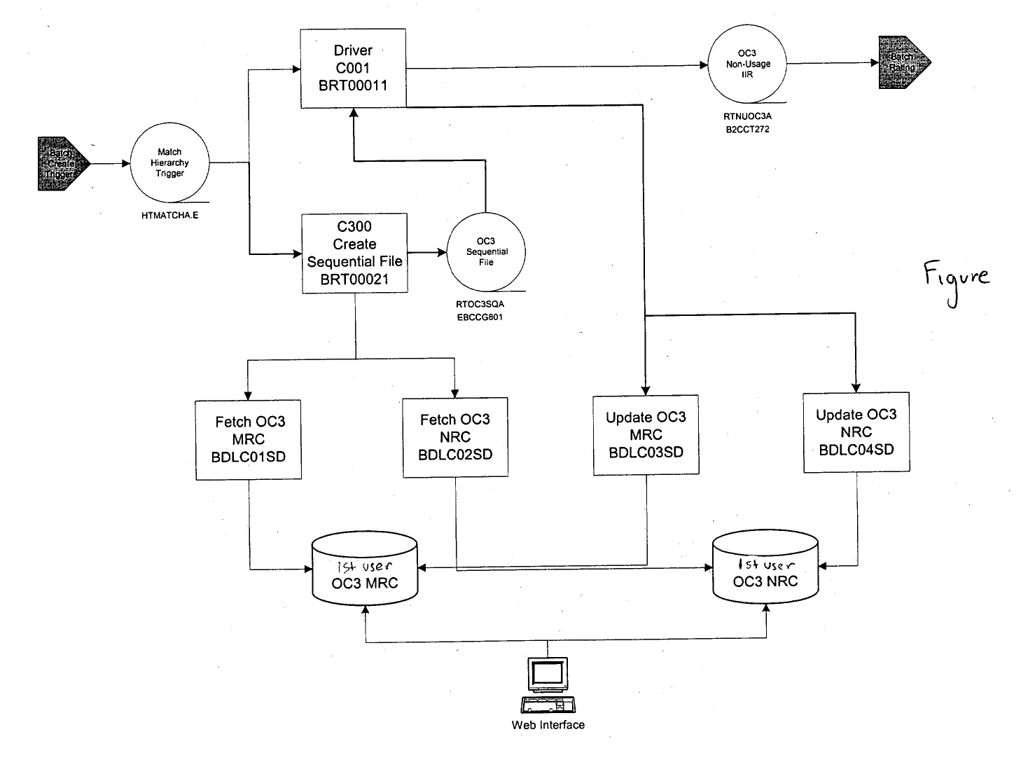

FIG. 90 illustrates a block diagram of a preferred embodiment depicting the eBill Cycle—Batch Validate Bank Payments.

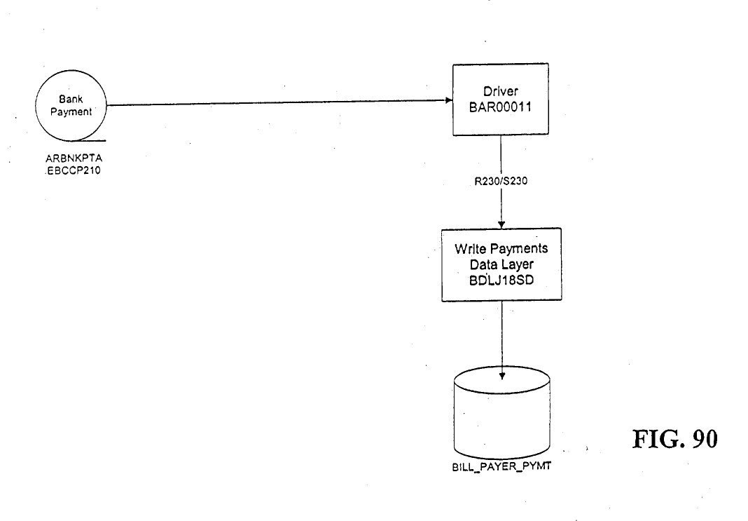

FIG. 91 illustrates a block diagram of a preferred embodiment depicting the eBill Cycle—Batch Allocate New Bill Payer Payments.

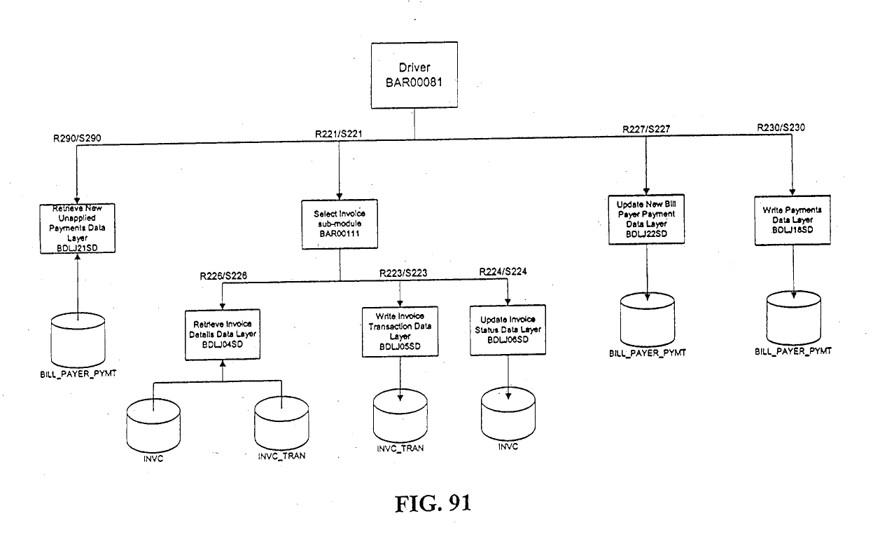

FIG. 92 illustrates a block diagram of a preferred embodiment depicting the Start Bill Cycle: Current Day File (SUDs) Creation.

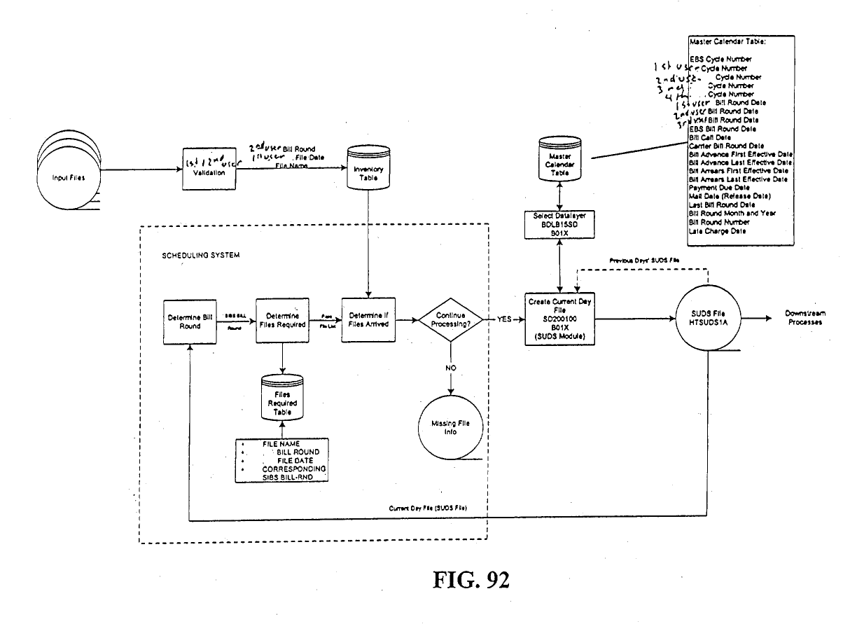

FIG. 93 illustrates a block diagram of a preferred embodiment depicting the Format Infrastructure: Paged Flow Part 1.

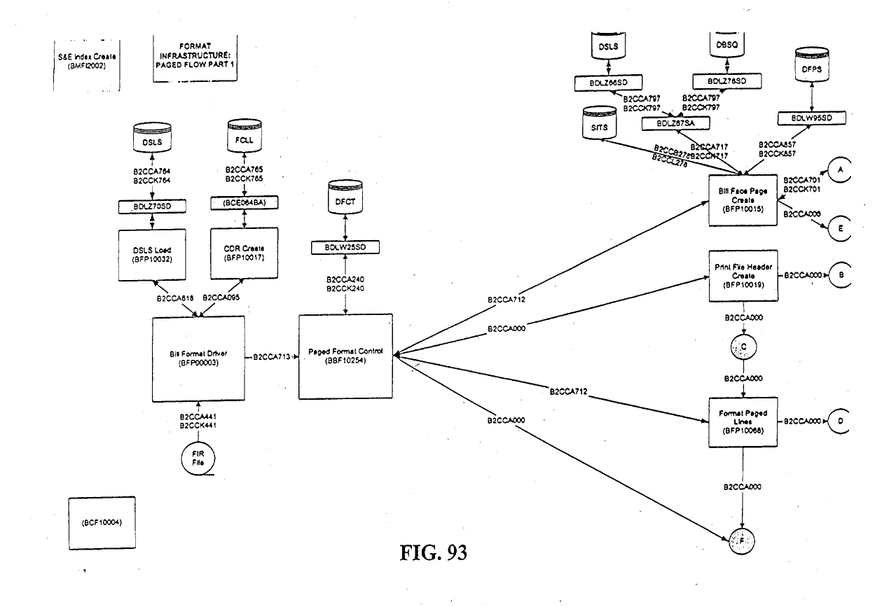

FIG. 94 illustrates a block diagram of a preferred embodiment depicting the Format Infrastructure: Paged Flow Part 2.

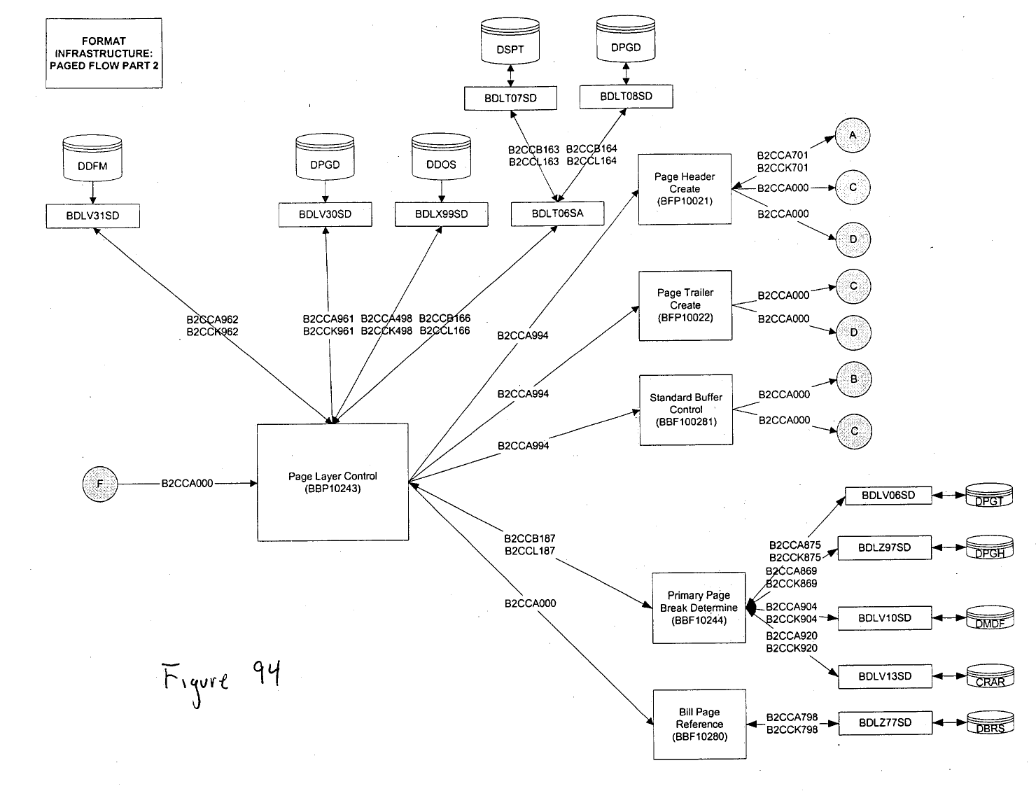

FIG. 95 illustrates a block diagram of a preferred embodiment depicting the Format Infrastructure: Paged Flow Part 3.

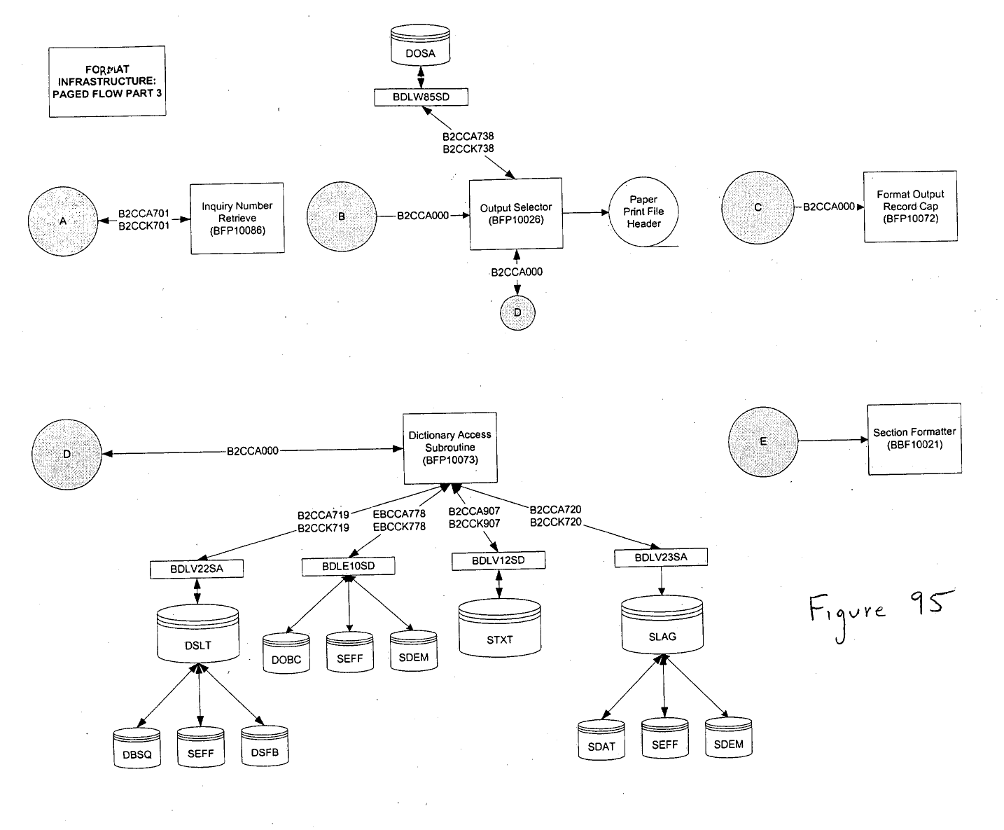

FIG. 96 illustrates a block diagram of a preferred embodiment depicting the Format Infrastructure: Non-Paged Flow Page 1.

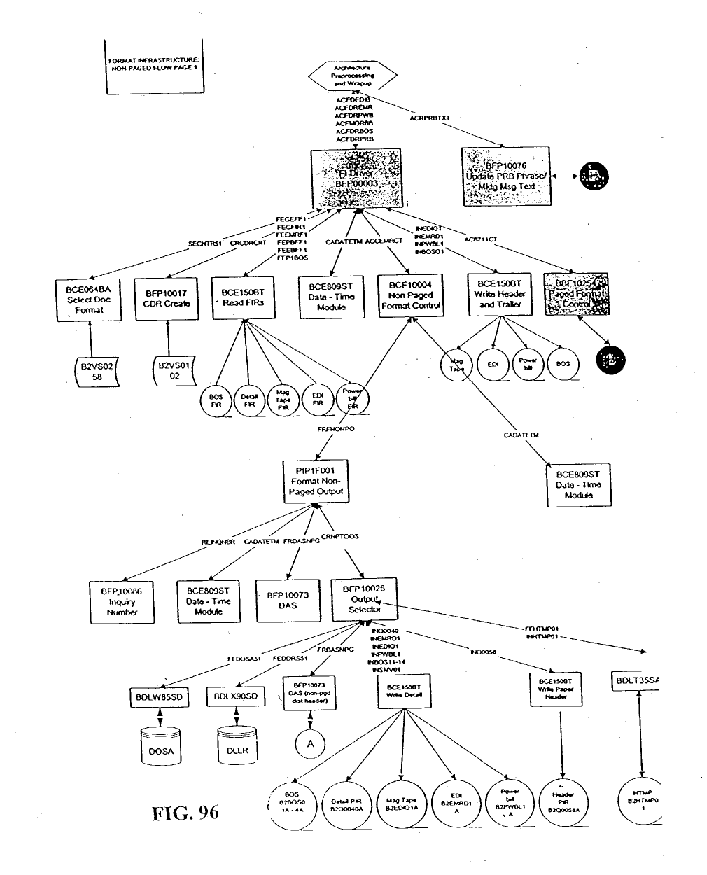

FIG. 97 illustrates a block diagram of a preferred embodiment depicting the Format Infrastructure: Non-Paged Flow Page 2.

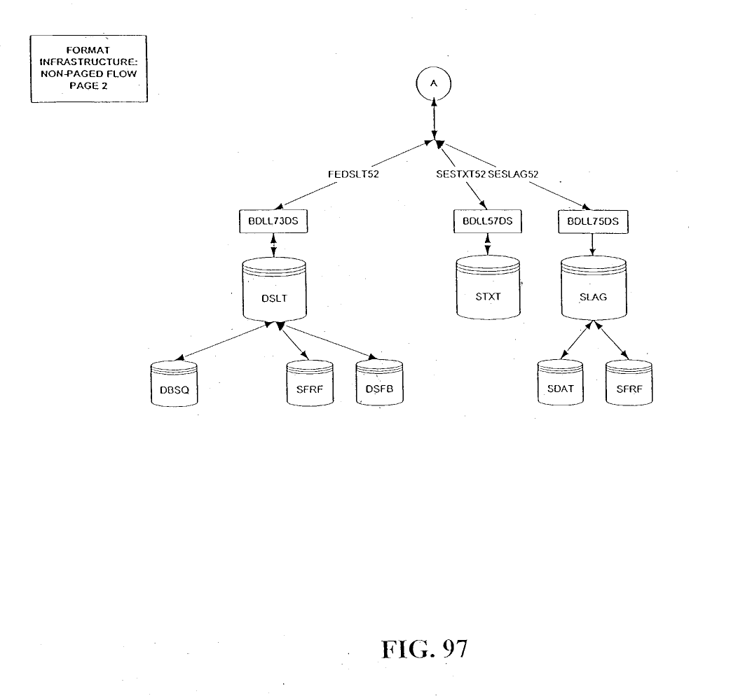

FIG. 98 illustrates a block diagram of a preferred embodiment depicting the eBill—DI Process.

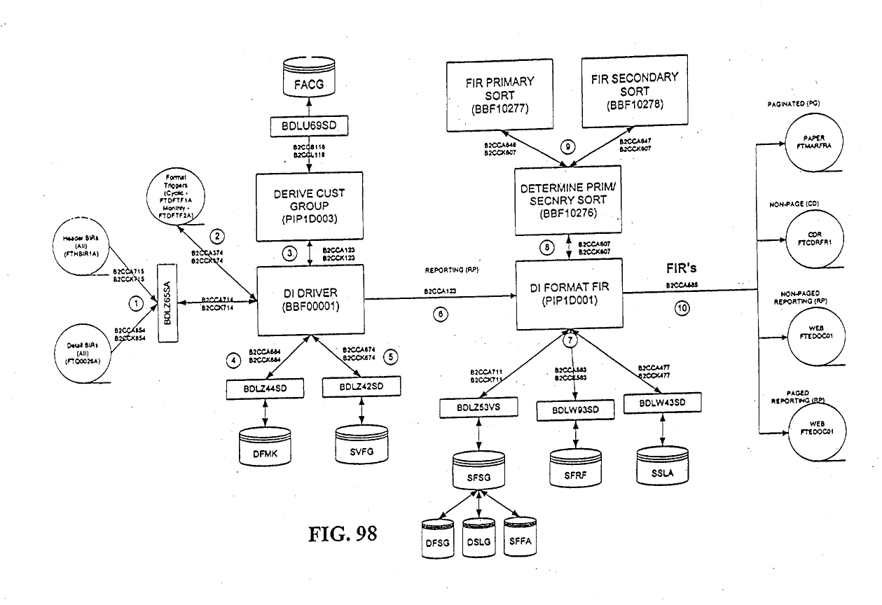

FIG. 99 illustrates a block diagram of a preferred embodiment depicting the Reporting—OI Process.

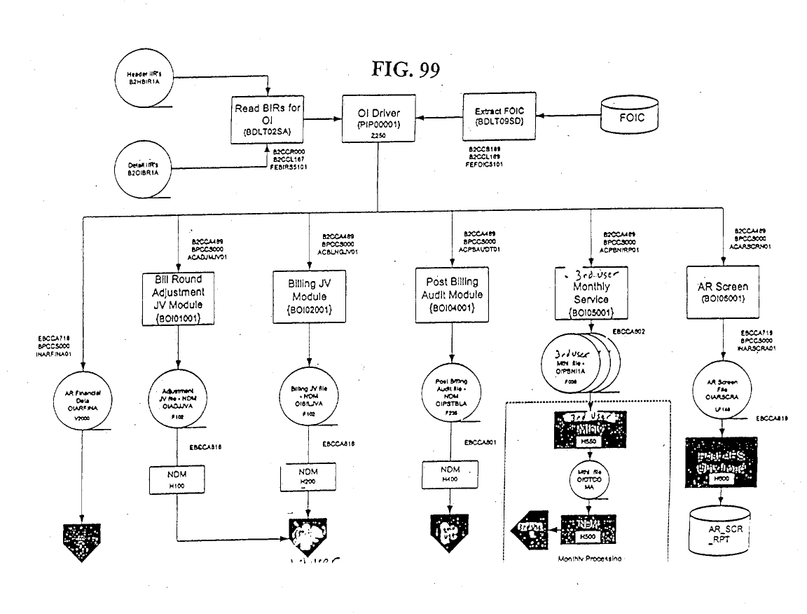

FIG. 100 illustrates a block diagram of a preferred embodiment depicting the PI System Flow.

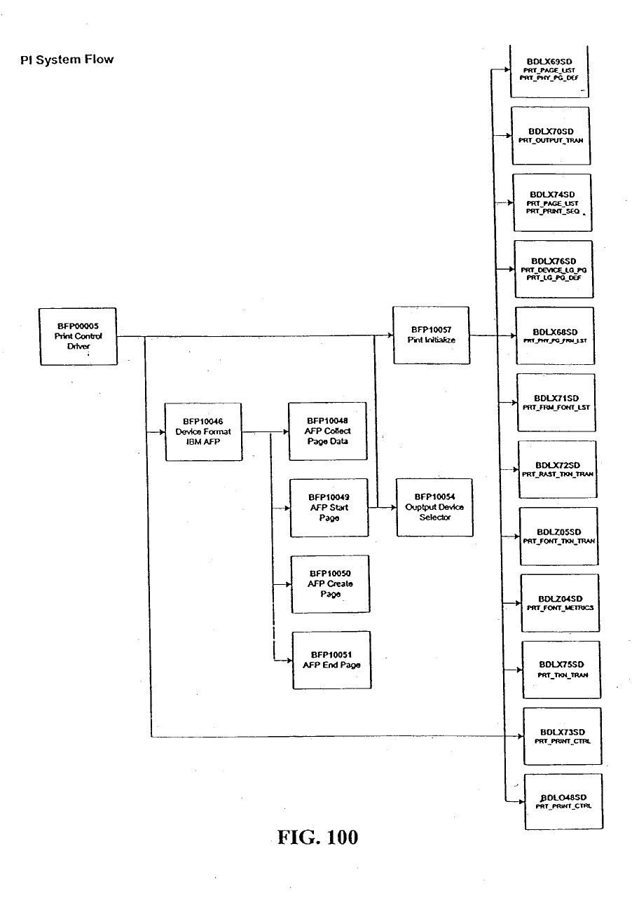

FIG. 101 illustrates a block diagram of a preferred embodiment depicting the eBill—Monthly Data Flow.

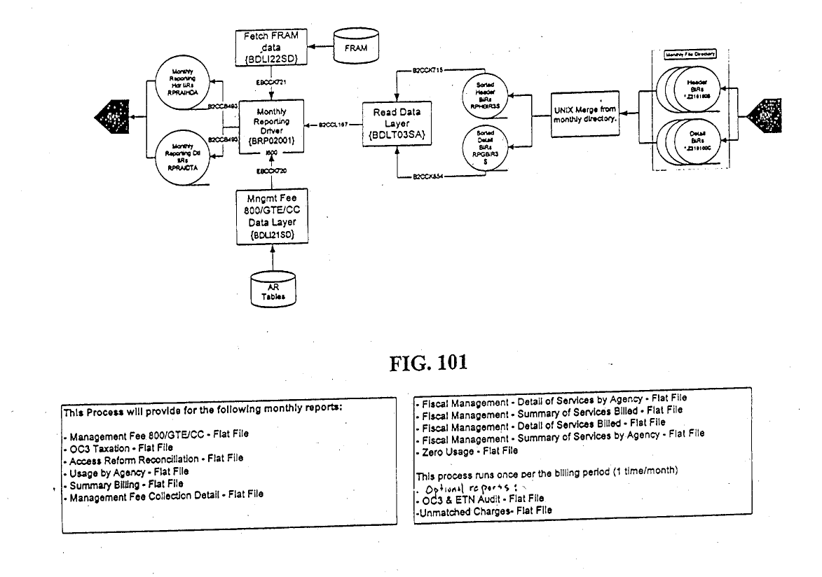

FIG. 102 illustrates a block diagram of a preferred embodiment depicting the eBill—Monthly Processing Flow.

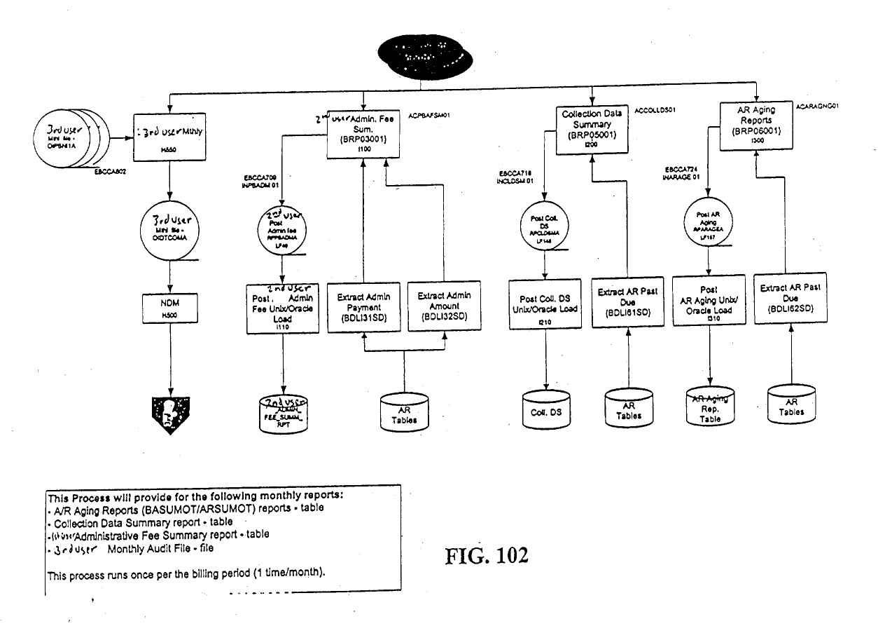

FIG. 103 illustrates a block diagram of a preferred embodiment depicting the eBill—Daily Reports.

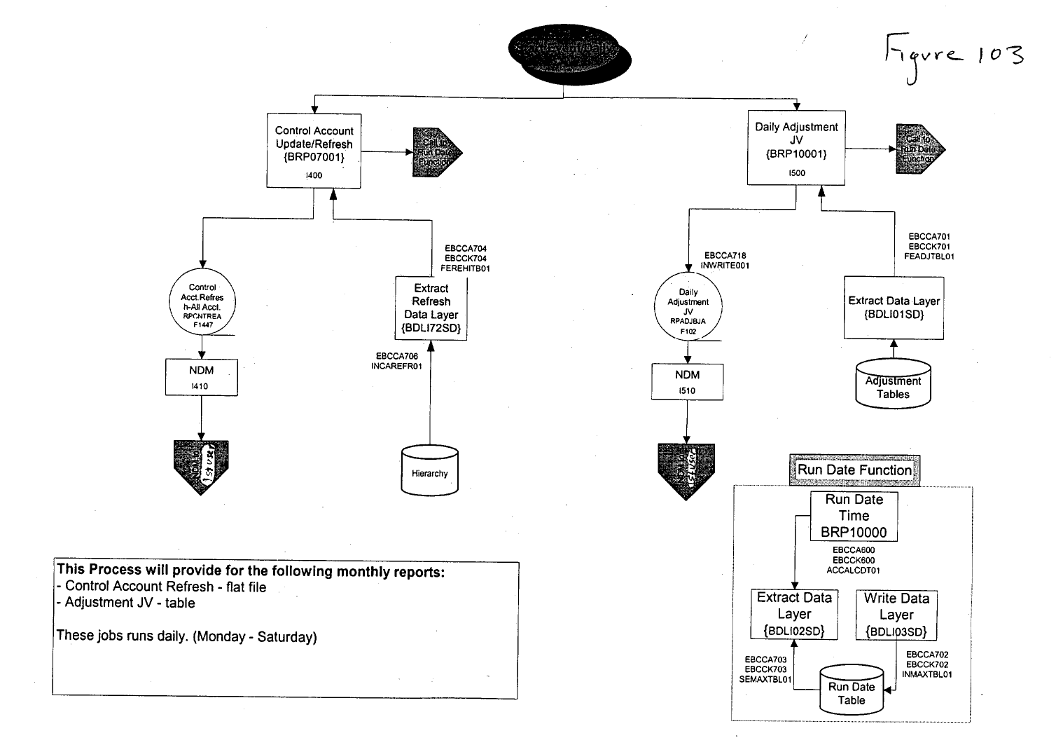

FIG. 104 illustrates a block diagram of a preferred embodiment depicting the eBill—Reprints Process.

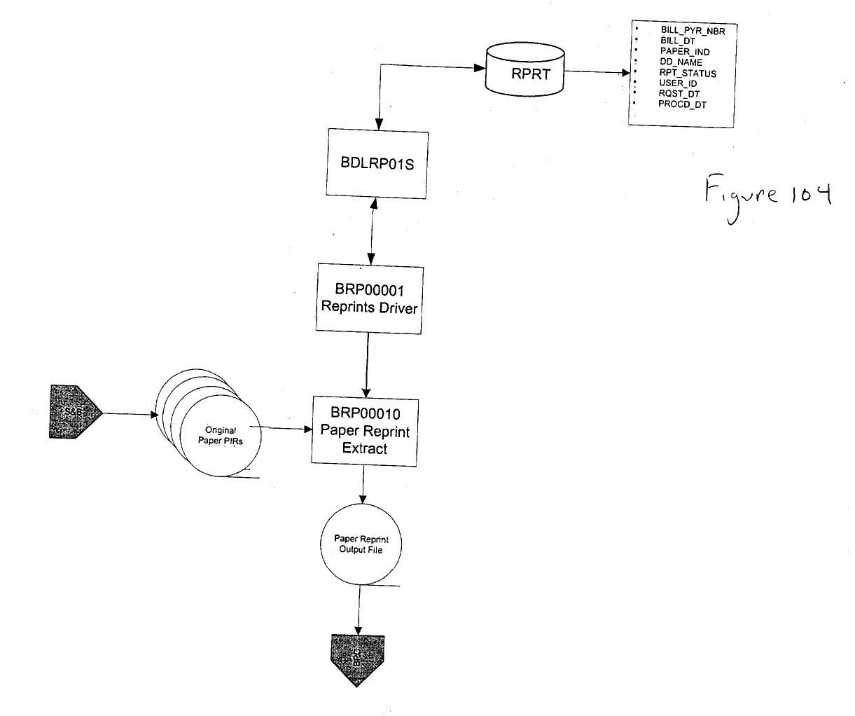

FIG. 105 illustrates a block diagram of a preferred embodiment depicting the Stack & Burst Flow.

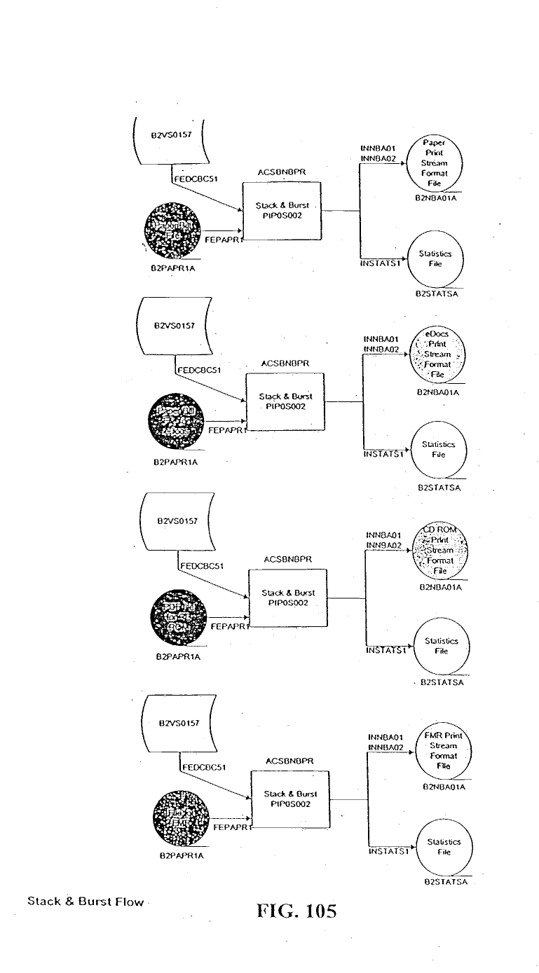

### DETAILED DESCRIPTION OF THE INVENTION

The present invention provides a solution to the needs described above through a system and method for a web-based, convergent communications billing solution for large-scale customers.

The present invention provides an electronic, integrated invoice platform capable of incorporating complex large-scale hierarchical billing files from multiple legacy systems into a single data stream, organized into a hierarchical view that reflects the customer's organization. The system produces web-based invoices and reports, enabling fast, efficient analysis, notifying the customer via E-mail when their information is ready for viewing. It also accepts a single payment, which is disbursed to respective carriers. In addition, the system handles disputes and adjustments online, applies fees, rating, taxes and surcharges and contains online print and data download capability, supporting exportation of data to external analysis tools for additional manipulation. The system also provides the capability for Customer Service Representatives (CSR) to view customer invoices and reports, access account history and add notes to the customer account. User-friendly tools are also available for instant invoice rendering.

The system's accounts receivable function is capable of receiving the single integrated invoice payment, overpayment or underpayment. It determines which amounts should be paid to the respective carriers, as well as what can or cannot be paid.

The present invention may include the following:

(1) Aggregate billing files across carriers into a single data stream;

(2) Organize billing data into a hierarchy or “departmentalized” view;

(3) Apply fees, rating, taxes and surcharges;

(4) Produce web-based invoices and reports for enabling fast analysis;

(5) Notify the customer via E-mail when their information is ready for viewing;

(6) Accept a single payment, which is disbursed to respective carriers;

(7) Handle disputes and adjustments online;

(8) Contain online print and data download capability;

(9) Provide for Service Rep (SR) notes and account history; and

(10) User-friendly tools for instant invoice rendering.

Benefits to Customers:

Web-based billing; no more boxes of paper

Integrated billing information across carriers

Automatic notification

Historical trending—understanding of telecom spend, quality of bill check and management of internal budget

Invoice images and reports displayed in seconds

Pay one amount—write one check or use electronic funds transfer

Faster turnaround time to pay, adjust and/or dispute charges

Less headcount needed to process invoices

No cost associated with internal software programming to read mag tape or EDI

No professional auditors needed to review invoices

Benefits to Providers (carriers):

Wins new or win back previous customers seeking enhanced billing capabilities

Protects existing revenue by retaining current customers and serving them better

Increases revenue through charging a fee for electronic billing and custom report generation

Recognizes revenue through accelerating payments

Limits or eliminates manual billing processes and resources to support existing operations

Reduces budget for internal one-off IT initiatives designed to improve billing

Avoids spending on piecemeal solutions incapable of meeting enterprise-wide billing needs

Cuts invoice production cost (paper, alternative media, postage, bill print center)

Lowers customer inquiries to the call center

Operating Environment

The environment in which the present invention is used encompasses the general Internet environment, with connections to Banks and other similar payment mechanisms, connections to multiple carriers to obtain legacy files and to provide results and analysis capabilities to these same carriers, and encompasses modem computing and server technology to process the data, create the integrated bills, process payments and adjustments and provide the required reports to the multiple carriers participating.

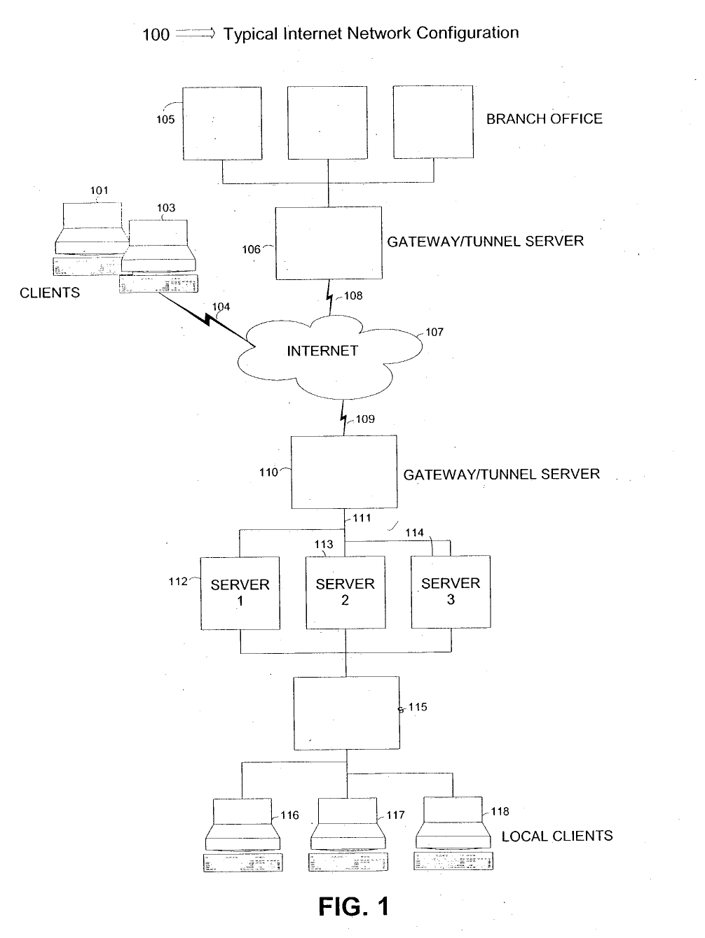

Some of the elements of a typical Internet network configuration are shown in FIG. 1, wherein a number of client machines 105 possibly in a branch office of an enterprise, are shown connected to a Gateway/hub/tunnel-server/etc. 106 which is itself connected to the internet 107 via some internet service provider (ISP) connection 108. Also shown are other possible clients 101, 103 similarly connected to the internet 107 via an ISP connection 104, with these units communicating to possibly a home office via an ISP connection 109 to a gateway/tunnel-server 110 which is connected 111 to various enterprise application servers 112, 113, 114 which could be connected through another hub/router 115 to various local clients 116, 117, 118. Any of these servers 112, 113, 114 could function as a process server of the present invention, as more fully described below. Any user situated at any of these client machines would normally have to have authorized passwords and account identification numbers in order to participate in the billing system.

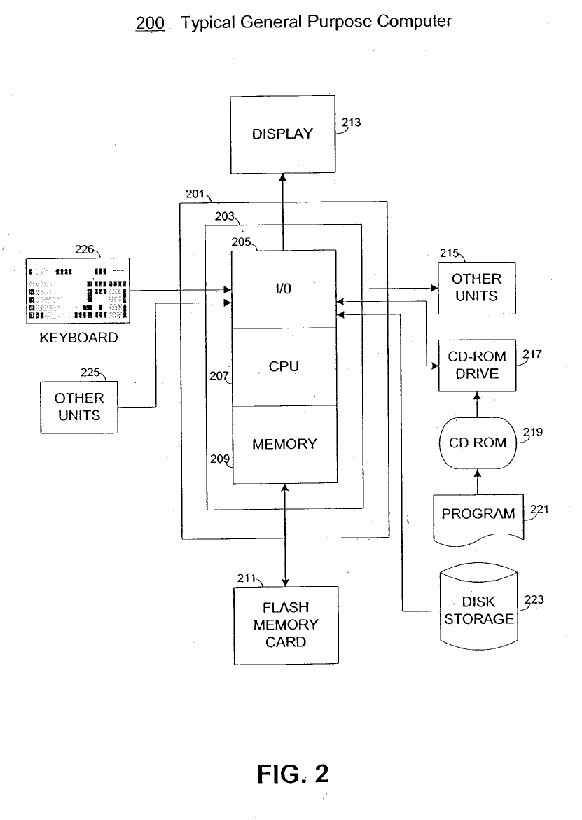

An embodiment of the Electronic billing System of the present invention can operate on a general purpose computer unit which typically includes generally the elements shown in FIG. 2. The general purpose system 201 includes a motherboard 203 having thereon an input/output (“I/O”) section 205, one or more central processing units (“CPU”) 207, and a memory section 209 which may have a flash memory card 211 related to it. The I/O section 205 is connected to a keyboard 226, other similar general purpose computer units 225, 215, a disk storage unit 223 and a CD-ROM drive unit 217. The CD-ROM drive unit 217 can read a CD-ROM medium 219 which typically contains programs 221 and other data. Logic circuits or other components of these programmed computers will perform series of specifically identified operations dictated by computer programs as described more fully below.

The Invention

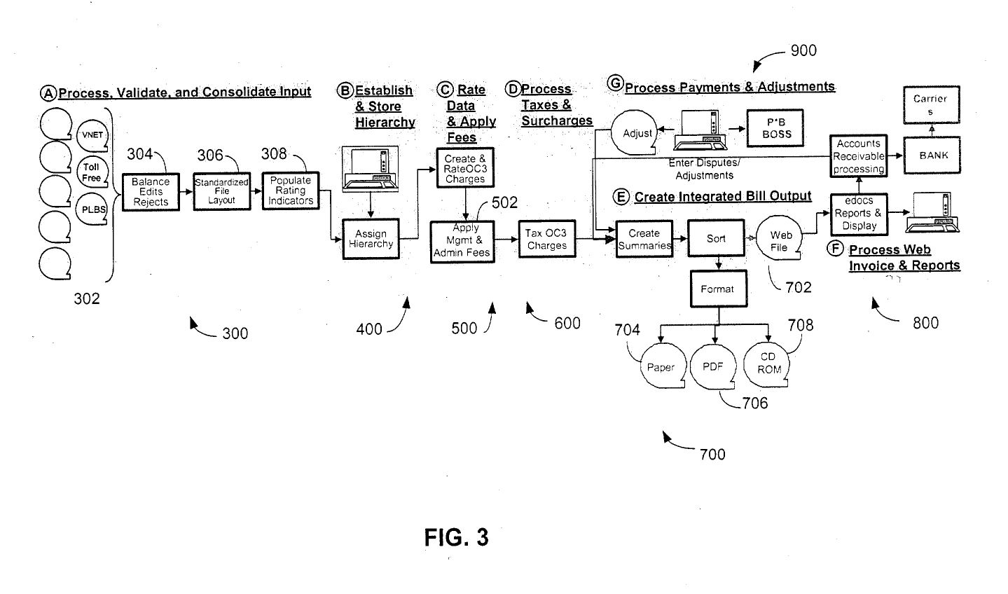

Referring now to FIG. 3, the basic architecture of the system is described, the components of which will be described in more detail later.

FIG. 3 shows the functional architecture of the invention according to one embodiment and includes the following components:

Process, Validate & Consolidate Input module 300, which may perform the following:

a. Process input files from various user sources/databases 302

b. Validate, balance and create audit report upon receipt 304

c. Perform pre-billing hierarchy matching

d. Populate missing data

e. Merge input files into a standard record layout 306

f. Populate rating indicators 308

g. Systematically update service address based on input record

h. Accepts legacy billing files “as is” from multiple users (see 302)

i. Report input file discrepancies to users

i. Missing extensions report

ii. Validation errors

iii. Pre-audit report

A. Establish & Store Hierarchy module 400, which may perform the following:

a. Maintain hierarchy (7 level reporting, 3 level billing)

i. Add, modify, delete relationships and attributes

ii. Perform address validation

b. Match all input records to customer-defined hierarchy

i. By extension

ii. By BTN

c. Identify, create report and recycle unmatched extensions

d. Identify zero usage extensions

e. Generate and assign unique account and invoice numbers

B. Rate Data & Apply Fees module 500, which may perform the following:

a. Maintain consolidated rate table for additional fees, additional product rates, product validation and product descriptions

b. Rate additional product data (recurring & non-recurring)

c. Apply admin fees at the product level 502

i. Percentage

ii. Flat rate

d. Apply management fees at the product level 502

i. Intralata revenue compensation from carrier to carrier

e. Track admin & management fees

C. Process Taxes & Surcharges module 600, which may perform the following:

a. Apply taxes and surcharges for additional products

b. Prorate products and fees

c. Merge product adjustments with fee adjustments

d. Report charge discrepancies to carriers

i. Unmatched charges report

Create Integrated Bill Output module 700, which may perform the following:

a. Create integrated user invoice via the web 702, paper 704, PDF 706 and CD-ROM

b. Track and report invoice lines used by user

c. Create custom invoice sections

i. Provide additional details on CSR online invoice

d. Produce remit only paper for web customers

e. Support multiple media copies as requested by customer

f. Interface with Bill Print Centers and Operations Centers

g. Perform reporting for USPS

h. Support bill regeneration

Process Web Invoice & Reports module 800, which may perform the following:

a. Provide a secure site for billing data

b. Restrict site access by user profile

i. User groups: bill payer, customer service representatives, system administrators

c. Provide online bill presentment for Bill Payers and CSRs

d. Display invoice views in 3-5 seconds

e. Send e-mail notification when information is ready for viewing

f. Produce online reports

g. Support filtering, sorting, printing and downloading of invoice and report data

h. Provide collection and account management reports via the web

i. Provide note entry screens for CSRs

j. Maintain online history of invoices, adjustments, payments, hierarchy relationships and additional products

k. Provide user administration

l. Maintain reference tables

m. Generate reports

i. Account management

ii. Customer care

iii. Fiscal management, summarizing billing data across 7 levels of the hierarchy

iv. Post-audit reports for carriers

1. Monthly billing summary

2. Billing and adjustment

3. Journal verification files

4. Monthly invoice report

n. Support online report viewing or downloading

Process Payments & Adjustments module 900, which may perform the following:

a. Process electronic payments via the web

b. Use external lockbox for paper and electronic payment processing

c. Allocate payments to carriers via ACH and EDI transactions

d. Handle payment exception processing (e.g., over and under-payments, missing remit stub)

e. Track & report adjustments, altering payments to carriers accordingly

f. Track receivables & pay by carrier at both the BTN and invoice (bill payer) level

g. Maintain real-time balance due

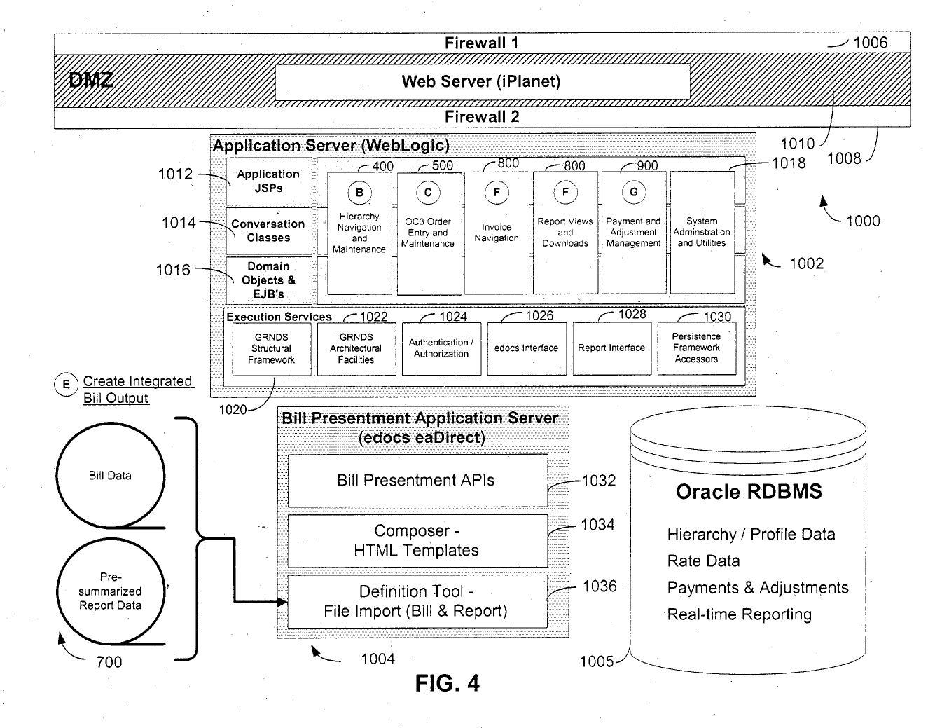

FIG. 4 shows the Web Architecture overview. The Web Architecture includes a web server 1000, web logic application server 1002, a bill presentment application server 1004 and an Oracle RDBMS table 1005.

Web server 1000 includes firewalls 1006 and 1008 and DMZ 1010.

Web logic application server 1002 includes application JSPs module 1012, conservation classes module 1014, domain objects and EJBs module 1016, and system administration and utilities module 1018. Server 1002 also includes the modules for hierarchy navigation 400, OC3 order entry and maintenance 500, invoice navigation 800, report views and downloads 800, and payment and adjustment management 900. In addition, server 1002 includes execution services such as GRNDS structural framework 1020, GRNDS architectural facilities 1022, authentication/authorization 1024, edocs interface 1026, report interface 1028, and persistence framework accessors 1030.

Bill presentment application server (edocs eaDirect) 1004 includes bill presentment APIs 1032, composer—HTML templates 1034, definition tool—file import (bill & report) 1036. The definition tool 1036 receives input from the create integrated bill output module 700.

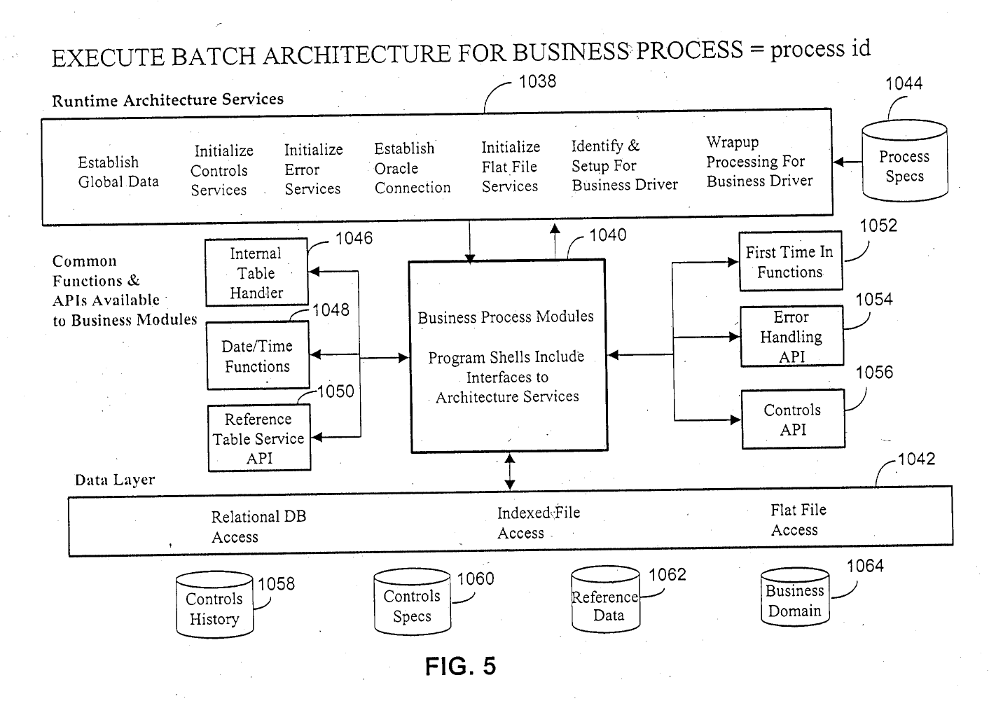

FIG. 5 shows the Batch Execution Environment. The Batch Execution Environment includes run time architecture services 1038, business process modules 1040, and data layer 1042. Run time architecture services 1038 accesses process specifications from table 1044 and may include the following services: establish global data, initialize control services, initialize error services, establish oracle connection, initialize flat files services, identify and set up for business driver, and wrap up processing for business driver.

Business process modules 1040 have program shelves that include interfaces to architecture services. FIG. 5 shows some of the common functions in APIs available to the business modules 1040 including internal table handler 1046, date/time functions 1048, reference table service API 1050, first time end functions 1052, error handling API 1054, and controls API 1056.

Data layer 1042 includes relational database access, index file access, and flat file access. Data layer 1042 also interfaces with data for controls history 1058, controls specifications 1060, reference data 1062, and business domain 1064.

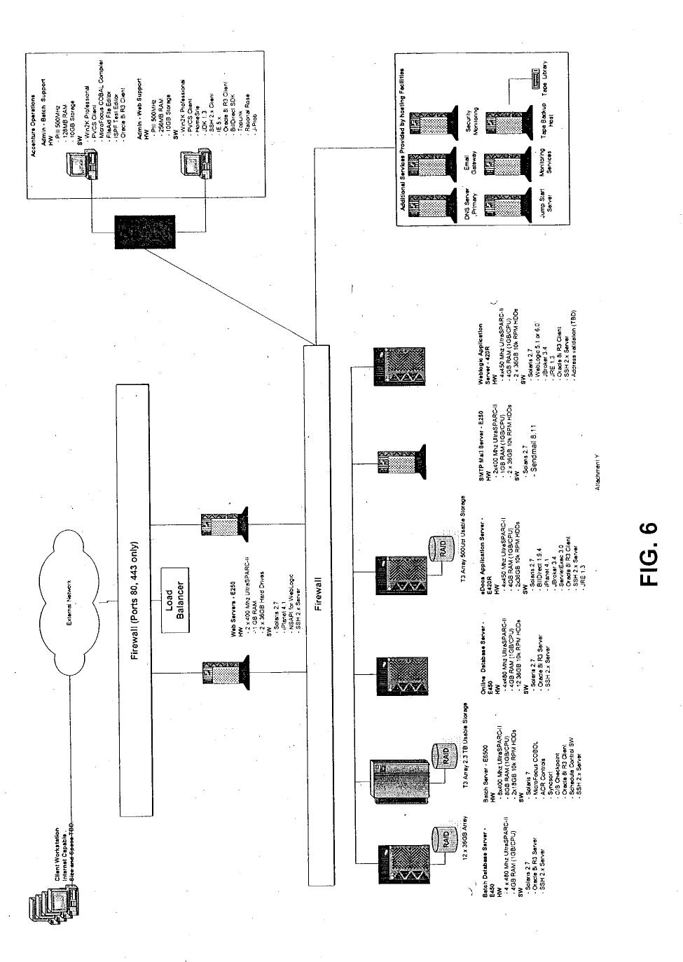

FIG. 6 illustrates a block diagram of a preferred embodiment depicting the Production Hardware/Software Configuration. This shows one example of a number of possible configurations.

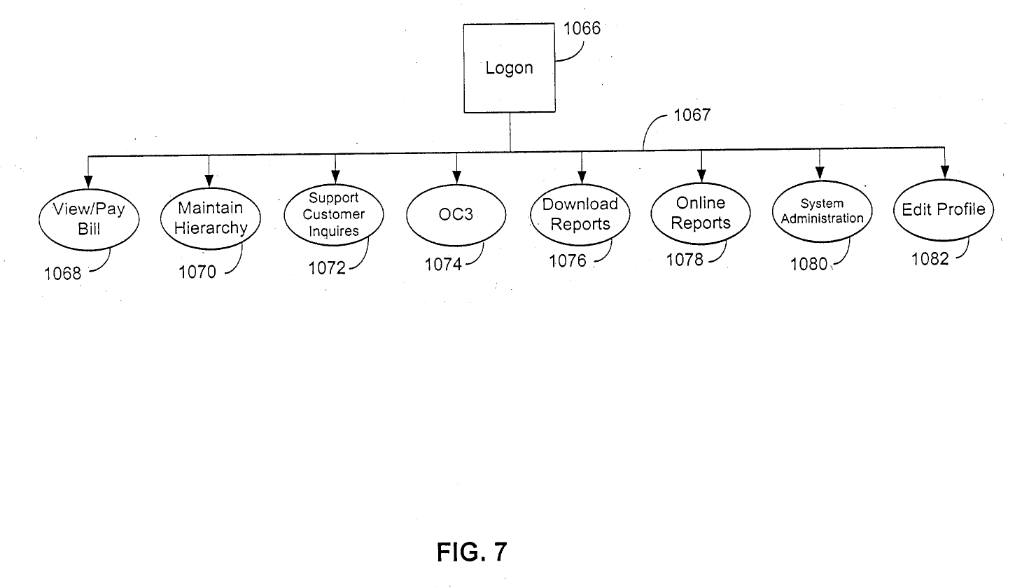

FIG. 7 illustrates a block diagram of a preferred embodiment depicting the Site Map for the electronic billing solution (EBS). The EBS website begins with a logon screen 1066. After logon, a user will have access to the eight major sections of the EBS site through weblinks 1067. The major sections include a View/Pay bill section 1068, and maintain hierarchy section 1070, a customer support inquiry section 1072, an OC3 section 1074, a download report section 1076, an online reports section 1078, a system administration section 1080, and edit profile section 1082.

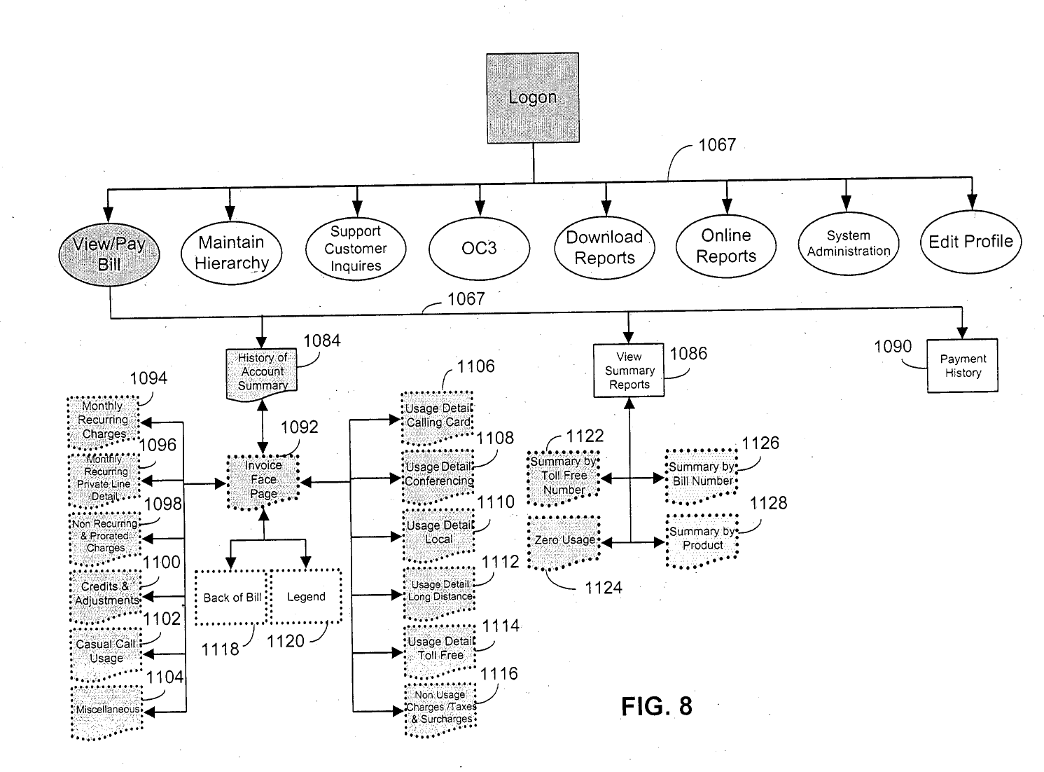

FIG. 8 illustrates a block diagram of a preferred embodiment depicting the View/Pay bill section of the EBS Site Map. FIG. 8 shows the View/Pay bill section 1068 of the EBS site. After accessing the View/Pay bill section 1068, the user can be taken through weblinks 1067 to three destinations. The destinations are EDOCS page report screen history of account summary 1084, EDOCS page webscreen view summary reports 1086, and EDOCS webscreen payment history 1090. Summary report screen 1084, the user can access invoice face page 1092. Invoice face page 1092 gives the user access to the majority items in the history of account summary 1084. These items include monthly recurring charges screen 1094, monthly recurring private line detail screen 1096, nonrecurring and prorated charges screen 1098, credits and adjustments screens 1100, casual call usage screen 1102, miscellaneous screen 1104, usage detail calling card screen 1106, usage detail conferencing screen 1108, usage detail local screen 1110, usage detail long distance screen 1112, usage detail toll free screen 1114, non usage charges/taxes and surcharges screen 1116, back of bill webscreen 1118, and legend webscreen 1120.

The view summary reports page 1086 gives access to the summary by toll free number screen 1122, the zero usage screen 1124, the summary by bill number screen 1126, and the summary by product screen 1128.

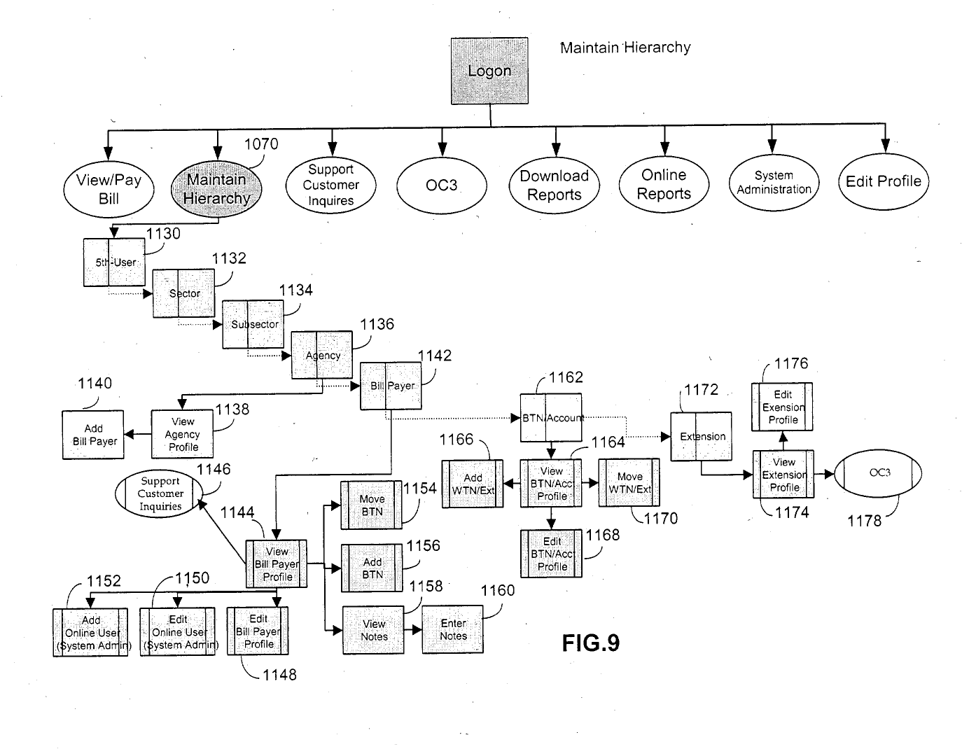

FIG. 9 illustrates a block diagram of a preferred embodiment depicting the maintain hierarchy section of the EBS Site Map. FIG. 9 shows the items available under the maintain hierarchy section 1070. These items include user screen 1130, sector screen 1132, subsector screen 1134, and agency screen 1136. Agency screen 1136 also gives access to the view agency profile screen 1138 which in turn gives access to the add bill payer screen 1140.

After agency screen 1136 comes bill payer screen 1142. Bill payer screen 1142 gives access to view bill payer profile screen 1144. View bill payer profile screen 1144 gives access to the predefined support customer inquiries screen 1146; edit bill payer profile screen 1148, edit online user (system admin) screen 1150, and add online user (system admin) screen 1152; move BTN screen 1154, add BTN screen 1156, and view notes screen 1158 and enter notes screen 1160.

After bill payer screen 1142 comes BTN/account screen 1162, which gives access to the view BTN/acct profile screen 1164. Screen 1164 in turns gives access to the add WTN/Ext. screen 1166, edit BTN/acct profile screen 1168, and move WTN/Ext. screen 1170.

After BTN/account screen 1162 comes extension screen 1172, which gives access to the view extension profile screen 1174, edit extension profile screen 1176, and predefined OC3 screen 1178.

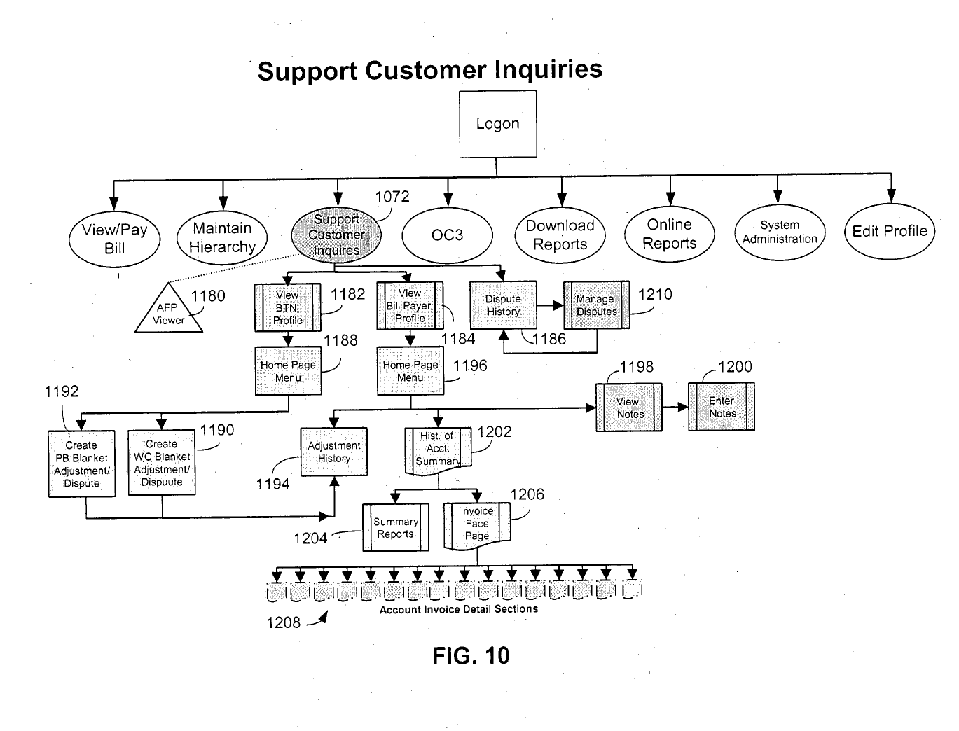

FIG. 10 illustrates a block diagram of a preferred embodiment depicting the support customer inquiries section of the EBS Site Map. From the customer support inquiries section 1072, the user has access to the AFP viewer 1180, view BTN profile 1182, view bill payer profile 1184, and dispute history 1186.

From view BTN profile 1182, the users is given access to home page menu 1188 then the create first user blanket adjustments/dispute screen 1192 and create second user blanket adjustments/dispute screen 1190. From the disputes screens, the user can access the adjustment history screen 1194.

From the view bill payer profile 1184, the user accesses home page menu 1196. Home page menu 1196 gives access to the adjustment history screen 1194, view notes 1198, and inter notes 1200. Also, the user can access history of accounts summary screen 1202, which provides access to the summary reports screen 1204, and invoice face page 1206. Invoice face page 1206 also provides access to account invoice detail sections 1208.

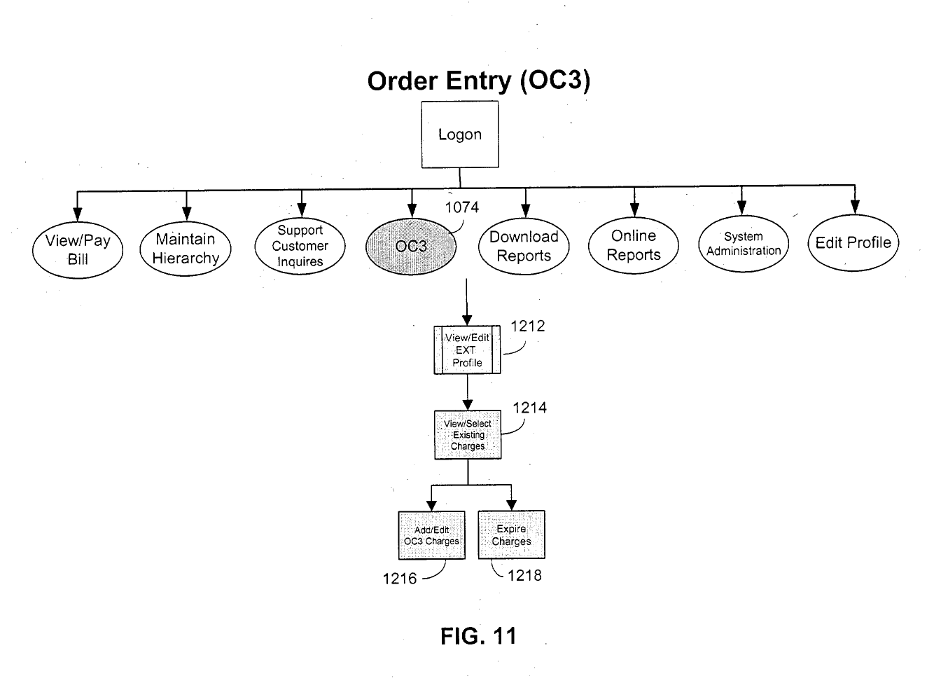

FIG. 11 illustrates a block diagram of a preferred embodiment depicting the order entry (OC3) section of the EBS Site Map. FIG. 11 shows one example of the order entry (OC3) section 1074. Section 1074 provides access to the view/edit EXT profile 1212, view/elect existing charges 1214, add/edit OC3 charges 1216, and expire charges 1218.

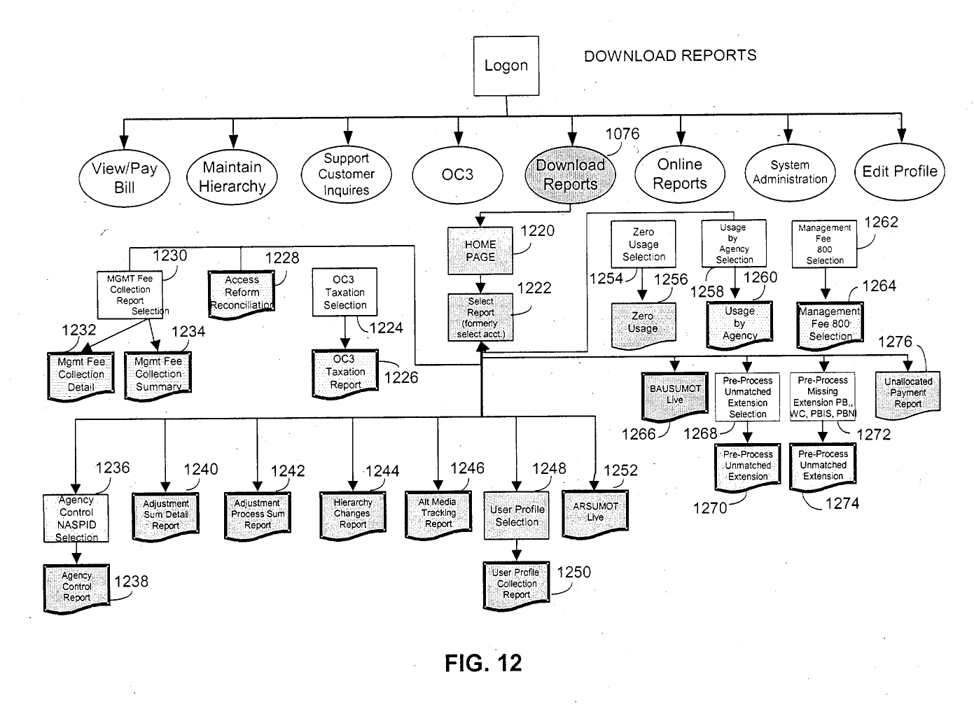

FIG. 12 illustrates a block diagram of a preferred embodiment depicting the download reports section of the EBS Site Map. FIG. 12 shows one example of the down load reports section 1076. Section 1076 leads the user to home page 1220 and then to select report 1222. From screen 1222, the user can access four different areas.

The first area leads to OC3 taxation selection screen 1224 and OC3 taxation reports screen 1226, access reform reconciliation screen 1228, and management fee collection report selection screen 1230. Screen 1230 gives access to management fee detail collection screen 1232 and management fee summary screen 1234.

The second section gives access to agency control NASPID selection screen 1236 and agency control report screen 1238, adjust summary detail report 1240, adjustment process summary report 1242, hierarchy changes report 1244, alternate media tracking report 1246, user profile selection 1248, and user profile collection report 1250, and ARSUMOT live screen 1252.

The third section give access to zero usage selection screen 1254 and zero usage screen 1256, usage by agency selection screen 1258 and usage by agency screen 1260, and management fee 800 selection screen 1262 and management fee 800 selection report screen 1264.

The fourth section provides access to BAUSUMOT live report screen 1266, preprocess unmatched extension selection 1268 and preprocess unmatched extension report screen 1270, preprocess missing extension for various users 1272 and preprocess unmatched extension report screen 1274, and unallocated payment report screen 1276.

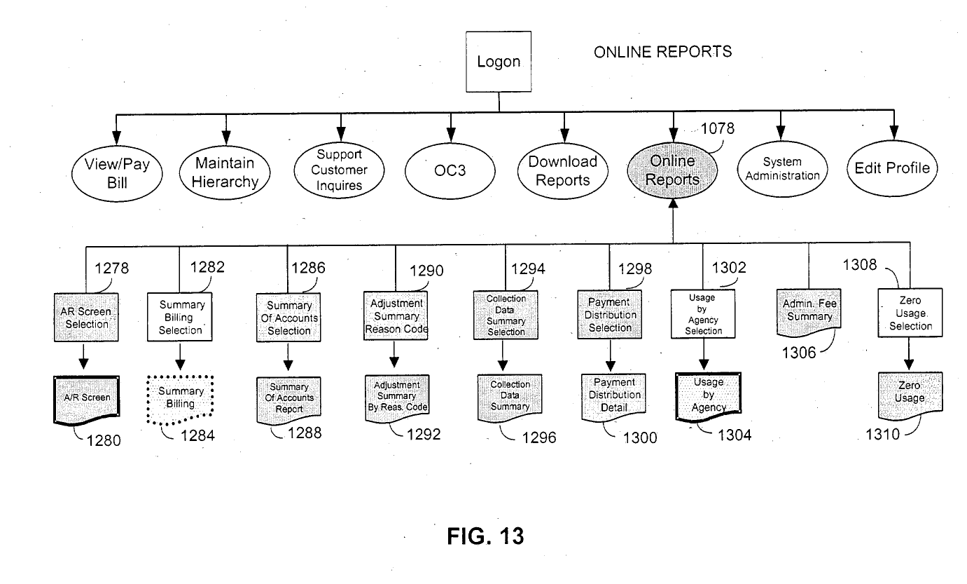

FIG. 13 illustrates a block diagram of a preferred embodiment depicting the online reports section of the EBS Site Map. FIG. 13 shows one example of the online reports section 1078.

Section 1078 provides access to AR screen selection 1278 and AR report screen 1280, summary bill selection 1282 and summary billing report screen 1284, summary of accounts selection 1286 and summary of accounts report 1288, adjustment summary by reason code 1290 and adjustment summary by reason code report screen 1292, collection data summary selection 1294 and collection data summary report screen 1296, payment distribution selection 1298 and payment distribution detail report screen 1300, usage by agency section 1302 and usage by agency report screen 1304, admin fee summary 1306, and zero usage selection 1308 and zero usage report screen 1310.

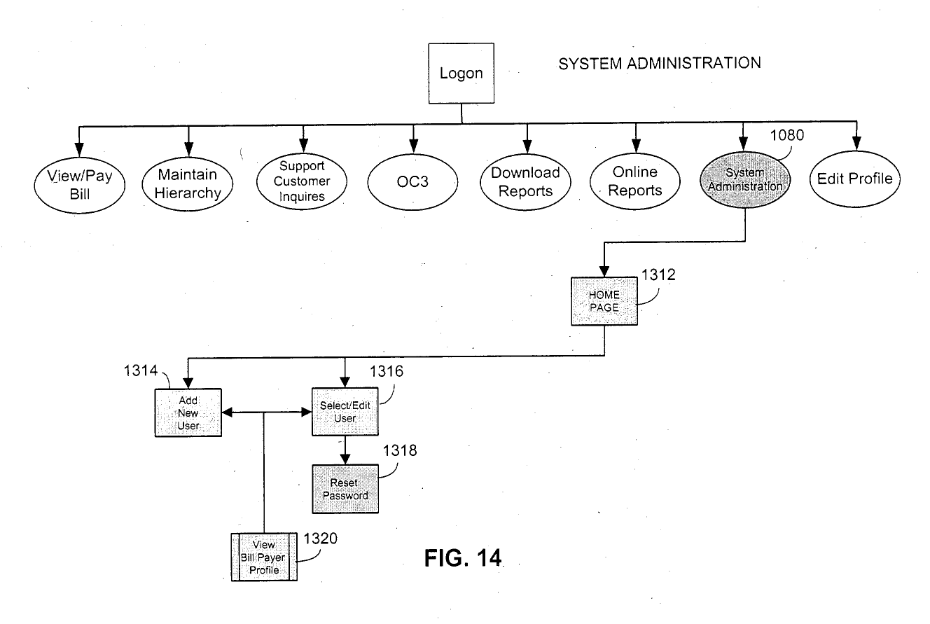

FIG. 14 illustrates a block diagram of a preferred embodiment depicting the system administration section of the EBS Site Map. FIG. 14 shows one example of the system administration section 1080. Section 1080 provides access to home page 1312, which in turn provides access to add user screen 1314 and select/edit user screen 1316. Screen 1316 provides access to reset password screen 1318. In addition, view bill payer profile 1320 provides access to the add user screen 1314 and the select/edit user screen 1316.

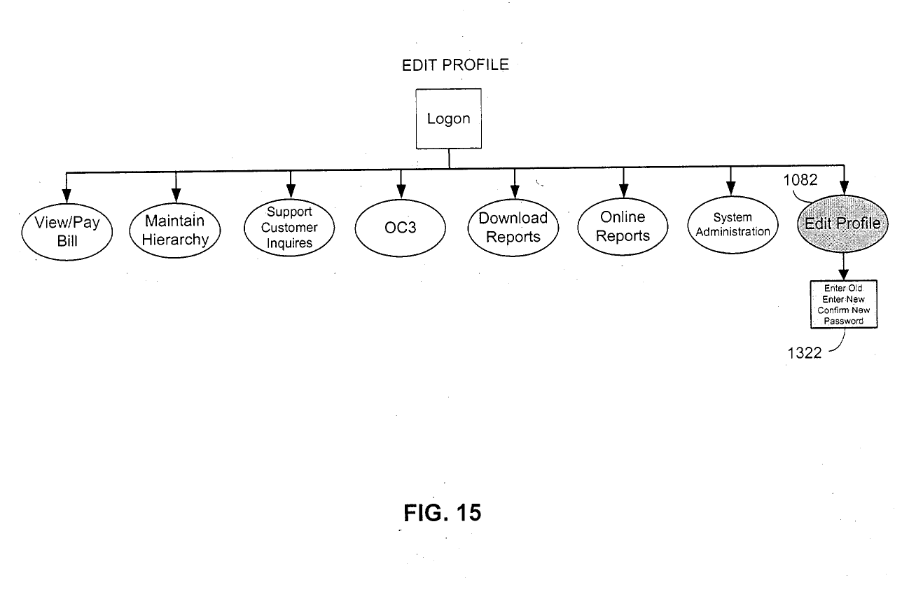

FIG. 15 illustrates a block diagram of a preferred embodiment depicting the edit profile section of the EBS Site Map. FIG. 15 shows one example of the edit profile section 1082, which provides access to enter old/enter new/confirm new password screen 1322.

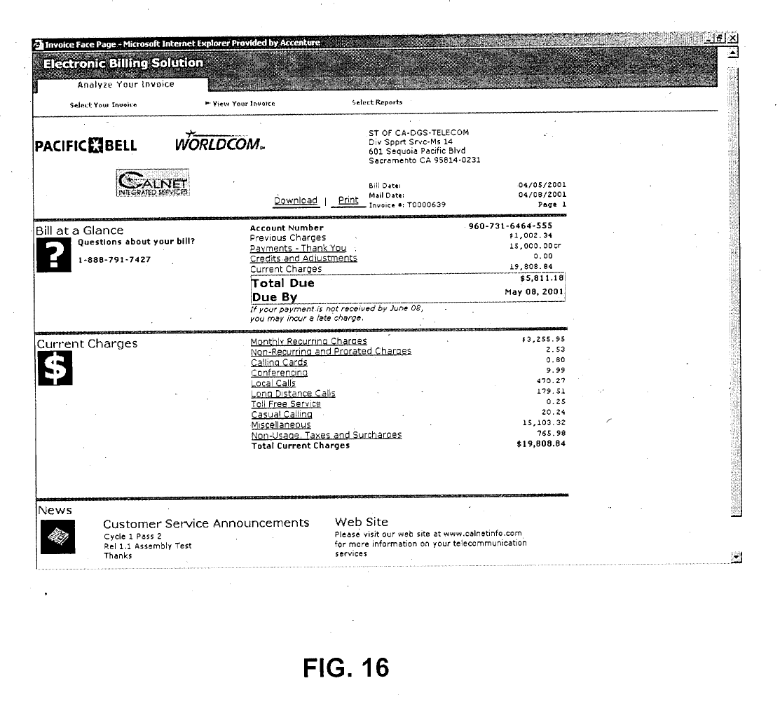

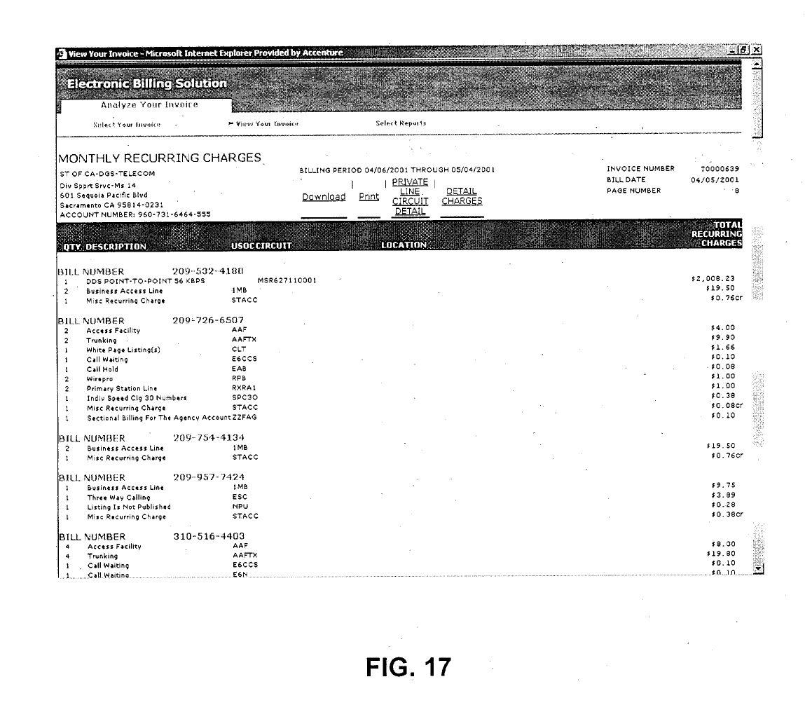

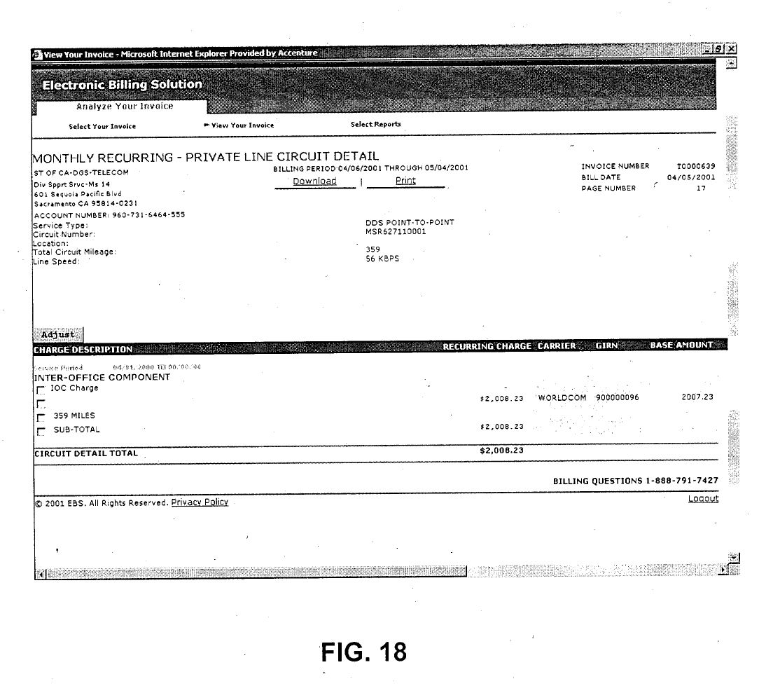

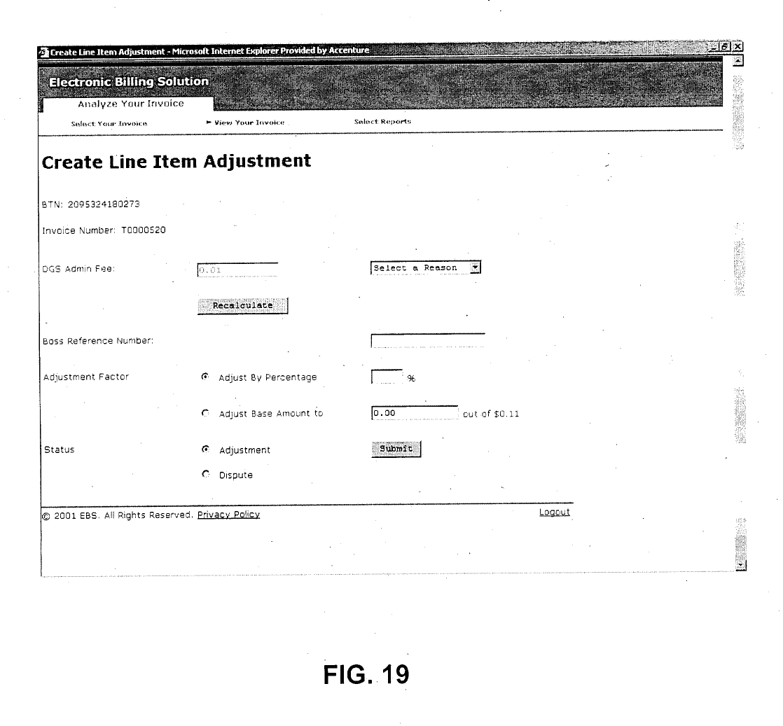

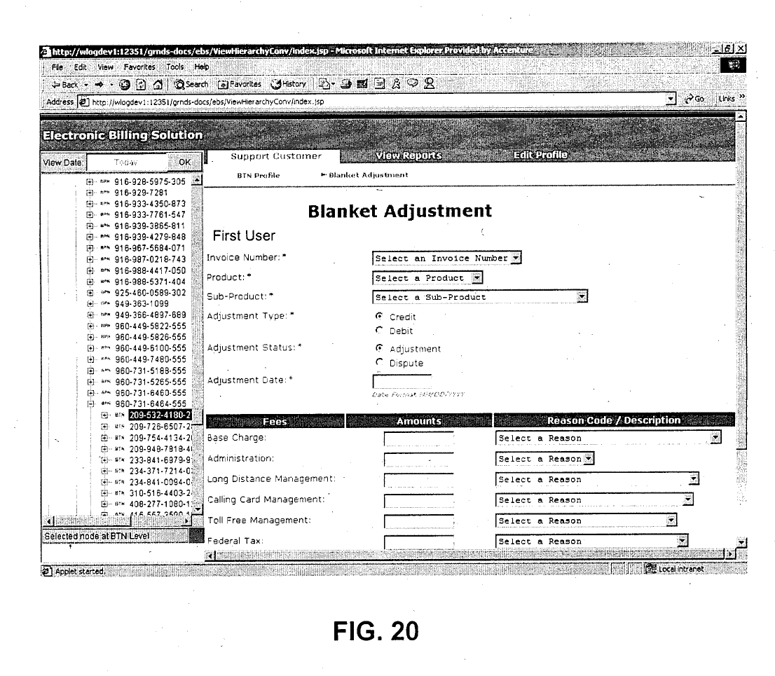

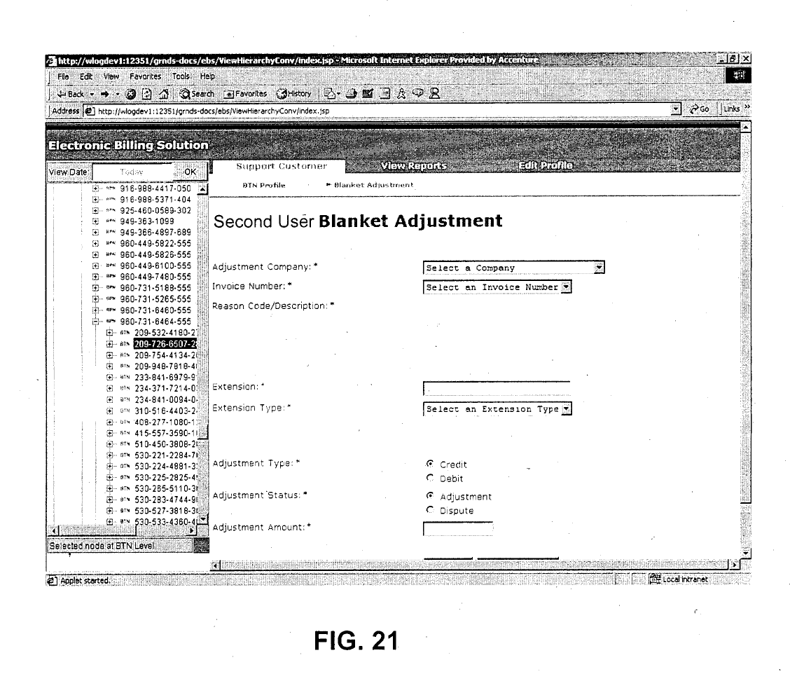

FIGS. 16-21 show screen shots of examples of the invoice face page, summary bill face page, summary bill face page—private line circuit detail, line item adjustment, a first user blank adjustment and a second user blank adjustment.

The following sections describe certain processes in a preferred embodiment of the invention. The sections use selected assumptions or criteria for example purposes only. The assumptions/criteria can be changed or altered without departing from the spirit and scope of the present invention. In addition, the description refers to multiple Users. These are used to provide example of how the invention can be configure for users with different requirements.

Adjustments:

Assumptions:

All 2nd User base charge amount adjustments will be handled via BOSS. EBS will only be used to adjust DGS Admin Fees for these charges (except for blanket adjustments where the blanket base charge adjustment is made in EBS).

2nd User and 1st User blanket adjustments will not have taxes credited when they are made.

All adjustment amounts, pro-rating, and taxes are calculated and written to the Adjustments Table(s) by the Web interface.

Create IIRs process will have assigned fit codes to the 2nd User BOSS adjustments records.

Online system will not be available to users when the batch processes are running.

The following data will be supplied by the Web team on the adjustments table(s) depending on the carrier:

Invoice Number

Bill Payer Number

BTN

WTN

BOSS Reference Number (for 2nd User), Blank for 1st User

Adjustment Charge Amount (for 1st User), 0 for 2nd User

Adjustment Charge Reason Code

Adjustment Charge Description

Admin Fee Adjustment Amount

Admin Fee Adjustment Reason Code

Admin Fee Adjustment Description

Management Fee Adjustment Amount

Management Fee Adjustment Reason Code

Management Fee Adjustment Description

Management Fee Type

Blanket Adjustment Reason Code

Blanket Adjustment Description

Federal Tax Adjustment

Federal Tax Adjustment Reason Code

Federal Tax Adjustment Description

State Tax Adjustment

State Tax Adjustment Reason Code

State Tax Adjustment Description

Surcharge Tax Adjustment

Surcharge Tax Adjustment Reason Code

Surcharge Tax Adjustment Description

File Source/Origin

Adjustment Type

Carrier ID

Key Inputs:

| Description/Content | Provided By | Sorting Requirement |
|---|---|---|
| 2nd User Adjustment IIR | Hierarchy | BOSS, BTN, |
| file | Match | WTN |
| Adjustments Table(s) | Web | None |
| Billing Extract Trigger | Create | Bill Payer |
| | Triggers | |

Key Outputs:

| Description/Content | Provided To | Sorting Requirement |
|---|---|---|
| Combined 2nd User and 1st User | AII | 1. Bill Payer |
| Adjustment IIR file | | 2. BTN |
| | | 3. WTN |
| | | 4. Product |

Functional Description:

Preferably, only detail charges on the EBS bill will be able to be adjusted directly. Summary amounts (e.g. section totals, current charge totals, etc.) and taxes are typically not adjusted via the EBS adjustment interface. The Web interface allows users to make adjustments on 2nd User Detail, 2nd User Blanket, 1st User detail and 1st User blanket charges.

2nd User detail adjustments for all 5th user accounts are recorded both in the 2nd User BOSS legacy system and EBS. The actual 2nd User adjustment amount will be adjusted in BOSS while the DGS Admin Fee will be adjusted via the EBS Web interface.

EBS will merge adjustments from the 2nd User BOSS system and the EBS Web Adjustment interface for display on the invoice. This merge will be performed using the BOSS reference number (entered into both BOSS and EBS), BTN and WTN. The reference number, BTN and WTN will be sent to EBS in the 2nd User billing adjustment records. If a match is found, these two adjustments will be added together to create a single line item adjustment which displays the adjustment text sent by 2nd User on the input record. If multiple adjustments have the same reference number, BTN, WTN and description, the adjustments will be rolled into one group display on the bill.

The matched 2nd User adjustment record will contain the following fields: BOSS Reference Number, Adjustment Reason Code, Adjustment Reason Text, Adjustment Date and Adjustment Amount. (The default values will come from the BOSS file for matched 2nd User detail line item adjustments.) The total sum of the adjustment is also included, along with the breakdown of the DGS Admin Fee to be used to credit the amount owed to DGS for Admin Fees in the EBS A/R process.

There may be instances where more than one adjustment record (in 2nd User adjustment input file) exist with the same BOSS Reference #, BTN and WTN. If this is the case, the first record will be matched against the Adjustments table. If a match is found, the table will be updated to show that the adjustment has been billed. Therefore the second record with the same Reference #, BTN and WTN will not find a match on the table.

Tax records will not be processed, but written directly to the output file. An indicator will identify these particular records and no matching will be performed for tax adjustment records.

An attempt will be made to match all adjustments made via EBS on 2nd User charges to a BOSS adjustment for a period of at least 60 days from the adjustment date. If a match is not found during that timeframe, the EBS adjustment will be placed on the appropriate Bill Payer's bill in the Credits and Adjustments section as a Service Fee Adjustment (on the bill day that follows after 60 days). The adjustment description used on the invoice will be standard text for all unmatched 2nd User DGS Admin Fee adjustments.

2nd User blanket adjustments are made through the Web interface. If the blanket adjustment is not a DGS blanket adjustment, there is no corresponding entry in the BOSS system and therefore no matching will be performed on 2nd User blanket adjustments. The following fields will be written to the Adjustments table for a 2nd User blanket adjustment record: Adjustment Reason Code, Adjustment Reason Text, Adjustment Date and Adjustment Amount. The adjustment will be retrieved from the Adjustments table and written to an IIR record.

1st User adjustments are made only via the EBS Web interface. The adjustments will be retrieved from the Adjustments Table and the text used for bill display will be the adjustment description text entered on the Adjustments table via the Web interface. An IIR record will be created for each adjustment in order for it to be processed in All.

All 2nd User tax-related adjustments will be created in BOSS and as a result, no taxes need to be credited as part of the EBS adjustment processing. For adjustments made on 1st User charges, the EBS Web adjustment interface calculates the amounts, and types, of taxes (Federal, State and Surcharge) to be credited as part of the adjustment.

Fit codes are assigned to 2nd User unmatched DGS, 2nd User blanket and 1st User adjustments based on record type. The output adjustments file is passed on to All for further processing.

Process Flow Description:

Trigger extract initiates process.

2nd User input adjustments file read in from Rate and Apply Fees process.

1. Fetch call made to Adjustments Table to match 2nd User adjustment record.

2. If match not found, input BOSS adjustment record written to output file with contents of input record.

3. If match found, following occurs:

i. DGS Admin Fee (from table) added to 2nd User adjustment found on file and adjustment amount populated on output IIR.

ii. BOSS Reference #, Adjustment Reason Code, Adjustment Reason Text, and Adjustment Date values from the input record will be populated in the output IIR.

iii. Adjustments Table will be updated to show that adjustment of DGS Admin Fee has been billed.

6th user and 4th user adjustments.

1. No Admin Fees adjusted using Web interface.

2. Input record written to output IIR.

Fetch data layer to Adjustments table to return all unbilled adjustments for Bill Payer entered via Web interface (excluding 2nd User DGS matched adjustments processed previously).

1. 2nd User Blanket Adjustment

i. Identified as adjustment type of “non-DGS”.

ii. Fit code assigned based on record type.

iii. No matching performed. Write adjustment to IIR.

2. 2nd User>60 days Adjustments

i. Any adjustment posted to the table>60 days before EBS bill round date.

ii. Fit code assigned to record type.

iii. Write adjustment to IIR.

3. 1st User Adjustments

i. Both adjustment charge amount and fees adjusted via Web interface.

ii. Fit code assigned based on record type.

iii. Create IIR for each retrieved.

All corresponding billed adjustment entries on table will be updated with a billing indicator.

Output file passed to All for further processing.

Process Components and Descriptions:

| Component | | |
|---|---|---|
| (driver, | | |
| data layer, | | |
| etc.) | Name/ID | Description of Function |
| Driver | New | Driver will control the sub-modules |
| | | that will match the adjustments, write |
| | | to file and assign fit codes. |
| 2nd User | New | Module will retrieve all 2nd User |
| Adjustments | | adjustments: |
| Module | | 1) Match the 2nd User |
| | | adjustments file with DGS Admin Fee |
| | | adjustments found on the Adjustments |
| | | table. If a match is found, the |
| | | adjustment credit amount and Admin |
| | | Fee will be added and presented |
| | | together as one line item. If no |
| | | match is found, 2nd User adjustment |
| | | record from file will be written to |
| | | output file with info in input |
| | | record. |
| | | 2) Extract all 2nd User Admin |
| | | Fee adjustments > 60 days. IIR record |
| | | written. Fit code assigned to each |
| | | adjustment record. |
| | | 3) Extract all 2nd User blanket |
| | | adjustments based on Adjustment Type |
| | | of “non-DGS”. No matching |
| | | is performed. |
| 1st User | New | Module will extract all 1st User |
| Adjustments | | corresponding Bill Payer level |
| Module | | adjustments (based on trigger) and |
| | | create IIRs for the records. Fit |
| | | code assigned to each adjustment |
| | | record and corresponding taxes. |
| | | 1) Extract 1st User detail |
| | | adjustments. |
| | | 2) Extract 1st User blanket |
| | | adjustments. |
| Data Layer | New | Fetch Data Layer to Adjustments |
| | | Table using BOSS Reference Number, |
| | | BTN and WTN as key (2nd User). |
| | | Return matching DGS Admin Fee |
| | | adjustment. |
| Data Layer | New | Fetch Data Layer to Adjustments |
| | | Table to return all adjustments for |
| | | a given Bill Payer. |
| Data Layer | New | Update Data Layer to Adjustments |
| | | Table to update all rows to |
| | | “billed” (once billed) for |
| | | 2nd User DGS Admin Fee adjustments > |
| | | 60 days, 2nd User blanket |
| | | adjustments and 1st User adjustments. |

Tables and Descriptions:

Oracle Tables:

| | | CRUD | |
|---|---|---|---|
| | | (Create, | Owner |
| | | Read, | (Process: |
| | | Update, | Web, AR, |
| Table Name | Description/Content | Delete) | OI, etc) |
| Adjustments | Contains information needed to | Read, | Web |
| Table(s) | process adjustments, including | Update | |
| | the following: | | |
| | Bill Payer Number/Control | | |
| | Account ID | | |
| | BTN | | |
| | WTN | | |
| | BOSS Reference Number | | |
| | (for 2nd User) | | |
| | Adjustment Charge Amount | | |
| | (for 1st User) | | |
| | Adjustment Charge Reason Code | | |
| | Adjustment Charge Description | | |
| | Admin Fee Adjustment Amount | | |
| | Admin Fee Adjustment Reason | | |
| | Code | | |
| | Admin Fee Adjustment Descrip- | | |
| | tion | | |
| | Management Fee Adjustment | | |
| | Amount | | |
| | Management Fee Adjustment | | |
| | Reason Code | | |
| | Management Fee Adjustment | | |
| | Description | | |
| | Management Fee Type | | |
| | Blanket Adjustment Reason | | |
| | Code | | |
| | Blanket Adjustment Descrip- | | |
| | tion | | |
| | Federal Tax Adjustment | | |
| | Federal Tax Adjustment Reason | | |
| | Code | | |
| | Federal Tax Adjustment Descrip- | | |
| | tion | | |
| | State Tax Adjustment | | |
| | State Tax Adjustment Reason | | |
| | Code | | |
| | State Tax Adjustment Descrip- | | |
| | tion | | |
| | Surcharge Tax Adjustment | | |
| | Surcharge Tax Adjustment Reason | | |
| | Code | | |
| | Surcharge Tax Adjustment Descrip- | | |
| | tion | | |
| | File Origin (e.g. VNET, PLBS) | | |
| | Adjustment Type | | |

Interfaces:

| Interface Name | Description |
|---|---|
| Match | Sends 2nd User Adjustment IIR file. |
| Hierarchy | |
| Create Triggers | Sends in Billing Extract trigger. |
| AII Process | AII process reads the output files from the |
| | Match Adjustments process. |
| Web | 2nd User DGS Admin Fee, 2nd User blanket and |
| | 1st User adjustments will be made through the |
| | Web interface. |

AII—Billing AII (BAI) & Reporting AII (RAI):

Assumptions:

All input data will be tagged with the BTN, Bill Payer, and agency ID.

All of the service types, features, and product identifications needed for bill summaries will be passed into AII on the detail records. AII will not need to do any product look up or text translations.

The zero usage monthly report will be generated by the Hierarchy process and The details will be passed through BAI.

Report ID will be added to the sort cap of the IIR layout but should not be populated until REP.

All tax records will be passed on one record for every tax type. From 2nd user, these tax types will be summarized at the BTN level. From 1st User, they will be individual taxes records for each tax type for every charge record.

Hierarchy team will create report triggers containing the break levels. One trigger per report with updated date information.

The IIR/BIR copybook will be the same layout. The output of Billing All will be the same as the IIR layouts.

Reporting AII will only create summaries for the reports that are generated using Edocs and only the details for these reports will be sent on the input files.

No negative confirmation is required when we suppress a zero usage account in AII.

Products with the same Service Type and Charge type will have the same rate. This process will not create different summaries based on rate and will only separate product charges by service type/feature type.

Key Inputs:

BAI inputs.

| | | | Process |
|---|---|---|---|
| | Provided | Sorting | Sorted |
| Description/Content | By | Requirement | By |
| Extract Trigger with account properties and | Triggers | Bill Round | Triggers |
| Hierarchy data. One record per bill payer. | Team | Bill Payer | |
| This file contains the Bill Payer to State | | | |
| hierarchy data and all of the other account | | | |
| level information. This record is used to | | | |
| create the two file match for creating the | | | |
| BAI summaries. The hierarchy information | | | |
| on this record will determine the summary | | | |
| breaks. For the Bill invoice, the summaries | | | |
| will not exceed the BTN or Bill Payer | | | |
| levels. All Bill Payer account information | | | |
| will be on this record and help the BAI | | | |
| process create the invoice. They include | | | |
| all hierarchy data from Level 1 to level 5. | | | |
| AR detail file with Bill Payer. | AR batch | Bill Round | AR. |
| These files contain all of the detail | team. | Bill Payer | |
| charges with the detail record associated | | | |
| to the Bill Payer Level. | | | |
| The details of this file will need to be | | | |
| associated to the Bill payer and agency | | | |
| ID. This file will contain payment records | | | |
| to itemize the amount paid and the date | | | |
| from the previous month for each Bill | | | |
| Payer. If no payments are made, a zero | | | |
| amount record will be passed. The file | | | |
| also contain any past due amount for each | | | |
| Bill Payer. The Past due amount record | | | |
| should only be sent if there is a current | | | |
| past due amount. This past due amount will | | | |
| not be reflected in the totals and subtotals | | | |
| sent back to AR from the output of BAI. Any | | | |
| other credit or adjustment information that | | | |
| is not included in the Rating file will be | | | |
| in the AR file. Each of the detail records | | | |
| will also contain a FIT-CD to allow BAI to | | | |
| identify the record as a payment, past due | | | |
| amount, credit, or adjustment. | | | |
| Rating file at Bill Payer Level. These files | Rating. | Bill Round | Rating. |
| contain all of the detail usage and non- | | Bill Payer | |
| usage charges associated to the Bill Payer | | | |
| Level. Each of the charges and products | | | |
| will have been rated and taxed (when | | | |
| applicable) prior to entering this process. | | | |
| Each record should include carrier, BTN, | | | |
| and file of origin for BAI summary breaks | | | |
| and product display text for the bills and | | | |
| reports. Each record will contain a FIT-CD | | | |
| that will allow BAI to identify the record. | | | |
| Billing Zero usage details will be sent to | | | |
| AII at the Bill Payer level for the Zero | | | |
| Usage Billing report section. The zero usage | | | |
| detail will be generated in the Hierarchy | | | |
| Process. | | | |
| Adjustment file at the Bill Payer Level. | Rating. | Bill round | Rating |
| This file contains the credit and adjustment | | Bill Payer | |
| details. The adjustment will contain the | | | |
| adjustment text, amount and FIT-CD. | | | |

RAI Inputs.

| | | | Process |
|---|---|---|---|
| | Provided | Sorting | Sorted |
| Description/Content | By | Requirement | By |
| Reporting extract trigger-This | Hierarchy/ | Report ID. | Hierarchy |
| file contains report level | Triggers | | Team |
| information that will help | team | | |
| determine the report summaries. | | | |
| This record is used to create | | | |
| the two file match for creating | | | |
| the RAI reporting summaries. | | | |
| For the reports, the summaries | | | |
| will be created at various levels | | | |
| including extension, Bill Payer, | | | |
| Agency, Sector, Sub-Sector, and | | | |
| state branches. The extract | | | |
| trigger will need to contain | | | |
| the break levels which will be | | | |
| different for each report. There | | | |
| will only be 15 triggers, one for | | | |
| each report created in RAI. | | | |
| Reporting Details- The detail | Reporting | Report ID | Report |
| file is from the | | | |
| reporting engine and contains all | Process | Agency ID | Process |
| of the report details that will be | | Bill Payer | |
| displayed on the web using Edocs. | | | |
| Each of the records will have been | | | |
| assigned a FIT-CD that corresponds | | | |
| to report sections prior to entering | | | |
| this process. | | | |

Key Outputs:

BAI Outputs.

| | Provided | Sorting |
|---|---|---|
| Description/Content | To | Requirement |
| Header BIR file will contain | OI DI. | Bill Payer |
| all of the Bill Payer level | | |
| information including the Bill | | |
| Payer total amount due. Also | | |
| contains the suppression code | | |
| when no detail records are | | |
| passed. | | |
| Detail file with all hierarchy | DI. | Bill Round |
| information and contains all | | Bill Payer |
| of the details, product subtotals, | | |
| the BTN totals, and Bill Payer | | |
| totals on the BIR output file. | | |
| OI BIR detail file. This file will | OI | Bill Round |
| contain all of the summaries | | Bill Payer |
| needed for the AR revenue file, | | |
| and the reports. Many of the de- | | |
| tails included in the DI detail | | |
| file will not be included in | | |
| this OI file. For AR, Bai will | | |
| need to create a summary for | | |
| every BTN by carrier. | | |

RAI Outputs

| | Provided | Sorting |
|---|---|---|
| Description/Content | To | Requirement |
| Report output file- These report | DI | Report ID |
| details will be summarized to create | | Bill Payer |
| the subtotals and report lines. | | |
| When all of the details are processed, | | |
| the output BIR's will be sent to DI to | | |
| sort the reports for presentation on | | |
| the web. | | |

Functional Description:

This AII process will aggregate all of the billing and reporting details and create summaries that we will use on the billing invoices. Details from several sources will enter AII with all of the detail billing information already generated. AII takes all of these details and generates summaries for different sections of the bill or report.

The AII process can be divided into two different parts, Billing AII (BAI) and Reporting AII (RAI). The BAI process will create the bill invoice summaries and the RAI process will create the report summaries being sent to Edoc's. The functionality needed for both of these processes is the same and will utilize the same Driver, modules, summary modules, internal copybooks, and summary tables. During the Bill Cycle executions, the BAI will be executed to generate the Billing summaries. After the Billing AII process has completed, the details are sent to the backend process, and OI. In OI the details are processed to create daily and bill cycle audit reports.

At the end of the every Bill Cycle, the reporting engine will process all of the monthly and daily report data. The report details are processed and additional details are created and written to a file. At the end of the month, a reporting cycle will be kicked off and the Reporting process will generate additional files for RAI. The Reporting AII job will read in the Reporting file and create the report summaries. The report details and summaries are then passed to DI backend for sorting.

The example described herein will be using the NBS code as a base for the AII process. The NBS AII is a stream-lined version of the full AII code available in the original BPP2 software.

Some changes will be required for the NBS software to satisfy all of the requirements for the example described herein. The following section will list and explain the changes to the NBS software to support the functionality of Billing AII (BAI) and Reporting AII (RAI) required for the example described herein.

BAI/RAI Executions.

The Billing and Reporting AII process will utilize the same sub-modules and summarization tables. The two different jobs will use a different driver.

Billing Changes needed for Hierarchy.

The system is required to create summary levels for the billing invoices at the Bill Payer level, data needs to be sent to AR at the BTN level, and reports need to be created at various hierarchy levels above Bill Payer. Because the NBS software only supports one level of summaries, there are changes needed to support this requirement.

Summary Break Changes/Summary Creation.

For the example described herein, multiple reporting levels are needed. Summaries need to be created at each reporting level to display for each bill section and report. The required summaries can be divided into 4 categories, State level, hierarchy levels, Bill Payer level, and product detail level. A description of how each level's summaries will be created is described in more detail below.

Bill Payer Level.

The Bill Payer Level summaries combine the information for each bill payer. This will be at the highest level for the bill invoice reports. For the report summaries, this will be an intermediate level summary. The only RAI modification required for these summaries is to allow RAI to sort the input by Report ID and set the break logic using the Report-ID as one of the keys.

Hierarchy Level.

Hierarchy level summaries only apply to the Reporting AII, RAI. Hierarchy level summaries are created at different levels between the State and Bill Payer hierarchy levels. One of the best examples of these summaries is the Fiscal Management Reports. These reports contain summaries at the State level, sector level, sub-sector, agency level, and bill payer level. Because there are so many different summary levels, special logic will need to be created to make these summaries. Extensive changes in the All driver and sub-modules will need to be made to create these S-summaries. This S-level CA-RECUR-FIT-IND also has a FASC-LVL-CD that will determine the level that it will be created. For these reporting summaries, the FIT's will roll directly to the level where it is needed. Each FASC-LVL-CD corresponds to a different summarization level of the hierarchy.

State Level.

State level summaries only apply to the Reporting AII, RAI. The State level summaries combine all of the data from across all bill payers and all bill rounds. When possible, these reporting summaries will utilize “seed summaries” (described below) created in the first execution of the Billing All process. These “seed summaries” will be combined in the Reporting All process to create the State level amounts. For example, the 2nd User Admin Fee report contains the total amount charged to the customers for the 2nd User admin fee for all of the charges and all of the bill payers in one month. During the BAI execution of AII, the total admin fee summary amount will be created for each Bill Payer and put on a summary record. These summary records from all of the bill payers will be combined in Reporting AII to find the state grand total. Other reports also require Reporting All to summarize the state's details to create one state summary.

To create the State level summaries, the Report-ID will be considered the master account, or M-level. This will be the highest level that a summary can be created. The code will need to be modified to allow these summaries to be created using Report-ID as the highest summary break key.

Detail Level.

The Detail level summaries are summaries by product. Many detail level summaries are required for the Bill Payer Bill Invoice and these same detail summaries are also used for some monthly reports. Where possible, the report summary details will be created in BAI to eliminate the need to pass all of the detail records to OI and the reporting engine. Each of these summaries will be at the Bill Payer level. The reporting detail level summaries created in BAI are called “seed summaries”. The seed summaries will be BIR summaries at the bill payer level that will combined in RAI to create Reporting summaries at higher levels.

FASC/FASR Changes.

The summarization rules are based on FIT-CD. The detail FIT's are listed on the FASC table. Each row on this table identifies how the detail FIT is summarized. The other summary table FASR controls how summaries are combined with other summaries. In addition to providing the detail and summary FIT combinations, the FASC & FASR tables also indicate how a summary is created by listing the summary module used to create the summary.

Summary Modules.

Generic summary modules are modules that manage a particular type (or shape) of summary. These modules should only differ in the BIRs they write and the internal summary keys they maintain in the All Summary Table. As an example, a summary for usage that totals minutes of use, calls, and amounts is handled by a different summary module than a summary for total amount due. Similarly a different summary module will be used to create user specific subtotals and the grand total amount due.

The existing NBS summary modules have the ability to summarize the fields needed for many of the Bill Invoice sections.

Summary Module Changes. ADD SUMY-MOD-DEFN-CD.

For the example described herein, the first change needed is to increase the functionality of the summary modules by adding the SUMY-MOD-DEFN-CD column to FASC and FASR tables. The column on the summary table will indicate what portion of the summary module the summary will utilize. This will also prevent creating several new summary modules to create only a slightly different summary. For example, one SLMY-MOD-DEFN-CD can be used to call a summary module for the billing invoice, and a second SUMY-MOD-DEFN-CD can be used to call that same summary module for creating a report summary that has slightly different keys.

New Summary Modules.

ADMIN FEES.

The admin and management fees will be applied to each of the detail records. The code fragment will automatically roll-up to the higher level summary FIT's.

LONG DISTANCE and more.

Summary modules will be needed to create the summaries for the product and product types not already included in the NBS code.

FISCAL MANAGEMENT MODULE.

A new summary module will be created for summarizing the Fiscal Management reports. These reports require multiple columns of data to be summarized across multiple hierarchy levels.

Preferred Summaries.

AR SUMMARIES.

AR requires BAI to create summaries for every BTN. For each Bill Payer, AR requires each of the BTN subtotals divided by carrier. Within each BTN summary, the following is required, Original product charge amount, DGS amount, Tax amount, Admin Fee, and any other charges applied at the BTN level for each carrier. AR does not want Payment information, Bill Payer current amount due, past due amount, or Bill Payer amounts. AR only requires the BTN level amounts by carrier.

Other Changes Required for SIBS.

Bill Suppression.

No bill suppression logic is required. The bill suppression indicator will be set in BAI10064 when no details are processes for a Bill Payer. The suppression indicator will be set, but this will not cause the bills to be dropped in DI. If future requirements change, DI will be able to use the suppression indicator to suppress these account invoices.

OCR Scan Line.

The NBS software already contains some logic for creating the data for the scan line (BAI10007). The code will need to be updated for specific lock box requirements.

Barcode.

The NBS software already contains some logic for creating the data needed for the barcode (BAI10007). This code should be updated to source the past due information and past due date. The call to the julian date module was removed for NBS so it will need to be updated if the lock box will utilize this function.

Check-Digit.

The NBS software already contains logic for creating the check digit (BAI10047). The code will need to be updated when the lock box requirements are received to perform the desired check digit calculation.

Remove all PBCF Calls.

The NBS used PBCF calls in all of the BPP2 modules. This project deployment will eliminate all PBCF calls. This impacts nearly every module in AII. The driver utilizes PBCF calls for calling the sub-modules and the FASC and FASR tables also use contracts. The PBCF calls must be replaced with COBOL calls using the steps defined by the tech arc team.

Process Flow Description:

Process Overview.

The Aggregate Input Invoice Report (AII) process is responsible for creating the summary billing information necessary to generate the Billing and Report summaries. The first execution of AII (Billing AII-BAT) will create only the invoice summaries required for the Bill Payer bills. The second execution of AII (RAI-Reporting AII) creates the summaries for the reports. Both All processes receive detail records and calculate summary amounts. The generic summary modules generate summaries using keys required for the bill invoice and report displays.

AII Driver.

The process is driven by the AII Driver. The driver controls processing by executing control modules that direct the details IIRs to the proper format and summarization modules. The execution uses a two file match method to process the IIRs. The Extract Trigger file is the master file in the two file match method. Each extract trigger will match with a band of data in the detail file. Each detail record is read in by the driver and matched against the Extract trigger record. If they match, AII will begin processing the record. When the detail doesn't match the trigger, the account (BAI) or report (RAI) begins the wrap-up logic to write out all of the account summary BIR's, then the next extract trigger is read and matched with the next detail record.

Detail Processing.

All summarization and notification is managed by FIT Code. The Detail FIT summary table FASC contains the FIT code and processing contracts that are associated with that FIT code. The driver reads a record and using the FIT code, will search the FASC table for matching rows. If matching rows are found, the Driver will call the specified contract for each matching summary FIT. Based on the contract, the Driver sends the detail IIR record to any number of lower-level summary modules to create the summary FIT based on keys specific to that summary module. If another detail is read that also rolls to the same summary FIT, the keys will be compared and if matched, it will be added to the summary FIT. A summary FIT is like accumulation pots (example: dollar amount, number of calls, minutes per call) into which the input records are added. An accumulation pot will exist for every summary created. The summaries are maintained in an internal table until the account break. After the detail record is processed, the record is passed to the write module (BAI10070) and the detail record is written.

Account Breaks.

At the Bill Payer or report break (when one account or report ID changes to another), the driver will call wrap-up modules listed on the Summary Wrap-up Control Table (B2VS0224). This table contains a list of modules that should be called at every account/report break. Using these modules, the process will create summary roll ups. Rolling-up means to move the summaries one level up to the parent hierarchy point and adding and combining them with summaries with the same attributes coming from another child for the same parent hierarchy point. When a summary FIT is being rolled-up, its contents will be added to a new summary FIT (upper summary) based on the FASR table. The FASR table contains the rules that determine how a summary FIT must be rolled up when a particular type of control break occurs. Finally all of the summaries maintained on the internal table are written to the output file and the next Bill Payer or Report ID begins processing.

Process Components and Descriptions:

New Components:

| Component | |
|---|---|
| (driver, | |
| data layer, | |
| etc.) | Description of Function |
| Summary | CATL-(blank)-Summarize by account |
| Module | & carrier. (amt, tm, qty) For toll free |
| | summaries. |
| | CATL-(L01)- Summarize by account, |
| | carrier & location. (2amt, tm, qty) |
| | CATL-(L02)-Summarize by account, carrier, |
| | location & lata. (2amt, tm, qty) |
| | This will be a new summary module. |
| Summary | This summary module will create the summaries |
| Module | needed for the Fiscal Management Reports. These |
| | reports require multiple columns of data to be |
| | added together. Summarizes contract only charges |
| | for FMR. |
| | CATM-(MOl) FMR SVC ID and FMR feature. |
| | CATM-(MO2) FMR SVC ID. |
| | CATM-(M05) FMR SVC ID and FMR feature and |
| | TCC-ID). |
| | CATM-(M07) FMR SVC ID. |
| Summary | CATR-(R01)- Summarize by account, carrier. For |
| Module | NRC & pro-rated calls. (5amt, tm, 2qty) |
| | CATR-(R02)- Summarize by account, carrier & |
| | service type. (5amt, tm, 2qty) |

Existing Components:

| Component | |
|---|---|
| (driver, | |
| datalayer, | Description |
| etc.) | Of Function |
| Driver | The driver will need to be modified to |
| | read the new record layout. It will also |
| | need to accommodate the Bill Payer break |
| | logic. Remove call to BAI10053, whom to |
| | call module. PBCF changes. The driver |
| | will need to be modified to read the |
| | new record layout. It will also need to |
| | accommodate the Bill Payer break, |
| | s-summary creation and master level |
| | summaries required to create the |
| | Reporting information. |
| Module | The module will need to be modified to |
| | create output detail BIR's that contain |
| | the Bill Payer hierarchy information. |
| | PBCF changes. Don't need to populate |
| | the BIR custom area. |
| Module | The module will need to be modified to |
| | create output Header BIR's that contain |
| | the Bill Payer hierarchy information. |
| | This module will also need to be updated |
| | to create the BAR-CD information. This |
| | module also creates the OCR scan line |
| | data that is sent downstream. This will |
| | need to be updated based on the remit |
| | center requirements. Also need to ensure |
| | that the FIT-assignment in FATT is |
| | created for both the bar-cd record and |
| | scanline record. PBCF changes. |
| Module | This module will need updates to create |
| | the Check Digit according to the 5th |
| | user requirements. PBCF changes. |
| Module | The module will need to be modified to |
| | create output detail BIR's that contain |
| | the Bill Payer hierarchy information. |
| | (see A32141-FMT-BIR-SORT-CAP). Also need |
| | to make modifications to write summary |
| | BIR's for the state report agencies. PBCF |
| | changes. Extensive modifications to the |
| | account summary BIR logic. Need to make |
| | changes to continue the rollup after a |
| | summary BIR is processed. Also need to |
| | make changes to not write out a summary |
| | BIR until it reaches the desired |
| | hierarchy level. This module will also |
| | need changes to always roll up the admin |
| | fee, management fee, and original amount. |
| | Need to pass the rate amount without |
| | adding the rate amount. |
| Module | Bill Payer suppression logic will be |
| | added to suppress bills if no charges or |
| | credits are passed. PBCF changes. |
| Module | Called by BAI10048 and other BIR create |
| | modules to write the HDR, BIR, & OI |
| | output files. The module will need to |
| | be modified to create output detail |
| | BIR's that contain the hierarchy |
| | information. PBCF changes. Remove |
| | custom BIR moves. |
| Summary | CATA-Summarize by account. (amt) |
| Module | This module will require modifications |
| | due to changes in the summary key |
| | copybook, R501. This module will be |
| | modified if the summary FIT tables are |
| | changed. PBCF changes. |
| Summary | CATB (B01)-Summarize by account and |
| Module | carrier. (amt) |
| | CATB (B02)-Summarize by account and |
| | carrier. (amt, amt, amt) |
| | This module will require modifications |
| | due to changes in the summary key |
| | copybook, R501. This module will be |
| | modified if the summary FIT tables are |
| | changed. PBCF changes. |
| | Need to expand the summary module to |
| | include multiple sumy-module-def- |
| | cd's. The additional summary types will |
| | be required for the BTN, carrier |
| | summaries for AR. |
| Summary | CATC (C01)-Summarize by Child IP and |
| Module | carrier. (amt, tm, qty) |
| | CATC (C02)-Summarize by child IP. |
| | Space out TCCI. (amt, tm, qty) |
| | This module will require modifications |
| | due to changes in the summary key |
| | copybook, R501. This module will be |
| | modified if the summary FIT tables |
| | are changed. PBCF changes. |
| Summary | CATE-(blank)-Summarize by account & |
| Module | carrier. |
| | CATE-(E1)-Summarize by account, |
| | carrier, adjustment ref number. |
| | CATE-(E2)-Summarize by account, |
| | carrier, file name. |
| | CATE-(E3)-Summarize by account, |
| | carrier, USOC. |
| | CATE-(E04)-Summarize by account, |
| | carrier, Sum by Prod description. |
| | CATE-(E06)-Summarize by account, |
| | carrier, adjustment ref num, product |
| | description. |
| | CATE-(E07)-Summarize by account & |
| | WTN code. |
| | CATE-(E08)-Summarize by account, |
| | carrier and file name. |
| | CATE-(E09)-Summarize by account, |
| | carrier. |
| | CATE-(E10)-Summarize by account, |
| | carrier, service category code. (amt). |
| | UA - Usage average for SumTollFree |
| | Number. Calculates average call |
| | duration and average charge per minute. |
| | This module will require modifications |
| | due to changes in the summary key |
| | copybook, R501. This module will be |
| | modified if the summary FIT tables are |
| | changed. PBCF changes. |
| Copybook | Update the keys to reflect changes to |
| | the IIR/BIR layouts. |
| Code | Need to modify the TCC-ID evaluate |
| Fragment | section to allow for 1st User carrier |
| | types, 2nd user and any other carrier |
| | types. Also need to make changes to always |
| | aggregate the admin fee, management fee, |
| | and original charge amounts. Need to pass |
| | the rate amount without adding the rate |
| | amount. |
| Datalayer | Need to modify the datalayer to retrieve |
| | the new extract trigger with the Bill |
| | Payer hierarchy data. PBCF changes. |
| AII | This copybook and it's children will need |
| Copybook | to be updated to include the multiple |
| | breaks needed for the project. This |
| | copybook contains all of the break level |
| | indicators. |
| System | Various changes will need to be made to |
| Copybooks | the copybooks for the project. Among |
| | other changes, for AII the following |
| | sort key fields need to be included: |
| | BILL PAYER |
| | REPORT-ID |
| | BTN |
| | WTN/Circuit |
| | Ext type |
| | USOC |
| | AGENCY |
| | SECTOR, SUB-SECTOR, GOVERNMENT BRANCH, |
| | STATE Hierarchy. |
| | SERVICE TYPE |
| | FEATURE |
| Summary | The copybooks that are used to define |
| Copybooks | the summary break logic will need to |
| | be created and updated with the SIBS |
| | summary requirements. |

BAI Reports.

| | |
|---|---|
| Report Name | Description/Content |

| | | |
|---|---|---|
| 5. | Bill at | AII will create the Bill summaries. |
| | a Glance | |
| 6. | Current | AII will create the Bill Summaries. |
| | Charges | |
| 8. | Remit Stub | AII will create some of the scan |
| | | line and barcode data. |
| 10. | Credits & | AII will summarize where needed. |
| | Adjustments | |
| 11. | Summary by | AII will create the BTN/ext summaries. |
| | Bill Number | |
| 12. | Summary by | AII will create the product summaries. |
| | Product | |
| 18. | Usage Detail | AII will create the usage summaries |
| | Local | for Zone 1 & 2. |
| 19. | Usage Detail | AII will create the interstate, |
| | Long Distance | intralata, and interlata summaries. |
| 24. | Non Usage | AII will create the tax summaries |
| | Charges | from the detail tax records. |
| | Taxes & | |
| | Surcharges | |

RAI Reports.

| Report Name | Description/Content |
|---|---|
| Access Reform | |
| Reconciliation | |
| Fiscal Management - | |
| Detail of Services | |
| Billed | |
| Fiscal Management - | |
| Detail of Services by | |
| Agency | |
| Fiscal Management - | |
| Summary of Services | |
| Billed | |
| Fiscal Management - | |
| Summary of Services | |
| by Agency | |
| Management Fee | |
| 800/Intralata/CC | |
| Usage by Agency | |
| Management Fee | |
| Collection | |
| Zero Usage Report | |
| OC3 Taxation | |
| Summary Billing | |

Interfaces:

BAI Interfaces.

| Interface | |
|---|---|
| Name | Description |
| Trigger's | The Trigger's team will need to pass |
| | Bill extract triggers to the AII |
| | process. The extract trigger file must |
| | contain a trigger for every Bill |
| | Payer. |
| AR batch | The AR team will need to send a batch |
| | billing file containing the payments, |
| | credits, and past due information that |
| | is required for the bill invoices. All |
| | records will need to have an appropriate |
| | detail FIT-CD assigned. |
| Rating | The rating team will need to send a file |
| | containing all of the billing details |
| | including usage, non-usage, and adjustments. |
| | All records will need to have an appropriate |
| | detail FIT-CD assigned. |
| AR | BAI will need to pass all of the carrier |
| interface | details at the BTN level to allow |
| | AR to calculate the amount required at |
| | each BTN level. The summary total and |
| | sub-totals will be passed to AR through |
| | OI. The summaries will |
| | be at the level of detail needed by AR |
| | and AR will not need to summarize for |
| | processing. |
| OI | AII will need to pass the details and |
| interface | summaries needed for OI to create the |
| | Ancillary counts for the Bills Generated |
| | Monthly Report. |
| Reporting | AII will need to pass all of the bill |
| Interface | details that will be used for the reports. |
| | For most of the reports, BAI will create |
| | “seed summaries” that will contain the |
| | summarized data (at the Bill Payer level) |
| | that will be used for the reports. |
| DI | AII will pass all of the billing details |
| Interface | to DI at the bill payer level. |

RAI Interfaces.

| Interface | |
|---|---|
| Name | Description |
| Reporting | Need all of the report details in |
| | the reporting input files. |
| Hierarchy | Need an extract trigger for each |
| | of the reports created in AII. One |
| | record per report with the Report |
| | ID and current dates. |
| DI | Our output file will need to be |
| | sorted by DI before it is sent to |
| | Edoc's. |

Validate:

Assumptions:

UNIX system and NBS architecture can support concurrent processing.

EBS system administrators will contact carriers when files are rejected.

No new files will be sent by carriers until rejected files are corrected and resubmitted.

If concurrent processing streams try to access the same resource (table, file etc) at similar times, the second stream will wait for first stream to access resource.

The scheduling system will automatically recognize which files have arrived and execute the proper process.

The files will arrive in ASCII format.

Key Inputs Matrix:

| | Provided | Layout |
|---|---|---|
| Description/Content | By | Type |
| VNET File: | 1st User | Variable |
| Received on 20^{th} of each month. | | Line Seq. |
| PLBS File: | 1st User | Fixed |
| Received on the 20^{th} of each month. | | |
| Toll Free: | 1st User | Fixed |
| Received on the 20^{th} of each month. | | |
| VNET Transmittal File: | 1st User | Fixed |
| Received on the 20^{th} of each | | |
| month. | | |
| PLBS Transmittal File: | 1st User | Fixed |
| Received on the 20^{th} of each month. | | |
| Toll Free Transmittal File: | 1st User | Fixed |
| Received on the 20^{th} of each month. | | |
| VNET Extension File: | 1st User | Fixed |
| Received on the 13^{th} of each month. | | |
| PLBS Extension File: | 1st User | Fixed |
| Received on the 13^{th} of each month. | | |
| Toll Free Extension File: | 1st User | Fixed |
| Received on the 13^{th} of each month. | | |
| NPA/NXX File: | 1st User | Fixed |
| Received on the 1st of each month. | | |
| CBD North File: | 2nd User | Fixed |
| Received at least 19 times per month. | | |
| CBD South File: | 2nd User | Fixed |
| Received at least 19 times per month. | | |
| CALN North File: | 2nd User | Fixed |
| Received at least 19 times per month. | | |
| CALN South File: | 2nd User | Fixed |
| Received at least 19 times per month. | | |
| 4th user File: | 2nd User | Variable |
| Received on the 1st of each month. | | Line Seq. |
| 6th user File: | 2nd User | Variable |
| Received on the 15th of each month. | | Line Seq. |

Key Outputs:

| Description/Content | Provided To |
|---|---|
| Validated VNET File: | Standardize |
| 1 produced\per month. | Input Files |
| Validated PLBS File: | Standardize |
| 1 produced per month. | Input Files |
| Validated Toll Free: | Standardize |
| 1 produced per month. | Input Files |
| Indexed NPA/NXX File: | Standardize |
| 1 produced per month. | Input Files |
| (if necessary) | |
| Validated CBD North File: | Standardize |
| at least 19 produced per month. | Input Files |
| Validated CBD South File: | Standardize |
| at least 19 produced per month. | Input Files |
| Validated 4th user File: | Standardize |
| 1 produced per month. | Input Files |
| Validated 6th user File: | Standardize |
| 1 produced per month. | Input Files |
| CBD Pre Audit File: | NDM to |
| 1 produced per CBD file | 2nd User |
| 6th user Processing File | NDM to |
| | 6th user |
| VNET Pre Audit File: | Web |
| 1 produced per month | |
| PLBS Pre Audit File: | Web |
| 1 produced per month | |
| Toll Free Pre Audit File: | Web |
| 1 produced per month. | |
| 4th user Pre Audit File | Web |
| 1st User Missing Extensions Report | Web |
| CBD North Missing Extensions Report | Web |
| CBD South Missing Extensions Report | Web |
| 6th user Missing Extensions Report | Web |
| 4th user Missing Extensions Report | Web |

Functional Description:

The Validation Process is the interface between 1st User, 2nd User, 6th user, 4th user and the EBS system. The two carriers send the input files mentioned in the Key Inputs Matrix across a dedicated circuit provided by 1st User. The files arrive via NDM on the EBS UNIX server from the 2nd User, 6th user, 4th user and 1st User billing systems.

These files constitute the billing information for usage, non-usage, credits & adjustments, and taxes for all telecommunications products and services provided to the State of California and its agencies by 1 st User and 2nd User. In most cases these products and services are included in the 5th user contract. However, some government entities have the option of participating in the contract on a piecemeal basis. Their usage might be covered but not the non-usage or vice-versa. All billing data received by the EBS system will be processed regardless of whether it is covered by the 5th user contract or not.

As indicated by the Key Inputs matrix, some files arrive alone, while others arrive in a batch across the circuit. The arrival of a new file or set of files from the carriers initiates the pre-processing portion of the EBS system which consists of the validation and standardize input files processes.

It is possible that different groups of files will arrive at the same time. For example, on the 20^{th} of each month 1st User sends the VNET, PLBS, and Toll-Free files, and it is possible that 2nd User could send a CALN/CBD file combination on that day as well. When this occurs, the two file groups will be processed separately in two streams that run concurrently. This is referred to as concurrent processing. Once initiated, a processing stream will continue through the validation and standardize input files processes. The one exception is if the files contain errors that cause them to be rejected. In this case the stream processing the rejected file will terminate.

The purpose of the Validation Process is to detect errors in the input files and report them. Several different types of error detection are performed. In some cases detecting errors cause the files to be rejected. When errors are encountered reports are created for the system administrators or for the customer reps to view via the web interface. For other types of errors a file is created which may be sent back to the parent billing system via NDM. The error detection requirements for 1st User vs. 2nd User are similar. However there are important differences. These will be described in detail.

To facilitate the error detection process, an Oracle file inventory table will be maintained. Files from all four carriers will be recorded. The files recorded in the table correspond to the logical units of work:

1. CBD North

2. CBD South

3. 6th user

4. 4th user

5. 1st User VNET

6. 1st User Toll Free

7. 1st User PLBS

8. 1st User Extension files.

Other tables will be used to control certain aspects of the validation process-particularly for the balancing that will take place.

When a file is rejected no files will be accepted from the carrier from whom the file came before the resubmission of the problematic file. Hence, new entries will be made to the inventory table only for files that pass the validation requirements.

The validation process will also be responsible for loading the NPA/NXX file into indexed format. This will be accomplished by a UNIX script component written specifically for this purpose.

2nd User Validation Requirements.

The following requirements apply to CBD, 6th user, and 4th user files

A. Detect duplicate files where the header/trailer file sequence number has been processed previously.

B. Detect any missed or skipped files where the header/trailer files sequence number is not one greater than the previous billing file processed.

C. Detect files where the total number of records in the files is not equal to the trailer record count.

D. Detect missing trailer record.

E. Detect missing header record.

F. Detect files in which the trailer is not the last record in the file.

G. Detect files in which the data has not been formatted according to the expected format.

When any one of these errors is encountered the validation process will terminate and a report will be created for the System Administrators. The administrators will contact the carrier to work out a resolution. No data will be NDM'd or displayed on the web for these errors. If a group of files is being processed, the stream will not terminate until all files have been validated to ensure all errors have been identified.

It is important to note that a few of the CBD/CALN files may not contain ordinary billing information. They may even by empty. These files, however, will be processed just as any other CBD/CALN file would be. No special logic will need exist to account for them.

The following requirements apply to the CBD and CALN files:

H. Balance the total current charges on the detail records in the CBD file with the BTN total in the CALN file. Detect missing balancing records, missing billing records, out of balance BTN's and balanced BTN's. Indicate the total number of BTNs processed.

A file known as the 2nd User Pre Audit file will be created based on this balancing. It will consist of a header, trailer, and detail records. A detail record will exist for each BTN and will contain fields for the CALN and CBD amounts, as well as indicating which of the four above conditions apply. The exact file layout is contained in the SIBS Controls document from the 2nd User requirements package. The Pre Audit file will be sent to 2nd User via NDM after each validation cycle. An imbalance will not cause the process to terminate. A unique pre-audit file will be created for CBD North and CBD South files.

The following requirement applies to the 6th user file only:

I. Balance the total detail charges with the total current charges on the header record as well as providing a balance of charges by BTN.

This balancing information will be contained in the 6th user Processing Report. The file layout for this report will be the same as for the 2nd User Pre Audit file and the reason codes will be reused.

For release 1.1, if an imbalance is detected the 6th user file will be rejected. This is the only 2nd User file that is rejected for an imbalance. When this occurs the system administrators will contact the carrier and the web team will create the pre-audit report.

However, for the initial release of the system software, the file rejection due to imbalance is not in scope.

The following requirement applies to the CBD file:

J. The BTN/Ext combination on each 2nd User charge will be matched against the BTN/Exts on the EBS hierarchy. The following will be identified during pre-processing: BTNs that don't exist in the hierarchy and BTN/Extension combinations that do not exist in hierarchy regardless of effective date.

A Missing Extension file will be created using a standard layout. This file will be accessed directly by the eDocs application for display on the web. The file layout has not yet been determined. This should be accomplished in consultation with the web team during the detail design phase. Missing extensions will not cause rejection of files.

The following requirement applies to 6th user and 4th user files:

K. The BTN on each charge record will be matched against the BTNs on the EBS hierarchy file. The comparison will be made using the 1^{st} day of the billing month against the beginning and end effective dates on the hierarchy for each BTN

An unmatched BTN file will be created using a standard layout. This file will be accessed directly by the eDocs application for display on the web. The file layout has not yet been determined. This should be accomplished in consultation with the web team during the detail design phase.

1st User Specific Validation Requirements.

The following requirement applies to the VNET, PLBS and Toll Free and 1st User Transmittal files.

A. Perform detail charge balancing between each detail charge file and its corresponding 1st User Transmittal file.

EBS will calculate the total current charges from the details in each billing file and compare it to the amount in the corresponding balancing file.

The 1st User Pre-Audit File will be created containing the results of this validation process. Any file found to be out of balance will not be processed, and the system will terminate. The EBS system administrators will notify 1st User with information from the ABEND report. The 1st User Pre-Audit report will not be sent to 1st User but will be available on the web. The termination will not occur until all files have passed through the validation process.

The following requirement applies to the 1st User extension file.

B. Each extension file will be validated against the 1st User hierarchy. The comparison will be made using the 1^{st} day of the billing month against the beginning and end effective dates on the hierarchy for each extension in the 1st User hierarchy file. The extensions will be matched using the extension number and the extension type.

As with 2nd User, an unmatched extension file will be created using a standard layout. The file will indicate any extensions that appear in the extension file that are not part of the active EBS hierarchy. This file will be accessed directly by the eDocs application for display on the web. The file layout has not yet been determined. This will be accomplished in consultation with the web team during the detail design phase. Unmatched extensions will not cause termination of the process. A single file will be created for all unmatched extensions.

Process Flow Description:

File(s) arrives from 2nd User or 1st User on the EBS system.

A UNIX script will invoke the batch executive which will call the appropriate driver module. BII00011 will be called for 2nd User, 6th user, and 4th user files. BII00031 will be called for 1st User files.

1. BII00011 will perform the following: Map each input record with the appropriate layout, based on the process ID. CBD files will be mapped depending on whether they are headers/trailers or details. Only the common area of the details will be mapped. Hence only one layout will be required. 6th user will be mapped similarly. The 4th user file will be mapped into a layout as well.

2. Read inventory table to verify requirements described in Functional Description for 2nd User CBD, 6th user, and 4th user files:

i. Files in correct sequence.

ii. No duplicate files.

iii. Correct header/trailer information

iv. Perform record count of CBD details and compare with trailer count.

3. Call BII00071

4. Call BII00041

5. Call BII00021

When BII00021 is called by BII00011 it will perform the following:

1. Balance CALN amounts with detail amounts in CBD file.

2. Balance 6th user detail amounts with 6th user header record total amount.

3. Create Pre-Audit file.

4. Return control to BII00011.

BII00031 will perform the following:

1. Map each input record with the appropriate layout, based on the process ID.

2. Call BII00071.

3. Call BII00061.

4. Call BII00081.

When BII00041 is called by BII00011 it will perform the following:

1. Perform extension matching between CBD/6th user/4th user files and the EBS hierarchy file.

2. Create Unmatched BTN/WTNs file to be read by web application.

3. Return control to BII00011.

When BII00061 is called by BII00031 it will perform the following:

1. Balance VNET, Toll Free, and PLBS detail charges against the Transmittal files

2. Create Pre-Audit Report

3. Terminate the process if files do not balance.

When BII00071 is called by the BII00031 or BII00011 it will perform the following:

1. Translate the input data from ASCII format to EBCDIC format

When BII00081 is called by the BII00031 it will perform the following:

1. Perform extension matching between the 1st User extension file and the EBS hierarchy.

i. Create Unmatched Extensions file to be read by web applications.

2. Return control to BII00031.

BII00011 and BII00031 will perform the following for files that pass all terminating error requirements:

1. Update Inventory Table with file information.

2. Write output file(s).

BII00011 or BII00031 will terminate process:

1. Normally if files pass fatal validation requirements.

2. Abnormally if file or 1st User balancing errors are encountered.

3. Abnormally if 2nd User file level errors are encountered.

4. Abnormally if 6th user balancing errors are encountered.

The NPA/NXX file will be read and processed in a process completely separate from the carrier billing, balancing and extension files. When the NPA/NXX file arrives via NDM, the scheduling system will recognize it and initiate a UNIX script that will index the file for use by the Standardize Input Files and Taxing/Rating/Fees processes.

2nd User requires a single missing extension report for the CBD North and CBD South billing files each bill round. A separate script will be executed after the missing extension files are created from each billing file. The script will sort the records together in their respective groups (BTN/Extension, BTN only, Extension only) into a single file, which will be accessed by the web. Since the 1st User Extension files are processed together as a single logical unit of work, no such sort job is required.

A dependency will be added to the scheduling/scripts controlling the process initiation that will make sure that the 1st User Extension files have been received and processed before any of the 1st User files will be processed.

Process Components and Descriptions:

New Components:

| Component | Description Of Function | |
|---|---|---|
| UNIX | This script will read CBD and CALN North files and | |
| Script | process them using a unique process ID. It will call the | |
| | 2nd User driver module BII00011 passing the files. | |
| UNIX | This script will read CBD and CALN South files and | |
| Script | process them using a unique process ID. It will call the | |
| | 2nd User driver module BII00011 passing the files. | |
| UNIX | This script will read the 6th user file and process it | |
| Script | using a unique process ID. It will call the 2nd User | |
| | driver module BII00011 passing the file. | |
| UNIX | This script will read the 4th user file and process it | |
| Script | using a unique process ID. It will call the 2nd User | |
| | driver module BII00011 passing the file. | |
| UNIX | This script will read the VNET billing and transmittal | |
| Script | files and process them using a unique process ID. It will | |
| | call the 1st User driver module BII00031 passing the files | |
| UNIX | This script will read the PLBS billing and transmittal | |
| Script | files and process them using a unique process ID. It will | |
| | call the 1st User driver module BII00031 passing the files | |
| UNIX | This script will read the Toll Free billing and transmittal | |
| Script | files and process them using a unique process ID. It will | |
| | call the 1st User driver module BII00031 passing the files | |
| UNIX | This script will read the 1st User Extension files and | |
| Script | process them using a unique process ID. It will call the | |
| | 1st User driver module BII00031 passing the files | |
| UNIX | This script will sort the missing extension files from the | |
| Script | CBD North and South billing files together into a single | |
| | file. The records will be sorted by record type: | |
| | 1. | Missing BTN/Extension combination |
| | 2. | Missing BTN. |
| | 3. | Missing Extension. |
| UNIX | 1st User | |
| Script | This script will read the NPA/NXX file and index it for | |
| | use by the Taxing/Rating/Fees process. | |
| Driver | Module processes CBD, CALN, 6th user and 4th user | |
| | files. | |
| | 1. | Determine FILE TYPE based on process ID global |
| | | variable. |
| | 2. | Read inventory table and perform table/file |
| | | comparison to determine the following: |

| | |
|---|---|
| a. | Detect CBD, 6th user, 4th user files out |
| | of sequence. |
| b. | Detect duplicate files for CBD, 6th user, |
| | 4th user files. |
| c. | Detect missing header/trailer records for |
| | CBD, 6th user, 4th user files. |

| | |
|---|---|
| 3. | Count number of records in CBD file and |
| | compare with trailer record count. |
| 4. | Call appropriate module based on input file |
| 5. | Update Inventory Table after all validation |
| | procedures. |
| 6. | Write out output file after all validation |
| | procedures are complete. |
| 7. | Terminate process |

| | |
|---|---|
| a. | Normally if validation conditions are |
| | passed. |
| b. | Abnormally if file or balancing errors |
| | are encountered. Create ABEND report. |

| Driver | Module will process VNET, PLBS, Toll Free billing | |
|---|---|---|
| | extension and transmittal files. It will call BII00071, | |
| | BII00081 and BII00061. The driver will perform the | |
| | following: | |
| | 1. | Determine file type based on process ID |
| | | global variable. |
| | 2. | Call appropriate module based on File Type. |
| | 3. | Update Inventory Table after all validation |
| | | procedures are complete. |
| | 4. | Write validated output files. |
| | 5. | Terminate process |

| | |
|---|---|
| a. | Normally if validation conditions are |
| | passed. Abnormally if file or balancing |
| | errors are encountered. Create ABEND report. |

| | The transmittal files will be read directly by BII00081 | |
|---|---|---|
| | and its charge amount will be saved to working storage. | |
| | This amount will be compared to the sum total of the | |
| | detail charges when all records have been processed. | |
| Module | 1. | Match extensions |

| | |
|---|---|
| a. | CBD, 6th user, 4th user files vs. 2nd |
| | user hierarchy file |
| b. | Create Unmatched Extensions File for |
| | input to web system. |

| | 2. | Return control to BII00011. |
|---|---|---|
| | Missing extensions will be displayed only once on | |
| | the Missing Extension report. The program will keep | |
| | track of what it has already written to the file as it reads | |
| | each record to prevent duplicate entries. | |
| | 6th user and 4th user will be validated by BTN only. | |
| | The Missing Extension output file of this job for CBD | |
| | north and CBD south will be sorted together after both | |
| | files from a given bill round have been processed. | |
| Module | 1. | Find Missing extensions |

| | |
|---|---|
| a. | Extension file vs. 1st User hierarchy file |
| b. | Create Missing Extensions File for input to |
| | web system. |

| | | |
|---|---|---|
| Module | 1. | Perform charge balancing |

| | |
|---|---|
| a. | Balance CBD vs. CALN file (North or |
| | South) |
| b. | Balance 6th user detail charges vs. header |
| | record. |
| c. | Create Pre-Audit File for input to 2nd User |
| | legacy system. |

| | | |
|---|---|---|
| Module | 1. | Perform charge balancing |

| | |
|---|---|
| a. | Balance VNET, Toll Free, and PLBS detail |
| | charges against the extension totals in the |
| | 1st User Transmittal files. REC and |
| | BAL_FLD_NAME will be accessed to control |
| | this process. |
| b. | Create Pre-Audit file for display on the web. |
| | ****Removed From Scope Mar. 21, 2001**** |

| | | |
|---|---|---|
| Module | 1. | Translates data from ASCII format to EBCDIC |
| | | format. |
| Data layer | 1. | Retrieve BTN/WTN information from hierarchy |
| | | tables. |
| Data layer | 1. | Retrieves all rows from REC |
| Data layer | 1. | Retrieves all rows from REC_FLD |

Tables and Descriptions:

EC/DC Tables:

| Table Name | Description/Content |
|---|---|
| HIER_MATCH | Contains BTN/WTN combinations from |
| | hierarchy tables. |
| CEINITCT | Need to remove contract ID and |
| | insert Module name. |
| CEPROCESS | Need to remove contract ID and |
| | insert Module name. |
| CEWRAPUP | Need to remove contract ID and |
| | insert Module name. |
| CETHRESH | Error threshold information. |
| BDTCE001 | File Definitions - application |
| | specific entries |
| CECTLEXT | External Control Groups - application |
| | specific entries |
| CECTLGRP | Balance Group - application specific |
| | entries |
| CECTLINT | Internal Control Groups - application |
| | specific entries |
| CECTLOPT | Control Options - application specific |
| | entries (if necessary) |
| CEINITCT | Initialization functions - application |
| | specific entries |
| CEPROCES | Initialization functions - application |
| | specific entries |
| ER | Errors |

Oracle Tables:

| | | | CRUD |
|---|---|---|---|
| | | | (Create, |
| | | | Read, |
| Table | | | Update, |
| Name | Description/Content | | Delete) |
| USG_{—} | Table contains information to allow | | Read, |
| FILE_{—} | validated input files to be tracked | | Update |
| INVTY | and identified Some information will | | |
| | be different for 2nd user vs 1st User | | |
| | files 2nd user will be tracked by | | |
| | sequence number whereas 1st User | | |
| | files will be tracked by file date | | |
| | Fields that must be included are | | |
| | 1 | File Type | |
| | 2 | File Date (Monthly files 6th user, | |
| | | 4th user, VNET, PLBS, Toll Free) | |
| | 3 | File Sequence Number (2nd User | |
| | | only) | |
| REC | This table controls the process of | | Read |
| | summarizing amounts from detail | | |
| | records to be compared with header | | |
| | records or balancing files The | | |
| | purpose of its existence is to | | |
| | greatly simplify the logic in the | | |
| | code The table will contain the | | |
| | following fields | | |
| | 1 | REC_ID - unique record identifier | |
| | 2 | DS - description | |
| | 3 | REC_TYPE_CD | |
| | 4 | BAL_ELEM-NM | |
| | 5 | REC_CNT_IND - field on record that | |
| | | identifies multiple records that | |
| | | apply to the same charge The only | |
| | | current example is the input GIRN | |
| | | This field will allow the charges | |
| | | only the first 2nd User Adds & | |
| | | Changes and CSR records pertaining | |
| | | to the same charge to be added into | |
| | | the running total for the BTN | |
| | 6 | BAL_FLD_OCCUR_NB - balance fld | |
| | | occurrence number | |
| | 7 | REC_ELEM_NM - field containing | |
| | | charge amount to be summarized for | |
| | | balancing | |
| | 8 | REC_FLD_OCCUR_NB - record fld | |
| | | occurrence number | |
| | 9 | SUM_ELEM_NM - summary element name | |
| | 10 | SUM_FLD_OCCUR_NB - summary fld | |
| | | occurrence number | |
| REC_{—} | Table defined in Standardize Input | | Read |
| FLD | Files Application Design. This | | |
| | table will work in conjunction with | | |
| | REC in summarization This prevents | | |
| | the need for using copybooks in the code | | |
| | 1 | This table is loaded via the Parser | |
| | | contains all of the offsets of a | |
| | | field for a given copybook | |

Reports.

| | | | Delivery |
|---|---|---|---|
| | | | Method |
| | | | (File NDM, |
| Report | | | File web, |
| Name | Description/Content | | table) |
| 2nd User | Contains the following information | | NDM to 2nd |
| Pre-Audit | CBD/CALN BTN totals out of balance | | User Legacy |
| File | CALN BTNs for which there is no | | system |
| | corresponding BTN in the CBD file | | |
| | CBD BTNs for which there is no | | |
| | corresponding BTN in the CALN file | | |
| | Confirmed balanced BTNs | | |
| | Confirmed successful EBS processing | | |
| | Total BTNs processed (total unique | | |
| | CBD + total unique CALN + total | | |
| | shared CBD/CALN) | | |
| | A separate pre-audit file will be | | |
| | produced for the CBD North and CBD | | |
| | South input files respectively This | | |
| | amounts to a maximum of 44 files per | | |
| | month that will be NDM'd back to 2nd | | |
| | User | | |
| | For 4th user files | | |
| | The current requirement states that | | |
| | balancing must take place between the | | |
| | details and header record However, the | | |
| | current header record layout does not | | |
| | contain the total charges | | |
| | A Pre-Audit report will be created for | | |
| | each N and S CBD/CALN combination received | | |
| | and one for the 6th user file This equates | | |
| | to 39 total pre audit files per month The | | |
| | number is 40 if 4th user is included (TBD) | | |
| | File will be sent to 2nd User via NDM | | |
| 6th user | Contains following for 6th user files | | Web |
| Processing | From requirements “Include summary by | | |
| Report | BTN itemized by those accepted and | | |
| | rejected and include invoice dollar | | |
| | amount for BTN and total” | | |
| | The 6th user Processing Report will be | | |
| | created using exactly the same output | | |
| | layout as the Pre Audit File However, | | |
| | only the balanced and unbalanced | | |
| | options will be set | | |
| 1st User | Contains the following information | | Web |
| Pre-Audit | for VNET/Toll Free/PLBS vs 1st User | | |
| Report | Transmittal file | | |
| | Totals out of balance Amounts will be | | |
| | displayed | | |
| | Totals in balance Amounts will be | | |
| | displayed | | |
| | Empty Transmittal File | | |
| | One file will be created per month. | | |
| | File will be accessed for display on | | |
| | the web. The following is from the | | |
| | Pre Audit File requirements document. | | |
| | Copybooks will need to be created | | |
| | for the layouts indicated. | | |
| | Header Records - HH658220000131TSFT | | |
| | P001PACBELL00999999 | | |
| | | “HH” (1-2 byte) - These | |
| | | two bytes indicate this is the | |
| | | Header record. | |
| | | “6582” (3-6 byte) - This | |
| | | field is the 2nd User billing cycle | |
| | | number. | |
| | | “2000” (7-10 byte) - This | |
| | | field displays the 4-digit year | |
| | | (YYYY). | |
| | | “0131” (11-14 byte) - This | |
| | | field displays the month and date | |
| | | (MMDD). | |
| | | “TSFT” (15-18 byte) - This | |
| | | field indicates the file is send by | |
| | | Telesoft (TSFT). | |
| | | “P001” (20-23 byte) - This | |
| | | field displays the program/application | |
| | | number. | |
| | | “2nd User” (24-30 byte) - | |
| | | This field indicates the file is send | |
| | | to 2nd User. | |
| | | “00999999” (31-38 byte) - | |
| | | This field is the number of accounts | |
| | | in the error file. | |
| | 2.2.2. | Account Records - ER000001001 | |
| | | Out-of-Balance Error | |
| | | “ER” (1-2 byte) - This field | |
| | | displays the account record | |
| | | identification number. | |
| | | “000001” (3-8 byte) - This | |
| | | field is the counter for number of | |
| | | accounts written in the error file. | |
| | | The counter will start at “000001” | |
| | | and will be incremented by 1 for each | |
| | | additional account in the file. The | |
| | | maximum value for this field is | |
| | | “999999”. | |
| | | “001” (9-11 byte) - This | |
| | | field displays the reason code for | |
| | | account rejected. There are three | |
| | | pre-defined reason codes for accounts | |
| | | that are rejected. | |
| | | “001” indicates Out-of-Balance | |
| | | error, and “002” indicates All | |
| | | Other unknown or unidentified errors. | |
| | | All detailed account records will | |
| | | also be written following the reason | |
| | | code. The account detail records will | |
| | | be identical to 2nd User billing | |
| | | records sent to Telesoft. | |
| | 2.2.3. | Trailer Records - HH658220000131TSFT | |
| | P001PACBELL00999999 | | |
| | | “TT” (1-2 byte) - These two | |
| | | bytes indicate this is the Trailer | |
| | | record. | |
| | | “6582” (3-6 byte) - This | |
| | | field is the 2nd User billing cycle | |
| | | number. | |
| | | “2000” (7-10 byte) - This | |
| | | field displays the 4-digit year | |
| | | (YYYY). | |
| | | “0131” (11-14 byte) - This | |
| | | field displays the month and date | |
| | | (MMDD) | |
| | | “TSFT” (15-18 byte) - This | |
| | | field indicates the file is send by | |
| | | Telesoft (TSFT). | |
| | | “P001” (20-23 byte) - This | |
| | | field displays the program/application | |
| | | number. | |
| | | “2nd User” (24-30 byte) - | |
| | | This field indicates the file is | |
| | | send to 2nd User. | |
| | | “00999999” (31-38 byte) - | |
| | | This field is the number of accounts | |
| | | in the error file. | |

| | | |
|---|---|---|
| Missing 1st | Contains the following: | Web |
| User | Listing of all extensions not matched to | |
| Extensions | hierarchy from the 1st User extension files. | |
| | Extension Type. | |
| | One file will be created per month containing | |
| | unmatched extension from all three 1st User | |
| | extension files. | |
| | File will be used for display on the web. | |
| Missing | Contains the following | Web |
| 2nd User | For CBD files: | |
| BTN/ | List of BTNs not matched to hierarchy. | |
| Extensions | List of BTN/Extension combinations not | |
| | matched to hierarchy. | |
| | For 6th user and 4th user files: | |
| | List of BTNs not matched to hierarchy. | |
| | One file will be created for the 4th user file | |
| | One file will be created for the 6th user file | |
| | One file will be created for the CBD North and | |
| | CBD South unmatched extensions. This gives a | |
| | total of 19-22 Missing Extension files per | |
| | month. | |
| | File will be used for display on the web. | |

Interfaces:

| Interface | |
|---|---|
| Name | Description |
| Standardize | The creation of validated output files |
| IIRS process | will initiate the standardize IIRS process |
| 1st User | Provides 1st User billing, balancing and |
| | NPA/NXX files |
| 2nd User | Provides CBD, CALN, 6th user, and 4th |
| | user files. |
| Hierarchy | Daily job creates files from hierarchy |
| Tables | tables |
| Web Team | Processes pre audit and unmatched |
| | extension files for web display. |

Create OC3:

Assumptions:

No field validation in the OC3 tables will need to be performed. The Web Team will use field edits to ensure that correct data is entered into the tables.

The billing indicator for all new entries in the OC3 MRC and NRC tables will be set to zero (to indicate that the MRC and NRC has not been billed) by the Web interface when entered.

The following date fields will be supplied by the Web Team on the OC3 MRC and NRC tables:

1. Posted Date

2. Beginning Effective Date

3. End Effective Date

Online system will not be available to users when the batch process is running.

Key Inputs:

| Description/ | Provided | | Process |
|---|---|---|---|
| Content | By | Sorting Requirement | Sorted by |
| MRC OC3 table | Web | None | N/A |
| NRC OC3 table | Web | None | N/A |
| Match Hierarchy | Create | Extension | |
| Trigger | Triggers | | |
| OC3 Sequential | OC3 | Extension | OC3 |
| File | | | |

Key Outputs:

| Description/ | Provided | Sorting |
|---|---|---|
| Content | To | Requirement |
| OC3 Non-Usage | Hierarchy | |
| IIR file | Match | |

Functional Description:

The purpose of this process is to read the two OC3 tables (MRC and NRC) and create IIR records which will be passed to the Hierarchy Match process and then sent downstream for further invoice creation processing.

The EBS system will not receive input file records from 1st User for the MRC or NRC charges for OC3 products (classified as Private Line, ATM and Frame Relay). Rather, EBS enables 1st User service representatives to enter and update OC3 charges billed to a customer via OC3 order entry screens (via the web interface.)

Two separate fetch data layers will be called to read the OC3 MRC and NRC tables and return eligible entries for IIR generation. Should back billing be necessary, a separate IIR will be created for each month's back billed charges. One output non-usage IIR file will be created: both with MRC and NRC records. The file will be passed to the Hierarchy Match process.

NOTE: The IIR records created in this process are incomplete, as they do not contain charge information. The rating of these products will occur in the Rating, Fees, and Taxes process further downstream.

Process Flow Description:

A. Match Hierarchy Trigger initiates process.

B. Sequential file (sorted by Extension) will be created from the OC3 tables. This will allow quicker retrieval of the OC3 charges for which IIRs must be created. Sequential file is created and sent to the OC3 driver.

C. Control of process is held by driver module.

D. An IIR will be created for every extension (in trigger file) where an MRC or NRC exists.

E. Date comparison between the bill round date and beginning effective date of OC3 product will be performed for monthly recurring charges. If the beginning effective date of the product is before the billing month, a separate IIR will be created for each month's back billed charges.

F. For each MRC and NRC where an IIR is created, an update data layer will be used to update the corresponding entries as “billed” in the OC3 tables.

G. Records passed to Rating for further processing.

Process Components and Descriptions:

New Components:

| Component | | |
|---|---|---|
| (driver, | | Description |
| data layer, | Name/ | Of |
| etc.) | ID | Function |
| Driver | New | Module will perform the following: |
| Module | | Read OC3 sequential file and match |
| | | extensions where IIR needs to be |
| | | created. |
| | | Create IIR for each OC3 MRC retrieved |
| | | If Beg Eff Date is before billing |
| | | month and not billed, create |
| | | IIR for each backbilled month. |
| | | Read OC3 sequential file and match |
| | | extensions where IIR needs to |
| | | be created |
| | | Create IIR for each OC3 NRC |
| | | retrieved |
| | | Contain default error processing. |
| Create OC3 | New | Module will perform the following |
| Sequential | | the following: |
| File | | 4 Call Fetch data layers to extract |
| | | all active charges |
| | | 2 Create OC3 Sequential File to be |
| | | used by driver |
| Fetch MRC | New | Retrieve rows from the OC3 MRC table. |
| Data Layer | | |
| Fetch NRC | New | Retrieve rows from the OC3 NRC table |
| Data Layer | | |
| Update Data | New | Update OC3 MRC entries as “billed” |
| Layer | | when IIR created |
| Update Data | New | Update OC3 NRC entries as “billed” |
| Layer | | when IIR created |

Tables and Descriptions:

Oracle Tables:

| | | CRUD | |
|---|---|---|---|
| | | (Create, | |
| | | Read, | Owner (Process: |
| | | Update, | Web, AR, OI, |
| Table Name | Description/Content | Delete) | etc) |
| OC3 MRC | Should include the following | Read | Web |
| Table | fields | | |
| | Beginning Effective Date | | |
| | End Effective Date | | |
| | Posted Date | | |
| | Charge Code | | |
| | Quantity | | |
| | Mileage | | |
| | Associated Extension | | |
| | Extension Type | | |
| OC3 NRC | Should include the following | Read, | Web |
| Table | fields: | Update | |
| | Beginning Effective Date | | |
| | Posted Date | | |
| | Charge Code | | |
| | Quantity | | |
| | Associated Extension | | |
| | Extension Type | | |
| | Billing Status | | |

Interfaces:

| Interface Name | Description |
|---|---|
| Hierarchy Match | Match Bill Payer process reads |
| | the OC3 IIR file. |
| Web | OC3 charges are entered via the |
| | Web interface. |

Distribute (DI):

Key Inputs:

| | | | | Process |
|---|---|---|---|---|
| | Provided | Layout | Sorting | Sorted |
| Description/Content | By | Type | Requirement | by |
| Format Trigger File - | AII | Key fields: | Bill Date, | Create |
| contains the format trigger | | Bill Date | Bill Payer | Triggers |
| record for each media that | | Bill Payer | | |
| the customer selected by | | DocFmtOpt ID | | |
| Bill Payer. This is a Fixed | | Media Opt ID | | |
| length file(See copy book | | Doc Code | | |
| for detail.) | | Doc Cpy Cnt | | |
| | | Cust Name | | |
| | | Cust Address | | |
| | | Copybook: | | |
| | | B2CCT258 | | |
| Billing Information Records | AII | | Bill Date, | AII |
| (BIRs) Header file - | | | Bill Payer | (LUW) |
| contains Bill Payer | | | | |
| level information, | | | | |
| such as amount due. | | | | |
| Billing Information Records | AII | Sort Area | Bill Date, | AII |
| (BIRs) Detail file contains | | contains all | Bill Payer | (LUW) |
| all detail charges to be | | hierarchy | | |
| mapped to detail bill | | details per | | |
| displays, as well as AI | | charge/ | | |
| created summary records. | | summary | | |
| Both record types contain | | record | | |
| both hierarchy information | | Generic Amt | | |
| as well as charge total and | | fields contain | | |
| sub total amount records. | | all detail and | | |
| | | summary level | | |
| | | totals. | | |

Key Outputs:

| | Provided | Sorting |
|---|---|---|
| Description/Content | To | Requirement |
| Paper FIR File - contains all header, | FI (Paper) | Bill Date, |
| RA, and detail FIRs to produce the | | Bill Payer |
| following types of Paged Documents: | | |
| Full Paper Bill, Remit Only Document, | | |
| and the CD-ROM/Diskette PDF file. | | |
| CD-ROM/Diskette FIR File - contains all | FI (CD- | Bill Date, |
| header, RA, and detail FIRs to produce | ROM/Disk) | Bill Payer |
| the following types of Non-Paged | | |
| Documents: CD-ROM Flat file feed and | | |
| Diskette Flat file feed. | | |
| Multiple Reporting FIR files - There | Edocs and | Bill Date, |
| will be two output files created by a | FMR | Bill Payer, etc. |
| Reporting instance of DI. For each of | | (as specified in |
| the following reports to will be sent | | the primary and |
| to FMR or eDocs: Access Reform | | secondary sort |
| Reconciliation, OC3 Taxation, | | copybooks for |
| Management Fee 800/Intralata/CC, the | | each report). |
| 4 Fiscal Management Reports, Usage by | | |
| Agency, Summary of Accounts, Bills | | |
| Generated Monthly, Summary Billing, | | |
| Alt Media Tracking | | |

Functional Description:

The BIR Distribute process converts the Billing Information Records (BIRs) received from the Aggregate Input Interface (AII) process into the Format Information Records (FIRs), in order to generate the customer bill. DI's principle functions are to 1) determine which documents need to be created for a particular Bill Payer based on media choices, 2) match charge and summary records to documents and sections, 3) determine the sort order for all sections produced, and 4) format the FIR appropriately.

The BIRs from the AII process consist of a Header BIR and a Detail BIR for each Bill Payer. The BIR and Format Trigger files are sorted by Bill Payer in ascending order. The BIR Distribute driver (BBF00001) first reads all the format triggers for an account from the format triggers file. After all triggers have been read for an account, the driver begins processing BIRs from the header/detail BIR file.

The driver formats the trigger area and account information for the output FIR. In order to handle the new hierarchy levels for the state of California's billing structure, the driver will need to be updated to populate these new fields (Sector, Sub-Sector, Agency, etc.).

The Format General FIR module (PIP1D001) is responsible for formatting FIRs for processing in Format Infrastructure (FI). The Format Module receives and processes format triggers first. The Reporting Arrangement is formatted from information passed on in linkage from the Distribute driver. After formatting each Reporting Arrangement, the Format module writes the RA to the corresponding FIR file.

The Format module then receives BIRs from the driver. The first BIR received is the header BIR and the format module creates a header FIR. The format module will need to be updated to call a new data layer to access the new Billing Date Display table. This new table will contain the date ranges to be displayed on the page headers for particular Usage and Charge paper bill sections. Both the arrears and advanced billing date ranges will be pulled from the table, and carried through to the header FIR.

Next, the Derive Cust Grp Fmrt Code module is invoked to derive the Cust Grp Formt code for flavoring. This functionality will be retained for SIBS; However, FI will not be utilizing flavors for bill section development.

For each Detail BIR received, the Format module will then access the data layer to retrieve format group sequence codes from the FIT Section Line tables and format them on the FIR sort cap. Other information retrieved from this data layer access is copybook id information to be used by the Determine Primary/Secondary Sort module. The Format modules create as many FIRs as rows retrieved. The DI tables will need to be updated to map all fit codes to appropriate sections and lines, based upon the SIBS bill display requirements.

Once a FIR has been mapped to an appropriate section and line via fit code, the format module calls the Determine Primary/Secondary Sort Area module (BBF100276) to populate the primary and secondary areas of the FIR. Based on the copybook id information passed from the format module, the Determine module calls the Format FIR Primary Sort module to format the Primary Sort area on the FIR and/or calls the Format FIR Secondary Sort module to format the Secondary Sort area on the FIR. The primary and secondary sort copybooks assigned to each FIR will be based on the section to which a particular FIR belongs. These copybooks drive the sort requirements for each bill section, whether it be a paper or an alternate media bill section. The sort fields also enable FI to loop on some of these fields for sub-totaling and header display requirements. The Format Primary Sort (BBF10277) and the Format Secondary Sort (BBF10278) modules will each have to be updated to incorporate new sort requirements for both the paper bill displays and the RAI report feeds for eDocs. For each new primary and secondary sort copybook that will be created, a new paragraph in the associated format sort module will need to be added to populate the appropriate sort fields.

The following table details the current bill section sort requirements:

| Sort Criteria | Sections Impacted |
|---|---|
| For Payment Part: EBCCG701 | Credits and |
| Bill Payer Id (A13), Bill Round | Adjustments |
| Date (N8), Credit Adj. Reference (A20) | |
| For Credit/Adj Part: EBCCG702 | |
| BTN CC Grp (N13), Line Number (A26), | |
| Bill Round Date (N8), Credit Adj. | |
| Reference (A20) | |
| EBCCG703 | Summary By |
| BTN CC Grp (N13) | Bill Number |
| EBCCG704 | Summary By |
| Description Text (A30) | Product |
| EBCCG705 | Monthly Recurring |
| BTN CC Grp (N13), USOC Group (A5), | Charges |
| Line Number (A26) | |
| EBCCG706 | Monthly Recurring |
| BTN CC Grp (N13), Line Number (A26), | Private Line |
| Service Address Line (A36) | Circuit Detail |
| EBCCG707 | Nonrecurring and |
| BTN CC Grp (N13), Line Number (A26) | Prorated Charges, |
| | Zero Usage |
| EBCCG708 | Usage - Calling Card, |
| BTN CC Grp (N13), Line Number (A26) | Audio Conf, Local, |
| | LD, Toll Free, Casual |
| EBCCG710 | Summary by Toll Free |
| BTN CC Grp (N13), Line Number (A26), | |
| World Com Service Location Id (A8) | |
| EBCCG711 | Miscellaneous |
| BTN CC Grp (N13) | |
| EBCCG709 Secondary Copybook | Usage Detail - Audio |
| Call Placement Code (A2), Start | Conferencing |
| Date (N8), Transaction Start | |
| Time (N6) | |
| EBCCG712 | MRC Detail (Web Only) |
| Usoc Group (A5) | |
| EBCCG746 Secondary Copybook | Usage Detail - Calling Card, |
| Start Date (N8), Transaction Start | Local, LD, Toll Free, Casual |
| Time (N6) | |
| EBCCG747 Secondary Copybook | Summary by Toll Free |
| Description Text (A30) | |
| EBCCG748 Secondary Copybook | Miscellaneous |
| Carrier Bill Round Date (A30) | |
| No Copybook Used | Taxes and Surcharges |

The following table details the current report sort requirements:

| Sort Criteria | Sections Impacted |
|---|---|
| EBCCG740 | Summary of Billing Report |
| IP File Name (N2) | |
| EBCCG734 | Summary of Services Billed |
| Sector (N1), | |
| Exempt Ind (N1) | |
| EBCCG732 | Detail of Services Billed |
| Sector (N1), | |
| Exempt Ind (N1) | |
| EBCCG733 | Summary of Services by Agency, |
| Sector (N1), | Detail of Services by Agency |
| Exempt Ind (N1), | |
| Sub Sector Ind (N1) | |
| EBCCG739 | Usage by Agency |
| Bill Payer Name (A40), | |
| Control Acct Id (A8) | |
| EBCCG741 | Zero Usage |
| Bill Round Date (N9), | |
| Bill Payer Name (A40), | |
| Network Acc Cd (A2), | |
| Line Number (A26) | |
| EBCCG738 | OC3 Taxation |
| Bill Payer Name (A40), | |
| Bill Payer Id (A13), | |
| Bill Round Date (N8) | |
| EBCCG731 | Access Reform Reconciliation |
| IP File Name (N2), | |
| Line Number (A26), | |
| 1st User Service Location Id (A8), | |
| Cord Id (A8), | |
| Control Acc Id (A8) | |
| EBCCG737 | Management Fee Collection |
| Bill Payer Name (A40), | |
| Invoice Number (A8) | |
| EBCCG736 | Management Fee, 800, and Intralata |
| Bill Payer Id (A13) | |
| EBCCG743 Secondary Copybook | Summary of Services Billed, |
| FMR Service Id (A15) | Summary of Services by Agency |
| EBCCG742 Secondary Copybook | Detail of Services Billed, |
| FMR Service Id (A15), | Detail of Services by Agency, |
| FMR Service Name (A25) | Management Fee Collection |
| EBCCG745 Secondary Copybook | Usage by Agency |
| Description Text (A30), | |
| FMR Service Name (A25) | |

Finally, after all of the fields on the FIR sort cap and FIR common area are formatted, the FIR Format Module will format and write the FIRs to the corresponding format group FIR file to be read as input by FI. The Format Module will need to be updated as a part of the SIBS project to write to additional FIR output files. DI will now write FIRs to one of the following output files, depending upon the value of the Document Format Option ID:

| | Doc Format |
|---|---|
| File | Option ID Value |
| Paper FIR File | Paper, Remit Only, |
| | PDF Document, |
| | or eDocs Feed |
| CD-ROM/Diskette | |
| FIR File | CD-ROM or Diskette |
| Mag-Tape FIR File | Mag-Tape |

Each output FIR file is sorted upon being output from Distribute. The sort parameters used to sort the FIRs prior to being read by the Format Driver in FI are the fields in the FIR sort cap [D610.B2GR5024]. These parameters will also need to be updated to include the new hierarchy fields (Sector, Sub-Sector, Agency, etc.) that will now be included in the DI sort cap. In addition, new sort jobs will need to be created for the two new output FIR files: CD-ROM/Diskette FIR File and Mag-Tape FIR File.

eDocs Report Creation

In addition to the on-cycle instance of DI, this process will also execute across an input BIR file containing all of the RAI report details and summary records.

In order to support additional sort requirements for the eDocs report feeds, the Primary and Secondary sort module updates will need to encompass the new sorts for the reports. The following eDocs reports, input from RAI, will be sorted by a reporting instance of DI:

Access Reform Reconciliation

OC3 Taxation

Management Fee 800/Intralata/CC

4 Fiscal Management Reports

Usage by Agency

Summary of Accounts

Bills Generated Monthly

Summary Billing

Alt Media Tracking

In addition, the updates to the Format General FIR module to handle the new output files will also encompass the new reporting output files. For Reporting DI, each eDocs report will be written to a separate output file. This will be driven by Document Format Option ID, and each report will be assigned a separate Document Format Option ID by the upstream triggers process.

Twelve new instances of the FIR sort jobs (one for each report) will need to be created for these reporting FIR files. Following each sort job, and NDM transmission job will need to be created to send these feeds to eDocs.

Process Flow Description:

During the critical path bill round execution, DI will be executed with the input detail and summary BIRs from AI. DI will read each BIR and associate it to the document types ordered by the customer via the input triggers. DI assigns fit codes and section line information to each FIR. Then, DI determines the sort criteria for each of the sections produced for every document. This sort criteria, defined by the primary and secondary sort copybooks will be evaluated, and all sort information will be populated. Finally, the formatted FIRs will be written to the appropriate FIR files, based on document format, to be processed by Format Infrastructure (FI).

A second instance of DI will run in the reporting stream. This stream will produce a number of report feeds for eDocs, to be displayed on the Web. This input to Reporting DI will be the output BIR file from the Reporting AI Engine, and processing will proceed as it does in the critical path bill stream. The outputs of this process will be sorted FIR records that will be transmitted to the eDocs server.

Process Components and Descriptions:

New Components:

| Component | | | NBS |
|---|---|---|---|
| (driver, | | | Components |
| data layer, | | Description | to be |
| etc.) | Name/ID | Of Function | copied |
| Data Layer | | New PDL to access the new | |
| | | Billing Date Display table | |
| Job | | New JCL for the Reporting | |
| | | DI job. | |
| 2 Sort | | 2 new sort jobs will need | |
| Cards | | to be created to sort the | |
| | | CD/Diskette FIR file and | |
| | | the Mag Tape FIR file. | |
| 12 Sort | | 12 new sort jobs will need | |
| Cards | | to be created to sort the | |
| | | reporting feeds for eDocs. | |
| 12 NDM | | 12 new NDM jobs will need | |
| | | to be created to send each | |
| | | of the reports to eDocs. | |

Existing Components:

| Component | | |
|---|---|---|
| (driver, | | |
| data layer, | Name/ID | Description |
| etc.) | (if known) | Of Function |
| Driver | BBF00001 | Update the driver to pass the new |
| | | hierarchy fields (agency, sector, |
| | | etc.) onto the FIRs. Also update the |
| | | driver to call a new data layer to |
| | | pull Bill Date Display Ranges from a |
| | | new table. |
| Module | PIP1D001 | The Format Module will be updated |
| | | to handle our new FIR output files. |
| Module | BBF10276 | The Determine Primary/Secondary Sort |
| | | module will need to have all PBCF |
| | | calls removed. |
| Module | BBF10277 | The Format Primary Sort module will |
| | | need to be updated to populate new |
| | | primary sort copybooks for bill |
| | | sections and eDocs report feeds. |
| Module | BBF10278 | The Format Secondary Sort module will |
| | | need to be updated to populate new |
| | | secondary sort copybooks for bill |
| | | sections and eDocs report feeds. |
| JCL | | Update the JCL for the Distribute |
| | | job to include the 2 additional |
| | | output files for CD-ROM/Disk and |
| | | Mag Tape. |

Tables and Descriptions:

Oracle Tables:

| | CRUD | Owner |
|---|---|---|
| | (Create, | (Process |
| | Read, | Web, |
| | Update, | AR, OI, |
| Description/Content | Delete) | etc) |
| Billing Date Display Table - | | Tables |
| Contains the date ranges for charges | | |
| billed in arrears and advanced, as | | |
| they should be displayed in section | | |
| headers. | | |

Interfaces:

| Interface | |
|---|---|
| Name | Description |
| FI | Instances of FI (Paper, CD-ROM/Diskette, |
| | Mag-Tape) will each receive a feed from |
| | DI containing FIRs. Paper FI will receive |
| | all paged FIRs, and the other FI jobs will |
| | receive all Non-Paged FIRs. |
| Web Team | The Web Team will receive sorted reports |
| | from RAI via an instance of DI. These |
| | reports will be provided once per bill cycle. |

DI Modules:

| Module | Description |
|---|---|
| BBF00001 | BIR Distribute Driver |
| BBF10276 | |
| BBF10277 | |
| BBF10278 | |
| BBLL33DS | |
| BDLL58DC | STXT / Reads a sequential DB2 unloaded |
| | copy of STXT Transforms to a NON-DB2 |
| | format and writes to a VSAM Linear |
| | Dataset for Dataserv access |
| | Creates a FIRST-NEW-KEY-IN-BLOCK Cross |
| | reference file to support access via |
| | Dataserv |
| BDLL72DC | SITS / Reads a sequential DB2 unloaded |
| | copy of SITS Transforms to a NON-DB2 |
| | format and writes to a VSAM Linear |
| | Dataserv access |
| | Creates a FIRST-NEW-KEY-IN-BLOCK Cross |
| | reference file to support access via |
| | dataserv |
| BDLU69SD | FIT_ACCT_CUST_GRP / Retrieves all records |
| | from this table, ordered by keys and |
| | effective date |
| BDLV53DS | SSLA / Based on fields received, |
| | accesses SSLA returns Doc Sectn Cd |
| BDLW43SD | SSLA / based on fields received, |
| | accesses SSLA, returns Doc Sectn Cd, |
| | SLN Seq Ord CD, and Doc Logc Ln Code |
| BDLW93SD | SLA_FIR_FIELD_DATA / Program fetches |
| | SFRF copybook data from SLA_FIR_FIELD_DATA |
| BDLZ42SD | |
| BDLZ44SD | |
| BDLZ53SD | SFSG / Loads SFSG table |
| BDLZ65SA | This access, retrieves the billing |
| | information records by merging records |
| | from headers and details |

Format Infrastructure (Fl):

Assumptions:

The only alt media that receives a PDF is CD-ROM.

The AFP feed for paper, PDF, & eDocs is the same.

CD-ROM may be able to reuse the DocFormt CD.

Key Inputs:

| | Provided | Sorting | Process |
|---|---|---|---|
| Description/Content | By | Requirement | Sorted by |
| Paper FIR file | Created by | FIR file is sorted | DI Sort/Merge |
| Input file has the header, trigger, | DI process | by the Sort CAPS | |
| and detail records Header records | | field The input is | |
| contain Bill Payer data | | sorted by format | |
| information Detail records | | header, trigger, | |
| contain the document section and | | and detail record | |
| logical line format information | | information | |
| This FIR file also includes a | | The sort | |
| sortcap with 4 fields required by | | requirements are | |
| eDocs. *This information will be | | then defined, per | |
| included in the Paper/Remit input | | document section, | |
| file as well, and then dropped in | | via the DI tables. | |
| the Output Selector, so it will not | | | |
| be in the Paper/Remit PIR file. | | | |
| (This is the easiest way to insure | | | |
| that the extra eDoc information | | | |
| gets to the Output Selector) In the | | | |
| Output Selector, the information | | | |
| will be moved from the sortcap in | | | |
| the eDocs file to the end of the | | | |
| file. | | | |
| CD-ROM FIR file | Created by | FIR file is sorted | DI New |
| Input file contains the header, | DI process. | by the Sort CAPS | Sort/Merge |
| trigger, and detail data sorted by | | field. The input is | |
| account (Bill Payer) | | sorted by format | |
| | | header, trigger, | |
| | | and detail record | |
| | | information.The sort | |
| | | requirements are | |
| | | then defined, per | |
| | | document section, | |
| | | via the DI tables. | |
| Paged Reporting FIR file | Created by | FIR file is first | DI New |
| Input file contains the header, | DI process. | sorted by total | Sort/Merge |
| trigger, and detail data sorted by | | contract or state | |
| report ID, as there is only one Bill | | code, then by doc | |
| Payer in monthly processes. | | format option ID | |
| | | (report ID) | |
| Non-Paged Reporting FIR file | Created by | FIR file is first | DI New |
| Input file contains the header, | DI process. | sorted by total | Sort/Merge |
| trigger, and detail data sorted by | | contract or state | |
| report ID, as there is only one Bill | | code, then by doc | |
| Payer in monthly processes. | | format option ID | |
| | | (report ID) | |

Key Outputs:

| | | Sorting |
|---|---|---|
| Description/Content | Provided To | Requirement |
| Paper Bill Header File | Stack & Burst | Bill Date, |
| (Remit included in this) | process (ending at | Bill Payer, |
| Header file contains account | BPC for paper) | & Document |
| (Bill Payer) data | | Section. |
| information. | | |
| Paper Bill Detail File | Stack & Burst | Bill Date, |
| (Remit included in this) | process (ending at | Bill Payer, |
| Detail file contains the | BPC for paper) | & Document |
| document section and | | Section. |
| logical line format | | |
| information. | | |
| Web Format Header File | Stack & Burst | Bill Date, |
| (PIR file in the eDocs | process (for | Bill Payer, |
| flow; Paper stream) | eDocs) | & Document |
| Header file contains | | Section. |
| account (Bill Payer) data | | |
| information. | | |
| Web Format Detail File | Stack & Burst | Bill Date, |
| (PIR file in the eDocs | process (for | Bill Payer, |
| flow; Paper stream) | eDocs) | & Document |
| Detail file contains the | | Section. |
| document section and | | |
| logical line format | | |
| information. | | |
| PDF Format Header File | Stack & Burst | Bill Date & |
| (to be included on | process (ending at | Bill Payer |
| CD-ROM. In Paper FI flow) | Burn Center for | |
| Header file contains | PDF) | |
| account (Bill Payer) data | | |
| information. | | |
| PDF Format Detail File | Stack & Burst | Bill Date & |
| (to be included on CD- | process (ending at | Bill Payer |
| ROM. In Paper FI flow) | Burn Center for | |
| Detail file contains the | PDF) | |
| document section and | | |
| logical line format | | |
| information. | | |
| Flat CD-ROM Format | Burn Center | Bill Date, |
| File | | Bill Payer, |
| | | & Record |
| | | Type |
| Paged Reporting (FMRs) | Stack & Burst | Total Contract |
| Header File | process (for | (state code), |
| Header file contains | FMRs) | doc format |
| account (Bill Payer) data | | code |
| information. | | |
| Paged Reporting (FMRs) | Stack & Burst | Total Contract |
| Detail File | process (for | (state code), |
| Detail file contains the | FMRs) | doc format |
| document section and | | option ID, |
| logical line format | | Bill Payer, |
| information. | | BTN. |
| Flat Non-paged Report | EDOCs web | None |
| files (one for each of | solution | |
| the seven CSR download | | |
| only reports) | | |

Functional Description:

The various NPM and paper output files are created based on the customer's media format selections. A formatted trigger will be processed by the distribute process and will create one file for each of the media formats, selected by the customer. These files will be the input files for the Paper and NPM processes, respectively.

The FI modules driving the formatted Paper bill creation will use the data mapping tables (i.e., DBSQ, SDAT, and STXT) to handle all the data mapping for generating feeds to the Stack and Burst (S&B) process. In addition, this process needs to perform various set ups for building the Non-Operational (NOP) records that the PI process will use to interface with the Bill Print Center (BPC). BPC receives the AFP print ready output file and the BPC will be responsible for sorts, prints, enclosures, as well as mailing the customer bills.

There is a process that must run before Fl which deletes and rebuilds the SEFF (expanded parser) table, and writes out two VSAM files (DSLT and SLAG) representing table joins that are used extensively in DAS. The DSLT file is a join of DBSQ, DSFB, DBSQ, SDEM, and SEFF. This file is the first accessed in DAS, and tells the attributes (sourcing requirements, formatting indicators) for each block in a logical line or data pop. The SLAG file is a join of SDAT, SDEM, SEFF. This file gives start positions and lengths for which data needs to be sourced from parsed copybooks and input records.

The Non-Paged Media (NPM) modules will use these same data mapping tables to handle all the normal data mapping/field sourcing. This special data mapper table for alt-media is known as FOG (Fielded Output Generator). (It is for field sourcing and logical line design, and its basic function is to take the value in field x and put it in position y.) It is also important to note that Headers and Trailers, different in each of the alt-media files, will be created in the FI Driver Module (BFP0003), and the module that calls FOG will be BFP10072.

The processing of non-paged files is different than the paged data. Within the FOG module, and internal table is loaded from a data layer that joins the SFRA, SFOC, SDEM, and SEFF tables. This internal table is similar to the DSLT VSAM file created for the paged processes. This table is loaded per “Data Pop’ (non-paged logical line). Each row on the internal table is equivalent to a block on a logical line. As each ‘block’ is processed its sourcing and formatting can be any of the following: DS—DAS formatting required, (space)—straight sourced information, AA—constant value. In the FOG module the action code is evaluated and corresponding processing occurs. If the action code calls for a constant value to be populated, that value is found on the internally loaded table (from the SFRA). If the action code calls for straight sourcing, the sourced copybook information is retrieved from the internal table (start position, field length, etc.) and the appropriate parsed copybook is laid over the input record, and corresponding information is grabbed. With an action code that requires DAS formatting, the processing is quite different.

When an action code that requires DAS formatting is encountered, DAS is called directly from the FOG module. This requires only the ‘blocks’ with DAS action codes from SFRA to have entries on the DBSQ and SDAT tables for population to the DSLT and SLAG VSAM files. In DAS those blocks are sourced and formatted, then (based upon start positions in DBSQ each formatted block is put onto the Z013 buffer area in its own 66 byte row. Upon return to FOG the first formatted block is moved into the output area and onto the output record. For each successive DAS action code for the same data pop (logical line) encountered, an index is incremented and the next 66 byte, DAS formatted row in the Z013 buffer area (a data pop block) is moved into the output area and onto the output record. DAS will be called only once per data pop, and at that point, all blocks requiring DAS formatting for that data pop, will be formatted and prepared on the Z013 buffer area for ultimate population in FOG.

A customer can request any number of additional copies for any media, which they select for their account. The DOC Copy Count of the RA FIR will be set to the number of copies that the customer requested. For each additional copy requested for paper, SIBS will provide the necessary copies of the media sent to the 2nd User Billing Print Center. For example, if a customer requests two copies of Paper bill, SIBS will need to provide two copies of the account's data in the file provided to the 2nd User Bill Print Center. If a customer requests extra copies of an alt-media such as CD-ROM, the copy count will be passed to the CD account header, and the Burn Center will burn copies of the document.

The record length out of FI is a variable blocked file. CD files will be load balanced into ten different files (one for each burner) and cannot exceed 2 gigabytes. Files for the paper stream are not split out of FI because Stack & Burst and PI can handle files larger than 2 gig; the Bill Print Center cannot process files larger than 2 gigs, so files in the paper stream are split in PI, and this value will be table managed. There is a COBOL function that exists that will facilitate the 2 gig split in FI. If the output file for an invoicing cycle is greater than 2 gigabyte, the process will segment the file into 2 files, each with a unique file name.

By utilizing the following algorithm, the output file is guaranteed to not be larger than 2 gig. This method involves adding the value of the largest customer's account (table managed, estimated value) to the value of each incoming account. Therefore, at the end of each customer, the program will do a check and add x bytes to the total number of bytes already calculated by the COBOL function. If this number is less than the limit, another account will be read into the file. This check will continue until the number of bytes (of already processed accounts)+x bytes, is greater than the limit. When this occurs, a new file will be opened. Also, the limit will not be set at exactly 2 gig. Instead, the formula: 2g−y bytes (buffer)=the file limit. This is a safeguard, in case the last account read in is the largest one.

The function of burning the physical CD-ROM, and PDF file onto the CD-ROM belongs to the Burn Center. Therefore, NDM jobs must be created in order to transmit the Alt Media FIR flat files out of FI to the Burn Center and hosting vendor respectively.

The OCR scan-line requirements have not yet been finalized. Once SIBs' bank selection is complete, lock box processing requirements can be finalized. However, format requirements (such as the contents of the OCR scan-line and/or check digit calculation) may cause changes in the feed from AI, which would impact what FI tables do. However, neither should involve code changes.

For page breaking, there will be simple ‘forced page breaking’ and ‘natural page breaking’ (i.e. nothing out of the ordinary) If the final requirements remain these two types, then module BBF10244 will be able to handle this without any code changes. One assumption is that if there is a page break, the header will be carried over to the next page, and ‘continued’ will not be on the header. Also, it is assumed that details will be carried over to the next page, and the program cannot page break on a subtotal.

At this point, flavors are not needed because there is only 1 bill type. This may change for reports and alt media.

BFP10073/Dictionary Access Subroutine Module.

The Dictionary Access Subroutine (DAS) needs to be updated to change DOBC to handle field value checks rather than simple indicator checks.

BFP00003/FI Driver Module.

The Driver module will need to add the logic to create the file header & file trailer for the CD-ROM and diskette NPM file creation.

BFP10026/Output Selector.

This module will need to change to accommodate the new non-paged media output files format and/or provide multiple copies of the account data in the file provided to 2nd User Bill Print center, based on the Z001-COPY-CT.

Also, this module will need to handle an output file larger than 2 gigabyte. First, the program needs to determine the record length of the output file. Second, the program needs to maximize the number of records per file=2 gigabyte/record length of the output file. Third, the program needs to keep a counter for the number of records that are sent to the output file. Whenever the program reaches the maximum number of records per file, the program will send the additional records to the second output file.

BFP10072/Format Output Record Cap.

This module will need to set the Z013-PI-PRT-REC-CD indicator to NOP for all the records generated out of FI process.

BBF10281/Standard Buffer Control.

This module will need to build the end page and Quality Assurance Key information. The PI process will use this information to build the Non-Operational (NOP) records.

BBF10021/Section Formatter Module.

This module will need to handle the reporting of 10 rows by 10 columns. Currently the section formatter is set up to handle for 10 rows by 4 or 5 columns. The copybook B2CCZ001, B2CCZ002 and various working storage fields, will need to increase the ‘occurs clause’ and ‘maximum limit value’ to accommodate the new reporting requirements.

Process Flow Description:

The FIRS coming out of DI will be sorted into 3 process flows, based on media type. The 3 processes include 1) Paper FIRS 2) CD-ROM & Diskette (CBD) FIRS 3) MagTape FIRS

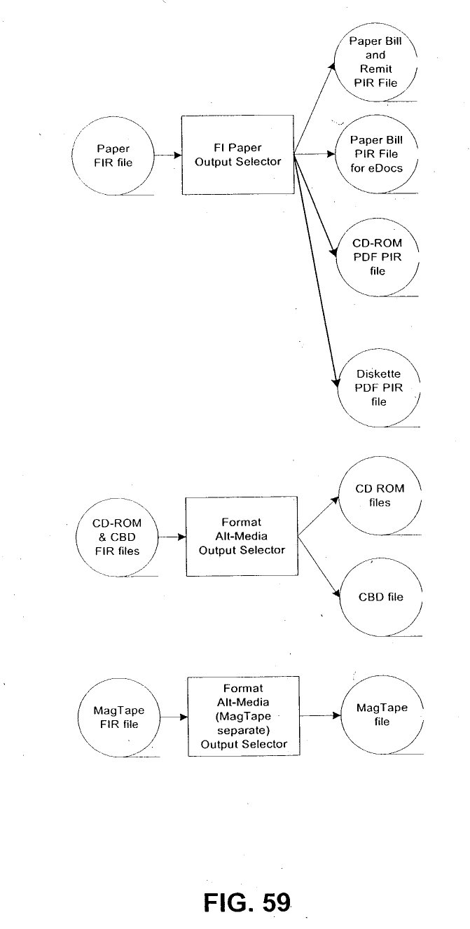

Process flow for FI: See FIG. 59.

FI Paper.

Output file determination is made via the Output Selector table, driven by Document Format Option ID. The four streams produce the Paper Bill, the eDocs file, the PDF/CD-ROM, and the PDF/Diskette files respectively.

Paper Bill & Remit Files.

The paper bill stream is kicked off when paper is chosen as output by the Output Selector. In addition, a remit is sent to the customer when paper is not chosen as media selection; instead, one of the alternative medias was selected. This remit only document is also written to the paper output file.

Two files, one for headers, the other for details, are sent to the Stack and Burst process. From S&B, the files are sent to Print Infrastructure (PI), and then on to the Bill Print Center. These documents are printed and sent to the customer through the mail.

eDocs file.

Regardless of which media is selected by the customer, an eDocs file is always generated in the FI paper stream. It is necessary for the eDocs file to be processed separately from the regular paper print bill for three reasons.

There is no 2 gigabyte limit, as eDocs requires that the file is not split. This stream will feed to a PI stream that will not perform the split function.

There are 4 extra fields that eDocs needs to show, and this differentiates the AFP file's format from the paper bill format. Three of the extra fields are tax fields and the fourth is the GIRN (needed for adjustments.) To ensure that the extra eDocs information gets to the output selector, it will be necessary to send the information in both Paper and eDocs' sortcaps. For the eDocs stream, a modification to the output selector is necessary in order to move the four extra fields to the end of the eDocs/paper file. (If the four fields remained at the beginning of the file, eDocs would not be able to process the file because eDocs would not recognize the file as an AFP one.)

There are no multiple copies in eDocs; so if a customer requests multiple copies of a paper bill, only 1 record is written to the eDocs output PIR file, while multiple records may be written to the Paper PIR file.

The functionality within the Output Selector needs modified to be able to write to eDocs if Paper, eDocs, and/or PDF triggers are received.

PDF Reports.

The PDF report is included on the CD-ROM and CBD packages, and it allows the customer to see a formatted view of their bill. However, the PDF is only created when CD-ROM or CBD have been selected. The flow is similar to the Paper bill in that the PDF files (out of output selector) go to Stack & Burst then to Print Infrastructure. Out of PI, the AFP files are converted to PDF and then sent to the Burn Center to be put on the CD-ROM and CBD respectively. (There is an indicator on the PDF trigger to say CD or CBD as there are two output files.)

FI Alt-Media.

CD-ROM.

The CD-ROM flow is very similar to the CBD flow. CD-ROM FIR files are sent to the Burn Center where the physical CD-ROM is made. It is also at the Burn Center where the PDF is included on the CD-ROM. Because the sorting is done out of Output Selector, the CD-ROM flow is able to bypass the Stack & Burst process.

The CD-ROM format file will contain the file header, record 00 through record 13, and file trailer, as mentioned in section 14.3 of this document. These are broken down as such:

File Header (low values)—Cycle Number and Bill Date,

Account Header (record 00)—the Bill Payer, Bill Date, CD Quantity, and Diskette quantity information,

Detail records (record 01 through 13)—the Bill Payers detail billing information,

The Account Trailer (record 99)—the Bill Payer and Bill Date information,

File Trailer (high values)—Cycle Number, Bill Date, and record count.

Process Components and Descriptions:

New Components:

| Component | | | NBS |
|---|---|---|---|
| (driver, | | | Components |
| data layer, | | Description | to be |
| etc.) | Name/ID | Of Function | copied |
| Copybook | (New) | New copy book for NPM | |
| | | output file layout | |
| JCL | (New) | Required for NDM process | |
| | | out of FI for NPM, | |
| | | to the Bill Print Center | |
| CNTLCARD | (New) | This sort card will need | |
| | | to be created to put the | |
| | | records in an order that | |
| | | the customer has | |
| | | requested. | |
| Module | NPM | This module will be | |
| | Format | created in order to handle | |
| | Module / | the special or exception | |
| | BFP10070 | data mapping. | |

Existing Components:

| Component | | |
|---|---|---|
| (driver, | | Description |
| datalayer, | Name/ID | Of |
| etc.) | (if known) | Function |
| File | EC/DC | This file needs to be updated |
| | VSAM file | for the new NPM process, the |
| | | new NPM Output files, and the |
| | | new NPM files, sorting |
| | | sequence. |
| Module | FI Driver | The Driver module will need to |
| | Module / | add the logic to create the file |
| | BFP00003 | header & file trailer for the |
| | | CD-ROM and diskette NPM file |
| | | creation. The module will also |
| | | need to call the NPM module |
| | | (BFP10070) to generate the NPM |
| | | format output files. |
| Module | Dictionary | The Dictionary Access Subroutine |
| | Access | (DAS) needs to be updated |
| | Subroutine | to change DOBC to handle field |
| | Module / | value checks rather than |
| | BFP10073 | simple indicator checks. |
| Module | Output | This module will need to change |
| | Selector / | to accommodate the new |
| | BFP10026 | non-paged media output file |
| | | format and/or provide multiple |
| | | copies of the account data. |
| | | Also, the new NPM format module |
| | | will need to handle an |
| | | output file larger than 2 gigabyte. |
| Module | Standard | This module will need to build |
| | Buffer | the end page and Quality |
| | Control | Assurance Key information. The |
| | Module / | PI process will use the |
| | BBF10281 | information to build the |
| | | Non-Operational (NOP) records. |
| Module | Format | This module will need to set |
| | Output | the Z013-PI-PRT-REC-CD |
| | Record Cap | indicator to NOP for all the |
| | module / | records generated out of FI |
| | BFP10072 | process. |
| Module | Section | Will need to be updated to |
| | Formatter / | handle the reporting of 10 rows by |
| | BBF10021 | 10 columns |
| Copybook | B2CCZ001 | Increase occurs clause to handle |
| | | the reporting of 10 rows by |
| | | 10 columns. |
| Copybook | B2CCZ002 | Increase occurs clause to handle |
| | | the reporting of 10 rows by |
| | | 10 columns. |
| Copybook | B2CCZ000 | Add NOP 88 level for |
| | | Z000-FI-ACTN-CD |
| Copybook | B2CCZ013 | Add NOP 88 level for |
| | | Z013-PI-PRT-REC-CD |

FI Modules:

Module
BBF10021
BBF10243
BBF10244
BBF10254
BBF10280
BBF10281
BCF10056
BDLL57DS
BDLL73DS
BDLL75DS
BDLT06SA
BDLT07SD
BDLT08SD
BDLV06SD
BDLV10SD
BDLV13SD
BDLV22SA
BDLV30SD
BDLV31SD
BDLW25SD
BDLX99SD
BDLZ67SA
BDLZ70SD
BDLZ97SD
BDLZ98SD
BDLZ99SD
BFP00003
BFP10015
BFP10017
BFP10019
BFP10020
BFP10021
BFP10022
BFP10026
BFP10032
BFP10068
BFP10072
BFP10073
BFP10086

Hierarchy Match (Bill Day Process):

Assumptions:

The Customer Service Reps (CSRs) will be able to update Bill Payer “profile” information. Web will provide an online screen for maintenance of the Bill Payer's; name, billing address, city, state, and zip code, etc. CSRs will not be able to update service address information. CSRs will be able to update the OC3 Circuit address information.

The Standardize Input Files process will provide four files (Usage, Non-Usage, Tax, and Credits and Adjustments) each Bill Round.

The Hierarchy Match process will not begin until we receive all 1st User and 2nd User for that Bill Round.files.

The Sector Name, Sub-Sector Name, and State Name for each Bill Payer will be derived from the Agency Id by downstream processes.

When a BTN is moved from one Bill Payer to another the CUST-CD will change for 2nd User related BTNs. The Account Number will not change for 1st User.

The BTNs and/or Extensions levels within the customer hierarchy will not receive an invoice for any media, except for when it is assigned to a default Bill Payer.

Unmatched Extension report is not separated by Carrier.

Key Inputs:

| | Provided | Sorting | Sorted |
|---|---|---|---|
| Description/Content | By | Requirement | by |
| Standardized Usage Input | Standardize | BTN | Hierarchy |
| Interface Records (IIRs) | Input files | | Match |
| | | | Process |
| This file contains Usage | | | |
| Records from the | | | |
| Standardize Input file | | | |
| Process Space will be | | | |
| Allocated on each record | | | |
| to allow the Bill Payer | | | |
| account level (levels 1-5) | | | |
| information to be passed | | | |
| to downstream processing | | | |
| Standardized Non-Usage | Standardize | BTN | Hierarchy |
| Input Interface Records | Input files | | Match |
| (IIRs) | | | Process |
| This file contains Non- | | | |
| Usage Records from the | | | |
| Standardize Input file | | | |
| Process Space will be | | | |
| Allocated on each record | | | |
| to allow the Bill Payer | | | |
| account level (levels 1-5) | | | |
| information to be passed | | | |
| to downstream processing | | | |
| Standardized Credit and | Standardize | BTN | Hierarchy |
| Adjustment (C/A) | Input files | | Match |
| This file contains C/A | | | Process |
| Records from the | | | |
| Standardize Input file | | | |
| Process. Space will be | | | |
| Allocated on each record | | | |
| to allow the Bill Payer | | | |
| account level (levels 1-5) | | | |
| information to be passed | | | |
| to downstream processing. | | | |
| Standardized Tax and | Standardize | BTN | Hierarchy |
| Surcharge (T/S) | Input files | | Match |
| This file contains T/S | | | Process |
| Records from the | | | |
| Standardize Input file | | | |
| Process. Space will be | | | |
| Allocated on each record | | | |
| to allow the Bill Payer | | | |
| account level (levels 1-5) | | | |
| information to be passed | | | |
| to downstream processing. | | | |
| Hierarchy Match Extract | Triggers | Bill Round | Hierarchy |
| records. These extract | | Bill Payer | Match |
| records will contain all | | BTN | Process |
| levels (1-7) of | | Extension | |
| the Customer Hierarchy. | | | |
| They will be used to match | | | |
| Extensions during the | | | |
| Hierarchy Match process. | | | |
| For matched extensions | | | |
| the customer's information | | | |
| will be moved to the | | | |
| Billing Extract Trigger. | | | |
| Extension Service Address | 1st User/ | None | N/A |
| table SVC_ADDR | 2nd User | | |
| Contains all extension level | | | |
| address information that | | | |
| will be added to the Zero | | | |
| Usage report | | | |
| and Bill Sections. | | | |
| Re-circulated Unmatched | Triggers | BTN | Hierarchy |
| records. These records | | | Match |
| contain unmatched extensions | | | Process |
| and BTNs that will be merged | | | |
| into the input file stream | | | |
| in an attempt to match to | | | |
| associated Bill Payer | | | |
| information. These records | | | |
| will be re-circulated after | | | |
| each bill round until a | | | |
| match is determined. On the | | | |
| 20^{th} bill round they will | | | |
| be considered unmatched and | | | |
| merged with the output files | | | |
| and sent to the Apply Fees | | | |
| and Taxes process. | | | |

Key Outputs:

| | Provided | Sorting |
|---|---|---|
| Description/Content | To | Requirement |
| Hierarchy Matched Usage | Apply Fees | Bill Round |
| IIRs. These Records will | and Tax | Bill Payer |
| contain the matched | | BTN |
| Extensions with Bill Payers | | Extension |
| and Agency Ids. | | |
| Hierarchy Matched Non-Usage | Apply Fees | Bill Round |
| IIRs. These records will | and Tax | Bill Payer |
| contain the Matched extensions | | BTN |
| with Bill Payers And Agency | | Extension |
| Ids. | | |
| Hierarchy Matched C/A IIRs. | Apply Fees | Bill Round |
| These Records will contain | and Tax | Bill Payer |
| the matched Extensions with | | BTN |
| Bill Payers And Agency Ids. | | Extension |
| Hierarchy Matched T/S IIRs. | Apply Fees | Bill Round |
| These Records will contain | and Tax | Bill Payer |
| the matched Extensions with | | BTN |
| Bill Payers And Agency Ids. | | Extension |
| Re-circulated Unmatched records. | Hierarchy | BTN |
| These records are both inputs | Match | Extension |
| and outputs to this process. | | (note: 1st |
| | | User |

Functional Description:

Overview.

This process will apply the Customer Hierarchy structure to the input data within SIBS. The 2nd User and 1st User customer input data will be associated to a Bill Payer within the structure and used in bill production. The customer's agency, sub-sector, sector and state level hierarchy as well as the exempt indicator will need to be stored and maintained in the system databases. The Agency Id will serve to match the Bill Payer to their associated levels account levels (level 1-4) within the customer Hierarchy. The Bill Payers detail level information (5-7) including associated Extensions and BTNs will also be stored and maintained by the system databases.

The four standardized input files (Usage, Non-Usage, Credits/Adjustments, and Taxes/Surcharges) will be processed by BTN and extension. The Hierarchy Match process will then match the 2nd User BTNs and 1st User Extensions from the input files to their corresponding 2nd User BTNs and 1st User Extensions (levels 6 and 7) in the Hierarchy Match Extract. The Hierarchy Match Extract will contain a “mushroom” of all levels (levels 1-7) of the Bill Payer's hierarchy. The information from this Extract will then be moved onto the IIR records that are sent to downstream processing.

The input files will contain the customer's 2nd User BTN and 1st User extension information and the output files will contain the customers 2nd User BTN and 1st User extension information with their extension, BTN, Control Account Id, Bill Payer Number, Bill Payer Name, Agency Name and Agency Id. Each input and output record will contain space allocated for BTN, Extension/Type, Control Account Id, Bill Payer Number, Bill Payer Name, Agency Name, Bill Round Date, Bill Round, and Agency Id.

If a match to the Hierarchy Match Extract is not found, the unmatched records will be routed to an unmatched file each bill round. This unmatched file will be re-circulated through the bill stream in an attempt to match the 2nd User BTNs and 1st User extensions against the Hierarchy Match extract. This file will be re-circulated after each bill round (1-19). On bill round it will be determined that these records are indeed unmatched.

Levels of Customer Hierarchy across 1st User and 2nd User

| Level | 2nd User | 1st User | Notes |
|---|---|---|---|
| 1 | State Level | State | Stored in the |
| | | Level | Agency Id. |
| 2 | Sector | Sector | Stored in the |
| | | | Agency Id. |
| 3 | Sub-Sector | Sub-Sector | Stored in the |
| | | | Agency Id. |
| 4 | Agency | Agency | Stored in the |
| | | | Agency Id, |
| | | | has an exempt or |
| | | | non-exempt |
| | | | indicator. |
| 5 | Bill Payer | Control | All records are |
| | | Account | mapped to Bill |
| | | | Payer \ Control |
| | | | Account. |
| 6 | BTN | Account | |
| 7 | WTN | Extension/ | Extension |
| | | Circuit | Type |
| | | Id | |

Hierarchy Account Update.

The CSRs will use the Web online interface to directly update the Customer Hierarchy Tables with changes (adds/deletes/updates/moves). Prior to the creation of the Format and Extract Triggers and the matching of the Extract Triggers with the input files, the Customer Service Reps will have made all updates to the Hierarchy tables. The technical implications of accessing the Hierarchy tables will be further addressed in the Technical Design and Interface Agreement documents.

Detail Level Updates to Hierarchy.

SIBS will provide the 2nd User and 1st User account teams with an online interface to move 2nd User BTNs (and subsequent WTNs), and 1st User BTNs and extensions from one Bill Payer to another.

The Web team will write to the customer tables. Updates to these tables will be performed directly. The effective start date and end date will be updated and a history of changes will be kept for all updates made.

The detail level information (Extension to Agency) will be updated via the online interface. These updates include the following relationships within the Customer Hierarchy levels including the Bill Payer to Agency Id, Bill Payer to BTN, and BTN to Extension. When updating the detail level information within the Customer tables, the Account teams will be required to provide the following:

Beginning Effective Date

Ending Effective Date

Bill Payer Number

Agency Id

Bill Round Date

Other updated information (e.g. address information)

2nd User only, and 2nd User/1st User shared updates:

(see Scenarios for a more detail look at process of moving WTNs, BTNs, Bill Payers, and Agencies within the Customer Hierarchy.)

WTN to BTN.

A WTN may be moved from one BTN to another. The WTN under the old BTN will be end-dated on the desired date, and the WTN under the new BTN will begin-dated on the same desired date. The Web team will manage this process via the online screens.

BTN to Bill Payer.

When a 2nd User BTN moves from one Bill Payer to another a new BTN will be created. The 10-digit portion of the BTN itself will not change, but rather the CUST-CD (last three digits) of the BTN will be different for the new Bill Payer. All WTNs associated with that BTN will be moved individually.

Bill Payer to Agency.

When a 2nd User Bill Payer moves from one Agency to another a new Bill Payer number will be created.

Bill Payers will be able to be moved from one Agency to another via the online interface All WTNs and BTNs associated with that Bill Payer will be moved individually.

1st User Updates: (see Scenarios for a more detail look at process of moving WTNs, BTNs, Bill Payers, and Agencies within the Customer Hierarchy.)

Extension to BTN (Account #).

1st User Extension moves from one BTN to another will require CSRs to make the effective dates for these changes effective at the first of the following month. Methods and Procedures (M&P) will be used to ensure that that when moving 1st User Extensions they will need to be effective the beginning of the next month.

BTN to Bill Payer.

1st User BTN moves from one Bill Payer to another will require CSRs to make the effective dates for these changes effective at the first of the following month. Methods and Procedures (M&P) will be used to ensure that that when moving 1st User BTNs these will not be effective until the beginning of the next month. 1st User BTNs do not have a CUST-CD equivalent; thus 1 st User BTNs will not change when moved. The BTN under the old Bill Payer will be end-dated on the desired date, and the BTN under the new Bill Payer will begin-dated on the next date. The Web team will manage this process via the online screens.

Bill Payer to Agency.

A 1st User Bill Payer may move from an old Agency to a new Agency via the online interface. A new Bill Payer number will be created when moving Bill Payers. All Extensions, and BTNs associated with that Bill Payer will be moved individually.

Account Level Updates to Hierarchy.

The account level information (Agency to State levels) will be updated via a standard maintenance request from the 2nd User and 1st User Account Teams. A manual process will be used to read the maintenance from the Account teams and update the Hierarchy tables appropriately.

Technical implications for Table Maintenance.

Updating the Customer Tables across Web and the Batch processes involves some technical issues that will require a more detailed look in the Technical Design document. The CSRs will be able to add/modify/move/delete customer information online. During the Hierarchy Matching Extract create process the Customer tables will be locked and will not allow for real time updating via Web. One possible solution to this is to create a daily copy of the Customer tables that the web will run against for updates.

In addition a standard process for clearing out the tables will be further defined in the Technical Design document. The data will be purged off the tables after 6 months.

Web Interface.

Adds, deletes, and modifies of the Customer Tables will be performed via the Web Interface. The relationship between the Batch and Web teams, with regard to these tables, will be finalized and covered in greater detail within Detail Design.

Process Flow Description:

Read Input files.

The first step in the Hierarchy Match process is to determine which files to read coming from the prior Standardize File process. This will be covered in greater detail in the Technical Design document.

Combine Non-Usage Files.

The first step in the Hierarchy Match process is to read in all four input files (Usage, Non-Usage, Credits and Adjustments, Taxes and Surcharges). In addition, after the first bill round, the re-circulated unmatched file will be read in and merged with the other files.

Merge Input Files.

The remaining four files will be read in and keyed by BTN. After the sort the control will be passed to the driver module to begin matching input records containing BTNs and/or Extensions with their related Bill Payer information from the Hierarchy Match Extract.

Match Hierarchy.

The Hierarchy Matching Trigger Extract initiates the matching process. The execution matches two files: the Extract Trigger and the input IIRs.

The driver module will read in each extract trigger creating an internal table and attempt to match the extensions from each trigger with the extensions from the input file. If a match is found, the extension's Bill Payer Number, Bill Round Date, and Agency Id will be moved to each record and sent to the subsequent process. If the extension is not matched, it will be re-circulated and processed during the next bill round. On the 20th bill round, the unmatched extensions will be tagged and added to the file and sent to the subsequent process. A report will be created of all unmatched extensions for the month. See below for a detailed look how the report is created.

2nd User Matching.

The matching process will be SIBS Bill Round driven. All 2nd User detail charge records contain BTN and child WTN information. 2nd User BTNs, from the input files, will be matched to BTNs (level 6) in the Hierarchy Match Extract trigger. Only 2nd User BTNs will need to be matched because every 2nd User extension will already have an associated BTN on the input files. They will then be matched with their respective Bill Payers by Bill Round date. All 2nd User BTNs will be associated with a Bill Payer and all charges received for a given BTN, and corresponding WTNs for a given month, will be billed to its Bill Payer.

1st User Matching.

The matching process will be SIBS Bill Round driven. All 1st User detail charge records contain Extension information. 1st User Extensions and Extension Types from the input files will be matched to Extensions (level 7) and Extension Types in the Hierarchy Match Extract trigger. Only 1st User Extensions and Extension Types will need to be matched because the 1st User input files do not contain a BTN equivalent. They will then be matched with their respective BTNs and Bill Payers by SIBS Bill Round date. All 1st User Extensions will be associated with a BTN and all charges received for a given Extension for a given month will be billed to its Bill Payer.

Create Zero Usage Billing Report.

This report contains all extensions that did not have usage charges for the month during all bill rounds (1-20). To determine if an extension has no usage for a given month an indicator will be set when matching the extensions and BTNs from the input files for all matched extensions. If a given extension is contained on the Customer Tables (Hierarchy Match Trigger), but does not show up on the input files a zero usage scenario will occur. All “final” accounts (Bill Payer Level) will be suppressed from the report as well as circuit extension types. The variables contained in the report are: zero usage extension, extension type, BTN (for 2nd user records), and service location. The extension service location is contained in the Extension Service Address Table (SVC_ADDR). This table will be read to fetch the service location for each extension that has zero usage. The information for the report will be sent in the billing stream on the Non-Usage files to downstream processes and created on the Bill.

Unmatched Hierarchy Processing.

There exists the probability that in any of the billing files received from either 1st User or 2nd User, there will be extensions that are not part of the customer Hierarchy. This could be the result of moving extensions from one BTN to another. These extensions must be identified and added to the Hierarchy tables via the CSRs prior to billing to maximize the charges that get billed on time. During pre-processing the input extensions will be validated against the customer tables to identify all extensions that do not exist on the tables. This will give the customer service representatives the necessary time to move these extensions to valid Bill Payers. Although this will minimize the number of unmatched extensions, there may still be extensions that are not matched during the matching process.

As noted above, the unmatched extensions will be routed to a re-circulation file after each bill round. The unmatched file will be merged with the input files prior to the start of the matching process for the next bill round in an attempt to match these “unmatched” extensions with their respective Bill Payers.

Create Unmatched Extension Billing Report.

This report contains all unmatched BTNs and/or extensions that were not matched for each month. This report will be sent to the Web in one file each Month. The report contains the following variables: BTN, and/or Extension/Type, Carrier Bill Round Date and TCC-ID. To determine if an extension is unmatched for a given month an indicator will be set when matching the extensions and BTNs from the input files for all matched extensions. If a given extension is contained on the input files, but does not show up in the Hierarchy Match Extract pulled from the customer tables and unmatched scenario will occur. The information for the report will be sent in the billing stream on the Non-Usage files to downstream processes and created on the Bill.

Process Components and Descriptions:

| Component | | | | NBS |
|---|---|---|---|---|
| (driver, | | Description | | Components |
| datalayer, | | Of | | to be |
| etc.) | Name/ID | Function | | copied |
| Sort Card | New | Hierarchy Matching extract sorted by Bill | | None |
| | | Round, Bill Payer, BTN and | | |
| | | Extension | | |
| Sort Card | New | Input files by BTN | | None |
| Sort Card | New | Re-sort outgoing files by Bill Payer, BTN, and | | None |
| | | extension. | | |
| Driver | New | Driver will control the sub module that matches | | None |
| Module | | input files to the Hierarchy Match Extract | | |
| | | trigger. | | |
| | | 1. | Files read and combined two file match. | |
| | | 2. | Send control to Hierarchy Match module for | |
| | | | output processing to begin two-file match | |
| | | | process. | |
| Sub | New | The module will process all input records | | None |
| Module | | accordingly: | | |
| Perform | | | | |
| Hierarchy | | 1. | Read first record to determine | |
| | | | extension | |
| Match | | 2. | Attempt to match BTN/extension or | |
| Process | | | Extension from the Input files to | |
| | | | BTN/extension or Extension from the | |
| | | | Hierarchy Match extract | |
| | | | a. If match found then move all Bill | |
| | | | Payer information from Hierarchy | |
| | | | Match Extract to record and send | |
| | | | IIR to downstream | |
| | | | Processing. | |
| | | | b. If a match not found, write record | |
| | | | to the unmatched re-circulated file. | |
| | | | This file will be re-circulated each | |
| | | | Bill Round. | |
| | | | On the 20^{th} Bill Round these records | |
| | | | will be determined as unmatched. | |

| | | | |
|---|---|---|---|
| Sub Module | New | | None |
| Sub Module | | Create Unmatched Extension Report that is | None |
| | | sent to the Web | |
| Sub Module - | | Create Zero Usage Report that is sent for | None |
| Datalayer | | downstream report generation | None |
| | | Retrieve rows from EXTN table to create the | |
| | | Zero Usage report | |

Tables, Reports, and Interfaces:

| Table | | | | |
|---|---|---|---|---|
| Name | Description/Content | | CRUD | Owner |
| SVC | Extension Service Address table. | | Read | Triggers |
| ADDR | | | | |
| | EXT_TEL_NUM | Extension | | |
| | EX_TYP_IND | Extension Type | | |
| | | CARD Calling Card | | |
| | | CIRCKT T-1, circuit | | |
| | | CONF Conf. ID | | |
| | | OC3ATM OC3 ATM service | | |
| | | OC3DSO OC3 DS service | | |
| | | OC3FR OC3 FR service | | |
| | | TF Toll Free | | |
| | WTN | Working Tel Numb / ANI | | |
| | ADDR_LN_1 | Address line one | | |
| | ADDR_LN_2 | Address line two | | |
| | ADDR_LN_3 | Address line three | | |
| | CITY | City | | |
| | ZC_1 | Zip Code | | |
| | CRR_ROUTE_ID | Carrier Route Identifier | | |
| | STATE | State | | |
| | EFF_START_DT | Effective Start Date | | |
| | EFF_END_DT | Effective End Date | | |
| | TIME_STMP | Last time stamp of last | | |
| | | access | | |

Reports.

| Report | | Delivery |
|---|---|---|
| Name | Description/Content | Method |
| Billing | Will contain all extensions that do not | File to Web |
| Unmatched | match a given Bill Payer during the Billing | |
| Extensions | Cycle. | |
| Zero Usage | Will contain all extensions that do not | File to RAI |
| Billing | contain usage during the Billing Cycle. | |

Interfaces.

| Interface | |
|---|---|
| Name | Description |
| Adjustments | The Credit and Adjustments IIR file |
| | will be sent directly to the |
| | Adjustment process. |
| Apply Fees | All four output files will be read |
| and Tax | by the Apply Fees and Tax process. |
| Web | Web team will update the Customer |
| | tables. |
| Hierarchy | Re-circulated File for unmatched |
| Match | extensions. |

Output Interface Process (OI):

Key Inputs:

| | | | Process |
|---|---|---|---|
| | Provided | Sorting | Sorted |
| Description/Content | By | Requirement | by |
| Header IIR - total charges | BAI | Bill Round, | BAI |
| at the bill payer level. | | Bill Payer ID, | |
| | | BTN, | |
| | | NTWK-ACC | |
| OI Detail IIR - all | BAI | Bill Round, | BAI |
| hierarchy information with | | Bill Payer ID, | |
| total and sub total amounts. | | BTN, | |
| | | NTWK-ACC | |

Key Outputs:

| | Provided | Sorting |
|---|---|---|
| Description/Content | To | Requirement |
| AR Financial File | AR | Bill Round, |
| {CYCLE_NAME}.Z250100A - this | | Bill Payer ID, |
| file will contain all header, some | | BTN, |
| detail and BOSS Adjustment records. | | NTWK-ACC |
| This file is created every bill round. | | |
| Adjustment JV File | 1st User - | None |
| {CYCLE_NAME}.Z250100C - this | NDM | |
| file will contain 1st User charges | | |
| for every bill cycle. The Adjustment | | |
| JV will include billed OC3 usage, | | |
| calculated management and admin fees | | |
| and post invoicing adjustments. | | |
| Billing JV File | 1st User - | None |
| {CYCLE NAME}.Z250100B - this file | NDM | |
| will contain all 1st User charges for | | |
| every bill cycle. The Billing JV will | | |
| summarize all charges transmitted to | | |
| 5th user via the SCSS Extension files. | | |
| 5th user will summarize usage at the | | |
| control account level and provide | | |
| one record per control account. | | |
| Post Billing Audit File | 2nd User - | None |
| {CYCLE_NAME}.Z250100E - this file | NDM | |
| will provide all BTN's at the conclusion | | |
| of each 5th user bill round. The Post | | |
| Billing Audit file will include, BTN's | | |
| with Customer Code, Total 2nd User | | |
| Current Charges, Total 2nd User DGS | | |
| Admin Fees, Total 1st User carriers | | |
| current charges, Total 1st User DGS | | |
| Admin Fees, Total 3rd user and PBINFOSV | | |
| charges, Total 3rd user and PBINFOSV | | |
| carriers DGS Admin fees, and Total of | | |
| all current charges. | | |
| 3rd user Monthly Invoice Report | 3rd user - | None |
| {CYCLE_NAME}.Z250100D - this file | NDM | |
| will summarize all 3rd user charges | | |
| created at calendar month's end. | | |
| AR Screen Oracle Report Load - This | Database | None. |
| file is created from the inputs to OI | | |
| and will be loaded on the AR_SCREEN | | |
| report table. | | |

Functional Description:

The OI (Output Interfaces) Process is responsible for filtering input data as appropriate and writing the filtered data to the proper files for further processing. OI's filtering mechanism is dependent upon the FOIC (FIT-CD driven) table. With the help of the FOIC table, each record is driven to appropriate sub-module depending on the FIT-CD and PROD-PROV-TCC-ID assigned to every processing record and the relation of that FIT-CD to the Sub-module name, established within the FOIC table.

The OI Process will provide Accounts Receivable (AR) with a file containing all header IIR's and one record for every BTN per carrier for a particular bill round. This file will contain DGS charges, MGMT fees, current charges, total due, and taxes. No payment or adjustment information will be included.

The OI Process will create and NDM the following files to 1st User, 2nd User, and 3rd user respectively:

1st User:

Adjustment JV File

Billing JV File

2nd User:

Post Billing Audit File

The OI Process will create one of the custom 5th user reports that will be viewed on the web. This particular report will be loaded into an Oracle table from which the web will extract the date to present on the web.

Process Flow Description:

OI Process will receive two files containing 2nd User, 1st User, 3rd user, and 6th userFOSV carriers billing information from the BAI Process at the end of every bill round. These files are the Header IIR and the OI Detail IIR. Each record will contain a FIT-CD. When the OI driver reads the record, it's FIT-CD is matched against that of the FOIC table.

The FOIC table will contain the following columns:

FIT_CD

CONTR_NM

CONTR_VER

PROD_PROV_TCC_ID

BEG_EFF_DT

END_EFF_DT

OI_PROC_CD

TBL_ROW_DESC

MODUL_NM

TIME_STAMP

The FOIC table is internally loaded into memory at the initialization process. The driver performs a binary search on the FOIC table to do the FIT-CD and PROD-PROV-TCC-ID match. When a match is made between the processing record FIT-CD and PROD-PROV-TCC-ID and the FOIC table, the driver will send the processing record to the associated sub-module.

The driver will then use looping logic and move to the next record within the FOIC table evaluating if next row contains the same FIT-CD and PROD-PROV-TCC-ID. If it does, then the driver will send that record to the appropriate sub-module referenced under MODUL-NM. If the next row within the FOIC table does not contain the same FIT-CD and PROD-PROV-TCC-ID, the driver will read in the next record, reset the FOIC table counter to 0 and begin searching the FOIC table from the beginning. The following will describe how each record is processed.

AR Financial Data File.

OI Process will provide the AR repository with service charges billed to 2nd User and 1st User every bill round. Information such as DGS charges, MGMT fees, current charges, total due, and tax information will be provided. AR process will receive all records containing the following FIT-CD:

H1000—Header IIR's

DC053—BTN Total Charges

SA000—BOSS Adjustments

Create Adjustment JV File (BOI01001)

Provide Adjustment JV file at the conclusion of each 5th user bill round. The OI driver will send all of the records containing the following FIT-CD's to the Adjustment JV sub-module where the record will be formatted, written to a file, and NDM'd to 1 st User:

SJ050—OC3 Non-taxable charges and Admin/Management Total

SJ051—OC3 taxes

Created at Bill Payer level

Create Billing JV File (BOI02001)

Provide Billing JV file at the conclusion of each 5th user bill round. The OI driver will send all of the records containing the following FIT-CD's to the Billing JV module where the records will be formatted, written to a file, and NDM'd to 1st User:

SA061—1st User total charges

SJ150—OC3 charges

SJ051—OC3 taxes

Created at Bill Payer level.

Create Post Billing Audit File (BOI04001)

Provide a Post Billing audit file at the conclusion of each 5th user bill round. The OI driver will send all of the records containing the following FIT-CD's to the Post Billing Audit module where the records will be formatted, written to a file, and NDM'd to 2nd User:

SA050—2nd User current charges and DGS fees

SA051—1st User current charges and DGS fees

SA055—Other carrier current charges and DGS fees

SJ353—Total current charges and DGS fees

Created at BTN level.

Create Monthly Invoice File (BOI05001)

Provide an Invoice file at the conclusion of each month. The OI driver will send all of the records containing the following FIT-CD's to the Post Billing Audit module where the records will be formatted, written to a file, and NDM'd to User:

SA053—Total 3rd user current charges

Created at BTN level.

Create AR Screen Report File (BOI06001)

Create an AR Screen Report (Invoice amount) load-file at the conclusion of each month. The load file will need to contain the charges by invoice number for each Bill Payer in a Billing cycle. The data will be a summary of the charges by carrier. The OI driver will send all of the records containing the following FIT-CD's to the Post Billing Audit module where the records will be formatted, written to a file, and then loaded to an Oracle table:

SI152
SA060
SA061
SA062
SA063

Created at Bill Payer level.

Process Components and Descriptions:

New Components:

| Component | | |
|---|---|---|
| (driver, | | Description |
| data layer, | | Of |
| etc.) | Name/ID | Function |
| Sub-module | BOI01001 | This sub-module will be responsible |
| | | for creating the Adjustment JV file, |
| | | which will be NDM'd to 1st User. |
| Sub-module | BOI02001 | This sub-module will be responsible |
| | | for creating the Billing JV file, |
| | | which will be NDM'd to 1st User. |
| Sub-module | BOI04001 | This sub-module will be responsible |
| | | for creating the Post Billing Audit |
| | | file, which will be NDM'd to 2nd User. |
| Sub-module | BOI05001 | This sub-module will be responsible |
| | | for creating the 6th user Monthly |
| | | Service file, which will be NDM'd to |
| | | 6th user. |
| Sub-module | BOI06001 | This sub-module will be responsible |
| | | for creating the AR Screen table |
| | | report file. This file will be loaded |
| | | into the database by a subsequent |
| | | process. |

Existing Components:

| Component | | |
|---|---|---|
| (driver, | | Description |
| data layer, | Name/ID | Of |
| etc.) | (if known) | Function |
| Driver | PIP0O001 | The driver will filter all of the input |
| | | data and distribute it to the sub-module |
| | | as appropriate. The driver will also |
| | | create the Bill Round Reporting Data |
| | | file and the AR file. |
| Data Layer | BDLT09SD | Fetch FOIC, SVFG data. |
| Data Layer | BDL02SA | Read OI input BIRs. |

Tables and Descriptions:

EC/DC Tables:

| Table | |
|---|---|
| Name | Description/Content |
| BDTCE001 | File Definitions |
| CECTLEXT | External Control Groups |
| CECTLGRP | Balance Group |
| CECTLINT | Internal Control Groups |
| CECTLOPT | Some type of options control |
| | options |
| CEDRVAPP | Application Drivers |
| CEINITCT | Initialization functions |
| CEPROCES | Initialization functions |
| CEPRTDVC | Report Output Format Definition |
| CEREPORT | Report Definition |
| CERPTDVC | Report Device Definition |
| CERPTITL | Report Title Definitions |
| CERPTRLR | Report Trailer Definitions |
| CERPTTEM | Report Title Templates |
| CEWRAPUP | Wrapup Functions |
| CETHRESH | Error thresholds |
| ER | Errors |
| BDTCE001 | B2HBIR1A - Header IIR/BIRs |
| | (Output File) |
| | B2OIBR1A - OI Detail IIR/BIRs |
| | (Output File) |

Oracle Tables:

| | | CRUD | |
|---|---|---|---|
| | | (Create, | Owner |
| | | Read, | (Process |
| Table | | Update, | Web, AR, |
| Name | Description/Content | Delete) | OI, etc) |
| FOIC | Filters detail records and | Read | OI |
| | sends only records needed | | |
| | to calculate Number of Bills | | |
| | and Bill messages. | | |
| AR_SRC_RPT | AR Screen (Invoice Amount | Update | OI |
| | section) Oracle table. Will | | |
| | contain the charges by | | |
| | invoice number for each Bill | | |
| | Payer in a Billing cycle. | | |

Reports.

| | | Delivery |
|---|---|---|
| | | Method |
| | | (File NDM, |
| Report | | File web, |
| Name | Description/Content | table) |
| Adjustment | The Adjustment JV will include 5th | NDM |
| JV | user billed OC3 usage, 5th user | |
| | calculated management and admin fees | |
| | and TelMaster post invoicing | |
| | adjustments. | |
| Billing | The Billing JV will summarize all | NDM |
| JV | charges transmitted to 5th user via | |
| | the SCSS Extension files. | |
| Post | The Post-Billing Audit files | NDM |
| Billing | summarize all of 2nd User charges, | |
| Audit | 2nd User DGS Admin Fees, and other | |
| | charges billed by 5th user on all 5th | |
| | user accounts. | |
| 6th user | Create at calendar month's end | NDM |
| Monthly | summarizing all 6th user charges | |
| Service | invoiced by EBS. | |
| File | | |
| AR | Creates bill payer data that summaries | Oracle |
| Screen | how much a bill payer had on the current | Load |
| Report | month's invoice. | |

Interfaces:

| Interface | |
|---|---|
| Name | Description |
| AR | Every bill cycle, the OI Process will provide |
| | the AR repository with AR Financial Data file |
| | which will include service charges billed to |
| | the client of 2nd User, and 1st User |
| | telecommunication companies every bill |
| | cycle. Information such as DGS charges, MGMT |
| | fees, current charges, total due, and tax |
| | information will be provided through this file. |
| 1st User | The OI Process will NDM three files to 1st User. |
| 2nd User | The OI Process will NDM one file to 2nd User. |
| 3rd user | The OI Process will NDM one file to 6th user. |

Print Interface (PI):

Assumptions:

Current assumption is that the architecture does not handle dynamic file allocation. The 2 gig split files will be statically created in the PI process, for the paper stream. (This is done in the Fl process for alt media.)

Key Inputs:

| | | | Process |
|---|---|---|---|
| | Provided | Sorting | Sorted |
| Description/Content | By | Requirement | by |
| Paper Stream Format File from the Stack | Stack & | Bill Payer Id, | Stack & |
| & Burst process (Paper Bill and Remit | Burst | Master CBA Id, | Burst |
| PIR File). This file contains all the | | BTN CC Grp, Doc | |
| records that are required to create the | | Copy Nbr, Srt | |
| paper bills from the current bill round | | Seq Nbr, Rptex | |
| that will be printed in Sacramento and | | Rec Cd, Req | |
| sent to the customer. | | Seq Cd. | |
| Paper Stream Format File from the Stack | Stack & | Bill Payer Id, | Stack & |
| & Burst process (Paper Bill PIR file for | Burst | Master CBA Id, | Burst |
| eDocs feed). This file contains all the | | BTN CC Grp, Doc | |
| records that are required to create the | | Copy Nbr, Srt | |
| feed for eDocs (including additional tax | | Seq Nbr, Rptex | |
| and adjustment fields). This feed will be | | Rec Cd, Req | |
| used to build the invoice sections on the | | Seq Cd. | |
| web. | | | |
| Paper Stream Format File from the Stack | Stack & | Bill Payer Id, | Stack & |
| & Burst process (CD-ROM PIR file) | Burst | Master CBA Id, | Burst |
| | | BTN CC Grp, | |
| | | Doc Copy Nbr, | |
| | | Srt Seq Nbr, | |
| | | Rptex Rec Cd, | |
| | | Req Seq Cd. | |
| Paper Stream Format File from the Stack | Stack & | Bill Payer Id, | Stack & |
| & Burst process (FMR Monthly file) | Burst | Master CBA Id, | Burst |
| | | BTN CC Grp, | |
| | | Doc Copy Nbr, | |
| | | Srt Seq Nbr, | |
| | | Rptex Rec Cd, | |
| | | Req Seq Cd. | |
| Reprints PIR file | | | |
| See the Reprints process for more | | | |
| details. | | | |

Key Outputs:

| | Provided | Sorting |
|---|---|---|
| Description/Content | To | Requirement |
| Paper Output File | 2nd User | There must be one |
| This output file from print | Billing | File Header record |
| infrastructure contains all the | Print | for every file, and it |
| paper bill records in AFP format, | Center | must always be the |
| with NOP records. | | first record. The |
| | | Dynamic Due Date |
| | | File Header Record |
| | | must follow this. |
| EDocs Output File | EDocs | There must be one |
| This output file from print | (for the | File Header record |
| infrastructure contains all the | Web) | for every file, and it |
| paper bill records in AFP | | must always be the |
| format, with NOP records. | | first record. The |
| | | Dynamic Due Date |
| | | File Header Record |
| | | must follow this. |
| PDF/CD-ROM Output File | Burn | There must be one |
| This output file from print | Center | File Header record |
| infrastructure contains all the | (but first, | for every file, and it |
| paper bill records, in AFP | AFP file is | must always be the |
| format. This file will be | converted | first record. The |
| converted from AFP to PDF format, | to a PDF | Dynamic Due Date |
| then NDM'ed to the Burn Center, | file) | File Header Record |
| where it will be burned onto a | | must follow this. |
| CD-ROM. | | |
| FMR Monthly Output File | AFP file is | There must be one |
| This output file from print | converted | File Header record |
| infrastructure contains all the | to a PDF | for every file, and it |
| paper bill records, in AFP | file | must always be the |
| format. | | first record. The |
| | | Dynamic Due Date |
| | | File Header Record |
| | | must follow this. |

Functional Description:

The BPP2 Print Infrastructure processes a device independent input data stream. The input data stream contains formatted print information, which is translated into device specific print commands by the Print Infrastructure application. The Advanced Function Printing (AFP) is supported by the Print Infrastructure (i.e., IBM page-mode laser printing).

In short, PI's principle function is to read in sorted PIR records from the Stack & Burst processing and convert the customer bills into AFP documents. (AFP is the printer language.) How the AFP documents are processed prior to PI differs between the three streams (Paper bill, eDocs, PDF & FMR). After PI, the output files can then be sent to the Bill Print Center, to be printed and sent through the mail to the Bill Payer; or, the output files, having been converted into AFP format, can be sent to the web (which will facilitate Bill Invoice report creation) via eDocs; or, the AFP files can be converted into PDF format and sent to the St Louis Burn Center, to be included on a CD-ROM.

The output files from PI will have NOPs to delineate the start and end of each Bill Payer. The NOP records need to be embedded in the AFP stream to facilitate the following activities: 1) The Customer Address will be placed on the backside of the remittance stub by Bill Print Center (BPC). 2) The Assembler Barcodes used by the BPC enclosing machines will be placed on the backside of every physical page of the bill by BPC. 3) The QAK (Quality Assurance Key) is used by BPC print operations for error, audit, and control processes and will be placed on the backside of every physical page of the bill by BPC. Because of these requirements, the following NOP records must be created.

File Header Record

At the File Level

There must be one file header record for every file, and the file header must always be the first record.

Involves updating BFP10046/C2CX540

Dynamic Due Date (DDD) File Header Record

At the File Level

An input record that allows the Bill Print Center to populate the return DDD file with a Standard File Header Record.

Key Dynamic Due Date Fields are Cycle Number, Cycle Date, and State ID

The DDD file header record must follow the File Header record.

Involves updating BFP10046/C2CX540

Special Handling Address Information Record

At the Statement Level

This record contains the address information to mail the special handling bill back to the correct address at the SBC property responsible for processing the bill.

Involves updating BFP10048

Summary Page Introducer Record

At the Page Level

This is a non-printed AFP NOP record that identifies the beginning of the information for the summary page introducer.

Involves updating BFP10048

Address Information Record

At the Page Level

This record contains the address information.

Involves updating BFP10048

Dynamic Due Date Location Record

At the Page Level

This is an AFP NOP record, which identifies the location of the Dynamic Due Date string. This NOP record must immediately precede the corresponding print record containing the Dynamic Due Date string. This record reduces print chaining efficiency in the data file.

Involves updating BFP10049

Assembly Bar Code Location Record

At the Page Level

The Assembler Barcode is used by the BPC enclosing machines and will be placed on the backside of every physical page of the bill by BST.

Involves updating BFP10048

Remit Stub Front Begin

At the Page Level

This record is used to identify the beginning of the remit stub for disaster recovery formatting.

Involves updating BFP10051

Remit Stub Front End

At the Page Level

This record is used to identify the end of the remit stub for disaster recovery formatting

Involves updating BFP10051

Remit Stub Back Begin

At the Page Level

This record is used to identify the beginning of the remit stub on the back of the Summary page for disaster recovery formatting.

Involves updating BFP10051

Remit Stub Back End

At the Page Level

This record is used to identify the back of the remit stub on the back of the Summary page for disaster recovery formatting.

Involves updating BFP10051

Detail Page Introducer Record

Detail Page Format

This is an AFP NOP record that identifies the beginning of the information of the detail pages.

Involves updating BFP10048

Dynamic Due Date Location Record

Detail Page Format

This is an AFP NOP record, which identifies the location of the Dynamic Due Date string.

This NOP record must immediately precede the corresponding print record containing the Dynamic Due Date string.

This record reduces print chaining efficiency in the data file

Involves updating BFP10049

Quality Assurance Key (QAK) Location Record

At the Detail Page Format

This is an AFP NOP record that identifies the location of the Quality Assurance Key information string.

When statements have to be manually inserted, the production printer operators look at the QAK information string to determine which inserts to pull.

This NOP record must immediately precede the corresponding print record containing the QAK information string.

Involves updating BBF10281

Assembly Bar Code Location Record

Detail Page Format

This is an AFP NOP record, which identifies the location of the assembly bar code page control string. This NOP record must immediately precede the corresponding print record containing the assembly barcode string.

Involves updating BFP10048

Statement Trailer Record

At Statement Level

This record signifies the end of a statement to the PRINT CENTER process. It contains specific information about the statement. Every statement must have a statement trailer record.

Involves updating BFP10046/C2CX540

File Trailer Record

At File Level

This record contains the summary information needed for audit checks to ensure all data was received.

Involves Updating BFP10046/C2CX540

In order to generate these required NOP records, that will interface with the 2nd User Billing Print Center, the PI process needs additional logic in the following modules and copybooks:

Print Driver module/BFP10046

This module will parse the header record to retrieve the customer address (occurs field (6)), cycle, bill round date, and state name, and move these fields to the expanded B2CCX540 copybook. A WS-LIT character for the NOP requirement will be moved to the C2CX540 copybook when the fields of the specified NOP record have been populated. The NP detail(s) will be parsed for populated fields to support the types of NOP records this module will control which are the File Header Record, DDD File Header Record, Statement Trailer Record, and File Trailer Record.

The Total Amount Due Record can only be populated by the Collect Page module (BFP10048) and the Create Page module (BFP10050) The logic will be provided in order to interactively call the Collect Page module and the Create Page module to affect multiple TPX records.

Collect Page module/BFP10048

This module will need to be updated to remove the bar code printing on the paper bill for the enclosing machine.

It also will trap (not write out to text buffer) and parse the NP detail records, to extract fields that pertain to the NOP records this module controls. They are Summary Page Introducer Record, Address Information Record, and Detail Page Introducer Record.

This module will also contain logic to control the text buffer for multiple TPX records (although this module doesn't know of TPX records) that the Create Page module acts upon. When the page record is received a ‘Z’ is written to the text buffer followed by all the text and draw commands until the next page record is received. Control is then returned to the driver.

Begin Page module/BFP10049

This module will spool to the Output Selector module (BFP10054)the NOP File Header record and NOP Dynamic Due Date File Header record before the resources are first called. The NOP File Header record's non-default fields, will be populated by the X540 copybook. When processing moves on to the A31000-PRE-UPD-PROCESS paragraph & A32000-UPD-PROCESS paragraph, it will spool to the Output Selector, the Begin Page (includes MCF, IPS and OPS records and AFP records up to before TPX record of each AFP page) of each page in the file.

If it's a Summary page, the AFP NOP Summary Page Introducer record and NOP Address Information record will be spooled to the Output Selector module before the Begin Page AFP records. If it's a Summary page and flag has been received to write the NOP Dynamic Due Date Location record, then logic will check if start byte offset and end byte offset have been received.

If so, then the NOP Dynamic Due Date Location record is populated and spooled to Output Selector module; otherwise, a X540 flag is set for the Output Selector. Also, all but the start byte and end byte of the Dynamic Due Date Location record is populated and spooled out to the Output Selector.

When page processing begins, NOP records and AFP records are spooled out to the Output Selector. Control is then returned to the Print Driver.

Create Page module/BFP10050

This module acts upon the text buffer (page list) provided by the Collect Page module. In order to support multiple AFP TPX records, the Print Driver module will interactively call the Collect Page module. This module (BFP10050), formats the AFP buffer, then formats the AFP print record and calls the Output Selector module.

The text and draw commands will be processed until the end of the page, one or more times, resulting in another AFP TPX record being spooled out the Output Selector. Logic provided in this module (BFP10050) will find the location of the end byte for the DDD Location record. The logic will spool to the B2CCX540 copybook setting an X540 flag, so that the Output Selector can populate the end byte and write the AFP NOP DDD Location record before the AFP TPX record.

An X540 flag will be set when the remit section of the Summary page is found, for the Output Selector to act upon. When the end of page is encountered, control is returned to the Print Driver (BFP10046).

End Page module/BFP10051

This module outputs AFP records, which contain Rasters & shaded boxes, as well as the end of the logical page. Logic will be provided to write out the Remit Stub Front End AFP NOP record, Remit Stub Back Begin, and Remit Stub Back End AFP NOP record(s), when an X540 remit flag is received, after the last end page AFP record.

Output Selector module/BFP10054

This module writes out the AFP spool file from input received from the Begin Page module, the Create Page module and the End Page Module. It will monitor the X540 copybook flags set, while parsing for AFP NOP DDD LOCATION record and if flag set, populate the start and end offsets before writing. This entails providing logic that would save the NOP record and TPX record, populate the NOP record, then write out the NOP AFP record and TPX AFP record, and reinitialize the save area. This logic would only retain certain NOP record(s) and TPX record(s).

Copybook/B2CCX540

Add PI-EMEM-ADDR-GRP with PI-EMEM-ADDRS of PIC X(40) OCCURS 6 TIMES and INDEXED BY STAT-ADDR-IX to the PI-EMEM-STATS of the PI statistical counters copy book B2CCX540.

Copybook/B2CCX505

Add DOC-ADDR-GRP with DOC-ADDRS of PIC X(40) OCCURS 6 TIMES to the BATCH-FILE-HDR of the PI interface input record buffer area copy book B2CCX505.

The font codes that the Bill Print Center will use are listed below:

FONT01=H4109C

FONT02=H4108C

FONT03=H4100C

FONT04=H410AC

FONT05=H210AC

FONT06=H410DC

FONT07=H3100C

FONT08=H2108C

FONT09=H217FN

FONT10=H2109C

FONT11=H417FN

FONT12=H217FN

FONT13=H218FN

FONT14=H418FN

FONT15=H21AFN

FONT16=H41AFN

FONT17=H417SP

FONT18=H410BC

FONT19=GT14SP COPI

The file size for all of the NPM and paper (except eDocs) output files cannot be larger than 2 gigabytes. (This value will be table managed.) There is a COBOL function that exists that will facilitate the 2 gig split in PI for the paper stream (except the eDocs file) and in FI for the NPM stream. If the output file for an invoicing cycle is greater than 2 gigabytes, the process will segment the file into 2 files, each with a unique file name.

By following an algorithm, the output file is guaranteed not to be larger than 2 gigs. This method involves adding the value of the largest customer's account (which will be an estimated and table-managed value, but will be referred to as ‘x’ in this document) to the value of each incoming account. Therefore, at the end of each customer, the program will do a check and add x bytes to the total number of bytes of already processed accounts. If this number is less than the limit, another account will be read in to the file. This check will continue until the number of bytes (of already processed accounts in this run)+x bytes, is greater than the limit. When this occurs, a new file will be opened. Also, the limit will not be set at exactly 2 gigs. Instead, the formula: 2gs−y bytes (buffer)=the file limit. This is a safeguard, in case the last account read in is the largest one.

Landscape vs. Portrait.

The requirements call for the face page to be in portrait format and the rest of the bill in landscape format. In the existing functionality, the document header record contains an indicator (a table driven AFP print command) that gauges if the whole document should be in either landscape or portrait format. However, to satisfy requirements, this check of ‘landscape or portrait’ needs to be adjusted from whole document to per page. This can be accomplished by further updating the Begin Page Module (BFP10049).

1. Need to add a new medium map to handle the portrait format—the Orientation value of Medium Descriptor (MDD) must be set up as X ‘00’ for portrait format. Currently, the AFP output has only one Orientation Value of Medium Descriptor (MDD) and it is set up as X ‘01’ for Landscape format.

2. Add an Invoke Medium Map (IMM) record to invoke the new portrait medium map for each face page printing.

3. After the face page printing is complete, add an Invoke Medium Map (IMM) record to call up the landscape medium map for the remainder of the invoice.

Required NDM transmission.

New NDM jobs must be created in order to transmit the Paper PIR files out of PI to the Bill Print Center.

Paper Bill & Remit

A paper bill is sent when the customer chooses paper as media selection.

A remit is sent to the customer when paper is not chosen as media selection; instead, an alternative media was selected.

Output is in AFP format, with NOPs to delineate the start and end of each Bill Payer.

These files can be split out of PI.

These files must be NDM'ed from PI to the Bill Print Center

1 NDM job also needs to be created for the eDocs file.

AFP paper file for eDocs

Regardless of the customer's media selection, an AFP file must be created so that Bill Invoice Sections can be made available.

Output is in AFP format, with NOPs to delineate the start and end of each Bill Payer, and with the 4 extra fields that are required for eDocs.

This file is preferably not split (the output selector logic will not be utilized for the eDocs feed)

This file needs to be NDM'ed from PI to eDocs

Similar NDM jobs must be created for the alt media PDF files, from Fl to the St Louis Burn Center.

PDF file

The PDF is included on the CD-ROM and Diskette, and it will be used by the 2nd User Account Reps to see the charge that a customer is referring to when they call in to dispute or discuss charges on their paper bill.

PDFs are created when CD-ROM and Diskette are among the customers' media selections.

Output from PI is in AFP format, with NOPs to delineate the start and end of each Bill Payer.

This file can be split out of PI.

This file needs to be converted from AFP to PDF, then NDM'ed to the Bill Print Center. (This new conversion utility will be run as a part of the bill cycle. A separate instance will need to run against each split PI AFP output file.)

Process Flow Description:

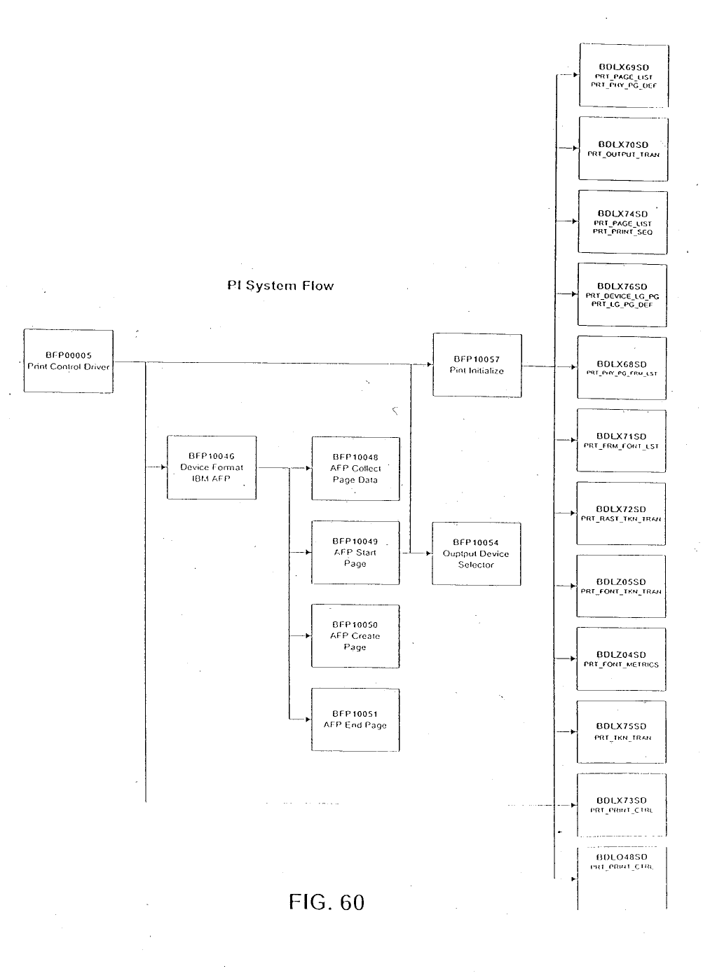

See FIG. 60 for is the level 2 process flow for PI. There will be four separate files from Stack and Burst into Print Infrastructure. One file will contain formatted and sorted Paper bill and/or remit information. One file will contain formatted and sorted bill information for eDocs. The third and fourth files will be formatted and sorted PDF files for CD-ROM and Diskette.

Process Components and Descriptions:

New Components:

| Component | | |
|---|---|---|
| (driver, | | |
| data layer, | | Description |
| etc.) | Name/ID | of Function |
| JCL | (New) | Needed to NDM files out of |
| | | PI (for the paper flow) to the |
| | | Bill Print Center. |
| JCL | (New) | New Job cards for new instances |
| | | of PI (eDocs, alt-media CD, alt |
| | | media Disk, reprint) |
| Job Cards | (New) | New job cards are required for |
| | | the AFP-PDF translation utility. |

Existing Components:

| Component | | |
|---|---|---|
| (driver, | | |
| data | Name/ID | |
| layer, | (if | Description |
| etc.) | known) | Of Function |
| Module | Print | This program controls the |
| | Control | bill/csr print process. It |
| | Driver | verifies that print record key |
| | module / | is valid and also verifies |
| | BFP00005 | that records are received in |
| | | the correct sequence. These |
| | | records, received from the |
| | | bsam access facility, are then |
| | | passed to the appropriate |
| | | device specific driver once |
| | | validated. Only print key and |
| | | sequencing validation is |
| | | performed - the data portion |
| | | itself is not validated. |
| Module | Device | Parses header records in order |
| | Format | to obtain customer address, |
| | IBM AFP | cycle, bill round date, & |
| | module / | state name, moving these fields |
| | BFP10046 | to copybook B2CCX540. Also, |
| | | parses NP details, for populated |
| | | fields, to support NOP records. |
| Module | Collect | This module will do three things |
| | Page | 1) Remove barcode printing on |
| | module / | paper bill (for the enclosing |
| | BFP10048 | machine) 2) Trap & parse NP |
| | | detail records pertaining to |
| | | the following NOP records this |
| | | module will control: Summary |
| | | Page Introducer Record, Address |
| | | Information Record, & Detail |
| | | Page Introducer Record. 3) Will |
| | | contain logic to control text |
| | | buffer for multiple TPX records |
| | | that Create Page Module |
| | | (BFP10050) acts upon. |
| Module | Begin | Module will spool to Output |
| | Page | Selector module (BFP10054) the |
| | module / | NOP file Header Record & NOP |
| | BFP10049 | DDD File Header Record |
| | | (before they're first called) |
| | | Also, spools to the Output |
| | | Selector, the Begin Page of |
| | | each page. |
| Module | Create | Formats the AFP buffer then |
| | Page | formats the AFP print record |
| | module / | and calls Output Selector |
| | BFP10050 | Module (BFP10054). Logic |
| | | provided in module will find |
| | | the location of the end byte |
| | | for the DDD Location Record |
| Module | End | Module outputs the AFP record, |
| | Page | which contains Rasters and |
| | module / | shaded boxes, as well as end |
| | BFP10051 | of the logical page. Logic in |
| | | this module is provided to |
| | | write out the Remit Stub Front |
| | | End AFP NOP record, Remit Stub |
| | | Back Begin, & Remit Stub Back |
| | | End |
| Module | Output | Writes out AFP spool file from |
| | Selector | input received from Begin Page |
| | module / | module (BFP10049), Create Page |
| | BFP10054 | module (BFP10050), & End Page |
| | | module (BFP10051) |
| Module | Print | This program is used by the |
| | Initial- | print infrastructure to load |
| | ize / | all tables Into the extended |
| | BFP10057 | memory. It will call the |
| | | appropriate data layer |
| | | modules to load all of the db2 |
| | | tables. It will also load those |
| | | tables that are vsam using the |
| | | encode/decode handler. The |
| | | Cobol array handler is used to |
| | | put all of the table rows into |
| | | the extended memory. |
| Module | PRT_PAGE_{—} | This data layer module performs |
| | LIST & | a fetch on the ppgl and pppd |
| | PRT_PHY_{—} | tables. |
| | PG_DEF | |
| | Tables / | |
| | BDLX69SD | |
| Module | PRT_{—} | This data layer module fetches |
| | OUTPUT_{—} | all rows from prt_output_tran |
| | TRAN | table for a given device type |
| | Table / | and batch effective date. |
| | BDLX70SD | |
| Module | PRT_PAGE_{—} | This data layer module will |
| | LIST | access the logical page list |
| | PRT_PRINT_{—} | table and logical print sequence |
| | SEQ Table / | table and get all the rows that |
| | BDLX74SD | have a specific device type. |
| Module | PRT_DEVICE_{—} | This data layer module fetches |
| | LG_PG | rows with matching device names |
| | PRT_LG_PG_{—} | and logical page names from the |
| | DEF Table / | prt_device_lg_pg table and the |
| | BDLX76SD | prt_lg_pg_def table. |
| Module | PRT_PHY_{—} | This data layer module fetches |
| | PG_FRM_{—} | selected rows from the |
| | LST | prt_phy_pg_frm_lst table. |
| | Table / | |
| | BDLX68SD | |
| Module | PRT_FRM_{—} | This data layer module fetches |
| | FONT_LST | all rows from the form font |
| | Table / | list table (pffl) and select |
| | BDLX71SD | rows that have a specific |
| | | device type. |
| Module | PRT_RAST_{—} | This data layer module will |
| | TKN_TRAN | read the raster token translation |
| | Table/ | table and get all rows that need |
| | BDLX72SD | to be loaded into internal memory. |
| Module | PRT_FONT_{—} | This data layer module fetches |
| | TKN_TRAN | all rows from the font token |
| | Table/ | translation table (pftt) and |
| | BDLZ05SD | select rows that have a |
| | | specific device type. |
| Module | PRT_FONT_{—} | This data layer module selects |
| | METRICS | all rows that have a specific |
| | Table / | device type from the font |
| | BDLZ04SD | metrics table |
| Module | PRT_TKN_{—} | This data layer module performs |
| | TRAN | a fetch on the prt_tkn_tran |
| | Table / | table. |
| | BDLX75SD | |
| Module | PRT_PRINT_{—} | This data layer module performs |
| | CTRL | a select on the prt_print_ctrl |
| | Table / | table to retrieve the device |
| | BDLX73SD | type for the print driver module |
| | | to call |
| Module | PRT_PRINT_{—} | This data layer module fetches |
| | CTRL | all rows from the prt_print_ctrl |
| | Table / | table (ppct) for a given device |
| | BDLO48SD | type. |
| Copybook | B2CCX540 | Copybook needs to be updated to |
| | | comply with NOP changes. |
| Copybook | B2CCX505 | Copybook needs to be updated to |
| | | comply with NOP changes. |

Tables and Descriptions:

Oracle Tables:

| | | CRUD | |
|---|---|---|---|
| | | (Create, | Owner |
| | | Read, | (Process |
| Table | | Update, | Web, AR, |
| Name | Description/Content | Delete) | OI, etc) |
| PRT_PAGE_{—} | Logical Page | | |
| LIST Table | List (PPGL) | | |
| PRT_PHY_{—} | Physical Page | | |
| PG_DEF | Define (PPPD) | | |
| Table | | | |
| PRT_OUTPUT_{—} | Output Trans | | |
| TRAN Table | Table (POPT) | | |
| PRT_PRINT_{—} | Print Sequence | | |
| SEQ Table | Table (PPSQ) | | |
| PRT_DEVICE_{—} | Device Logical | | |
| LG_PG | Page (PDLP) | | |
| Table | | | |
| PRT_LG_{—} | Print Logical | | |
| PG_DEF | Page Define (PLPD) | | |
| Table | | | |
| PRT_PHY_{—} | Print Physical | | |
| PG_FRM_{—} | Page List (PPFL) | | |
| LST Table | | | |
| PRT_FRM_{—} | Form/Font | | |
| FONT_LST | List (PFFL) | | |
| Table | | | |
| PRT_RAST_{—} | Raster Token | | |
| TKN_TRAN | Trans (PRST) | | |
| Table | | | |
| PRT_FONT_{—} | Font | | |
| TKN_TRAN | Translation | | |
| Table | Table (PFTT) | | |
| PRT_FONT_{—} | Font Metrics | | |
| METRICS | Table (PFTM) | | |
| Table | | | |
| PRT_TKN_{—} | Print Token | | |
| TRAN | Translation | | |
| Table | Table (PTKT) | | |
| PRT_PRINT_{—} | Print Control | | |
| CTRL Table | Table (PPCT) | | |

Reports.

| | | Delivery |
|---|---|---|
| | | Method |
| | | (File NDM, |
| Report | | File web, |
| Name | Description/Content | table) |
| N/A | All reports will be generated | |
| | out of AII/DI | |

Interfaces:

| Interface | |
|---|---|
| Name | Description |
| EDocs | An AFP file is created out of |
| | Print Infrastructure and sent |
| | to eDocs. |
| Burn Center | CD-ROM and Diskette PIR files |
| | sent here to be burned onto CD-ROM |
| | or Diskette respectively. |
| Bill Print | Where paper bill/remit PIR files |
| Center | are printed |
| PDF | Off-the-shelf packaged software |
| Translation | must be purchased for the translation |
| Software | of AFP files to PDF format. (For the |
| | inclusion of the paper bill image |
| | onto CD-ROM and Diskette media) |
| | Also entails creating a job in the |
| | schedule (integrated into our flow) |
| | that will handle this. |

Input/Output Files:

| | Input/ | | |
|---|---|---|---|
| Process | Output | DD Name | File Name |
| Paper E400 | Input | FTPIRECA | ${PROCESS}/ |
| | | | e0001.E350100A |
| | Output(s) | FTAFPS1A | ${PROCESS}/ |
| | | | e0001.E400100B |
| | | | (to E450) |
| | | FTPDFE1A | ${PROCESS}/ |
| | | | e0001.E400100C |
| | | FTPPSF1A | ${PROCESS}/ |
| | | | e0001.E400100A |
| Edocs E410 | Input | FTPIRECA | $ {PROCESS}/ |
| | | | e0001.E360100A |
| | Output(s) | FTAFPS1A | ${PROCESS}/ |
| | | | e0001.E410100B |
| | | | (to E460) |
| | | FTPDFE1A | ${PROCESS}/ |
| | | | e0001.E410100C |
| | | FTPPSF1A | ${PROCESS}/ |
| | | | e0001.E410100A |
| CDROM E420 | Input | FTPIRECA | ${PROCESS}/ |
| | | | e0001.E370100A |
| | Output(s) | FTAFPS1A | ${PROCESS}/ |
| | | | e0001.E420100B |
| | | | (to E470) |
| | | FTPDFE1A | ${PROCESS}/ |
| | | | e0001.E420100C |
| | | FTPPSF1A | ${PROCESS}/ |
| | | | e0001.E420100A |
| FMR E430 | Input | FTPIRECA | ${PROCESS}/ |
| | | | e0001.E380100A |
| | Output(s) | FTAFPS1A | ${PROCESS}/ |
| | | | e0001.E430100B |
| | | | (to E480) |
| | | FTPDFE1A | ${PROCESS}/ |
| | | | e0001.E430100C |
| | | FTPPSF1A | ${PROCESS}/ |
| | | | e0001.E430100A |

Rating, Fees and Taxes:

Assumptions:

Rating, DGS Admin Fee and Management Fee calculation will be based on the rates in the USOC Rate Table effective on the EBS bill day.

Management Fees only apply to usage and will not be pro-rated.

Pro-rating of DGS Admin Fees does not apply to usage, as they are minute based.

Beginning and End Dates are inclusive.

Key Inputs:

| | | | Process |
|---|---|---|---|
| Description/ | Provided | Sorting | Sorted |
| Content | By | Requirement | by |
| Non-Usage IIR | Hierarchy | | |
| file | Match | | |
| Usage IIR file | Hierarchy | | |
| | Match | | |
| Taxes & | Hierarchy | | |
| Surcharges | Match | | |
| IIR file | | | |

Key Outputs:

| Description/ | Provided | Sorting |
|---|---|---|
| Content | To | Requirement |
| Usage and Non-Usage | AII | 1. Bill Payer |
| IIRs file | | 2. BTN |
| | | 3. WTN |
| Unmatched 1st User | | 1. USOC |
| Charges Error File | | |
| Taxes & Surcharges | AII | 1. Bill Payer |
| IIR file | | 2. BTN |
| | | 3. WTN |

Functional Description:

This process has five main functions: rate the OC3 records, apply DGS and Management Fees, apply taxes, and assign fit codes.

Validation of the product is determined by the USOC existence on the USOC Rate and Product tables. Every USOC will be looked up on the USOC Rate/Product table to retrieve product information for population on the IIR.

2nd User USOCs for which there is not matching entry in USOC Rate Table will be written to an unmatched charges file. The fit code (previously assigned in Input Processing) for the record will be reassigned in order to bill the charge in the Miscellaneous Charges section of the customer invoice.

1st User charge codes that are not found on the USOC Rate Table will also be written to an unmatched charges file. The fit code (previously assigned in Input Processing) for the record will be reassigned in order to bill the charge in the Miscellaneous Charges section of the customer invoice.

1st User OC3 MRC and NRC IIR records created in the Create OC3 process will be populated with the required fields for rating but no charge amount will be included. The charge must be calculated using the information on the USOC Rate Table for the particular OC3 product. Calculation of the charge will be performed with the rate that is effective on the bill round date. (Pro-rated OC3 MRC and NRC debits/credits are also calculated at this time.)

DGS Admin Fees are calculated based on the rating information found on the USOC Rate Table (either on a flat rate or percentage basis) as of the bill round date. For 2nd User detail charges to which the DGS Admin Fee applies, the fee must be calculated and added to the total debit/credit presented on the customer bill. For 1st User detail charges to which the DGS Admin Fee applies, the fee is already included in the total charge amount sent on the input file to EBS. The Admin Fee charge will need to be identified by “reverse rating” the Admin Fee from the product charge. In both cases, the DGS Admin Fee Rate and Unit for each detail charge needs to be identified and stored for use in reporting and audit files. (Note: The billing amount on detail charges within the customer's invoice will include the DGS Admin Fee amount, rather than be presented separately. The charge amount and DGS Admin Fee will be broken out for the service representative's online view of the customer invoice.)

Management Fees (owed by 1st User to 2nd User) are collected on 1st User Intralata Toll Free calls, VNET Card calls, and VNET Long Distance traffic in specific territories. Management Fees only apply when the above three calls are Intralata and if VNET Long Distance calls are with CORP-ID of “99991334”. Intralata determination is made by a call to the NPA/NXX table. If the BELL LATAs for the ORIG-ANI and TERM-ANI are the same, then the call is classified as Intralata. If the NPA/NXX is not found, the records will have their fit code reassigned to drive to the Misc section of the invoice and the records will also be copied to the Unmatched Error file. Management Fee rates are found on the USOC Rate Table on a product basis, and are applied based on the rates effective on the EBS system date for the account being processed. The Management Fee, along with the type of Management Fee (e.g. Card), will be stored on the EBS billing record.

The process will also assign taxes to the MRC OC3 charges (NRC OC3 charges are not taxed). Admin Fees will have been added to the MRC OC3 charges prior to tax calculations as they are subject to taxation for 1st User. There are several surcharges and each must appear as separate line items on the Tax section of the customer's invoice. Each tax & surcharge record will be written to the Tax & Surcharges output file (there may be multiple for a given usage or non-usage IIR).

Fit code assignment is performed for the following types of records: OC3 charges, 2nd User unmatched charges, 1st User unmatched charges and OC3 taxes. The fit code will be assigned based on the record type.

Once all processing is complete in the Rating process, the records are sent to All for further invoice creation.

Admin/Management Fee calculation will occur as follows:

Multiply the message/summarized message duration by the Fee rate

Round the calculated usage Fee to 2 decimal places (using 5/4 rounding method)

Add the usage Fee to the individual usage detail or summarized usage

(The 5/4 rounding method will be used in all calculations. This is where EBS will round up when the number is 5 or greater and round down when the calculated number is 4 or less.)

Process Flow Description:

Files read in and sorted by USOC.

After sort, control passed to Driver.

USOC validation occurs as each record is read to retrieve product information. If found on USOC Rate Table, processing for record (rating, fees and taxes) continues.

4. If 2nd User USOC not found on table, reassign fit code on record so that charge can be written to Miscellaneous Section of invoice.

5. If 1st User charge code not found on table, reassign fit code on record so that charge can be written to Miscellaneous Section of invoice.

Unmatched 2nd User and 1st User Records are also written to error file.

OC3 MRC and NRC charges are rated.

1. OC3 MRC charges

i. OC3 MRC charges are billed for the 1^{st} to the 30^{th} of the month.

ii. Charge calculated using Quantity (found on input record) and rate data retrieved from rate table effective on the bill round date.

iii. Charge amounts are calculated using the following formulas (type of OC3 returned from call to rate table):

NRC: Quantity*Rate

MRC: Quantity*Mileage*Rate

iv. The current rate and rate units (per USOC) valid on the cycle processing date will be extracted from table and populated on the IIR.

v. Assign fit code.

2. OC3 NRC charges

i. Charge calculated rated by extracting flat rate from USOC rate table, multiplying by the quantity and populating charge on IIR.

ii. Assign fit code.

Pro-rating of OC3 MRC charges.

1. All OC3 MRC charges will be billed using a 30-day calendar.

2. Customer will only be charged for the portion of month that product was in service (date inclusive).

3. Pro-rated OC3 Debits.

i. If the Beginning Effective Date of the product is between EBS bill day and the end of the month, EBS will not create pro-rated charge until the following month.

If (Beginning Effective Date)<=30 and (established this month), then Pro-Rated Charge=(30-Beginning Effective Date+1)*Rate*Quantity*Mileage

4. Assign fit code.

Apply DGS Admin Fees.

1. Not all detail charge records in input file will have DGS Admin Fees applied; only products or services ordered as part of the 5th user contract receive the charges. The following charges will not include DGS Admin Fees:

i. Taxes, Fees and Surcharges (For 2nd User, taxes are calculated prior to DGS fee application and are included in the input records. For 1st User, taxes on the input records already include the DGS fee.)

ii. 2nd User records which indicate that the charge is not part of the 5th user contract (indicator in input record).

iii. For 2nd User, any charge that cannot be found on the USOC Rate Table will be written to an unmatched charges report and billed under the Miscellaneous Section.

6. For 1st User, any charge that cannot be found on the USOC Rate Table will be written to an unmatched charges file and reassign fit code on record so that charge can be written to Miscellaneous Section of invoice. iv.

2. Admin Fees are calculated either on a flat rate or percentage basis.

3. The DGS Admin Fee rate calculation information is found on the USOC Rate Table by USOC/charge code. The DGS Admin Fee rates used for calculation are based on the effective rate in the rate table as of the EBS bill round date.

i. For usage, the fee is calculated (Admin Fee Rate/Unit*Call Duration Units) and added to the total cost of the message.

ii. For recurring charges, the fee is found on table (Admin Fee Rate/Unit) and added to the monthly rate.

4. DGS Admin Fees for 2nd User and 4th user records.

i. Calculated only for charges covered under the 5th user contract (indicator set in input record).

ii. For eligible records, a call will be made to the USOC Rate Table using the USOC as the key. Upon return of the matching USOC from the table, the response will include the Admin Fee Rate and Unit. From this, the necessary calculations will be made in order to populate the following fields in the output record:

Charge (before Fee)

DGS Admin Fee

Total Charge (plus Fee)

Admin Fee Rate

Admin Fee Unit

iii. The Admin Fee Rate and Unit will be used for the fiscal Management Report.

5. DGS Admin Fees for 1st User and 6th user records.

i. All 1st User charges are covered under the 5th user contract.

ii. The DGS Admin Fee will have already been applied to the record in the input file. Therefore, the DGS Admin Fee will need to be “reverse” calculated in order to separate the fee from the total charge.

iii. For eligible records, a call will be made to the USOC Rate Table using the charge code as the key. Upon return of the matching charge code from the table, the response will include the Admin Fee Rate and Unit. From this, the necessary calculations will be made in order to populate the following fields in the output record:

Charge (before DGS Fee)

DGS Admin Fee

Total Charge (plus Fees)

Admin Fee Rate

Admin Fee Unit

iv. The Admin Fee Rate and Unit will be used for fiscal Management Report.

6. DGS Admin Fee Credits.

i. Credits for disconnected 2nd User charges billed in advance require that Admin Fees be credited on a pro-rated basis (assuming the product is eligible under the terms of the 5th user contract).

ii. The fee credit for 2nd User charges is calculated by making similar call to USOC Rate Table and pro-rated based on number of days the product was not in service in the previous month (passed in input record).

7. Pro-Rating DGS Admin Fees.

i. Admin Fees applied to OC3 products will be pro-rated when the charge/credit to which the fees were applied are pro-rated.

ii. Pro-rate Admin Fee Debits

If the Beginning Effective Date of an OC3 product is established between EBS bill round date and the end of the month, a pro-rated charge will not be created (and therefore an admin fee) until the next month.

If (Beg Eff Date)<=30 AND established this month, then Admin Fee Pro-Rated Charge=(30−Beg Eff Date+1)*Admin Fee Rate

Apply Management Fees.

1. Management Fees are applied only to 1st User Intralata Toll Free calls, VNET Card calls in GTE territory, and VNET Long Distance traffic in GTE territory.

2. The Management Fee is already included in the charge amount for the 1st User charge files. In order to determine the amount of the fee, it must be “reverse” calculated from the charge amount.

3. Fees will be calculated either on a flat rate or percentage basis. A call will be made to the USOC Rate Table will be made (using USOC as key) to determine the amount of the fee. Once retrieved, the fee amount will be populated in a field on the output IIR. The type of management fee (e.g. toll free) will be also be shown on the IIR.

4. Management Fees are only applied if the calls (Toll Free, VNET LD and Calling Card) are classified as Intralata.

i. The TPC-ORIG-ANI and TPC-TERM-ANI fields from the input record will be identified. The first six digits from each field (called the NPA-NXX) will be used as the key to the NPA-NXX table to retrieve the corresponding rows for the originating and terminating ANI. If the BELL-LATAs match on the two rows, the call is considered Intralata.

ii. If the NPA/NXX is not found on the NPA/NXX table, the record is assigned a new fit code and written to the Misc Section of the invoice and additionally written to the Unmatched Error file.

5. VNET Long Distance traffic in GTE territory.

i. In addition to the NPA/NXX determination, if the CORP-ID=“99991334” and the charges are for long distance, then management fees are calculated.

Applying Taxes.

1. Taxing OC3 Charges.

i. EBS will only apply taxes to OC3 recurring charges. (OC3 NRC is not taxed).

ii. The tax rates will be retrieved from a table updated by 1st User monthly.

iii. Admin Fees must have been added to the OC3 costs prior to tax calculations as they are subject to taxation for 1st User.

iv. The following surcharges apply to OC3 MRC (to be supplied by client):

| | |
|---|---|
| CA High Cost Fund Surcharge | 2.87% |
| CA Teleconnect Fund | 0.05% |
| CA Universal Lifeline Telephone | 2.40% |
| Service Surcharge | |
| CA Relay Service & | 0.25% |
| Communications Devices Fund | |
| CA PUC Fee | 0.11% |
| Total Special Surcharges | 5.68% |

v. The charge of the MRC (including any DGS Admin Fees) will be multiplied by the percentages above to result in the tax for each surcharge type.

vi. Each of the surcharges must appear as separate line items on the bill and will each have its own field in the output IIR record.

vii. The fit code assigned to the tax records will match those assigned to the non-OC3 1st User charges in the Create IIRs process.

2. Taxing 2nd User and 1st User Charges.

i. Taxes for 2nd User and 1st User (non-OC3) records will already include taxes as separate line items in the record.

ii. No calculation is necessary.

The records will be re-sorted back to Bill Payer for processing in AII.

Process Components and Descriptions:

New Components:

| Component | | | |
|---|---|---|---|
| (driver, | | | |
| data layer, | | Description | |
| etc.) | Name/ID | Of Function | |
| Driver | New | Driver will control the sub-modules | |
| | | to apply Admin/Management Fees, tax, | |
| | | and assign fit codes. | |
| | | An external copybook (sorted by USOC) | |
| | | of the USOC Rate/Product information | |
| | | will be created for quicker retrieval | |
| | | of rate information. | |
| | | If the record is OC3, modules are | |
| | | called as follows: | |
| | | Rating | |
| | | Apply Fees | |
| | | Taxes | |
| | | Fit Assignment | |
| | | If the record is not OC3, modules are | |
| | | called as follows: | |
| | | Apply Fees | |
| Rating | New | The module will process OC3 input | |
| Module | | records accordingly: | |
| | | 1. | Read first record. Move USOC |
| | | | value to WS-field. |
| | | 2. | Determine if the USOC received |
| | | | on the input record exists on |
| | | | the Rate/Product tables, |
| | | | a. If match not found, write |
| | | | record to unmatched charges |
| | | | report. |
| | | | b. If match found, rate record |
| | | | and populate required fields in |
| | | | IIR. |
| | | 3. | For MRC, create IIR for current |
| | | | billing month's charge. |
| | | | Pro-rate debit as necessary |
| | | 4. | For MRC, if service disconnected, |
| | | | pro-rate credit as necessary |
| | | 5. | Assign appropriate fit codes |
| | | | to records. |
| Apply | New | The module will process all input | |
| Fees | | records accordingly: | |
| Module | | 1. | Read first record. Move USOC value |
| | | | to WS field. |
| | | 2. | Make fetch call to USOC Rate Table |
| | | | with USOC key. |
| | | | a. If match not found, write record |
| | | | to unmatched charges report. |
| | | | 1st User: Charge is not billed. |
| | | | Record written to error file. |
| | | | 2nd User: Charge is billed to |
| | | | Miscellaneous Section. Call Fit |
| | | | Code module to reassign fit code. |
| | | | b. If match found, response will |
| | | | include Admin Fee and Management |
| | | | Fee rate info (rate and rate unit). |
| | | | Calculate Admin Fee based on |
| | | | Admin Fee Rate and Admin Fee Unit |
| | | | 2nd User: Admin Fee added to |
| | | | original charge |
| | | | 1st User: Admin Fee “reverse” |
| | | | calculated to determine original |
| | | | charge |
| | | | Calculate Mgmt Fee (if applicable) |
| | | | based on Mgmt Fee Rate and Mgmt Fee |
| | | | Unit |
| | | | Original Charge = (Total Charge) − |
| | | | (Admin Fee) − (Mgmt Fee) |
| | | | 1st User Intralata Toll Free calls: |
| | | | Call NPA/NXX table with ANI fields |
| | | | from input record |
| | | | VNET Card and Long Distance calls: |
| | | | Check values of input record to |
| | | | determine if Mgmt Fees apply |
| | | | Populate necessary fields on |
| | | | output IIR |
| | | 3. | If OC3 MRC record, call Tax |
| | | | module to apply taxes and |
| | | | assign fit codes to tax records. |
| Tax Module | New | Called by Apply Fees Module to | |
| | | determine taxes for OC3 MRC records. | |
| | | 1. | Fetch call made to 1st User Tax |
| | | | Table to return current tax |
| | | | surcharges for OC3 MRC charges. |
| | | 2. | Call Fit Assignment module to |
| | | | assign fit codes to tax records. |
| | | 3. | Assign appropriate fit codes to |
| | | | records. |

| | | |
|---|---|---|
| Create | New | Creates the Unmatched Charges Report. |
| Report | | |
| Module | | |
| Fetch | New | Fetch Data Layer to join USOC Rate and |
| USOC | | Product Tables. |
| Rate/Product | | |
| Data Layer | | |
| Fetch Tax | New | Fetch Data Layer to 1st User Tax Table |
| Data Layer | | to determine taxes for OC3 MRC charges. |

Tables and Descriptions:

EC/DC Tables:

| Table Name | Description/Content |
|---|---|
| | EC/DC table will be used for the following: |
| | NPA/NXX lookup: Contains information |
| | on the originating and terminating ANI. Used |
| | for determination if call is |
| | Intralata for purposes of Management Fee calculation. |

Oracle Tables:

| | | CRUD | Owner |
|---|---|---|---|
| | | (Create, | (Process, |
| | | Read, | Web, |
| | | Update, | AR, |
| Table Name | Description/Content | Delete) | OL, etc) |
| USOC | Contains the necessary | Read | Web |
| Rate/Product | information for rating and | | |
| Tables- | DGS Admin Fee/Management | | |
| RT_PROD,R | Fee calculation. | | |
| T_PROD_DT | Contains the product | | |
| L,SRVC_NM | descriptions by USOC. | | |
| ,SRVC_ID,P | | | |
| ROD_GRP,U | | | |
| OM | | | |
| 1st User Tax | Used for purposes of | Read | 1st User |
| Table | determining tax for | | |
| | OC3 charges. | | |

Reports.

| | | Delivery |
|---|---|---|
| | | Method |
| | | (File NDM, |
| Report | | File web, |
| Name | Description/Content | table) |
| Unmatched | List of 2nd User/1 st User USOCs that | File web |
| Charges | couldnot be matched on the USOC Rate | |
| Report | Table. Following fields to be included | |
| | in the report: | |
| | Bill ID/Corp ID | |
| | Product USOC | |
| | BTN | |
| | Extension | |
| | Charge Code | |
| | Literal | |
| | Charge Amount | |
| | Unmatched Type (USOC vs. NPA/NXX) | |

Interfaces:

| Interface | |
|---|---|
| Name | Description |
| Hierarchy | Input files sent by Hierarchy Match Process. |
| Match | |
| AII | Output file sent to AII. |
| Web | After the initial conversion (from |
| | 2nd User and 1st User), one 1st User and |
| | one 2nd User representative will have the |
| | authorization to update the USOC Rate Table |
| | via the Web interface. |
| | OC3 NRC records entered via the Web interface. |
| Create OC3 | OC3 non-usage input file rent by Create OC3 process. |

Reporting Engine Process (REP):

Key Inputs:

| | | | Process |
|---|---|---|---|
| | Provided | Sorting | Sorted |
| Description/Content | By | Requirement | by |
| Header IIR | BAI | Bill Round, | REP |
| {CYCLE_NAME}.I600MOUT.ml - | | Bill Payer | |
| Account level billing | | ID, BTN, | |
| information. This file will be | | NTWK-ACC | |
| provided to REP every bill | | | |
| round. | | | |
| Detail IIR | BAI | Bill Round, | REP |
| {CYCLE_NAME}.I600MOUT.m2 - | | Bill Payer | |
| Account detail and summary | | ID, BTN, | |
| billing information. | | NTWK-ACC | |

Key Outputs:

| | Provided | Sorting |
|---|---|---|
| Description/Content | To | Requirement |
| Monthly Reporting Header IIR | RAI | Report ID, |
| {CYCLE_NAME}.I600100A - this | | Bill Payer |
| file will contain all of the header | | |
| records that will be sent to the | | |
| RAI process. | | |
| Monthly Reporting Detail IIR | | |
| {CYCLE_NAME}.I600100B - this | | |
| file will contain all of the | | |
| detail/summary records that will | | |
| be sent to the RAI process. | | |
| 2nd User Administration Fee | WEB | None |
| Summary file | | |
| {CYCLE NAME}.I100100A - this | | |
| file will contain 2nd User's DGS | | |
| Charges, Adjustments, and Payments | | |
| for a specific EBS month. This file | | |
| will be loaded into an Oracle table. | | |
| Collection Data Summary | WEB | None |
| {CYCLE_NAME}.I200100A - | | |
| this report will provide an | | |
| automatic and manual ability to | | |
| identify accounts which are past | | |
| due. The views include a summary | | |
| of the ‘Live and Final’ | | |
| data collectively, an individual | | |
| summary of the ‘Live and | | |
| Final’ data and a summary of | | |
| the ‘Non-Categorized’ | | |
| data. This tile will be loaded | | |
| into an Oracle table. | | |
| AR Aging Report | WEB | None |
| {CYCLE_NAME}.I300100A - | | |
| this file contains information for | | |
| two reports: ARSUMOT and BASUMOT. | | |
| ARSUMOT is by the oldest dollar | | |
| {Total amount past due will go | | |
| into the Oldest bucket. BASUMOT | | |
| contains all the accounts with | | |
| an open status at the time they | | |
| are due. This file will be loaded | | |
| into an Oracle table. | | |
| Control Account Refresh file | NDM to | None |
| {CYCLE_NAME}.I400100A - | 1st User | |
| this file contains a download of | | |
| all active 1st User accounts from | | |
| the Hierarchy tables. | | |
| Daily Adjustment JV file | NDM to | As |
| {CYCLE_NAME}.I500100A - | 1st User | specified |
| this file will contains all of | | by the |
| the 1st User accounts that have | | client. |
| been adjusted. | | |

Functional Description:

From a high level perspective, the Reporting Engine Process (REP) is responsible for extracting and generating all of the data necessary to create the custom reports posted to the web and also provide reporting information for reports posted to the web by eDocs. The REP will extract and provide reporting data for the daily, and monthly reports as specified by the functional requirements.

Once the REP has extracted all of the reporting data and formatted it, the data will either be posted onto Oracle tables, sent to RAI via a flat file, or NDM directly to a specific carrier. The determining factor of how the reporting data is handled is dependent upon the report and the requirements. The web team will do two of the following in order to display the reports on the web:

1. Query the Oracle tables in order to retrieve, summarize (when necessary) and post the reporting data to the web. These reports are called ‘Custom Reports’.

2. Use eDoc's to extract and post the reporting data processed by RAI and Bill Format team. The reason some reports are sent to the RAI process whereas others are posted onto Oracle tables is dependent upon the following: The users of the EBS system expect a quick turnaround of the time it takes to display a report on the web. Many reports handled by the REP require complex summarizations in order to create all the information necessary for the report. If the summarization is too complex and will require much processing time, it will be written to a flat file and sent to RAI where it will be handled. However, if the summarization is fairly simple and would not require much processing time, it will be posted directly onto Oracle tables where the web team will run SQL to create the summaries and post the reports on the web.

Currently, REP is responsible for creating two types of reports: daily reports, and monthly reports. The daily reports are created every ‘business’ day of the week (Monday-Saturday), and the monthly reports are created once per the billing period. Because of this, the REP process is broken down into independent processes.

1. Monthly Data Process. (File to File/edoc's)

2. Monthly Table Data Process. (Table to File/Table)

3. Daily Reports. (Table to File/Table)

Monthly Data Process:

The Monthly Data Process is responsible for extracting and providing reporting data specifically for monthly reports. The Monthly Data Process will execute once per billing period. The Monthly Data Process will use the following OI process files:

Bill Round Reporting Data Files: Header IIR and Detail IIR. (One for every bill round. Approximately 19 files of each type should be expected.)

The Monthly Data Process is responsible for creating the following reports:

eDoc Reports Provided for:

sage by AgencySummary Billing

Management Fee 800/GTE/CC

Fiscal Management—Detail of Services by Agency

Fiscal Management—Summary of Services Billed

Fiscal Management—Detail of Services Billed

Fiscal Management—Summary of Services by Agency

Zero Usage

OC3 Taxation

Access Reform Reconciliation

Oracle Reports Provided for:

Management Fee Collection Detail

Monthly Table Data Process:

The Monthly Table Data Process is responsible for extracting and providing reporting data explicitly for reports requiring external process information, such as AR or Triggers/Hierarchy in order to create monthly reports.

The Monthly Table Data Process is responsible for creating the following reports:

Oracle Reports Provided for:

A/R Aging Reports (BASUMOT/ARSUMOT) reports

Collection Data Summary report

2nd User Administrative Fee Summary report

Daily Reports:

The Daily Reports Process is responsible for extracting and providing reporting data explicitly for reports requiring external process information, such as AR or Triggers/Hierarchy in order to create daily reports.

The Daily Reports Process is responsible for creating the following reports:

NDM to 1st User:

Control Account Refresh

Daily Adjustment JV

Process Flow Description:

Monthly Data Process (I600):

The Monthly Data Process produces a list of monthly reports. The reports are produced using the header & detail BIRs created from BAI and the A/R Invoice and Invoice Transaction tables.

The Monthly Data Process driver (BRP02001) will handle the following input files:

Sorted Header IIR

Sorted Detail IIR

All of the Header and Detail/Summary IIR's archived throughout the month will be sorted together and used in order to create the monthly reports. Each input record (header, detail IIR) will have an assigned FIT-CD. FIT-CD's are used to distinguish record types from one another. BRP02001's purpose is to translate the input FIT codes from billing and/or Collection to one or more RPT FIT codes. BRP02001 will further assign RPT ID's to each of the records in order for Bill Format to distinguish to know which report each of the records belong to. The translation of FIT code to RPT Fit code and the assignment of the RPT ID is done with the use of FRAM table.

Walk Through:

All header bill round files are sorted and created as one single file.

All detail bill round files are sorted and created as one single file.

As a record enters the driver, the FIT-CD is compared against the FIT-CD's located within the FIT_RPT_ASGN_MTHY (Fit Report Assign Monthly) table which is internally loaded into the driver module at the initialization stage. The FRAM table is used as a referencing guide to determine what needs to be done to each record.

The FRAM table will contain the following columns:

PROD_PROV_TCC_ID

FIT_CD

SEQREC_CT

PRT_FIT_CD

TBL_ROW_DS

TIME_STAMP

RPT_ID

When the processing records FIT-CD is matched against the FIT-CD on the FRAM table, FIT-CD reassignment takes place. The FIT-CD reassignment is necessary because of the specific summarization unique to each of the reports. Unlike the summaries that are create by the BAI, which at its most are at the bill payer level, some reports require summarization at levels such as: State, Exempt Designation, Sector, Sub Sector, and Agency. All of these levels are above the bill payer. Because of this, it is necessary to reassign FIT-CD's in such a fashion that when they enter RAI, which is responsible for creating Reporting summaries, they will be properly summarized. For example, if a certain report requires summarization of all the bill payers for a specific agency, the REP will need to identify all of the bill payers within that agency and assign them the same RPT-FIT-CD. The RAI will then sum up all of the records with the same RPT-FIT-CD in order to create the necessary summary at the agency level.

When the reassignment of the FIT-CD takes place, the record is assigned a RPT-ID, which is used for sorting by RAI and Bill Format.

This process continues to execute until all the data is processed.

Monthly Table Data Process (1100, 1200, 1300):

The Monthly Table Data process does not process any input files. This process consists of multiple independent sub-processes, which are triggered by a scheduler and use Data Layers to extract reporting data.

Each of the Monthly Table Data sub-processes is responsible for creating a specific report, thus each will contain unique business logic. Each of the sub-process will be responsible for retrieving, validating, formatting and finally writing the necessary reporting information a flat-file, which get uploaded to Oracle tables.

Walk Through:

I100-2nd User Admin Fee Summary (BRP03001):

BRP03001 will extract all of the 2nd User's DGS payments, adjustments, and charges for a particular month with the help of two data layers (BDLI31 SD, BDLI32SD). All of the necessary information is extracted from the following AR tables:

CRR_PYMT
INVC

Once all of the information is gathered, it is formatted and written to a flat file. An additional UNIX/Oracle load job I110 will load the flat file to an Oracle table (PB_ADMIN_FEE_SUMM_RPT).

I200—Collection Data Summary (BRP05001):

BRP05001 will extract all of the 2nd User's open accounts depending on the location for a particular month with the help of one data layer (BDLI61 SD). The open accounts are distributed to specific buckets depending on their time of delinquency (0-30 days, 31-60 days, . . . ). All of the necessary information is extracted from the following tables:

LOCN
USER_ACCT
BILL_PYR
INVC
INVC_TRAN

Once all of the information is gathered, it is formatted and written to a flat file. An additional UNIX/Oracle load job I210 will load the flat file to an Oracle table (COL_DAT_SUMM_RPT).

I300—AR Aging Reports (BRP06001):

BRP06001 will extract all of the 1st User and 2nd User open accounts for a particular month with the help of one data layer (BDLI62SD). This process will create two reports: ARSUMOT, BASUMOT. ARSUMOT will include a sum of all the delinquent 1st User and PacBell accounts by the oldest dollar along with the sum of the bill payers that fit into that category. BASUMOT will include a sum of all the delinquent 1st User and PacBell accounts on the date that the account is actually delinquent, along with the sum of the bill payers that fit into that category. All of the necessary information is extracted from the following tables:

BILL_PYR
INVC
INVC_TRAN

Once all of the information is gathered, it is formatted and written to a flat file. An additional UNIX/Oracle load job I310 will load the flat file to an Oracle table (AR_AGED_RPT).

Daily Reports Process (I400, I500):

The Daily Reports process does not process any input files. This process consists of multiple independent sub-processes, which are triggered by a scheduler and use Data Layers to extract reporting data.

Each of the Daily Report sub-processes is responsible for creating a specific report, thus each will contain unique business logic. Each of the sub-process will be responsible for retrieving, validating, formatting and finally writing the necessary reporting information a flat-file, which get uploaded to Oracle tables or NDM'd to a carrier.

I400—Control Account Refresh (BRP07001):

BRP07001 will extract all of the active 1st User and 1st User Joint accounts for a particular day from the hierarchy tables. All of the necessary information will be extracted from the following tables:

BILL_PYR
BILL_PYR_DTL
ADDR
BILG_TEL_NB_DTL
AGNCY
ACCT_OWN

Once all of the information is gathered, it is formatted and written to a flat file. Additional I410 job will NDM the flat file to 1st User.

I500—Daily Adjustment JV (BRP10001):

BRP10001 will extract all of the 1st User accounts that have been adjusted on a particular day. All of the necessary information will be extracted from the following tables:

BILL_PYR
INVC_TRAN
WCOM_BLNKT_ADJMT
BILG_TEL_NB_DTL
BILG_TEL_NBR

Once all of the information is gathered, it is formatted and written to a flat file. Additional I510 job will NDM the flat file to 1st User.

Process Components and Descriptions:

New Components:

| Component | | |
|---|---|---|
| (driver, | | |
| data | | |
| layer, | | Description |
| etc.) | Name/ID | Of Function |
| Driver | BRP02001 | Will read and sort all BAI output |
| | | Header and Detail IIR's for the |
| | | entire billing period. Will |
| | | reassign FIT-CD's to RAI_FIT_CD's |
| | | and assign Reporting ID's. Will |
| | | extract necessary data from the |
| | | AR Invoice tables for one a |
| | | section of the Management Fee |
| | | 800/GTE/CC report. |
| Data | BDLT03SA | Will validate, format, and write |
| Layer | | out the AR Screen (Invoice Amount) |
| | | reporting data to a flat-file. |
| Data | BDLI22SD | Fetch FRAM data. |
| Layer | | |
| Data | BDLT03SA | Read sorted Header and Detail |
| Layer | | IIR's. |
| Data- | BDLI21SD | This data layer will extract |
| Layer | | all of the 800, GTE, and |
| | | Calling Card ‘Collected’ |
| | | information for the current |
| | | month from the AR invoice tables. |
| Driver | BRP03001 | This module will call two data |
| | | layers and provide them with |
| | | information necessary to extract |
| | | 2nd User Administrative Fee |
| | | Summary reporting data from the |
| | | AR tables. This sub-module will |
| | | then validate, format, and write |
| | | the gathered reporting data to |
| | | a flat-file. |
| Data- | BDLI31SD | Extract the PacBell DGS fee paid |
| Layer | | and the date of the payment. |
| Data- | BDLI32SD | Extract the PacBell DGS fee |
| Layer | | charges and adjustments. |
| Sub- | BRP05001 | This module will call a data |
| Module | | layer and provide it with |
| | | information necessary to extract |
| | | the Collection Data Summary |
| | | reporting information from the |
| | | AR invoice tables. This sub-module |
| | | will then validate, format, and |
| | | write the gathered reporting data |
| | | to a flat-file. |
| Data- | BDLI61SD | Extract Collection Data summary |
| Layer | | data from the AR invoice tables. |
| Sub- | BRP06001 | This module will call a data |
| Module | | layer and provide it with |
| | | information necessary to extract |
| | | the AR Aging (BASUMOT/ARSUMOT) |
| | | reporting data from the AR tables. |
| | | This sub-module will then validate, |
| | | format, and write the gathered |
| | | reporting data to a flat-file. |
| Data- | BDLI62SD | Extract AR Aging data from the |
| Layer | | AR invoice tables. |
| Sub- | BRP07001 | This module will call a data |
| Module | | layer and provide it with |
| | | information necessary to extract |
| | | the Control Account Refresh daily |
| | | reporting data from the Hierarchy |
| | | tables. This sub-module will then |
| | | validate, format, and write the |
| | | gathered reporting data to a |
| | | flat-file, which will be NDM'd |
| | | to 1st User. |
| Data- | BDLI72SD | Extract all of the active 1st |
| Layer | | User and 1st User Joint accounts |
| | | from the Hierarchy tables. |
| Sub- | BRP10001 | This module will call a data |
| Module | | layer and provide it with |
| | | information necessary to extract |
| | | the Daily Adjustment JV reporting |
| | | data from the Adjustment tables. |
| | | This sub-module will then validate, |
| | | format, and write the gathered |
| | | reporting data to a flat-file, |
| | | which will be NDM'd to 1st User. |
| Data- | BDLI01SD | Extract all of the adjusted 1st |
| Layer | | User accounts for a specific |
| | | day from the Adjustment tables. |

Tables and Descriptions:

EC/DC Tables:

| Table Name | Description/Content |
|---|---|
| BDTCE001 | File Definitions |
| CECTLEXT | External Control Groups |
| CECTLGRP | Balance Group |
| CECTLINT | Internal Control Groups |
| CECTLOPT | Some type of options control |
| | options |
| CEDRVAPP | Application Drivers |
| CEINITCT | Initialization functions |
| CEPROCES | Initialization functions |
| CEPRTDVC | Report Output Format Definition |
| CEREPORT | Report Definition |
| CERPTDVC | Report Device Definition |
| CERPTITL | Report Title Definitions |
| CERPTRLR | Report Trailer Definitions |
| CERPTTEM | Report Title Templates |
| CEWRAPUP | Wrapup Functions |
| CETHRESH | Error thresholds |
| ER | Errors |

Oracle Tables:

| | | CRUD | Owner |
|---|---|---|---|
| | | (Create, | (Process |
| | | Read, | Web, |
| Table | | Update, | AR, OI, |
| Name | Description/Content | Delete) | etc.) |
| FIT_RPT_{—} | The Monthly Data Process | Read | REP |
| ASGN_MT | will use this table as a | | |
| HY | reference guide. This table | | |
| | will contain the following | | |
| | columns: | | |
| | FIT CD | | |
| | SEQ_REC_CT | | |
| | PRT_FIT_CD | | |
| | TBL_ROW_DS | | |
| | TIME_STAMP | | |
| | RPT_ID | | |
| PB_ADMIN_{—} | This table will contain | Create | REP |
| FEE_SUMM_{—} | all of the 2nd User | | |
| RPT | Administrative Fee | | |
| | Summary data. | | |
| COL_DAT_{—} | This table will contain | Create | REP |
| SUMM_RPT | all of the Collection Data | | |
| | Summary reporting data. | | |
| AR_AGED_{—} | This table will contain | Create | REP |
| RPT | all of the A/R Aging | | |
| | (BASUMOT/ARSUMOT) | | |
| | reporting data. | | |

Reports.

| | | Delivery |
|---|---|---|
| | | Method |
| | | (File NDM, |
| Report | | File web, |
| Name | Description/Content | table) |
| 2nd User | Summarize the amount of | Table |
| Administra- | administrative fees charged for | |
| tive Fee | each month, the amount of | |
| Summary | adjustments made, and the amount | |
| Report | paid to the Sate and the date | |
| | of the payment. Generate the report | |
| | at the conclusion of the month. | |
| | Display administrative fees for | |
| | 13 months; the current month plus | |
| | 12 months of | |
| | historical data. | |
| A/R Aging | The A/R Aging Report (BASUMOT) | Table |
| Reports | screen divides all 5th user accounts | |
| (BASUMOT) | by the age of delinquency and | |
| | indicates the amount owed for each | |
| | accounts receivable grouping. | |
| | Calculate the following: | |
| | Total balance per A/R grouping | |
| | Percentage grouping balance | |
| | contributes to total A/R | |
| | Count of accounts per grouping | |
| | Percentage the grouping count | |
| | contributes to the total number | |
| | of accounts with balances | |
| | Create reports as follows: | |
| | Report I provides information for | |
| | all the ‘Live’ accounts | |
| | receivable. Report IV provides | |
| | information for all 2nd User | |
| | ‘Final’ accounts. | |
| | Report V is the total accounts | |
| | receivable, which is the sum total | |
| | of Report I & IV added together. | |
| | Provide report updated monthly. | |
| A/R Aging | The Accounts Receivable Aging | Table |
| Reports | Reports ARSUMOT Screen divides all | |
| (ARSUMOT) | 5th user accounts with balances into | |
| | accounts receivable groupings by the | |
| | oldest dollar existing on each | |
| | account. Calculate the following: | |
| | Total balance per A/R grouping | |
| | Percentage grouping balance | |
| | contributes to total A/R | |
| | Count of accounts per grouping | |
| | Percentage the grouping count | |
| | contributes to the total number | |
| | of accounts with balances. | |
| | Create multiple reports as follows: | |
| | Report I provides information for | |
| | all of the ‘Live’ accounts | |
| | receivable. | |
| | Report IV provides information for | |
| | all 2nd User ‘Final’ accounts. | |
| | Report V is the total accounts | |
| | receivable, which is the sum total | |
| | of Report I and IV added together. | |
| | Provide report updated monthly. | |
| AR Screen | The Purpose of the A/R Screen is | Table |
| (Invoice | to allow the user to review the | |
| Amount) | charges on a customer invoice and | |
| Report | how the remittance was distributed | |
| | against the invoice charges. This | |
| | screen will be used in conducting | |
| | proactive collections activities | |
| | on behalf of 2nd User and 1st User, | |
| | as well as in taking to customers | |
| | who are delinquent. | |
| Collection | The Collection Data Summary report | Table |
| Data | will provide overall monthly | |
| Summary | collection effectiveness and allow | |
| Report | for identification of potential | |
| | problem areas. Provide report with | |
| | multiple views of collection data: | |
| | Summary of the ‘Live and | |
| | Final’ data collectively | |
| | Individual summary of the | |
| | ‘Live’ data | |
| | Individual summary of the | |
| | ‘Final’ data | |
| | Summary of the ‘Non- | |
| | Categorized’ data. | |
| Management | The Management Fee Report provides | Flat |
| Fee 800/ | calculated management fee dollar | file |
| Intralata/CC | amount by account billed (minus | |
| Report | credit) and Collected for 800 | |
| | Service and Intralata Toll for GTE | |
| | and Calling Card with a Revenue | |
| | Total Dollar amount by month and | |
| | Outstanding Total. | |
| OC3 | The OC3 Taxation Spreadsheet will | Flat |
| Taxation | provide an itemized history of taxes | file |
| | charged by the system related to OC3 | |
| | services on all 5th user accounts. | |
| | Provide history for all taxation | |
| | billed in a calendar month. | |
| Fiscal | Allows the user to review the | Flat |
| Management - | specific features and services | file |
| Detail of | provided to each state organization | |
| Services | for a specified invoicing month. | |
| by Agency | Report drives to the bill payer | |
| | level of detail, as well as | |
| | totaling at the state agency level. | |
| | This report is similar to the | |
| | Summary of Services by Agency, | |
| | except that individual features | |
| | and services are broken out and | |
| | that the admin fee rate and | |
| | admin fee unit are part of the | |
| | report. | |
| Fiscal | Allows the user to review the | Flat |
| Management - | services types provided to the | file |
| Summary of | overarching organizational | |
| Services | groupings (non-exempt state | |
| Billed | agencies, exempt state agencies, | |
| | higher education, and local | |
| | government & utilities) for | |
| | a specified bill month. The | |
| | report also provides a | |
| | detailed break down of the | |
| | taxes and surcharges incurred by | |
| | each organizational grouping. | |
| Fiscal | Allows the user to review the | Flat |
| Management - | specific features and services | file |
| Detail of | provided to the major groupings of | |
| Services | state organizations: state agencies, | |
| Billed | exempt agencies, higher education, | |
| | and local government & utilities. | |
| | This report is similar to the | |
| | Summary of Services Billed, except | |
| | that individual features and | |
| | services also are broken out | |
| | and the admin fee rate and admin | |
| | fee unit are part of the report. | |
| Fiscal | Allows the user to review the | Flat |
| Management - | service types and charges for | file |
| Summary of | individual bill payers, as well as | |
| Services | the service types and charges | |
| by Agency | totaled for each state agency, | |
| | for a specified invoicing month. | |
| Usage by | The Usage by Agency Report will | Flat |
| Agency | provide a monthly product usage | file |
| | summary that shows the amount each | |
| | account has been charged. Summarize | |
| | totals by each Bill Payer. Display | |
| | calculated fee separately for each | |
| | product type. | |
| | Management Fee | |
| | Administrative Fee | |
| | Summarize total account | |
| | charges by customer (bill payer) | |
| | Provide grand total of charges | |
| | billed. | |
| | Provide monthly. | |
| Summary | The Summary Billing Report will | Flat |
| Billing | provide a monthly report containing | file |
| Report | call counts, minutes and usage for | |
| | all matched and unmatched charges | |
| | and extension records sent in the | |
| | 1st User billing files each billing | |
| | cycle. | |
| | Provide monthly. | |
| Access | The Access Reform Reconciliation | Flat |
| Reform | Report will provide Control Account | file |
| Reconcil- | ID and Customer Name for all | |
| iation | extensions sent by 1st User so EBS | |
| Report | that were processed. | |
| | Created monthly. | |
| | Will be used to audit 1st User | |
| | internal Legacy system based on | |
| | the data send to SIBS. This reports | |
| | allows the 1st User account team to | |
| | audit the 1st User service location | |
| | and Corporate ID from the SCSS | |
| | billing files as well as Control | |
| | Account # and Customer Name in | |
| | the TelMaster hierarchy. | |
| Zero Usage | The Zero Usage report will provide | Flat |
| Report | a list of all extensions existing in | file |
| | EBS hierarchy, that have no usage | |
| | during a given billing period. This | |
| | is for World Com only extensions. | |
| Control | Control Account Refresh will include | Flat |
| Account | all of the active 1st User accounts | file - |
| Refresh | in the hierarchy tables. Provide | NDM |
| Report | Control Account Refresh report | |
| | daily via NDM to 1st User. | |
| Management | The Management Fee Collection | Flat |
| Fee | Detail report will provide collected | file |
| Collection | management fees from payments made | |
| Detail | during the selected time period. By | |
| Report | Bill payer. | |
| | Created Monthly. | |

Interfaces:

| Interface | |
|---|---|
| Name | Description |
| AR | The Reporting Engine Process will |
| | extract any additional reporting |
| | information from the AR tables |
| | that was not provided through the |
| | cycle data files received from |
| | the BAI Process. |
| Triggers/ | The Reporting Engine Process will |
| Hierarchy | extract any additional reporting |
| | information from the Triggers/ |
| | Hierarchy tables that was not |
| | provided through the cycle data |
| | files received from the BAI Process. |
| Rating and | The Reporting Engine Process will |
| Adjustments | extract any additional reporting |
| | information from the Adjustment |
| | tables that was not provided through |
| | the cycle data files received from |
| | the BAI Process. |
| BAI | The Reporting Engine Process will |
| | receive bill round input files |
| | from the BAI Process. |
| RAI | The Reporting Engine Process will |
| | provide the Reporting AII process |
| | with one file containing reporting |
| | data for eDoc's. |

Stack and Burst (S&B):

There are two Stack and Burst jobs that run following FT. The first part produces Print Stream Format files for the media, Paper, Edocs, CD-ROM and FMR. The second part uses the appropriate output file by media) from the first part and creates output files that are read by PI (Print Infra Structure).

Key Inputs:

| | | | Process |
|---|---|---|---|
| | Provided | Sorting | Sorted |
| Description/Content | By | Requirement | by |
| FI Paper Bill Header file - The | FI | Bill Payer Id, | S & B |
| header file contains one record | | Master CBA Id, | |
| per account and the mailing | | BTN CC Grp, Doc | |
| address information in the header | | Copy Nbr, Srt | |
| file is use to determine the | | Seq Nbr, Rptex | |
| mailing discount. Later, the | | Rec Cd, Req | |
| header and the detail file will | | Seq Cd. | |
| be sorted and combine together | | | |
| to create the paper bill print | | | |
| stream for the PI process. | | | |
| FI Paper Bill Detail file - | FI | Bill Payer Id, | S & B |
| The detail file contains Detail | | Master CBA Id, | |
| charges, summary charges, and | | BTN CC Grp, Doc | |
| total amount due. | | Copy Nbr, Srt | |
| | | Seq Nbr, Rptex | |
| | | Rec Cd, Req | |
| | | Seq Cd. | |
| FI eDocs Header file - The | FI | Bill Payer Id, | S & B |
| header file contains one | | Master CBA Id, | |
| record per account and the | | BTN CC Grp, Doc | |
| mailing address information | | Copy Nbr, Srt | |
| in the header file is use to | | Seq Nbr, Rptex | |
| determine the mailing discount. | | Rec Cd, Req | |
| Later, the header and the | | Seq Cd | |
| detail file will be sorted | | | |
| and combine together to | | | |
| create the paper bill print | | | |
| stream for the PI process. | | | |
| FI eDocs Detail file - The | FI | Bill Payer Id, | S & B |
| detail file contains Detail | | Master CBA Id, | |
| charges, summary charges, | | BTN CC Grp, Doc | |
| and total amount due. | | Copy Nbr, Srt | |
| | | Seq Nbr, Rptex | |
| | | Rec Cd, Req | |
| | | Seq Cd | |
| FI CD-ROM PDF Header file - | FI | Bill Payer Id, | S & B |
| The header file contains one | | Master CBA Id, | |
| record per account and the | | BTN CC Grp, Doc | |
| mailing address information | | Copy Nbr, Srt | |
| in the header file is use to | | Seq Nbr, Rptex | |
| determine the mailing discount. | | Rec Cd, Req | |
| Later, the header and the | | Seq Cd. | |
| detail file will be sorted | | | |
| and combine together to | | | |
| create the paper bill print | | | |
| stream for the PI process. | | | |
| FI CD-ROM PDF Detail file - | FI | Bill Payer Id, | S & B |
| The detail file contains Detail | | Master CBA Id, | |
| charges, summary charges, and | | BTN CC Grp, Doc | |
| total amount due. | | Copy Nbr, Srt | |
| | | Seq Nbr, Rptex | |
| | | Rec Cd, Req | |
| | | Seq Cd. | |
| FI FMR Header file - The header | FI | Bill Payer Id, | S & B |
| file contains one record per | | Master CBA Id, | |
| account and the mailing address | | BTN CC Grp, Doc | |
| information in the header file | | Copy Nbr, Srt | |
| is use to determine the | | Seq Nbr, Rptex | |
| mailing discount. Later, the | | Rec Cd, Req | |
| header and the detail file | | Seq Cd. | |
| will be sorted and combine | | | |
| together to create the paper | | | |
| reporting print stream for | | | |
| the PI process. | | | |
| * File is produced monthly | | | |
| FI FMR Detail file - The | FI | Bill Payer Id, | S & B |
| detail file contains Detail | | Master CBA Id, | |
| charges, summary charges, | | BTN CC Grp, Doc | |
| and total amount due. | | Copy Nbr, Srt | |
| * File is produced monthly | | Seq Nbr, Rptex | |
| | | Rec Cd, Req | |
| | | Seq Cd. | |

Key Outputs:

| | Provided | Sorting |
|---|---|---|
| Description/Content | To | Requirement |
| Paper Bill Print Stream | PI | Bill Payer Id, |
| Format File | | Master CBA Id, |
| ‘FH’ contains printing | | BTN CC Grp, |
| orientation information | | Doc Copy Nbr, |
| (landscape or portrait) | | Srt Seq Nbr, |
| ‘PG’ contains Page | | Rptex Rec Cd, |
| information | | Req Seq Cd. |
| ‘DL’ contains charges | | |
| information for one page. | | |
| ‘FT’ contains file | | |
| trailer information | | |
| eDocs Print Stream Format File | PI | Bill Payer Id, |
| ‘FH’ contains | | Master CBA Id, |
| printing orientation information | | BTN CC Grp, |
| (landscape or portrait) | | Doc Copy Nbr, |
| ‘PG’ contains Page | | Srt Seq Nbr, |
| information | | Rptex Rec Cd, |
| ‘DL’ contains charges | | Req Seq Cd. |
| information for one page. | | |
| ‘FT’ contains file | | |
| trailer information | | |
| CD-ROM PDF Print Stream | PI | Bill Payer Id, |
| Format File | | Master CBA Id, |
| ‘FH’ contains printing | | BTN CC Grp, |
| orientation information | | Doc Copy Nbr, |
| (landscape or portrait) | | Srt Seq Nbr, |
| ‘PG’ contains Page | | Rptex Rec Cd, |
| information | | Req Seq Cd. |
| ‘DL’ contains charges | | |
| information for one page. | | |
| ‘FT’ contains file | | |
| trailer information | | |
| FMR Print Stream Format | PI | Bill Payer Id, |
| File | | Master CBA Id, |
| ‘FH’ contains | | BTN CC Grp, |
| printing orientation | | Doc Copy Nbr, |
| information (landscape | | Srt Seq Nbr, |
| or portrait) | | Rptex Rec Cd, |
| ‘PG’ contains Page | | Req Seq Cd. |
| information | | |
| ‘DL’ contains charges | | |
| information for one | | |
| page. | | |
| ‘FT’ contains file trailer | | |
| information | | |
| * File is produced monthly | | |

Functional Description:

The Stack and Burst (S&B) Print Stream produces Bill and CSR batch print files for formatted, paper bills by grouping documents by format, media, and destination. The Stack and Burst Print Stream modules create batch ID and summary pages, balance control reports and the CBO statistical file. It also creates PDF records and barcodes to support the C.O.P.E. Automated Mail Processor for mechanized document enclosure.

NOP (No Operation) and Presentation Text (PTX) records will be created after processing of each header record and at the end of successful processing of all records.

The second part of Stack & Burst reads the output of the first part and generates a single output file by media in a different format. The trailer record is added in this process.

CASS Reporting.

In addition to the existing Stack and Burst logic, SIBS will need to perform address validation on all customer addresses. SIBS will use an off-the shelf utility, Finalist, to perform this function. A new job will be created to unload the customer address table, so that it may be sent as an input to the Finalist process, running in batch mode. Finalist will read each of the addresses in our Oracle table, confirm that the addresses as are correct, and create a CASS 3553 certification report. A new NDM job will then be created to transfer the CASS report to the BPC. The CASS 3553 report will be used by the BPC to obtain postal discounts. This series of jobs for CASS reporting will run in a monthly bill schedule, as the CASS report is not required each bill round.

Process Flow Description:

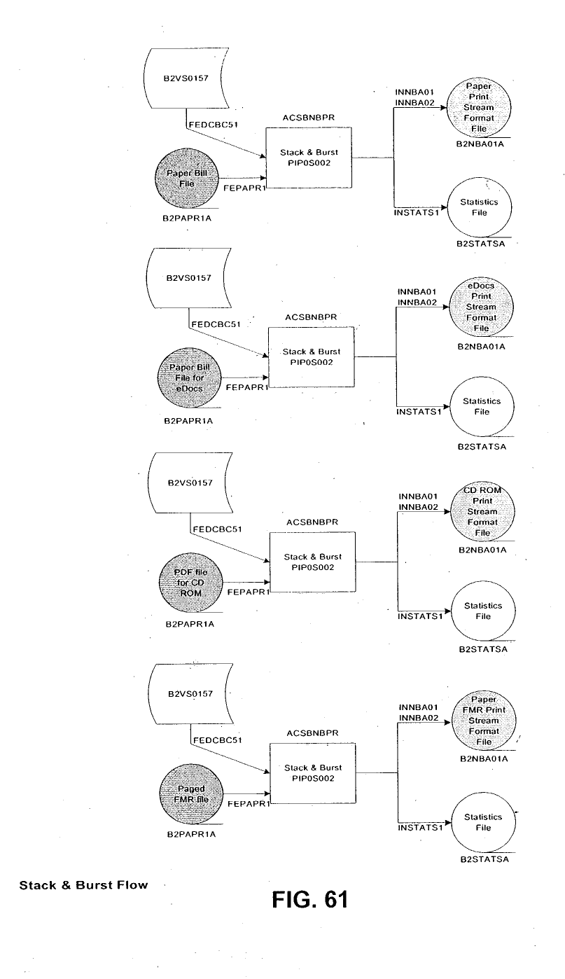

See FIG. 61 for the Stack and Burst Process Flow. Prior to being read by the Print Stream Driver module, the input files created by Format Infrastructure will be sort/merged. The resulting sorted files will be processed by the Print Stream Driver.

The Stack and Burst Print Stream Driver will read the sorted paper input files. Based on certain account characteristics each account will be batched to one of many output batch files. Batching is determined by analyzing each account's print file header and evaluating its account attributes against a pre-defined batching scheme coded in the application driver. Once the account's pre-defined batching scheme has been determined, the ultimate file where the account is batched to is determined by performing a Batch Id table search. Statistics for each batch file are updated and additional header fields are formatted for use in the downstream PT process. Corresponding statistical records are written based on each account header.

APPLICATION INIT.

During application init, the PIP0S002 driver module will initialize all working storage variables, and load the following VSAM encode/decode table:

Batch Id Table (B2VS0157)

The batch id table is loaded into a working storage table to determine Account batching, and all batch characteristics of each output file.

UPDATE PROCESS.

The two primary business functions which occur during update or transaction processing is:

a). batch file determination

b). batch file statistics

Each account's print file header (PFH) carries the necessary information to batch the account to the correct stack and burst output file.

The following records with record codes of ‘QAKCODE’ and ‘ENDPAGE’ for NOP and PTX are generated.

Batch file determination is a table/code driven process. Although an account can be batched to one of several output files, hierarchy batching logic will force the account into a specific batch file. This batching hierarchy will drive the correct encode field population for a table search on the T002-BATCH-ID-TBL.

Encode fields used in the T002-BATCH-ID-TBL:

BLG-PRVDR-TCC-ID - identifies billing company
DOC-CD - document code - Bill (b)
DOC-WT-CTGY-CD - weight category - assigned by FI
OVS-IND - overseas indicator
CNCUR-TASK-NBR - concurrent task - used to determine
process task number
BTCH-FILE-SEQ-NBR - Batch File Sequence Number

Logic driven batch determination will selectively populate certain parts of the encode/decode table key. A COBOL search will select the correct row on the T002-BATCH-ID-TBL, and contract id will be populated with the selected row's batch file contract table value.

A working storage BATCH-TOTALS-TABLE will keep running statistics and page totals for each batch (or BATCH-RUN-CD) defined in the T002-BATCH-ID-TABLE. If the batch file max. pages per file is exceeded during account processing the account records will be written to the batch file exceeding the specified file page limit—causing a warning message to be written to the exception file.

POST-UPD PROCESS.

During post update processing, account header information is used to create statistical records.

Statistics—account information for current cycle is formatted for statistics. Information includes: BLG-PRUDR-TCC-ID, acct number weight category, # of pages.

WRAPUP PROCESS.

Wrapup processing will post control information to the UACR database.

Process Components and Descriptions:

New Components:

| Component | | | |
|---|---|---|---|
| (driver, | | | NBS |
| data, | | | Components |
| layer, | | Description | to be |
| etc.) | Name/ID | Of Function | copied |
| JCL | | New table unload to dump | |
| | | the customer address table | |
| | | for address validation and | |
| | | CASS report generation. | |
| JCL | | New Job Card to kick off | |
| | | the Finalist software | |
| | | (or other address | |
| | | validation software) | |
| | | in batch mode. | |
| JCL | | New NDM job to send the | |
| | | CASS report to the BPC | |
| | | for postal discounting | |
| | | purposes. | |

Existing Components:

| Component | | |
|---|---|---|
| (driver, | | |
| data layer, | Name/ID | Description |
| etc.) | (if known) | Of Function |
| Driver | PIP0S002 | Stack and Burst Driver - Remove |
| | | the PBCF calls. |

Tables and Descriptions:

EC/DC Tables:

| Table Name | Description/Content | | | |
|---|---|---|---|---|
| EC/DC tables | To add the following entries: | | | |
| set up for | CECTLEXTBPB67A001SBREC | B67A0001 | | |
| S & B process | 0001CIBPZ670001Z6700001NBA01 | 000{NYN | 000 | Y |
| | CECTLEXTBPB67A002SBREC | B67A0002 | | |
| | 0001CIBPZ670001Z6700001NBA02 | 000{NYN | 000 | Y |
| | CECTLEXTBPZ670001Q0040 | Z6700001 | | |
| | 0005CRBPZ560005Z5650001Q0040 | 000{NYN | 000 | Y |
| | CECTLEXTBPZ670001Q0058 | Z6700001 | | |
| | 0010CRBPZ560005Z5650001Q0058 | 000{NYN | 000 | Y |
| | CECTLGRPBPZ670001 | Z6700001 | 010010YYNNNXZ670 | |
| | STACK AND BURST DRIVER CONTROLS | | | |
| | CECTLINTBPZ670001CIFP0086 | Z6700001 | 004C | |
| | CECTLINTBPZ670001CIFP0087 | Z6700001 | 005C | |
| | CECTLINTBPZ670001NBA01 | Z6700001 | 006C | |
| | CECTLINTBPZ670001NBA02 | Z6700001 | 007C | |
| | CECTLINTBPZ670001PAPR1 | Z6700001 | 003C | |
| | CECTLINTBPZ670001Q0040 | Z6700001 | 001C | |
| | CECTLINTBPZ670001Q0058 | Z6700001 | 002C | |
| | CECTLINTBPZ670001STATS | Z6700001 | 008C | |
| | CECTLOPTBPZ670001Z6700001 | | YYNNNX00380003900 | |
| | CEINITCTBPZ670001OPNBA01 | 01 | C | |
| | CEINITCTBPZ670001OPNBA02 | 01 | C | |
| | CEINITCTBPZ670001OPPAPR1 | 01 | A | |
| | CEINITCTBPZ670001OPSTATS | 01 | C | |
| | CEPROCESBPZ670 | | | |
| | BT00150000000000ACSBNBPR01 | | | |
| | CETHRESHBPZ6700012625PIP0S002 | | RPTXT | 00000000 |
| | CETHRESHBPZ670001A016PIP0S002 | | RPTXT | 00000001 |
| | CETHRESHBPZ670001A094PIP0S002 | | RPTXT | 00000001 |
| | CETHRESHBPZ670001A095PIP0S002 | | RPTXT | 00000001 |
| | CETHRESHBPZ670001A096PIP0S002 | | RPTXT | 00000001 |
| | CETHRESHBPZ670001A097PIP0S002 | | RPTXT | 00000001 |
| | CETHRESHBPZ670001A098PIP0S002 | | RPTXT | 00000001 |
| | CETHRESHBPZ670001A099PIP0S002 | | RPTXT | 00000001 |
| | CETHRESHBPZ670001A176PIP0S002 | | RPTXT | 00000001 |
| | CETHRESHBPZ670001I037PIP0S002 | | RPTXT | 00000000 |
| | CETHRESHBPZ670001O090PIP0S002 | | RPTXT | 00000001 |
| | CEWRAPUPBPZ670001CLNBA01 | 01 | A | |
| | CEWRAPUPBPZ670001CLNBA02 | 01 | A | |
| | CEWRAPUPBPZ670001CLPAPR1 | 01 | A | |
| | CEWRAPUPBPZ670001CLSTATS | 01 | A | |
| B2VS0157 - | B2VS0157BASECLT1 A | 01 | NBA10000INNBA01 | |
| Batch ID | 01NBA10000000010000000000 | | | |
| table | B2VS0157BASECLT1 C | 01 | NBA10000INNBA01 | |
| | 01NBA10000000010000000000 | | | |
| | B2VS0157BASECLT1 E | 01 | NBA20000INNBA02 | |
| | 01NBA20000000010000000000 | | | |
| | B2VS0157BASECLT1 G | 01 | NBA20000INNBA02 | |
| | 01NBA20000000010000000000 | | | |

Interfaces:

| Interface Name | Description |
|---|---|
| PI | PI will receive a four different feeds from S&B |
| | containing the Print Stream Format Information |
| | (Paper, eDocs, CD-ROM PDF, Diskette PDF). |

Input/Output Files:

| Process | Input/Output | DD Name | File Name |
|---|---|---|---|
| S & B Paper | Input(s) | FTQ0058A | ${PROCESS}/ |
| E300, E350 | | | E200100A (to E300) |
| | | FTQ0040A | ${PROCESS}/ |
| | | | E200100B (to E300) |
| | Output(s) | FTNBA01A | ${PROCESS}/ |
| | | | E300100A (to E350) |
| | | B2PAPR1A | ${PROCESS}/ |
| | | | E350100A (to E400) |
| S & B Edocs | Input(s) | FTQ0058A | ${PROCESS}/ |
| E310, E360 | | | E210100A (to E310) |
| | | FTQ0040A | ${PROCESS}/ |
| | | | E210100B (to E310) |
| | Output(s) | FTNBA01A | ${PROCESS}/ |
| | | | E310100A (to E360) |
| | | B2PAPR1A | ${PROCESS}/ |
| | | | E360100A (to E410) |
| S & B CD-ROM | Input(s) | FTQ0058A | ${PROCESS}/ |
| E320, E370 | | | E220100A (to E320) |
| | | FTQ0040A | ${PROCESS}/ |
| | | | E220100B (to E320) |
| | Output(s) | FTNBA01A | ${PROCESS}/ |
| | | | E320100A (to E370) |
| | | B2PAPR1A | ${PROCESS}/ |
| | | | E370100A (to E420) |
| S & B FMR | Input(s) | FTQ0058A | ${PROCESS}/ |
| E330, E380 | | | E230100A (to E330) |
| | | FTQ0040A | ${PROCESS}/ |
| | | | E230100B (to E330) |
| | Output(s) | FTNBA01A | ${PROCESS}/ |
| | | | E330100A (to E380) |
| | | B2PAPR1A | ${PROCESS}/ |
| | | | E380100A (to E430) |

Standardize Input Files:

Assumptions:

File Reading, Writing and Error Processing are handled by Architecture.

Key Inputs:

| | Provided | Sorting | Process |
|---|---|---|---|
| Description/Content | By | Requirement | Sorted by |
| Validated VNET File | 1st User | None | |
| Validated PLBS File | 1st User | None | |
| Validated Toll Free | 1st User | None | |
| Validated CBD North | 2nd User | None | |
| File | | | |
| Validated CBD South | 2nd User | None | |
| File | | | |
| Validated 4th user | 2nd User | None | |
| File | | | |
| Validated 6th user | 2nd User | None | |
| File | | | |
| External Control Item | Validation | None | |
| from Validation | process | | |
| Process: detail file | | | |
| charge balances | | | |

Key Outputs:

| | Provided | Sorting |
|---|---|---|
| Description/Content | To | Requirement |
| Usage IIR file | Hierarchy | 5. BTN |
| | Match | 6. Extension |
| Non-Usage IIR file | Hierarchy | 1. BTN |
| | Match | 2. Extension |
| Credits & Adjustments | Hierarchy Match | 1. BTN |
| IIR file | | 2. Extension |
| Taxes & Surcharges IIR | Hierarchy Match | 1. BTN |
| file | | 2. Extension |

Functional Description:

The purpose of this process is to read the validated files from the Validation Process, extract data required by the downstream processes and format the data into four standard Input Interface Record (IIR) copybook layouts. The process will read both 2nd User and 1st User validated files and will be initiated by the successful completion of the Validation Process. This process is part of the Pre-Processing portion of the system and will not be executed as part of the bill day cycle.

The input billing records (CBD, 6th user, 4th user, VNET, PLBS, Toll Free) contain similar data in unique formats. The logic in this process will be created to identify the location of this data on the input records and transfer it to common fields for charges, call units, quantities and other required information.

Output records will be written to four output files: usage, non-usage, credits & adjustments, and taxes & surcharges. EBS One set of these four output files will be created for each carrier billing file. The following matrix indicates the maximum number of files produced per each carrier billing file per month:

Total IIR Output Files per Carrier Input File.

| | | Non- | Credits & | Taxes & | Total IIR |
|---|---|---|---|---|---|
| File | Usage | Usage | Adjustments | Surcharges | Files |
| CBD North | 22 | 22 | 22 | 22 | 88 |
| CBD South | 22 | 22 | 22 | 22 | 88 |
| 6th user | 0 | 1 | 1 | 1 | 3 |
| 4th user | 0 | 1 | 1 | 1 | 3 |
| VNET | 1 | 1 | 0 | 1 | 3 |
| PLBS | 0 | 0 | 1 | 1 | 2 |
| Toll Free | 1 | 1 | 0 | 1 | 3 |
| | | | | Total Per | 190 |
| | | | | Month | |

The EBS bill cycles will begin on approximately the 20^{th} of every month. The number of EBS cycles will be equivalent to the number of 2nd User bill rounds received (max 22). Starting each EBS cycle will be dependent on having received the corresponding 2nd User CBD files, 6th user file, 4th user file and all of the 1st User files.

Files resubmitted from the carriers after error correction will be processed. Controls for file processing will be implemented. The process will use controls to ensure that the detail amount billed from the validated input files process equals the detail amount billed once the data has been reformatted into IIRs.

The input data will be formatted into customized versions of the Usage (B2CCT261), Non-Usage (B2CCT272), Credits & Adjustments/Payments (B2CCT284) and Taxes & Surcharges (B2CCT293) as previously stated. These layouts will contain fields necessary for populating required data from the input files, as well as fields that will be populated on bill day by downstream processes. The logic for this population will be table driven to maximize the ease of future maintenance and modification. Exception code will exist where necessary. A utility program has been created to parse the copybooks into tables.

An initial set of tables in the process will be used to determine the FIT-CD, FIT-CTGY-CD and record ID for the output IIR based on information on the input billing records. The possible fit category codes are 08 for usage, 13 for taxes and surcharges, 11 for credits and adjustments and 22 for non-usage. These values will be used as the output record ID values, and will be referenced by the downstream applications to determine the type of IIR.

A second set of tables will then contain the logic to populate the output IIR fields from the input record. Tables containing exception logic will then handle more difficult record population requirements and the combining of multiple input records into a single output record when necessary. These tables will drive processing to exception code to create multiple output records for a single input record. Instances where this sort of exception processing will take place are as follows:

1. Determine the Non-Recurring and Prorated charge type for 2nd User CBD records by checking the ‘00’ record previous to the actual charge record.

2. Populate the MRC Description Field for MRC and NRC records from the Rate table. If a match is not found on the Rate table, the description will be parsed from the FDSK filler portion of the input record.

3. Populate various fields by translating record indicators into the correct text descriptions.

4. Generate IIR records for each tax category found on the 1st User input records.

5. Set the NTWK-ACC-CD.

6. 1st User files: Translate Usage Detail Audio Conference Placed Call From and Place Called To fields based on indicator values (req 1.6.3).

7. Translate Usage Detail Toll Free Call Type field based on indicator values (1.6.4).

8. 1st User files: Translate Monthly Recurring Charge Detail Private Line Service Type field based on abbreviations (req 1.6.5).

9. 1st User files: Translate Monthly Recurring Charge Detail Line Speed field based on indicator values provided on the 1st User translation file (req 1.6.6).

10. CBD and 1st User files: Populate charge description based on USOC. Table will be provided by 2nd User. A maintenance agreement will be put in place between 2nd User to ensure that this table is kept up to date.

11. All files: Translate indicators to an equivalent domain value e.g. translate day=‘DY’ to day=‘1’.

1st User and 2nd User files will never be processed in the same stream. Each input billing file will be processed alone as a separate logical unit of work. The difference here between the Validate Input Files process is that Standardize Input files read only the billing files, not the balancing, extension or NPA/NXX files. When 2nd User and 1st User files are validated during the same period of time in separate Validation Process streams, the Standardize Input Files process will maintain these separate streams.

The process will extract the service address from 81, 82, and 87 CBD CSR records, and all PLBS records. When these records are encountered, the system will update the Service Address table if the address in the input record is different from what already exists in the table.

The process will also perform balancing operations between the IIR's generated from the 2nd User CBD/CALN files, and the 1st User VNET/Toll-Free/PLBS files respectively. This will ensure that the output-billed amounts from this process are the same as the validated amounts from the previous process. This is not a client requirement, but a safeguard to ensure all charges have been passed along properly. The process will require external control items from the Validate Input Files process in order to ensure that the total detail charges carried by the IIR records is equivalent to the carrier billing details.

Process Flow Description:

Validation Process Successfully completes validation of one of the following groups of files

7. CBD North

8. CBD South

9. 6th user

10. 4th user

11. VNET

12. PLBS

13. Toll Free

UNIX script executes once all validated files in a given group are written. A separate UNIX script will exist for each logical file group as indicated in the Validate Input Files Application Design. The scripts will be called by the scheduling system. Each script will assign a unique process ID. The Driver module will use the process ID to assign the Front End Record ID.

UNIX script will invoke the batch executive, which calls BII00051 (Driver).

Driver module identifies the file type by accessing the process id global variable.

BII00051 calls the Read/Write module (BCE150BT) and reads the input file using the appropriate contract and performs the following:

1. Identifies type of file and layout to map common area of record based on process ID.

2. Determines REC_ID as follows:

i. CBD Files: PERELINE-RCD-CD, 1^{st} two bytes of each record.

ii. 6th user: 1^{st} 2 bytes of each record.

iii. 4th user: 1^{st} 2 bytes of each record.

iv. VNET: Driver assigns ‘VNET’ (not mapped from record)

v. PLBS: Driver assigns ‘PLBS’ (not mapped from record)

vi. Toll Free: Driver assigns ‘TLFR’ (not mapped from record)

3. Calls BII00121 passing Record ID and input record.

4. Calls BII00141 passing the Record Id, the fit code, fit category code, fit mapping code, and input record

BII00101 assigns FIT_CD by performing the following

1. Identifies the first TEST_NODE_ID by accessing TOP_OF_TREE with record ID.

2. Reads the TEST NODE table to determine the FLD_NAME based on TEST_NODE_ID. FLD_NAME indicates the field on the input record that will be compared to the TEST_VALUE field on the TEST VALUE table based on the TEST_NODE_ID.

3. Perform lookup on REC_FLD table to obtain field attributes for FLD_NAME

4. TEST_VALUE is then searched by TEST_NODE_ID returning one or more rows.

5. The field on the input record indicated by FLD_NAME is compared to TEST VALUE starting with the TEST VAL_SEQ_NO=1. This comparison yields one of the following results:

i. Conditions for comparing TEST_VALUE to FLD_NAME are met. FIT_CD is populated on the row returned. In this case the FIT_CD is then assigned to the record.

ii. Conditions for comparing TEST_VALUE to FLD_NAME are met. The FIT_CD field on the row is blank but NEXT_TEST_NODE_ID is populated. Processing returns to step 2 signifying the next node in the decision tree.

iii. No match on FLD_NAME is found and there are more rows to search: FLD_NAME is compared to the next row on CMPR_FIELD_TBL.

iv. No match on FLD_NAME is found and no rows remain to search: Leads to default alley error processing for fit code assignment.

6. If a fit codes is not assigned through the above process, a default fit code will be assigned based on REC_ID through DFLT_REC_FIT_TYPE. The assignment of such a default FIT_CD will meet the following requirement: Process charge records not recognized by EBS if the process has not already abnormally terminated due to invalid data. The default fit code assigned will be mapped to the Miscellaneous Charges section of the bill.

7. FIT_TYPE table is searched with newly assigned fit code as key to assign FIT_CAT_CD and REC_ID to output record. The FIT_MAPG_TYPE_CODE will also be obtained from the table for certain records. This code will be used as a marker to drive exception processing in the code for the following:

i. Combining multiple input records into a single output record.

ii. Storing information from certain records for use by other records.

8. Returns control to the driver

BII00121 controls the logic that populates the output IIR once the FIT information has been determined. It does so in the following manner:

1. Search ASSOC_REC_FLD to populate Output IIR fields from input file data. The keys to ASSOC_REC_FLD are input REC_ID and output REC_ID (T261, T272, T284).

2. Search MAP_RULE by FIT_CD and REC_ID returning all FLD_NAMEs that require exception processing.

3. Perform exception processing on each FLD_NAME based on the MAP_RULE_TYPE_CD.

4. Because BII00141 writes out the IIR records, the MAP_RULE_TYPE_CD may be used for circumstances such as the following:

i. Saving off values or information from one record to be used in populating subsequent records.

ii. Preventing the writing out of a given record in case information from subsequent records needs to be included on it.

iii. Parsing unfielded information from unfielded areas of the input records. Examples where this will/may be necessary are the type of charge for 2nd User Adds and Changes (Add/Remove/Change/Discontinue), descriptive text from 2nd User CSR records.

iv. Parsing the comma delimited 4th user file.

5. The Mapping Rule table will be used to search and update the SVC_ADDR table. It will identify fields from the 81, 82 and 87CSR records that contain service address data and the FLD_NAME that carries the information to the bill. Exception processing in a separate module will load the SVC_ADDR table into internal memory and search it for each record. It will determine whether the address in the table has changed and update it if it has.

BII00141 controls the logic that populates the remaining IIR fields that could not be populated via the Related Record field because special logic needs to be performed prior to the field population. This module is responsible for writing out the IIR files. The following objectives are accomplished with this module:

1. Searches the Map_Rule table for the Map-Rule-Type-cd. Based on the Map-Rule-Type-cd a multitude of actions may occur:

a. ECDC table lookups for service address info

b. Fit code and Fit Type IIR population

c. Revenue Amount Calculations

Based on the Fit-Mapg-Cd, which is passed by the driver, is used to perform record level processing and serves primarily as a tag.

Process Components and Descriptions:

New Components:

| Component | | | |
|---|---|---|---|
| (driver, | | | |
| data layer, | | Description | |
| etc.) | Name/ID | Of Function | |
| UNIX | A100.ksh | This Script will be responsible for the | |
| Script | | following: | |
| | | 1. | Reading validated CBD North files. |
| | | 2. | Passing Process ID to architecture and |
| | | | calling BII00051. |
| | | 3. | Control Reading of CBD North input files |
| | | 4. | Control Writing of CBD output files. |
| UNIX | A110.ksh | This Script will be responsible for the | |
| Script | | following: | |
| | | 1. | Reading validated CBD South files. |
| | | 2. | Passing Process ID to architecture and |
| | | | calling BII00051. |
| | | 3. | Control Reading of CBD South input |
| | | | files. |
| | | Control Writing of CBD output files. | |
| UNIX | A120.ksh | This Script will be responsible for the | |
| Script | | following: | |
| | | 1. | Reading validated 6th user South files. |
| | | 2. | Passing Process ID to architecture and |
| | | | calling BII00051. |
| | | 3. | Control Reading of 6th user South input |
| | | | files. |
| | | Control Writing of 6th user output | |
| | | files. | |
| UNIX | A130.ksh | This Script will be responsible for the | |
| Script | | following: | |
| | | 1. | Reading validated 4th user South files. |
| | | 2. | Passing Process ID to architecture and |
| | | | calling BII00051. |
| | | 3. | Control Reading of 4th user South input |
| | | | files. |
| | | Control Writing of 4th user output files. | |
| UNIX | A140.ksh | This Script will be responsible for the | |
| Script | | following: | |
| | | 5. | Reading validated VNET files. |
| | | 6. | Passing Process ID to architecture and |
| | | | calling BII00051. |
| | | 7. | Control Reading of VNET South input |
| | | | files. |
| | | Control Writing of VNET output files. | |
| UNIX | A150.ksh | This Script will be responsible for the | |
| Script | | following: | |
| | | 8. | Reading validated PLBS files. |
| | | 9. | Passing Process ID to architecture and |
| | | | calling BII00051. |
| | | 10. | Control Reading of PLBS input files. |
| | | Control Writing of PLBS output files. | |
| UNIX | A160.ksh | This Script will be responsible for the | |
| Script | | following: | |
| | | 11. | Reading validated Toll Free files. |
| | | 12. | Passing Process ID to architecture and |
| | | | calling BII00051. |
| | | 13. | Control Reading of Toll Free input files. |
| | | Control Writing of Toll Free output files. | |
| Driver | BII00051 | Module will perform the following: | |
| | | 1. | Identify input file based on process ID |
| | | | from calling UNIX script. Process ID will |
| | | | be used to determine the file type (e.g. |
| | | | VNET, CBDN etc)_by looking it up on the |
| | | | FILE_TYPE EC/DC table. |
| | | 2. | Call architecture module to open files |
| | | | and read records. |
| | | 3. | Identify record type based on file type |
| | | | and record attributes. |
| | | 4. | Map or assign input FE_RCD_ID. |
| | | 5. | Call BII00121 passing input record. |
| | | 6. | Contain default error processing. |
| Module | BII00101 | Assigns fit code using iterative process | |
| | | described in the process flow section of | |
| | | this document: | |
| | | 1. | |
| | | 2. | Reads FIT_TEST_NODE TABLE to get first |
| | | | TEST NODE ID. |
| | | 3. | Reads FLD_NAME_TBL to get FLD_NAME. |
| | | 4. | Reads REC_FLD to get attributes for |
| | | | FLD_NAME. |
| | | 5. | Reads FIT_TEST_VAL to determine if |
| | | | FIT_CD can be determined or if another |
| | | | TEST_NODE_ID is required. |
| | | 6. | At end of decision process one or |
| | | | more fit codes may be assigned. The module |
| | | | will loop from this point to populate |
| | | | and write an IIR for each fit code |
| | | | returned. |
| | | 7. | Once FIT_CD is determined the module |
| | | | reads FIT_TYPE table to determine and |
| | | | populate FE_REC_ID for output record and |
| | | | FIT_CAT_CD, and FIT_MAPG_TYPE_CODE. |
| | | 8. | Search and assign default FIT from |
| | | | DFLT_REC_FIT_TYPE if necessary. |
| Module | BII00121 | Populates IIR record using tables-driven | |
| | | system described in the process flow | |
| | | section of the document. | |
| | | 1. | Search join of REC_FLD and RLTD_REC_FLD |
| | | | (ASSOC_REC_FLD_ATTR) to populate similar |
| | | | and related fields on the output IIR from |
| | | | the input record. |
| Module | BII00141 | This module will handle any exception | |
| | | logic relating to the population of the | |
| | | IIR fields. It will be called by BII00121 | |
| | | based on the entries in MAP_RULE. | |
| | | Responsibilities of this module that have | |
| | | already been determined: | |
| | | 1. | Populate IIR fields that require |
| | | | exception logic. Most instances of |
| | | | this are found in the CBD mapping |
| | | | document. This document should be |
| | | | used for detail design. |

| | | |
|---|---|---|
| | | Search and update the SVC_ADDR table. |
| | | It will identify the CSR records (81, |
| | | 82 and 87) that contain service address |
| | | data and the FLD_NAME that carries |
| | | the information to the bill. |
| Data layer | BDLA10SD | Retrieve rows from TOP_OF_TREE |
| Module | | |
| Data layer | BDLA11SD | Retrieve rows from TEST_NODE |
| Module | | |
| Data layer | BDLA12SD | Retrieve rows from REC_FLD |
| Module | | |
| Data layer | BDLA13SD | Retrieve rows from TEST_VAL |
| Module | | |
| Data layer | BDLA14SD | Retrieve rows from FIT_TYPE |
| Module | | |
| Data layer | BDLA15SD | Retrieve Rows from DFLT_REC_FIT |
| Module | | |
| Data layer | BDLA16SD | Retrieve rows from MAP_RULE |
| Module | | |
| Data layer | BDLA19SD | Retrieve rows from ASSOC_REC_FLD |
| Module | | |
| Data layer | BDLA22SD | Update Extension Table with |
| Module | | Service Address |
| Copybook | BIIPARSE | Parse Input and IIR copybooks |
| Parser | | into tables. |

Tables and Descriptions:

EC/DC Tables:

| Table | |
|---|---|
| Name | Description/Content |
| Various | Modifications will be required to |
| | multiple architecture encode/decode |
| | modules. |
| DECD_INPT_{—} | Contains key field(s) based on the |
| VAL | contents of DECD_KEY_FLD for a given |
| | FLD_NAME on the encode side. The |
| | decode side of the table contains |
| | the value/literal to be populated in |
| | FLD_NAME. This would be used for |
| | translation of a 1 on the input to |
| | an ‘A’ or some text string on |
| | the output. The population of this |
| | field must correspond to the |
| | DECD_KEY_FLD which is called based |
| | on the entries in MAP_RULE. The USOC |
| | translations and 1st User text |
| | population logic will exist in this |
| | table. |
| MSTR_CALDR | Contains bill round/file arrival |
| | information for 1st User and 2nd |
| | User input files. |
| FILE_TYPE | The file type EC/DC table will contain |
| | process id as the encode key and file |
| | type as the decode return value. This |
| | table will be read by the Driver module |
| | in order to determine the type of file |
| | being processed i.e. VNET, PLBS, CBDN, |
| | CBDS etc. |
| CEINIT | |
| CEPROCESS | |
| CEWRAPUP | |
| CETHRESH | Threshold for error processing. |
| BDTCE001 | File Definitions - application specific |
| | entries |
| CECTLEXT | External Control Groups - application |
| | specific entries |
| CECTLGRP | Balance Group - application specific |
| | entries |
| CECTLINT | Internal Control Groups - application |
| | specific entries |
| CEINITCT | Initialization functions - application |
| | specific entries |
| CEPROCES | Initialization functions - application |
| | specific entries |
| ER | Errors |

Oracle Tables:

| | | | CRUD | |
|---|---|---|---|---|
| | | | (Create, | Owner |
| | | | Read, | (Process |
| Table | | | Update, | Web, AR, |
| Name | Description/Content | | Delete) | OI, etc.) |
| TOP_OF_{—} | This table begins the fit assignment process by | | Read | Front |
| TREE | matching the initial record ID from input records | | | End |
| | to an initial TEST_NODE_ID. It contains the | | | |
| | following rows. Key fields are designated by (K). | | | |
| | 1. | REC_ID(K). | | |
| | 2. | SEC_NBR | | |
| | 3. | TEST_NODE_ID | | |
| | 4. | TIME_STMP. | | |
| | 5. | UPDT_LOGN. | | |
| | Table will be indexed to prevent | | | |
| | duplicate keys and to allow binary searching. | | | |
| TEST_NODE | This table matches TEST_NODE_ID to FLD_NAME. | | Read | Front |
| | FLD_NAME is not the actual Cobol name of the | | | End |
| | input record. Table containing the following | | | |
| | rows. Key fields are designated by (K). | | | |
| | 1. | TEST_NODE_ID (K). | | |
| | 2. | FE_FLD_NAME. | | |
| | 3. | TIME_STMP. | | |
| | 4. | UPDT_LOGN. | | |
| | Table will be indexed to prevent duplicate keys | | | |
| | and to allow binary searching. | | | |
| TEST_VAL | This table compares values on the input record to | | Read | Front |
| | values in the TEST_VAL field to determine | | | End |
| | whether a FIT_CD should be assigned or if | | | |
| | another TEST_NODE_ID is required. It contains | | | |
| | the following rows. Key fields are designated by | | | |
| | (K). | | | |
| | 1. | TEST_NODE_ID (K). | | |
| | 2. | TEST_VAL_SEQ_NBR | | |
| | 3. | BEG_EFF_DATE | | |
| | 4. | END_EFF_CT | | |
| | 5. | FIT_CD | | |
| | 6. | NEXT_TEST_NODE_ID. | | |
| | 7. | TEST_VAL_OPRND_CD: | | |
| | | ‘=‘,’<‘,’>‘,’>=‘, ’<=‘,’*’ | | |
| | | Values indicate the type of comparison that | | |
| | | will take place. | | |
| | 8. | TEST_VAL. | | |
| | | Contains text or numerals for comparison to input | | |
| | | records. | | |
| | 9. | SEC_TEST_VAL. | | |
| | Contains text or numerals for comparison to input | | | |
| | records. | | | |
| | 10. | RNG_TEST_IND. {‘Y’,’N’} | | |
| | | Value indicates whether a range test will take | | |
| | | place. | | |
| | 11. | DFLT_ALLEY_IND | | |
| | 12. | TIME_STMP. | | |
| | 13. | UPDT_LOGN. | | |
| | Table will not be indexed since it | | | |
| | will be possible for multiple rows to exist for | | | |
| | each TEST_NODE_ID. | | | |
| REC_FLD | Table contains field attributes. Key fields are | | Read | Front |
| | indicated by (K). This table will most likely be | | | End |
| | the same table that the BPP2 tables and formatting | | | |
| | teams use to contain their parsed copybooks. The | | | |
| | name of the table may change when this is decided | | | |
| | for sure. | | | |
| | 1. | FE_REC_ID | | |
| | 2. | FLD_NAME (K) | | |
| | 3. | RULE_SEQ_NBR - increments beginning | | |
| | | with first line of copybook. | | |
| | 4. | BEG_EFF_DATE | | |
| | 5. | END_EFF_DATE | | |
| | 6. | ELEM_LVL - indicates level in copybook. | | |
| | 7. | ELEM NAME - COBOL name. | | |
| | 8. | ELEM_TYPE - | | |
| | 9. | PIC_TYPE - Alphanumeric, Numeric | | |
| | 10. | ELEM_LEN - compressed length (if | | |
| | | compressed) otherwise same as INT_LEN | | |
| | 11. | INT_LEN - uncompressed length | | |
| | 12. | PRCSN_LEN - number of significant digits | | |
| | | past the decimal point. | | |
| | 13. | OCCURC_MAX - number of occurrence | | |
| | | fields | | |
| | 14. | COMPRS_YC - Spaces or 3 depending on | | |
| | | whether compressed or not. | | |
| | 15. | ELEM_LOCN- offset | | |
| RLTD_REC_{—} | This table maps the input copybook fields to | | Read | Front |
| FLD | output copybook fields for related fields, which | | | End |
| | are fields that carry the same data but have | | | |
| | different Cobol field names. | | | |
| | 1. | SOURCE FE_REC_ID | | |
| | 2. | SRC_FLD_NAME | | |
| | 3. | BEG_EFF_DATE | | |
| | 4. | END_EFF_DATE | | |
| | 5. | TARGET FE_REC_ID (T261, T272, T284) | | |
| | 6. | FLD_ORD_CD | | |
| | 7. | TIME_STMP | | |
| MAP_RULE | Controls exception processing for the population | | | |
| | of the IIR fields. | | | |
| | 1. | FIT_CD (K). | | |
| | 2. | FE_REC_ID (K). | | |
| | 3. | FLD_NAME | | |
| | 4. | FLD_ORD_CD - indicates occurrence. | | |
| | 5. | BEG_EFF_DATE. | | |
| | 6. | END_EFF_DATE. | | |
| | 7. | MAP_RULE_TYPE_CD | | |
| | Indicates one of the following possibilities: | | | |
| | | Encode Decode table lookup for population. | | |
| | | Sequencing | | |
| | | Constant value. | | |
| | | Call Module for exception processing | | |
| | 8. | Constant Value | | |
| | 9. | Encode Decode Table | | |
| | 10. | Exception Module Name | | |
| | 11. | Time Stamp | | |
| FIT_TYPE | Table contains fit descriptions, FE_REC_ID for | | | |
| | output records, and FIT_CAT_CD. | | | |
| | 1. | FIT_CD | | |
| | 2. | IN_FE_REC_ID | | |
| | 3. | FIT_CAT_CD | | |
| | 4. | OUT_FE_REC_ID | | |
| | 5. | BEG_EFF_DATE | | |
| | 6. | END_EFF_DATE | | |
| | 7. | FIT_DESC_1 | | |
| | 8. | FIT_MAPG_TYPE_CODE - This field will | | |
| | | tag input records to control the following: | | |
| | | a. Combining Records together | | |
| | | b. Performing exception logic. | | |
| DFLT_REC_{—} | This is the last stop for processing that is | | | |
| FIT_TYPE | unable to locate the correct fit code through | | | |
| | normal processing or default alley. It assigns | | | |
| | a fit code based on the input FE_REC_ID on a | | | |
| | one-to-one basis. | | | |
| | 1. | FE_REC_ID (K) | | |
| | 2. | BEG_EFF_DATE | | |
| | 3. | END_EFF_DATE | | |
| | 4. | FIT_CD | | |
| | 5. | TIME_STMP | | |

Reports.

| | | Delivery |
|---|---|---|
| | | Method |
| | | (File NDM, |
| Report | | File web, |
| Name | Description/Content | table) |
| Balancing | Will describe by BTN or file the | Process |
| Discrepancy | areas where the IIR balancing does | termination |
| Report | not equal the balancing results of | Report |
| | the Validation Process | |

Interfaces:

| Interface | |
|---|---|
| Name | Description |
| Validation | Provides validated carrier input |
| Process | files |
| Hierarchy | Hierarchy Process reads the three |
| Process | output files of the Standardize Input |
| | Files process. |
| Web Team | The web has access to the SVC_ADDR |
| | table for creating on line reports. |

Create Triggers (Bill Day Process):

Assumptions:

One unique Bill Payer Number will be created for each Bill Payer. This number will be the key across many of the customer tables. In addition, downstream processes (AR and Adjustments) will use the Bill Payer Number as their unique identifier for each Bill Payer.

The Sector Name, Sub-Sector Name, and State Name for each Bill Payer will be derived from the Agency Id by downstream processes. The attributes and values for these levels within the Customer Hierarchy will be stored in there own data sources

The Web team will generate the Control Account Id number during the Bill Payer's initial account setup.

11 Reporting Extract and Format Triggers will be created for the monthly reports and sent to RAI and RDI respectively.

All 1st User standalone extensions will have an associated BTN (Account Number) at level 6 within the Customer Hierarchy.

A Web trigger will be created for each Bill Payer per Bill Round regardless of other media selections.

If Paper is not chosen as Media Package type, the Bill Payer will automatically receive a Remit Bill.

Key Inputs:

| | | | Sorting | Process |
|---|---|---|---|---|
| | | Provided | Require- | Sorted |
| Description/Content | | By | ment | by |
| Bill Payer Hierarchy | | 1st | None | N/A |
| Information table | | User/2nd | | |
| (BILL_PYR, BILL_PYR_DTL). | | User | | |
| Contains key customer account | | | | |
| information such as the Bill | | | | |
| Payer's: Control Account Id, | | | | |
| Bill Round, Bill Round Date, | | | | |
| Bill Payer Number. | | | | |
| Customer Hierarchy tables: | | 1st | None | N/A |
| 1. | Agency Hierarchy | User/2nd | | |
| | Info Table (AGNCY) | User | | |
| 2. | (BILL_PYR, BILL_PYR_DTL) | | | |
| | Customer Hierarchy | | | |
| | BTN Table (BILG_TEL_NB_DTL). | | | |
| 3. | Customer Hierarchy | | | |
| | Extension Table (EXTN). | | | |

| | | | |
|---|---|---|---|
| These tables contain the Bill | | | |
| Payers account and detail level | | | |
| information. Levels 1-7 of | | | |
| the Customer Hierarchy, in | | | |
| additionthey contain attributes | | | |
| at each level. | | | |
| Customer Address table (ADDR). | 1st | None | N/A |
| Contains all Bill Payer address | User/PB | | |
| information that will be added | | | |
| to the Format trigger during | | | |
| invoice creation. | | | |
| Customer Media Package and | 1st | None | N/A |
| Format tables (MPBP MPDF and | User/PB | | |
| DFMG). | | | |
| The RMED table contains the | | | |
| media option information for | | | |
| a specific Bill Payer such as; | | | |
| media option type, copy count, | | | |
| and delivery option. | | | |
| The MPDF table contains the | | | |
| Media Package ID, Media Option | | | |
| ID and Document Format Option | | | |
| ID. All used by FI in | | | |
| downstream invoice creation. | | | |
| The DFMG table contains | | | |
| specific information about | | | |
| each media option used by FI | | | |
| in downstream invoice creation. | | | |

Key Outputs:

| | Provided | Sorting |
|---|---|---|
| Description/Content | To | Requirement |
| Billing Extract Trigger. This trigger | BAI, AR, | Agency Id, |
| will be created for all Bill Payers | Adjustments, | Bill Payer, |
| per Bill Round contained within the | and Create | BTN, and |
| customer hierarchy and sent to | OC3 | Extension |
| Accounts Receivable (AR), 1st User OC3, | | |
| and Adjustments. | | |
| One record per Bill Payer. This file | | |
| contains the Bill Payer to State | | |
| hierarchy data (levels 1-5) and | | |
| the Bill Payers Invoice Number. The | | |
| hierarchy information on this record | | |
| will determine the summary breaks in | | |
| BAI. | | |
| Hierarchy Match Extract Trigger. This | Hierarchy | Bill Round, |
| trigger will be created for each Bill | Matching | Agency Id, |
| Payer containing all levels of the | process | Bill Payer, |
| customer hierarchy (levels 1-7) | | BTN, and |
| and used during the hierarchy matching | | Extension |
| process. One trigger will be created | | |
| for each Bill Payer per Bill Round | | |
| within the valid effective dates. | | |
| Billing Format Trigger. This trigger | DI | Bill Payer, |
| will be created for each Bill Payer | | BTN and |
| and sent to Distribute (DI). The | | Extension |
| Billing Format Trigger will be | | |
| generated based on the customer media | | |
| options and customer billing address | | |
| as well as Media Option addresses. | | |
| One Billing Format Trigger will be | | |
| created for each Bill Payer per media | | |
| option. (Note: multiple billing format | | |
| triggers will be created if multiple | | |
| media choices are selected by the Bill | | |
| Payer, see table in section 1.5.3.3) | | |
| Billing Report Format Trigger. | RDI | Report Id |
| This trigger is generated during the | | |
| creation of the Billing Format Triggers. | | |
| The Billing Report Format Triggers are | | |
| report specific and will only be created | | |
| for the 11 monthly reports once per | | |
| month. | | |
| Billing Report Extract Trigger. This | RAI | Report Id |
| trigger is generated during the creation | | |
| of the Billing Extract Triggers. The | | |
| Billing Report Extract Triggers are | | |
| report specific and will only be created | | |
| for the 11 monthly reports once per month. | | |

Functional Description:

The Trigger process creates three different types of Extract triggers (Billing Extract, Hierarchy Match Extract, and Billing Report Extract), and two types of Format triggers (Billing Format, and Billing Report Format). The Trigger process is run each bill round and generates the triggers needed by Hierarchy Matching and downstream processing.

The Billing Extract and Billing Format trigger types will be created for each record at the Bill Payer level 5 within the Customer Hierarchy (see the Levels of Customer Hierarchy table below).

One Billing Extract Trigger will be created for each Bill Payer per Bill Round and sent to BAI, AR, Create OC3, Adjustments, and Reporting containing account level information (levels 1-5 within the customer hierarchy). The Report generation process will use the Billing Extract Triggers based on a Report Id that is designated for reports. Generally, one Billing Format Trigger will be created for each Bill Payer and sent to DI. The Billing Format Trigger will be generated based on the customer media options and customer billing address, as well as, Media Option addresses. In addition to the type of media, the attributes of the media type including the number of copies per media will be determined within this process. One Billing Format Trigger will be created for each Bill Payer per media option. For example, if a Bill Payer has 3 alternative billing media, there will be 3 different Format Media Triggers created, one for each media type. (see the “Media Option Trigger Sourcing” section below for a more detailed explanation of the number of Format Triggers that will be created for each media option selected). The Report generation process will use the Format Triggers based on a unique media option designated for reports.

One Hierarchy Match Extract Trigger will be created for each Bill Payer containing all levels of the customer hierarchy and used during the hierarchy matching process.

Levels of Customer Hierarchy.

| Level | 2nd User | 1st User | Notes |
|---|---|---|---|
| 1 | State Level | State Level | Stored in the Agency Id. |
| 2 | Sector | Sector | Stored in the Agency Id. |
| 3 | Sub-Sector | Sub-Sector | Stored in the Agency Id. |
| 4 | Agency | Agency | Stored in the Agency Id, |
| | | | has an exempt or non- |
| | | | exempt indicator. |
| 5 | Bill Payer | Control Account | All records are mapped to |
| | | | Bill Payer \ Control |
| | | | Account. |
| 6 | BTN | Account | |
| 7 | Extension | Extension | The Extension Type will |
| | | | be used as part of the key |
| | | | for each Extension. |

Process Flow Description:

Initiate Bill Cycle Process.

The details and timing around the initiation of the Bill Cycle will be further explained in the Technical Design document. The process will ensure that SIBS has received all required files from 1st User and 2nd User before starting Bill Day processes. A check will be required against the Master Day Calendar table to verify that all 2nd User and 1st User files have been received. The first SIBS Bill Round cannot commence until SIBS has received data from the first 2nd User, 6th user, and 4th user bill round, and has received all of 1st User files. SIBS will receive 1st User files on the 20^{th} of each month.

When the Start Bill Cycle process starts, it will review the input files, perhaps by fetching the data from the inventory tables. When the process identifies that all inputs have been received the cycle begins normally.

When the Create Trigger process starts and finds that there are missing input files, the process will remain dormant for a period of time (likely 24 hours). After waiting for a period of time, the job will re-execute and again search for all of the input files. This process will continue until all input files have been received and validated. Note, this process will be determined in the operating principles document.

Obtain Bill Payer Information.

The first step in the Hierarchy Match Triggers pre-process is to obtain general Bill Payer information from the Bill Payer Hierarchy Info Tables (BILL_PYR and BILL_PYR_DTL) using a fetch datalayer and select datalayer called by the driver module. This customer information will allow SIBS to identify what Bill Payers are scheduled to receive a bill on the current Bill Round. The SIBS Bill Round Date and Bill Round Number, which are derived from the SIBS Master Calendar file, drive this process. The Bill Payer's: Bill Round Number, Bill Round Date, Control Account Id and Bill Payer Number are the more important values that will be retrieved.

Create Extract Triggers.

Three different types of Extract Triggers will be created: Hierarchy Match, Billing, and Report. The Hierarchy Match process will use the Hierarchy Extract Trigger to match Bill Payers to Extensions. One Hierarchy Match Extract Trigger will be created for each Bill Payer per BTN/Extension per Bill Round. The Billing Extract Trigger will be sent to the following downstream processes: BAI, Create OC3, and Adjustments. One Billing Extract Trigger will be created for each Bill Payer per Bill Round. The Report Extract Trigger will have the same format as the Billing Extract and is used to create 11 monthly reports. One Report Extract Trigger will be created for each of the 11 reports per Month. These 11 report extracts will be created during processing on the 20^{th} Bill Round

Hierarchy Tables.

Several key tables will be maintained for the Customer Hierarchy processing: Agency Hierarchy (AGCY), Customer Hierarchy Bill Payer tables (BPYR and BPDL), Customer Hierarchy BTN (BTND), and Customer Hierarchy Extension (EXTN). A parent to child relationship exists between all hierarchy tables. For example, the BPYR table will contain Agency Ids (parent) and its associated Bill Payer Numbers (child). The BTN table will contain Bill Payer Numbers (parent) and its associated BTNs. The EXTN table will contain BTNs (parent) and its associated Extensions/Type (child). A more detailed look at the association between the Hierarchy tables will be contained in the Technical Design document for this process.

See the Table section “Oracle Tables” below for an explanation of each table and its attributes.

Create Hierarchy Match Extract Trigger.

In order to match the extensions and BTNs from the input records to their respective Bill Payers, the Hierarchy Match Extract Trigger will be created. Hierarchy Match Extract will contain the Bill Payer information from all levels (1-7) of the customer hierarchy including: Live/Final Indicator, Invoice Number, Agency Id, Agency Name, Bill Payer Number, Bill Payer Name, BTNs, and Extension/Types. This data will be extracted from the Customer Hierarchy Tables.

The Hierarchy Match Extract Trigger is created by associating the information contained on the Trigger Request file with the BTNs and EXTNs on the BTND and EXTN tables. The Assign Bill Round Extract driver BCC00150 retrieves the information contained on the Trigger Request file off of the BPYR, BPDL, and AGCY tables. This driver calls a fetch and a select datalayer to retrieve levels 1-5 of the hierarchy. Levels 6 and 7 (BTN and EXTN) are retrieved in the Create Hierarchy Match Extract Trigger process by driver BCC00050. The driver calls two fetch datalayers to retrieve all EXTN and BTN information for each Bill Payer.

The Bill Payers hierarchy information will be sent to the Hierarchy Matching and the Create OC3 process where the extensions and BTNs contained in the Hierarchy Matching Extract Triggers will be matched with the extensions and BTNs from the input files. If an extension or BTN match occurs, the customer information contained in the extract (which was pulled from the customer tables) will be added to the input IIR. If a match cannot be found then an unmatched scenario will result (see section 1.5.4). The layout for the Hierarchy Match Extract Triggers will be the same as the Billing Extract Trigger.

Create Billing Extract Trigger.

A Billing Extract Trigger will be created for each Bill Payer per Bill Round. The account level information for all Bill Payers contained in the Trigger Request file will be moved to the Billing Extract Trigger for each Bill Payer. The account level information is defined as the Bill Payer to State Level (levels 1-5) and their attributes within the Customer Hierarchy. An Invoice Number will also be created and added to the trigger. These Billing Extract Triggers will be sent to AR, and Adjustments for processing.

Generate Invoice Number.

As mentioned above a unique Invoice Number will be generated per Bill Round per Bill Payer receiving an invoice. The Invoice Number will be included in the Billing Extract Trigger that is sent to downstream processes.

The Invoice Number will be created using an PL/SQL function Sequence Number. Each time the number is referenced it will be incremented by one. The number is an 8-digit alphanumeric field beginning with a “T”, and followed by 7 unique digits, for example T1234567.

Create Billing Report Extract Trigger.

One Billing Report Extract trigger will be generated for each of the 11 monthly reports per month. Thus, only 11 Billing Report Extract Triggers will be created per month. These triggers will be generated during normal processing on the 20^{th} Bill Round and sent to RAI for report generation. The same process mentioned above to create the Billing Extract Trigger will be used to create the Billing Report Extract Trigger. The layout for this trigger will be the same as that of the normal Billing Extract Trigger. The Report Id field will serve to distinguish between a normal Billing Extract Trigger and Billing Report Extract Trigger.

Create Billing Format Trigger.

A Billing Format Trigger will be created for each Bill Payer per Bill Round. The number of Format Triggers created is dependent upon the media packages selected.

Two separate processes (Customer Media Options and Format Customer Address) will be used to create the Format Trigger. The Create Format and Extract Triggers sub-module will call a fetch datalayer to pull the Bill Payer's media options, including the address for each media option, per Bill Payer from the Customer Media Option tables (MPBP, MPDF and ADDR). In addition to the media options per Bill Payer, the Format Trigger will also contain information regarding number of copies of that media type that will be sent. Moreover, media specific data will be pulled from the Customer Format Media Group (DFMG) table that is used by the Format Infrastructure (FI) process.

If the customer needs or chooses a Remit Media Option, the Address Fetch datalayer will retrieve the Bill Payer's address information from the Customer Address table (ADDR). The Remit Bill will not have an address associated with it. The Remit will use the Bill Payer address. The Create Format and Extract Trigger module will use the media option and address feeds to create the Billing Format Trigger. This trigger will be sent to the Distribute (DI) process.

Create Billing Report Format Trigger.

One Billing Report Format trigger will be generated for each of the 11 monthly reports per month. Thus, only 11 Billing Report Format Triggers will be created per month. These triggers will be generated during normal processing on the 20^{th} Bill Round and sent to RDI for Report Formatting. The same process mentioned above to create the Billing Format Trigger will be used to create the Billing Report Format Trigger.

For reports, each report will have a different Format Trigger created. All reporting triggers will have the same Media Option ID (equal to report). Likewise, the Format Option ID for each report will be a unique value, representing the Report type or ID that needs to be created. These Media and Format Option ID combinations will drive the mapping and creation of each unique report, and they will ensure that each report is created and sent to EDOCs as a separate output file, per our requirements. The layout for the trigger will be the same as that of the Billing Format Trigger.

Media Option Trigger Sourcing.

Several relationships exist between the supported SIBS media types.

A Web Invoice will be created for each Bill Payer, thus a Web trigger will be created for each Bill Payer per bill round.

Logic within the program will ensure that no duplicate triggers are sent to DI.

The paper media type will be created for each Bill Payer unless an alternate media is selected. A Bill Payer may choose the paper media type plus an additional alternate media. If this scenario exists a Format Trigger will be created for each alternate media selected, and a “Paper” trigger will be created for the paper media.

A Bill Payer may have any number of medias, and the medias that the Bill Payer wants will be managed in the RMED and DFMG tables, and added or removed as required via the web interface. As a result, if a Bill Payer orders alt media with NO paper, then an update via the web team will remove the required Paper row from the RMED table. As a result, the Create Billing Format triggers process will not need to perform any suppression logic.

A “Remit” trigger will be created for all Bill Payers except those selecting a paper invoice. A face page and remit stub (with amount due included) will be sent to each Bill Payer not receiving a paper or Web invoice. A “Remit” trigger will be created for Web Only Bill Payers.

If a Bill Payer orders CD-ROM, without a “Paper” invoice, a “Remit” trigger will be created. If the Bill Payer orders “Paper” plus any other media, or they just receive their invoice via the “Web”, a “Remit” trigger is not needed.

It is important to note that if multiple alternate media are selected, an indicator will be set in the create Billing Format Trigger process to ensure only one Format Trigger is created for the remit and Web media types.

A Format Trigger will be created for the PDF media type if the Bill Payer requests either the CD-ROM media. The “PDF” trigger will contain an indicator to distinguish it between CD-ROM.

Format Trigger Sourcing Table.

The table below associates the Customer Media Options across its related media types and describes the conditions associated with that media option. A Billing Format Trigger will be created according to the matrix below for each Bill Payer. For example, if the Bill Payer selects the CD-ROM media option (column one, row three), three Format Triggers will be created: a trigger to create the CD-ROM, a trigger for the PDF media option contained on the CD-ROM, and a trigger for the Remit stub.

| | | Total # of | | | # |
|---|---|---|---|---|---|
| | Media | Triggers | | | of |
| # | Option | created | | Condition(s) | Mailings |
| 1 | Web | 1. | Web | Web Trigger activates | 1 |
| | | | Trigger | AFP file to create the | |
| | | 2. | Remit | Web version of invoice. | |
| | | | Trigger | | |
| 2 | Paper | 1. | Paper | Paper is the default | 1 |
| | | | Trigger | media type.• | |
| | | 3. | Web | | |
| | | | Trigger | | |
| 3 | CD- | 1. | CD-ROM | When customer chooses | 2 |
| | ROM | | Trigger | CD-ROM, the PDF version | |
| | | | | of the bill will also be | |
| | | 1. | PDF (CD) | sent (on the CD). | |
| | | | Trigger | | |
| | | 2. | Web | The face page and remit | |
| | | | Trigger | stub (with amount due | |
| | | 3. | Remit | included) will be sent to | |
| | | | Trigger | the customer. | |

| | | | | |
|---|---|---|---|---|
| 6 | Reports | 1 | One Format Trigger will | N/A |
| | | | be created for 11 monthly | |
| | | | reports. | |

Process Components & Description:

New Components

| Component | | | |
|---|---|---|---|
| (driver, | | | |
| data layer, | | Description | NBS Components |
| etc.) | Name/ID | Of Function | to be copied |
| Create | (new) | Creates the SUDs file by | SD200100 |
| Current | | accessing the Master | |
| Day file | | Calendar Table to retrieve | |
| | | the information for the | |
| | | BBS Cycle Number | |
| Assign | (new) | Creates a file with all | BCC00150 |
| Bill | | Bill Payers and their | |
| Round | | Account Level information | |
| Extract | | for those scheduled to | |
| | | receive a bill for the | |
| | | specified bill round. | |
| Datalayer | (new) | Retrieve rows from Bill | BDLBV2SD |
| | | Payer Hierarchy Tables | |
| | | (BPDL and BPYR). Fetch | |
| | | datalayer that retrieves | |
| | | general Bill Payer | |
| | | information, including | |
| | | Bill Payer name, address | |
| | | id, agency id, and other | |
| | | bill payer information | |
| Datalayer | (new) | Retrieve rows from Agency | BDLB03SD |
| | | table (AGCY). Select | |
| | | datalayer that retrieves | |
| | | the agency name and nasp | |
| | | id. | |
| Driver | (new) | Create Hierarchy Match | BCC00050 |
| Module | | Extract trigger used in | |
| | | the Matching process. File | |
| | | contains BTN and/or | |
| | | Extension level | |
| | | information for each Bill | |
| | | Payer from module BCC00150. | |
| Datalayer | (new) | Retrieve rows from BTND | BDLI69SD |
| | | table. Fetch datalayer | |
| | | that retrieves the BTN | |
| | | _CUST_CD and PB_COSVC | |
| Datalayer | (new) | Retrieve rows from EXTN | BDLB01SD |
| | | table. Fetch datalayer | |
| | | that retrieves the EXTN | |
| | | and EXTN TYPE CD | |
| Datalayer | (new) | Retrieve rows from ADDR | BDLT96SD |
| | | table (ADDR) used to | |
| | | create the REMIT Format | |
| | | Trigger. | |
| Driver | (new) | Controls Hierarchy Match | BFP00002 |
| Module | | Extract and creation of | |
| | | Billing and Format Extract | |
| | | triggers. | |
| Sub | (new) | Create Format and Extract | BFP10003 |
| Module | | Triggers for BPP2 | |
| Datalayer | (new) | Retrieve rows from | BDLT48SD |
| | | DSL_FRMT_MEDIA_GRP (DFMG), | |
| | | MEDIA_PCKG_DSL_FRMT_MEDIA_{—} | |
| | | ASSN (MPDF), | |
| | | MEDIA_PCKG_BILL_PYR_ASSN | |
| | | (M PBP) AND ADDR(ADDR) | |
| | | tables. Fetches customer | |
| | | media options off the | |
| | | Customer Media Option | |
| | | tables and the Address | |
| | | table that will be used | |
| | | in the Format Extract | |
| | | Trigger. | |
| Sub | (new) | Used to create the unique | BDLB04SD |
| Module | | Invoice Number per Bill | |
| | | Payer per Bill Round Date.. | |
| | | Put on the Billing Extract | |
| | | and Format Trigger sent to | |
| | | BAI. | |
| Datalayer | (new) | Retrieve rows from CHAG | |
| | | Customer Hierarchy table | |
| Datalayer | (new) | Retrieve rows from CHAX | |
| | | Customer Hierarchy table | |
| Datalayer | (new) | Retrieve rows from CHAB | BDLI69SD |
| | | Customer Hierarchy table | |

Tables and Descriptions:

Oracle Tables

| Table | | | | | |
|---|---|---|---|---|---|
| Name | Description/Content | | | CRUD | Owner |
| CHAB | Customer Hierarchy BTN table. | | | Read | Triggers |
| | BILL_PYR_NBR | Bill Payer Number | | | |
| | BLL_TEL_NUM | Billing Telephone Number | | | |
| | CUST_CD_BTN | Customer Code | | | |
| | EFF_START_DT | Effective Start Date | | | |
| | EFF_END_DT | Effective End Date | | | |
| | PB_COSV | 2nd User Class of Service | | | |
| | | (Optional) | | | |
| | CSR_ID | User ID of last modification | | | |
| | TIME_STMP | Last time stamp of last access. | | | |
| CHAX | Customer Hierarchy Extension table. | | | Read | Triggers |
| | BTN_TEL_NUM | BTN | | | |
| | EXTN | Extension | | | |
| | EX_TYP_IND | Telephone type indicator | | | |
| | | CARD | Calling Card | | |
| | | CIRCKT | T-1, circuit | | |
| | | CONF | Conf. ID | | |
| | | OC3ATM | OC3 ATM service | | |
| | | OC3DSO | OC3 DS service | | |
| | | OC3FR | OC3 FR service | | |
| | | TF | Toll Free | | |
| | | WTN | Working Tel Numb / | | |
| | | ANI | | | |

| | EFF_START_DT | Effective Start Date | | |
|---|---|---|---|---|
| | EFF_END_DT | Effective End Date | | |
| | CSR_ID | User ID of last modification | | |
| | TIME_STMP | Last time stamp of last access | | |
| CHAP | Bill Payer Hierarchy Information Table. | | Read | Triggers |
| | Contains general | | | |
| | Bill Payer information. | | | |
| | BILL_PYR_NBR | Bill Payer Number | | |
| | BILL_RND_NBR | Bill Round Number | | |
| | BILL_PYR_NM | Bill payer name | | |
| | BNK_RTNG_NMBR | Bank Routing Number | | |
| | BNK_ACCT_NMBR | Bank Account Number | | |
| | NASP_ID | NASP Identifier | | |
| | CNTL_ACCT_ID | Control Account identifier | | |
| | FAX_NBR | Facsimile Number | | |
| | ACCT_FNL_CD | Account Final Code | | |
| | CRR_CD | Carrier Code | | |
| | PB_FNL_BILL_DT | 2nd User final bill date | | |
| | MCI_FNL_BILL_DT | 1st User final bill date | | |
| | BEG_EFF_DT | Beginning Effective Date | | |
| | END_EFF_DT | Ending Effective Date | | |
| | CSR_ID | User ID of last modification | | |
| | TIME_STMP | Last time stamp of last access | | |
| CHAG | Account Level Hierarchy table, which | | Read | Triggers |
| | includes levels 1 to 5 of the customer | | | |
| | hierarchy information. | | | |
| | BILL_PYR_NBR | Bill Payer Number | | |
| | AGNCY_NM | Agency Name | | |
| | EXMPT_IND | Exempt Indicator | | |
| | AGNCY_ID | Agency Identifier | | |
| | BEG_EFF_DT | Beginning Effective Date | | |
| | END_EFF_DT | Ending Effective Date | | |
| | NASP_ID | National Sales Person Id | | |
| | CSR_ID | User ID of last modification | | |
| | TIME_STMP | Time Stamp | | |
| MPBP | Customer Media Option Table. Contains | | Read | Triggers |
| | customer's media options including | | | |
| | number of copies. | | | |
| | BILL_PYR_NBR | Bill Payer Number | | |
| | MEDIA_PCKG_ID | Media Package ID | | |
| | | WEB = 1 | | |
| | | Paper = 2 | | |
| | | CD ROM = 3 | | |
| | | PDF = 4 | | |
| | | Remit = 5 | | |
| | ADDR_ID | Address ID | | |
| | DOC_FRMT_OPTN_ID | Document Format Option Id | | |
| | QT | Media Copy Count (Quantity) | | |
| | MEDIA_DLVY_OPT_CD | Media Delivery Option Code | | |
| | | USPS = 1 | | |
| | | UPS = 2 | | |
| | | Fed Ex = 3 | | |
| | BEG_EFF_DT | Beginning Effective Date | | |
| | END_EFF_DT | Ending Effective Date | | |
| | MDFD_USER_NM | NMUser ID of last modification | | |
| | MODFD_DT_TM | Last time stamp of last access | | |
| DFMG | Customer Format Media Group table. Contains Media | | Read | Triggers |
| | specific information that will get sent to FI. | | | |
| | DOC_FRMT_OPTN_ID | Document Format Option Id | | |
| | MEDIA_OPT_ID | Media Option ID | | |
| | | AFP = 1 | | |
| | | Media = 2 | | |
| | | Report = 3 | | |
| | Rep | Report = 6 | | |
| | DOC_FRMT_CD | Document Format Code | | |
| | DOC_CD | Document Code | | |
| | BEG_EFF_DT | Beginning Effective Date | | |
| | END_EFF_DT | Ending Effective Date | | |
| | CSR_ID | User ID of last modification | | |
| | TIME_STMP | Last time stamp of last access | | |
| ADDR | Customer Address table. | | Read | Triggers |
| | ADDR_ID | Address ID | | |
| | ADDR_LN_1 | Address line one | | |
| | ADDR_LN_2 | Address line two | | |
| | ADDR_LN_3 | Address line three | | |
| | CITY | City | | |
| | STATE | State | | |
| | ZC | Code | | |
| | PSTL_CRR_CD | 3 Carrier Route Code | | |
| | CRNT_DT_TM | 1 Current Date/Time Stamp | | |

| | | | |
|---|---|---|---|
| CWEB | Web media reference table. | REF | Triggers |
| | CUST_MEDIA_OPT | | |
| | ZQZ | | |
| CPPR | Paper media reference table. | REF | Triggers |
| | CUST_MEDIA_OPT | | |
| | ZQZ | | |
| CROM | CD_ROM media reference table. | REF | Triggers |
| | CUST_MEDIA_OPT | | |
| CRPT | Report media reference table. | REF | Triggers |
| | CUST_MEDIA_OPT | | |
| CPDF | PDF media reference table. | REF | Triggers |
| | CUST_MEDIA_OPT | | |
| | ZQZ | | |

Interfaces:

| Interface | |
|---|---|
| Name | Description |
| BAI | One Billing Extract Trigger for each |
| | Bill Payer to create invoice rolled up |
| | to each level within the customer |
| | hierarchy. |
| RAI | One Report Billing Extract Trigger for |
| | each of the 11 monthly report created |
| | in RAI. |
| AR | One Billing Extract Trigger for each |
| | Bill Payer |
| Adjustments | One Billing Extract Trigger for each |
| | Bill Payer |
| Create OC3 | One Billing Extract Trigger for each |
| | Bill Payer |
| DI | One Billing Format Trigger for each |
| | Bill Payer/Media |
| RDI | One Report Billing Format Trigger for |
| | 11 each of the monthly reports. |
| Web | Web team will update the Customer |
| | tables. |
| Hierarchy | Hierarchy Match Extract Trigger |
| Match | |

Account Receivable:

Assumptions:

Account Teams (CSR's) will be notified of and will handle any short payments.

Account Teams (CSR's) will be notified of and will handle issues related to associating bill payers to payments when the lockbox receives insufficient information from the bill payer.

BTN is the lowest level at which payment will be sent to carriers. 1st User charges will be remitted at the Bill Payer level. The BTN is left blank on the Bill Payer Payment table if it's not available. 2nd User charges will be remitted at the BTN level.

For the purposes of this document, a carrier is any entity to which EBS remits payment separately. This includes 2nd User, 1st User, and 1st User Toll Free Management Fees.

For 2nd User, BOSS is used as their system of record and for 1st User, EBS is used as their system of record.

Lockbox is able to handle mail payments as well as EDI payments.

In the cases of no remit stub, the lockbox has the ability to manually key in Bill Payer Numbers if one is apparent on the check or included correspondence.

Key Inputs:

| | | Sorting | Process |
|---|---|---|---|
| | Provided | Require- | Sorted |
| Description/Content | By | ments | by |
| Bank Payments File - contents | Bank | None | |
| requiredare Bill Payer Number, | | | |
| Payment Date, and Amount of | | | |
| Payment. This information is | | | |
| used to create the Bill Payer | | | |
| Payment table and trigger | | | |
| invoice payments and payments | | | |
| to the carriers. It contains | | | |
| the results of mail payments | | | |
| and EDI transactions. | | | |
| Bill Payer Table- contains all | Hierarchy | None | |
| the valid bill payers. The | & Triggers | | |
| Validate Bank Payment process | & Web | | |
| checks the bill payer from the | | | |
| Bank Payment file against the | | | |
| Bill Payer table to ensure that | | | |
| the bill payer is valid. If the | | | |
| bill payer is invalid, the Bill | | | |
| Payer Number will be set to | | | |
| null. | | | |
| Record of payment configuration | Carrier | | |
| and bank routing information | Detail | | |
| for each carrier that will be | Table | | |
| paid separately. | | | |
| Extract Triggers File - contains | Hierarchy | None | |
| the account and hierarchy | & Triggers | | |
| information with one line per | | | |
| bill payer. This file determines | | | |
| which bill payers will be pulled | | | |
| during the Billing Extract | | | |
| process. The Billing Extract | | | |
| process extracts Previous Balance | | | |
| and Previous Payments for a given | | | |
| bill payer in the Extract | | | |
| Trigger. | | | |
| Billing Invoice File - contains | OI | Bill | J13X |
| one record for every BTN per | | Payer | |
| carrier for a particular bill | | Fit | |
| round. This file contains total | | Code | |
| balance, current charges, current | | | |
| line item charges, taxes, and | | | |
| 2nd User line item base | | | |
| adjustments. This file is used | | | |
| to load the Invoice and Invoice | | | |
| Transaction tables. This | | | |
| information tells how much of | | | |
| each payment should be | | | |
| distributed to each carrier. | | | |

Key Outputs:

| | Provided |
|---|---|
| Description/Content | To |
| Payment History File - contains | BAI |
| all payments and the previous balance. | |
| Provides input to the billing cycle. | |
| One record per previous balance and | |
| one record per individual payment will | |
| write out to the file. Each type of | |
| record will have its own Fit Code. | |
| Record of all payments received from | Bill Payer |
| the bill payers. | Payment Table |
| Record of BTN level details of each | Invoice |
| bill produced from all bill rounds. | Transac- |
| Provides a record of all charges, | tion Table |
| payments, credits, and adjustments | |
| pertaining to the invoices. The | |
| open amount for an invoice is | |
| represented by the sum of all the | |
| rows for an invoice number. | |
| Record of Bill Payer level details | Invoice |
| for each invoice along with its | Table |
| status and point in time balance. | |
| Record of carrier level detail for | Carrier |
| every payment that is to be made | Payment |
| from EBS to the carriers. One row | Table |
| is written to this table when the | |
| Process Carrier Payment process | |
| identifies payments applied to | |
| invoice charges that need to be | |
| transferred to the carriers. The | |
| Produce Carrier Payments process | |
| will read this table and create | |
| ACH transactions based on the | |
| information in it. | |
| Carrier Transaction File - contains | Bank |
| information for each necessary | |
| transaction to remit payments back to | |
| the carriers. This file is produced by | |
| the Produce Carrier Payments process. | |
| This file will be sent via the ACH | |
| interface to the bank as a set of 820 | |
| ACH transactions and will contain the | |
| BTN level detail for 2nd User and Bill | |
| Payer level with the Control Account | |
| Number for 1st User. This file contains | |
| one record for each ACH transaction | |
| that is to be created. | |

Functional Description:

This application is responsible for fulfilling all the requirements associated with the following:

storing amounts owed from each invoice by carrier

receiving and storing payment information from all sources including the bank lockbox process and EDI transactions.

applying payments to the correct open invoice(s) by carrier

receiving adjustments and credits made against the invoices by carrier

distributing bill payer payments to the carriers

providing payment and previous balance information to the billing process

providing a resource for other processes to get payment related information (i.e. online processes and reporting)

These requirements will be fulfilled in several manners. A set of database tables will store the invoice information, payment information, and adjustments to the invoices. The payment batch cycle will receive payments and distribute those payments to the carriers. The billing batch cycle will provide the invoice information needed to load into the tables. It will also trigger the extract of payment and previous invoice information for bill processing. Finally, the web interface and reporting teams will utilize the data present from the other processes; the web interface will provide additional information to A/R for adjustments.

Process Flow Description:

Batch Processing—Billing.

The Load Invoice Tables process receives a Billing Invoice file per bill round containing invoice details from the Billing batch cycle and loads them into the Invoice and Invoice Transaction tables. The Billing Invoice file will contain a line with the current charges for each carrier at the BTN level; the row will include Bill Payer Number, Control Account ID, BTN, Invoice Number, Carrier, Amount, and Bill Date. Each of these rows will be inserted into the Invoice Transaction table and given a Transaction Type of “Charge”. The Transaction Date will be the same as the Bill Date for charges.

The Invoice table will be loaded with one row per invoice with the total balance for that invoice. The Invoice table will also track the status of an invoice. The initial status will be set to “Open” unless there are no details associated with a particular invoice. The Load Invoice Tables process will be run with the billing stream.

The Load Invoice Tables process will also assign any system credits (generated to account for adjustments made after payment has been allocated and invoice marked as “Closed”) to the current invoice number sourced from the Billing Invoice file. The process will select from the join of the Invoice and Invoice Transaction tables any invoices with a status of “AOpen” for each bill payer that is in the Billing Invoice file. The process then write rows back to the Invoice Transaction table to close out the existing invoice and credit the current invoice. See the Adjustments made to Closed Invoices Example below.

Adjustment Processing—Billing/Web.

2nd User adjustments will come on the Billing Invoice file via the billing stream from 2nd User's BOSS legacy system. Adjustment information will be loaded into the Invoice Transaction table by the Load Invoice Tables process along with the invoice charge information and given a Transaction Type of “Adjustment”.

All other adjustments including all 1st User, all DGS, and 2nd User blanket adjustments will be entered into EBS via the Web interface. Adjustments entered through the Web will be written to the Invoice Transaction table also with a Transaction Type of “Adjustment”.

External Processing—Lockbox.

A lockbox vendor will receive all mail payments for payment processing. If a bill payer can be associated to the payment either through the EBS remit stub or corresponding documents, then the lockbox vendor will transmit the payment to the bank and write payment information to the Bank Payments file. Each remit stub contains a scan line for automatic association of a bill payer to the incoming payment. The scan line will include Bill Payer Number, Invoice Number, Unpaid Previous Balance, Total Amount Due, and Check Digit.

If a bill payer cannot be determined, the payment will be processed and sent to the bank for deposit as normal but with a Bill Payer Number of “Unknown”. The lockbox vendor will then send the EBS CSR team any correspondence received with “Unknown” payments, including a photocopy of the check. The EBS CSR team will use the additional correspondence to associate the payment with its correct bill payer. Once the CSR can determine the appropriate bill payer, they can update the Bill Payer Number through the Web interface. All customer payments sent to EBS via the lockbox for processing are done through an ACH (Automated Clearing House) lockbox interface of 823 transaction set.

Batch Processing—Payments.

The Payments batch cycle is executed each day, after the Bank Payments file is received from the bank. This file includes records of the mail payments and EDI transactions. Each transaction includes the Bill Payer Number (if available), Invoice Number (if available), Payment Date, Amount Paid, Trace Number, and Batch Number (Trace Number and Batch Number are for tracking purposes).

The Validate Bank Payments process receives and validates payments from the bill payers via the flat file received from the bank. This process verifies the format of the Bank Payment file, checking headers and trailers and verifying record counts. If the file does not validate successfully, then payment processing halts until a corrected version of the file can be obtained from the bank. Validate Bank Payments then checks the Bill Payer Number against the Bill Payer table to ensure that the Bill Payer Number is valid. If the Bill Payer Number is not valid, the payment is assigned a Bill Payer Number of null and continues to process with the rest of the payments.

After validation, the process writes the payment keyed with the Bill Payer Number to the Bill Payer Payment table. A line is written for each bill payer with the original Invoice Number (if available) and the Amount Paid.

Each row written to the Bill Payer Payment table will have an initial Allocated Status of “No”.

Once all payments in the file are written to the Bill Payer Payments table, the Allocate New Bill Payer Payments process retrieves all individual payments from the Bill Payer Payment table that have an Allocated Status of “No” denoting that payment has not been applied or attempted to be applied to invoices or “Fail” denoting that the payment previously failed allocation. For each record on the Bill Payer Payments table that matches the said criteria, the process then retrieves all open invoices on the Invoice Transaction table for that bill payer. Then the process assigns the payment to open invoices.

The system applies payment based on the Invoice Number denoted on the remit stub. If no Invoice Number is apparent the system tries to apply payment by matching up the amount of the payment with the amount of any outstanding invoices for that bill payer. It checks individual invoice amounts, sequential open invoice amounts, and then total charges. Payment will be allocated if any amount or combinations of amounts match. Payment will also be allocated if payment is greater than total charges for all invoices for a particular bill payer. In this case the left over payment will be written back to the Bill Payer Payments table as a credit to be applied to the next bill. See example below.

Allocation Example:

| Bill | Bill | Bill |
|---|---|---|
| Payer 1 | Payer 1 | Payer 1 |
| January | February | March |
| Invoice | Invoice | Invoice |
| $500 | | |

Process will start with January (oldest outstanding open invoice) and check the invoice amount against the payment amount. If it's equal, process will allocate payment to January Invoice. If it's not equal, process will check February Invoice (next oldest open invoice). If it's equal, process will allocate payment to February Invoice. If it's not equal, process will check March Invoice. If it's equal, process will allocate payment to March Invoice. Process will continue to check all open invoices for that bill payer.

Once all open invoices have been individually check and payment has not been allocated, process will check January Invoice ($500)+February Invoice ($1000). If it's equal, process will allocate payment to January Invoice and February Invoice and close both invoices. If it's not equal, process will check January Invoice ($500)+February Invoice ($1000)+March Invoice ($1500). If it's equal, process will allocate payment to January Invoice, February Invoice, and March Invoice and close all three invoices. Process will continue to check consecutive open invoices for that bill payer.

$1500 Payment Received—Process will allocate and close January Invoice($500) and February Invoice ($1000).

$2000 Payment Received—Process will allocate and close March Invoice ($2000).

$4000 Payment Received—Process will allocate and close January Invoice ($500), February Invoice ($1000), and March Invoice ($2000) and generate a $500 credit on the Bill Payer Payment table to be applied on next months invoice.

A Web report is created to list all payments that could not be applied systematically based on Invoice Number or Payment Amount. The CSR can view this report to call the customer and resolve any issues and disputes the customer has with an invoice(s). CSR's can resolve any issues by making adjustments via the online screens provided by the Web. Payments will not be applied until entire payment can be accurately determined. Invoice information is stored on the Invoice Transaction table by carrier and grouped by BTN (see Billing batch processing and Oracle table description) and therefore paid by applying payments to the Invoice Transaction table by individual carrier at the BTN level. The process will retrieve one row for every carrier, grouped by BTN for all individual open invoices for a particular bill payer. Each invoice will be summed and compared against the payment amount (see above Allocation example).

Once Allocate New Bill Payer Payments finds the appropriate invoice(s) to allocate payment to, each BTN per carrier is summed to include charges and adjustments for that carrier. The summed amount is used to create a payment record. The process writes a row per BTN for each carrier to the Invoice Transaction table with a Transaction Type of “Payment” and a default Distributed Status set to “No”. For each line with a Transaction Type of “Charge” there will be a corresponding line with a Transaction Type of “Payment” after a payment has been applied.

All payments for a bill payer will be summed into one payment and the summed amount is the amount used to compare to the invoice amounts for allocation; therefore each charge can only have one payment line.

After processing an invoice, the process determines the status of the invoice. If the sum of transactions for the invoice is=zero, the invoice is marked “Closed” on the Invoice table. If the sum is greater than zero, the status will remain “Open”. If the sum is less than zero, the invoice will be given a status of “Closed” and an additional line is written to the Bill Payer Payment table with the remaining amount of the payment to be summed and allocated with next month's payment.

If an adjustment is entered after the invoice has been marked “Closed” and payment has been allocated to the carrier, the Web will add a row to the Invoice Transaction table, as done with all adjustments, and update the Status on the Invoice table to “AOPEN”. The “AOPEN” status will trigger Load Invoice Tables to generate system credits. One with the previous invoice to close out the invoice and one with the current invoice number so that the credit is applied to the current invoice.

Adjustments made to Closed Invoices Example:

| Invoice Transaction Table | | | | Invoice Table | |
|---|---|---|---|---|---|
| Invoice # | Carrier | Amount | Type | Status | Who Updates |
| 1 | 1st user | 100 | Charge | Open | Load Invoice |
| 1 | 2nd user | 100 | Charge | Open | Load Invoice |
| 1 | 1st user | −100 | Payment | Closed | Allocate Pmts |
| 1 | 2nd user | −100 | Payment | Closed | Allocate Pmts |
| 1 | 1st user | −20 | Adjustment | Open | Web |
| 1 | 1st user | 20 | SCR | Closed | Billing Ext |
| 2 | 1st user | −20 | SCR | Open | Billing Ext |
| 2 | 1st user | 100 | Charge | Open | Load Invoice |
| 2 | 2nd user | 100 | Charge | Open | Load Invoice |
| 2 | 1st user | −80 | Payment | Closed | Allocate Pmts |
| 2 | 2nd user | −100 | Payment | Closed | Allocate Pmts |

The Allocate Bill Payer Payments runs directly subsequent to New Allocate Bill Payer Payments. Allocate Bill Payer Payments has the same basic functionality as Allocate New Bill Payer Payments, save that payments by bill payers are summed for each bill payer and payments are not allocated for a specific invoice if given, but rather by matching invoice amounts and consecutive invoice amounts.

The Process Carrier Payment process is executed daily to distribute the payments made by bill payers to the Carrier Payments table for all the payments received that day. It identifies the payments from the Invoice Transaction table by searching for any invoice with a Distributed Status of “No”. For payments to 2nd User, the payment will be written to the Carrier Payment table with the Bill Payer Number at the BTN level. For 1st User, payments will be made at the Bill Payer level leaving the BTN blank if one is not available. The new rows on the Carrier Payments table receive a Payment Status of “No” so that they will be picked up when the Produce Carrier Payment process is executed with that carrier's parameter. After each row is written to the Carrier Payments table, the Distributed Status is set to “Yes” on the Invoice Transaction table.

The Produce Carrier Payments process is executed daily to pay the carriers for all the bill payer payments allocated that day. It extracts each payment from the Carrier Payments table that has a Payment Status of “No” and a carrier matching the parameters for the run. It sends the formatted payment transactions to the ACH payment interface via a CTX with 820 records. It then updates the Carrier Payments table with the date of extraction and changes the Payment Status to “Yes”.

The process will be run for each carrier that is to be paid that day. The process will use the parameter, Carrier, to determine which payments to create. The Allocated Date on the Carrier Payments table will be used to select payments for a particular time frame dependent on Carrier. The Carrier field will be used to determine which carrier's payments to process. This will allow for some carriers to be paid on different schedules; for example, DGS will be paid once a month for the previous month's charges. See the following schedule of payments.

| | Payment Schedule |
|---|---|
| Carrier | (based on Allocation Date) |
| 2nd User | Daily |
| 1st User | Daily |
| 2nd User Management Fees: | |
| 1st User Toll Free | End of next month |
| Management Fees | |

Batch Processing—Billing.

The Billing Extract process, runs with the billing stream and extracts information from the AR tables based on the Extract Trigger file (HTDETF1A) that is necessary to create the bills. The information extracted from Accounts Receivable includes Previous Balance, Fit Code, description, and Date and Amount of payment(s) since last invoice. The information extracted reflects individual payments i.e. there is one record per payment.

Separate Fit Codes will be assigned in the Billing Extract process for Previous Balance and Payments. The process will be run once per bill round as part of the billing batch cycle. It will write to a file in the format of an IIR to be processed by BAI and integrated with the rest of the billing data.

Process Components and Descriptions:

New Components:

| Component | | | |
|---|---|---|---|
| (driver, | | | NBS |
| data | | | Components |
| layer, | | Description | to be |
| etc.) | Name/ID | Of Function | copied |
| Driver | BAR00011 | Validate Bank Payment. Validates | None |
| | | Bank Payment file and Bill Payer. | |
| | | Checks the Bill Payer Number | |
| | | against the Bill Payer table and | |
| | | uses the results to verify that | |
| | | a given Bill Payer Number is | |
| | | valid. It then uses the Write | |
| | | Payments data layer to insert | |
| | | new payments into the Bill Payer | |
| | | Payment table. | |
| Driver | BAR00081 | Allocate New Bill Payer Payments. | None |
| | | Uses the Retrieve New Unapplied | |
| | | Payments data layer to select | |
| | | rows (individual payments) that | |
| | | have not been applied to invoices | |
| | | (Status of “No” or | |
| | | “Fail”). The module then | |
| | | passes the information retrieved, | |
| | | Bill Payer Number, Invoice | |
| | | Number, and Payment Amount to | |
| | | the Select Invoice module for | |
| | | allocation. Allocate New Bill | |
| | | Payer Payments will receive back | |
| | | and indicator of “Yes” or | |
| | | “Fail” indicating whether | |
| | | a payment has been successfully | |
| | | allocated. This module then uses | |
| | | the Update New Bill Payer Payment | |
| | | data layer to update the Bill | |
| | | Payer Payment table | |
| | | with the Allocation Status Code | |
| | | and the Allocation Date if | |
| | | allocated. If an overpayment | |
| | | (open balance is less than | |
| | | payment) was made, the open | |
| | | balance will be paid and closed. | |
| | | The original payment will be | |
| | | marked as allocated and the Write | |
| | | Payments data layer is called to | |
| | | write the unused portion of the | |
| | | payment back to the Bill Payer | |
| | | Payment table. | |
| Driver | BAR00021 | Allocate Bill Payer Payments. | None |
| | | Uses the Retrieve Unapplied | |
| | | Payments data layer to select | |
| | | rows (payments) that have not | |
| | | been applied to invoices (Status | |
| | | of “No” or “Fail”). | |
| | | The module then passes the | |
| | | information retrieved, Bill | |
| | | Payer Number and Payment Amount | |
| | | to the Select Invoice module for | |
| | | allocation. Allocate Bill Payer | |
| | | Payments will receive back and | |
| | | indicator of “Yes” or | |
| | | “Fail” indicating whether | |
| | | a payment has been successfully | |
| | | allocated. This module then uses | |
| | | the Update Bill Payer Payment | |
| | | data layer to update the Bill | |
| | | Payer Payment table with the | |
| | | Allocation Status Code and the | |
| | | Allocation Date if allocated. If | |
| | | an overpayment (open balance is | |
| | | less than payment) was made, the | |
| | | open balance will be paid and | |
| | | closed. The original payment | |
| | | will be marked as allocated | |
| | | and the Write Payments data | |
| | | layer is called to write the | |
| | | unused portion of the payment | |
| | | back to the Bill Payer Payment | |
| | | table. | |
| Module | BAR00111 | Select Invoice. Uses the Retrieve | None |
| | | Invoice Details data layer to | |
| | | select invoices from a join on | |
| | | the Invoice and Invoice | |
| | | Transaction tables that have an | |
| | | Invoice Status of “Open”. | |
| | | Using the Bill Payer Number and | |
| | | Payment Amount passed from the | |
| | | Allocate Bill Payer Payments | |
| | | driver or the Allocate New Bill | |
| | | Payer Payments driver, the | |
| | | module applies the proper amount | |
| | | to each charge by using the | |
| | | Write Invoice Transaction data | |
| | | layer to insert payment rows | |
| | | matching the invoice charge and | |
| | | setting the Distributed Status | |
| | | to “No”. Select Invoice | |
| | | then calls the Update Invoice | |
| | | Status data layer to update the | |
| | | Invoice Status to “Closed”. | |
| | | The module then passes back to | |
| | | the driver an indicator whether | |
| | | successful allocation has been | |
| | | accomplished or not. | |
| Driver | BAR00031 | Process Carriers Payments. Uses | None |
| | | the Retrieve Allocated Payments | |
| | | data layer to select payments | |
| | | from the Invoice Transaction | |
| | | table that have not been | |
| | | distributed (Distributed Status | |
| | | equal to “No”) and writes | |
| | | a row to the Carrier Payment | |
| | | table using the Write Carrier | |
| | | Payments data layer. The row | |
| | | written will contain the | |
| | | Carrier, Bill Payer Number, BTN | |
| | | (for 2nd user; the field will be | |
| | | empty for 1st User), Payment | |
| | | Status, and Amount. The | |
| | | Distributed Status on the | |
| | | Invoice Transaction table will | |
| | | be set to “Yes” using the | |
| | | Update Invoice Transaction data | |
| | | layer, indicating that the | |
| | | payment has been distributed. | |
| Driver | BAR00041 | Produce Carrier Payments. Uses | None |
| | | either the Retrieve 2nd User | |
| | | Carrier Payments data layer, | |
| | | Retrieve 1st User Carrier | |
| | | Payments data layer, or | |
| | | Retrieve Other Carrier Payments | |
| | | data layer to select all rows | |
| | | that match the parameters | |
| | | (Carrier and Payment Date) from | |
| | | the Carrier Payment table with | |
| | | a Payment Status of “No”. | |
| | | For each row selected, the | |
| | | module sends the record to the | |
| | | Format ACH sub-module to write | |
| | | an ACH transaction to be | |
| | | transmitted to the ACH network. | |
| | | Selects the proper bank routing | |
| | | information from the Carrier | |
| | | Detail table using the Carrier | |
| | | Detail data layer. Uses the | |
| | | Update Date Driven Carriers or | |
| | | Update Non-date Driven Carriers | |
| | | to update Payment Status on the | |
| | | Carrier Payments table to | |
| | | “Yes”. Also updates the | |
| | | Pull Until Date on the Carrier | |
| | | Detail table using the Update | |
| | | Carrier Detail data layer. | |
| Module | BAR00051 | Format ACH. Formats payment | None |
| | | transactions into an ACH format | |
| | | that adheres to the lockbox 823 | |
| | | EDI standards. Records passed | |
| | | from the Produce Carrier | |
| | | Payments driver. | |
| Driver | BAR00061 | Billing Extract. During the | None |
| | | billing batch cycle, a triggers | |
| | | file is created which is input | |
| | | to this process. This file is | |
| | | read to determine which bill | |
| | | payers will be billed in this | |
| | | round. The Billing Extract | |
| | | module uses this file to extract | |
| | | Payments and Total Balance per | |
| | | bill payer. Payments are selected | |
| | | from the Bill Payer Payments | |
| | | table using the Retrieve Payment | |
| | | Details data layer and Total | |
| | | Balance is selected from | |
| | | the Invoice table using the | |
| | | Retrieve Total Balance data | |
| | | layer. Only those transactions | |
| | | since the last bill date are | |
| | | extracted. | |
| Driver | BAR00071 | Load Invoice Tables. Reads the | None |
| | | Billing Invoice file and uses the | |
| | | Write Invoice Transaction data | |
| | | layer to load the invoice charges | |
| | | into the Invoice Transaction | |
| | | table. Load Invoice Tables also | |
| | | uses information from the Billing | |
| | | Invoice file to Load a row for | |
| | | each invoice into the Invoice | |
| | | table using the Create Invoice | |
| | | Header data layer; this row | |
| | | represents the billed amount and | |
| | | current status, of the invoice. | |
| | | The initial status is set to | |
| | | “Open”. Portions of the | |
| | | record are passed down to the | |
| | | sub-modules Process System | |
| | | Credits and Process Adjustments | |
| | | for further processing. | |
| Module | BAR00121 | Process System Credits. Will be | None |
| | | called by Load Invoice Tables to | |
| | | assign any system credits. | |
| | | Process System Credits uses the | |
| | | Retrieve Invoice Details | |
| | | Datalayer to select any invoices | |
| | | with a status of “A” for | |
| | | AOPEN.” This process will | |
| | | call Write Invoice Transaction | |
| | | Datalayer to insert any system | |
| | | credits needed. The process | |
| | | then calls Update Invoice Status | |
| | | data layer to update the Invoice | |
| | | Status field to “Closed”. | |
| Module | BAR00131 | Process Adjustments. Will be | None |
| | | called by Load Invoice Tables | |
| | | for any adjustments that come | |
| | | in on the Billing Invoice file. | |
| | | It uses the Fetch Invoice Details | |
| | | Datalayer to retrieve the sum | |
| | | and status of a particular | |
| | | invoice. It then uses Write | |
| | | Invoice Transaction Datalayer | |
| | | to insert any adjustments. | |
| | | Lastly, it calls the Update | |
| | | Invoice Status data layer to | |
| | | update any Invoice status if | |
| | | they have changed. | |
| Data | BDLJ18SD | Write Payments. Allow Inserts to | None |
| Layer | | the Bill Payer Payment table to | |
| | | add individual bill payer | |
| | | payments. Called by the Validate | |
| | | Bill Payer Payments driver, the | |
| | | Allocate New Bill Payer Payments | |
| | | driver, and the Allocate Bill | |
| | | Payer Payment driver. | |
| Data | BDLJ15SD | Retrieve Unapplied Payments. | None |
| Layer | | Allow Selects from the Bill | |
| | | Payer Payment table to finds | |
| | | the sum of all payments for a | |
| | | particular bill payer that have | |
| | | not been allocated to invoices. | |
| | | Called by Allocate Bill Payer | |
| | | Payments driver. | |
| Data | BDLJ21SD | Retrieve New Unapplied Payments. | None |
| Layer | | Allow Selects from the Bill | |
| | | Payer Payment table to find all | |
| | | individual payments that have | |
| | | not been allocated to invoices. | |
| | | Called by Allocate New Bill | |
| | | Payer Payments driver. | |
| Data | BDLJ02SD | Update Bill Payer Payment. Allow | None |
| Layer | | Updates to the Bill Payer Payment | |
| | | table to update the Allocation | |
| | | Status for all payments for a | |
| | | particular bill payer. It also | |
| | | updates Allocation Date if | |
| | | payment has been allocated. | |
| | | Called by the Allocate Bill Payer | |
| | | Payments driver. | |
| Data | BDLJ22SD | Update New Bill Payer Payment. | None |
| Layer | | Allow Updatesto the Bill Payer | |
| | | Payment table to update the | |
| | | Allocation Status for individual | |
| | | payments. It also updates | |
| | | Allocation Date if payment has | |
| | | been allocated. Called by the | |
| | | Allocate New Bill Payer Payments | |
| | | driver. | |
| Data | BDLJ04SD | Retrieve Invoice Details. Allow | None |
| Layer | | Selects from a join on the | |
| | | Invoice and Invoice Transaction | |
| | | table to find invoices based on | |
| | | status for a given bill payer. | |
| | | Called by the Select Invoice | |
| | | module and the Process System | |
| | | Credits module. | |
| Data | BDLJ05SD | Write Invoice Transaction. Allow | None |
| Layer | | Inserts to the Invoice | |
| | | Transaction table to add rows | |
| | | to an invoice. Called by the | |
| | | Select Invoice module, the Load | |
| | | Invoice Tables driver, the | |
| | | Process Adjustment module, and | |
| | | the Process System Credits | |
| | | module. | |
| Data | BDLJ06SD | Update Invoice Status. Allow | None |
| Layer | | Updates to the Invoice table | |
| | | once the status of an invoice | |
| | | has changed. Called by the | |
| | | Select Invoice module, the Load | |
| | | Invoice Tables driver, the | |
| | | Process Adjustment module, and | |
| | | the Process System Credits | |
| | | module. | |
| Data | BDLJ16SD | Retrieve Allocated Payments. | None |
| Layer | | Allows Selects from the Invoice | |
| | | Transaction table to find any | |
| | | payments that have been | |
| | | allocated to invoices. Called by | |
| | | the Process Carrier Payments | |
| | | driver. | |
| Data | BDLJ07SD | Write Carrier Payments. Allow | None |
| Layer | | Inserts to the Carrier Payments | |
| | | table to add a payment row for | |
| | | any payment that is ready to be | |
| | | distributed to the carriers. | |
| | | Called by the Process Carrier | |
| | | Payments driver. | |
| Data | BDLJ17SD | Update Invoice Transaction. | None |
| Layer | | Allow Updates to the Invoice | |
| | | Transaction table to update the | |
| | | status for any payments that | |
| | | were distributed. Called by | |
| | | the Process Carrier Payments | |
| | | driver. | |
| Data | BDLJ08SD | Carrier Detail. Allow Selects | None |
| Layer | | from the Carrier Detail table | |
| | | to find carrier specific | |
| | | information. Called by the | |
| | | Produce Carrier Payments | |
| | | driver. | |
| Data | BDLJ09SD | Retrieve PacBell Payments. | None |
| Layer | | Allow Selects from the Carrier | |
| | | Payments table to retrieve any | |
| | | 2nd User, 4th user, or 3rd user | |
| | | payments that are ready to be | |
| | | paid to the carriers. Called by | |
| | | the Produce Carrier Payments | |
| | | driver. | |
| Data | BDLJ24SD | Retrieve 1st User Payments. | None |
| Layer | | Allow Selects from the Carrier | |
| | | Payments table to retrieve any | |
| | | 1st User payments that are | |
| | | ready to be paid to the | |
| | | carriers. Called by the Produce | |
| | | Carrier Payments driver. | |
| Data | BDLJ25SD | Retrieve Other Payments. Allow | None |
| Layer | | Selects from the Carrier Payments | |
| | | table to retrieve any DGS or | |
| | | Management Fee payments that are | |
| | | ready to be paid to the carriers. | |
| | | Called by the Produce Carrier | |
| | | Payments driver. | |
| Data | BDLJ10SD | Update Date Driven Carrier | None |
| Layer | | Payments. Allow Updates to the | |
| | | Carrier Payments table to update | |
| | | the status for any payments that | |
| | | have been paid based on date. | |
| | | Called by the Produce Carrier | |
| | | Payments driver. | |
| Data | BDLJ26SD | Update Non Date Driven Carrier | None |
| Layer | | Payments. Allow Updates to the | |
| | | Carrier Payments table to update | |
| | | the status for any payments that | |
| | | have been paid. Called by the | |
| | | Produce Carrier Payments driver. | |
| Data | BDLJ23SD | Update Carrier Detail. Allow | None |
| Layer | | Updates to the Carrier Detail | |
| | | table. Called by the Produce | |
| | | Carrier Payments driver. | |
| Data | BDLJ03SD | Retrieve Payment Details. Allow | None |
| Layer | | Selects from the Bill Payer | |
| | | Payment table to send payments | |
| | | since the last invoice to the | |
| | | billing stream. Called by the | |
| | | Billing Extract driver. | |
| Data | BDLJ19SD | Retrieve Total Balance. Allow | None |
| Layer | | Selects from the Invoice table | |
| | | to send total balance to the | |
| | | billing stream. Called by the | |
| | | Billing Extract driver. | |
| Data | BDLJ11SD | Fetch Invoice Details | |
| Layer | | (Status/Sum). Allows a fetch | |
| | | based on Invoice Number from | |
| | | a join on the Invoice and | |
| | | Invoice Transaction tables | |
| | | returning a summed amount for a | |
| | | particular invoice and its | |
| | | status. Called by Process | |
| | | Adjustments. | |
| Data | BDLJ13SD | Create Invoice Header in Invoice | None |
| Layer | | Table. Allow Inserts of Invoices | |
| | | to the Invoice table. Called by | |
| | | the Load Invoice Tables driver. | |

Tables and Descriptions:

Oracle Tables:

| Table | | | |
|---|---|---|---|
| Name | Description/Content | Actions | Owner |
| BILL_{—} | Receives Payments from bank via the | Insert, | AR |
| PYR_PMNT | Bank Payments file, the Allocate | Select, | |
| | Bill Payer Payment process and the | Update | |
| | Allocate New Bill Payer Payment | | |
| | process. Acts as source for | | |
| | distribution to invoices. The table | | |
| | contains the following pertinent | | |
| | fields: | | |
| | Bill Payer Number | | |
| | Incoming Payment Date | | |
| | Customer Provided Invoice Number | | |
| | Bill Payer Payment Amount | | |
| | Allocated Status (Y, N, F, S) | | |
| | Transaction Type Code | | |
| | Allocation Date | | |
| | Trace Number | | |
| | Batch Number | | |
| | The Allocation Status field will be | | |
| | updated when the payment is applied | | |
| | to the invoices. | | |
| INVC | Contains the current status of each | Insert, | AR |
| | invoice. Table contains the | Select, | |
| | following pertinent fields: | Update | |
| | Bill Payer Number | | |
| | Invoice Number | | |
| | Bill Date | | |
| | Bill Round Number | | |
| | Total Balance | | |
| | Invoice Status (Open, Closed, AOpen) | | |
| | Invoice Amount | | |
| | The invoice will be inserted when | | |
| | the charges are loaded into the | | |
| | Invoice Transaction table from | | |
| | billing. It will be updated when | | |
| | payment amounts are applied for that | | |
| | invoice. If the sum for the invoice | | |
| | is less than or equal to 0 after the | | |
| | payments are applied, the status | | |
| | will be “Closed” and the | | |
| | excess payment is written back to | | |
| | the Bill Payer Payment table. | | |
| | If the sum > 0 the status will be | | |
| | left “Open. | | |
| INVC_TRAN | Receives invoice detail from Billing | Insert, | AR |
| | Invoice file via the Load Invoice | Select, | |
| | Tables process. Represents all the | Update | |
| | actions made concerning an invoice. | | |
| | Used to determine disbursement to | | |
| | carriers. Receives adjustments from | | |
| | web interface and billing stream. | | |
| | The table contains the following | | |
| | pertinent fields: | | |
| | Invoice Number | | |
| | Invoice Transaction ID | | |
| | BTN | | |
| | Carrier | | |
| | Bill Date | | |
| | Transaction Type | | |
| | (Charge, Adjust, Payment, System | | |
| | Credit) | | |
| | Transaction Amount | | |
| | Transaction Date | | |
| | Distributed Status (Y, N) | | |
| | The original invoice amounts will | | |
| | receive a transaction type of | | |
| | “Charge”. Any adjustments from | | |
| | the web or billing stream will | | |
| | receive a type of “Adjustment”. | | |
| | Payments will receive a type of | | |
| | “Payment” and any credits due | | |
| | to adjustments made to closed | | |
| | invoices will receive the status of | | |
| | “System Credit”. Transactions | | |
| | that reduce the amount of the bill | | |
| | will be shown as negative numbers | | |
| | in the table. The Transaction | | |
| | Date records when the transaction | | |
| | was made against the invoice. Charges | | |
| | will use the Bill Date, Adjustments | | |
| | will use the Adjustment Date | | |
| | and Payments will use the Allocation | | |
| | Date as the Transaction Date. The | | |
| | payment distributed status is updated | | |
| | when a payment is converted to payment | | |
| | to the carriers. | | |
| CRR_DTL | Contains payment configuration | | |
| | information for each carrier that | | |
| | will be paid separately. The table | | |
| | contains the following pertinent | | |
| | fields: | | |
| | Carrier | | |
| | Routing Number | | |
| | Account Number | | |
| | Bank Name | | |
| | Pull Until Date This information will | | |
| | be used by the Produce Carrier | | |
| | Payments process to determine which | | |
| | bank to route payments to. The Last | | |
| | Payment field will be updated with | | |
| | the current date each time a payment | | |
| | is made. In some cases, this date | | |
| | may be used as a cutoff date for | | |
| | previous month's payments to allow | | |
| | for lump payments by month. | | |
| CRR_PYMT | Receives disbursement to carriers. | Insert, | AR |
| | Acts as source for payment creation. | Select, | |
| | Will be used by reporting to create | Update | |
| | payment reports. The table contains | | |
| | the following pertinent fields: | | |
| | Carrier | | |
| | Bill Payer Number | | |
| | BTN | | |
| | Payment Date | | |
| | Carrier Payment Amount | | |
| | Payment Status | | |
| | Invoice Number | | |
| | Allocation Date | | |
| | File ID | | |
| | Bill Payer Number and BTN are used | | |
| | to provide information to 2nd User | | |
| | and 1st User regarding who made the | | |
| | payment. Payment Status is updated | | |
| | when the Produce Carrier Payments | | |
| | process makes ACH transactions from | | |
| | the information provided on this | | |
| | table. | | |

Reports.

| | | Delivery |
|---|---|---|
| | | Method |
| | | (File |
| | | NDM, File |
| Report Name | Description/Content | web, table) |
| ACH Detail | Contains payments made from | Table |
| (Payment | EBS to the Carriers based on | |
| Selection) | either Transaction Amount, | |
| | Control Account (World Com), | |
| | BTN (2nd User), Invoice Number, | |
| | ACH Confirmation Number, or | |
| | ACH Date. Data will be extracted | |
| | from the Carrier Payments table | |
| | by the Web interface. | |
| ACH Detail | Contains payments made from EBS | Table |
| (Payment | to the Carriers based on either | |
| Detail) | Transaction Amount, Control | |
| | Account (World Com), BTN (2nd | |
| | User), Invoice Number, ACH | |
| | Confirmation Number, or ACH | |
| | Date. Data will be extracted | |
| | from the Carrier Payments | |
| | table by the Web interface. | |
| ACH Detail | Contains payments made from | Table |
| (Payment | EBS to the Carriers based on | |
| Master) | either Transaction Amount, | |
| | Control Account (World Com), | |
| | BTN (2nd User), Invoice | |
| | Number, ACH Confirmation Number, | |
| | or ACH Date. Data will be | |
| | extracted from the Carrier | |
| | Payments table by the Web | |
| | interface. | |
| 2nd User | Contains amount of DGS admin | Table |
| Administration | fees billed, adjustments to those | |
| Fee | fees, fees paid to DGS and the | |
| Summary | Date the fees were paid. This | |
| | information is available | |
| | from the Invoice Transaction | |
| | table. | |
| Collection | Contains the historical totals | Table |
| Data | for live, final and non-category | |
| Summary | accounts that are past due. Total | |
| | charges, Total past due, 31-60, | |
| | 61-90, etc are taken at point in | |
| | time and stored in a table. A process | |
| | will be written to make these | |
| | calculations once a month. This table | |
| | will then be read to produce the | |
| | report. The Bill Payer table can be | |
| | queried to determine if an account is | |
| | Live, Final or Non-Category | |
| Aged | Past due amounts and previous payment | Table |
| Receivables | amounts are obtained from the Invoice | |
| Detail/ | Transaction table. Other information | |
| Watched | such as Account Assigned to UUID, last | |
| Account List | reviewed date, etc will be maintained | |
| | on the web side. | |
| Payment | Will use the payment information on | Table |
| Distribution | the Invoice Transaction table to show | |
| | payments made by a bill payer throughout | |
| | a date range. This data is supplied | |
| | by selecting all the rows for the Bill | |
| | Payer Number with a Transaction Date | |
| | in the range and a Transaction Type of | |
| | “Payment” from the Invoice | |
| | Transaction table. | |
| A/R Aging | Will use the Invoice and Invoice | Table |
| Reports | Transaction tables to determine | |
| (BASUMOT) | dollar amounts and percentages of | |
| | invoices | |
| | that are in each category of aging. | |
| | The status table will tell which | |
| | accounts are in each category and | |
| | can be joined to the invoice table | |
| | to determine amounts due. | |
| A/R Aging | Will use the Invoice and Invoice | Table |
| Reports | Transaction tables to determine dollar | |
| (ARSUMOT) | amounts and percentages of invoices | |
| | that are in each category of aging. | |
| | The status table will tell which | |
| | accounts are in each category and | |
| | can be joined to the invoice table | |
| | to determine amounts due. | |
| A/R | Will use the Invoice and Invoice | Table |
| Screen | Transaction tables to provide open | |
| | amount information by Bill Date and | |
| | Invoice Number for the BTN or Bill | |
| | Payer that is chosen as selection | |
| | criteria. The open amounts will be | |
| | displayed by carrier in a column for | |
| | each bill date. | |

Interfaces:

| Interface Name | Description |
|---|---|
| Bank Lockbox | The Bank Lockbox provides Accounts |
| | Receivable with a Bank Payment |
| | file, which contains all transactions |
| | made against the EBS bank account |
| | with bill payer information, etc. |
| ACH Interface | Accounts Receivable sends carrier |
| | payment information from the Carrier |
| | Payment table to the ACH Interface |
| | to generate a payment transaction. |
| OI | OI provides invoice details from |
| | the billing cycle to Accounts |
| | Receivable. |
| BAI | Accounts Receivable sends payment |
| | since last invoice and total amount |
| | due to BAI for inclusion on the bill. |
| Web Interface | Accounts Receivable provides |
| | information through tables for several |
| | reports that are produced on the web. |
| Web Interface | The Web provides adjustment information |
| | to Accounts Receivable by updating the |
| | Invoice Transaction table directly. |
| Reporting | Accounts Receivable provides data for |
| | reports (see above descriptions). |
| | A/R information will be stored at |
| | the lowest level of detail necessary |
| | for any one of the reports. |

Glossary:

| | Definition |
|---|---|
| Full Payment | Payment is equal to total amount due. |
| Odd Payment | Payment is greater than the smallest |
| | invoice, not equal to any open |
| | invoice, and less than total amount due. |
| Short Payment | Payment is less than any open invoice. |
| Over Payment | Payment is greater than total amount due. |
| Current Charges | The charges for the current month's |
| | charges (previous bill round to current |
| | bill round). |
| Previous Balance | The summation of all transactions |
| | previous to the last bill round. |
| Total Balance | The total amount due as it appears |
| | on an invoice for the current |
| | month. Total Balance = previous |
| | balance − payments − adjustments |
| | + current charges |

Having described the invention in terms of a preferred embodiment, it will be recognized by those skilled in the art that various types of general purpose computer hardware may be substituted for the configuration described above to achieve an equivalent result. Similarly, it will be appreciated that arithmetic logic circuits are configured to perform each required means in the claims for performing the various features of message recognition, message creation, message storage and connection to a mobile telephony system. It will be apparent to those skilled in the art that modifications and variations of the preferred embodiment are possible, such as different server computer systems may be used, different communications media such as wireless communications, as well as different types of client computers may be used by addressees and or senders of various types of electronic messages, all of which fall within the true spirit and scope of the invention.

What is claimed is:

1. A method of integrating an invoice solution, comprising:
accepting billing data from multiple sources;
establishing a user defined hierarchy;
creating an integrated invoice for the user based on the billing data;
displaying the integrated invoice via a network; and
processing a payment from a customer.

2. The method of integrating an invoice solution according to claim 1, wherein the billing data from at least one of the multiple sources is in a different format than the billing data from another one of the multiple sources.

3. The method of integrating an invoice solution according to claim 2, wherein the network is Internet based.

4. The method of integrating an invoice solution according to claim 3, further comprising applying an administrative fee to the integrated invoice.

5. The method of integrating an invoice solution according to claim 4, wherein the administrative fee is tracked.

6. The method of integrating an invoice solution according to claim 3, further comprising calculating a tax for the integrated invoice and applying the tax to the integrated invoice.

7. The method of integrating an invoice solution according to claim 3, further comprising generating a report for the integrated invoice.

8. The method of integrating an invoice solution according to claim 3, further comprising generating a paper output and CD-ROM of the integrated invoice.

9. The method of integrating an invoice solution according to claim 3, further comprising processing an adjustment for the integrated invoice.

10. The method of integrating an invoice solution according to claim 3, wherein the payment processing includes accepting a single payment from the customer and remitting appropriate amounts of the payment to the multiple sources.

11. The method of integrating an invoice solution according to claim 10, wherein the single payment is less than a total invoice amount.

12. A system for integrating an invoice solution, comprising:
a data input module connected to multiple sources for receiving billing data;
an invoice module for creating an integrated invoice based on the received billing data;
a hierarchy module for establishing a hierarchy for the billing data;
an application module for apply a fee to the integrated invoice;
an output module for outputting the integrated invoice; and
a process module for processing a payment.

13. The system for integrating an invoice solution according to claim 12, wherein the data input module receives billing data in different formats.

14. The system for integrating an invoice solution according to claim 13, wherein the fee is one of an administrative fee, a tax, and a surcharge.

15. The system for integrating an invoice solution according to claim 13, wherein the output module outputs the integrated invoice as one of a data file displayable on a network, a paper output, and a CD-ROM.

16. The system for integrating an invoice solution according to claim 13, wherein the process module receives the payment and remits appropriate amounts of the payment to the multiple sources.

17. The system for integrating an invoice solution according to claim 16, wherein the payment is less than an invoice amount.

18. The system for integrating an invoice solution according to claim 13, wherein the invoice module creates a report for the integrated invoice.
